(19) United States
(12) Patent Application Publication
(10) Pub. No.: US 2026/0319102 A1
(43) Pub. Date: Oct. 15, 2026

(54) AUTHENTICATING NAVIGATION SIGNALS BASED ON APPLYING AN ACCUMULATED PLURALITY OF CRYPTOGRAPHIC PSEUDORANDOM FUNCTION RANGING CODE SAMPLES

(71) Applicant: Xona Space Systems Inc., Burlingame, CA (US)

(72) Inventor: Jason Steven Anderson, Redwood City, CA (US)

(73) Assignee: Xona Space Systems Inc., Burlingame, CA (US)

(21) Appl. No.: 19/641,837

(22) Filed: Apr. 8, 2026

Related U.S. Application Data
(60) Provisional application No. 63/788,261, filed on Apr. 14, 2025.
(60) Provisional application No. 63/788,263, filed on Apr. 14, 2025.
(60) Provisional application No. 63/887,332, filed on Sep. 24, 2025.
(60) Provisional application No. 63/891,731, filed on Oct. 1, 2025.

(51) Int. Cl. G01S 19/21; H04L 9/32

(52) U.S. Cl. CPC G01S 19/215; H04L 9/32

(57) ABSTRACT

A receiver module is operable to store an accumulated plurality of cryptographic pseudorandom function ranging code samples extracted from a first navigation signal transmitted via a first satellite of the plurality of satellites. A replica cryptographic pseudorandom function ranging code is generated based on processing cryptographic pseudorandom function seed data via a corresponding cryptographic pseudorandom function. A linear time invariant matching filter is applied to generate a plurality of first correlation data based on correlation of the replica cryptographic pseudorandom function ranging code with each of the accumulated plurality of cryptographic pseudorandom function ranging code samples. An aggregated value is generated based on processing the plurality of first correlation data, where the first navigation signal is authenticated based on the aggregated value comparing favorably to a threshold value.

### CROSS REFERENCE TO RELATED APPLICATIONS

The present U.S. Utility patent application claims priority pursuant to 35 U.S.C. § 119(e) to U.S. Provisional Application No. 63/887,332, entitled “GNSS RECEIVER OPERABLE TO APPLY A GNSS RANGING PROTOCOL IMPLEMENTING AUTHENTICATION SECURITY”, filed Sep. 24, 2025; U.S. Provisional Application No. 63/891,731, entitled “GALILEO RECEIVER OPERABLE TO IMPLEMENT AUTHENTICATION SECURITY OF GNSS RANGING AND METHODS FOR USE THEREWITH”, filed Oct. 1, 2025; U.S. Provisional Application No. 63/788,261, entitled “GENERATION AND/OR PROCESSING OF NAVIGATION SIGNALS”, filed Apr. 14, 2025; and U.S. Provisional Application No. 63/788,263, entitled “GENERATION AND/OR PROCESSING OF NAVIGATION SIGNALS VIA APPLYING AUTHENTICATION AND/OR ENCRYPTION MECHANISMS”, filed Apr. 14, 2025, all of which are hereby incorporated herein by reference in their entirety and made part of the present U.S. Utility patent application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This disclosure relates generally to satellite systems and more particularly to global navigation satellite systems and radio occultation.

### BRIEF DESCRIPTION OF THE SEVERAL VIEWS OF THE DRAWING(S)

FIG. 1 is a schematic block diagram of an embodiment of a satellite constellation system in accordance with various embodiments;

FIG. 2 is a schematic block diagram illustrating various communication links utilized by a satellite constellation system in accordance with various embodiments;

FIG. 3A is a schematic block diagram of a satellite in accordance with various embodiments;

FIG. 3B is a schematic block diagram of a satellite processing system in accordance with various embodiments;

FIG. 3C is a pictorial diagram of a satellite in accordance with various embodiments;

FIG. 3D is a pictorial diagram of a satellite in accordance with various embodiments;

FIG. 4 is a schematic block diagram of a satellite constellation system utilized to perform radio occultation in accordance with various embodiments;

FIG. 5A is a flowchart diagram illustrating an example of a state estimator flow performed by a satellite processing system in accordance with various embodiments;

FIG. 5B is a flowchart diagram illustrating an example of a navigation message generation flow performed by a satellite processing system in accordance with various embodiments;

FIG. 5C is a flowchart diagram illustrating an example of a broadcast flow performed by a satellite processing system in accordance with various embodiments;

FIG. 6 is an illustration depicting the process of self-monitoring by a satellite processing system in accordance with various embodiments;

FIG. 7A is a schematic block diagram of satellites utilized to perform neighborhood monitoring in accordance with various embodiments;

FIG. 7B is an illustration of orbital planes in accordance with various embodiments;

FIG. 7C is a schematic block diagram of satellites utilized to perform neighborhood monitoring in accordance with various embodiments;

FIGS. 8A-8L are schematic block diagrams illustrating utilization of a satellite constellation system by various client devices in accordance with various embodiments;

FIG. 8M is a flowchart diagram illustrating an example of a method in accordance with various embodiments;

FIG. 9A is a schematic block diagram illustrating an example client device in accordance with various embodiments;

FIG. 9B is a schematic block diagram illustrating an example client device in accordance with various embodiments;

FIGS. 10A-10E present example embodiments of at least one receiver module of a client device in accordance with various embodiments;

FIGS. 11A-11B are schematic block diagrams illustrating transmission of a stream of data frames by a data frame generation and transmission system for receipt by a plurality of data frame receival and processing systems in accordance with various embodiments;

FIG. 12A is a schematic block diagram of a navigation processing system implementing a navigation data generator module in accordance with various embodiments;

FIGS. 12B-12C is a schematic block diagrams of a client device implementing an authentication module in accordance with various embodiments;

FIG. 12D is a schematic block diagram of a navigation processing system that processes authentication data for multiple navigation signal components;

FIGS. 12E-12F are schematic block diagrams of a client device implementing an authentication module in accordance with various embodiments;

FIGS. 12G-12I are schematic block diagrams of a navigation processing system that implements a watermarking module in accordance with various embodiments;

FIGS. 12J-12K are schematic block diagrams of a client device that implements a watermarking module in accordance with various embodiments;

FIG. 12L is a schematic block diagram of a client device implementing an authentication module to generate statistical values in accordance with various embodiments;

FIG. 12M is a schematic block diagram of a navigation processing system that implements a watermarking seed data generator module in accordance with various embodiments;

FIG. 12N is a schematic block diagram of a client device that implements a watermarking seed data generator module in accordance with various embodiments;

FIG. 12O is a schematic block diagram of a navigation processing system that applies hash point usage scheduling data in accordance with various embodiments;

FIG. 12P illustrates a plurality of navigation processing systems that apply hash point usage scheduling data in accordance with various embodiments;

FIG. 12Q is a schematic block diagram of a navigation processing system that applies a hash point distribution plan in accordance with various embodiments;

FIG. 12R is a schematic block diagram of a client device that implements a hash point extraction module in accordance with various embodiments;

FIG. 12S is a schematic block diagram of a navigation signal generation and transmission module that applies a hash point distribution plan for a plurality of signal components;

FIGS. 12T and 12U are schematic block diagrams of a client device that implements a hash point extraction module in accordance with various embodiments;

FIG. 12V illustrates an example hash point distribution plan for a plurality of signal component groups in accordance with various embodiments;

FIGS. 12W-12X illustrate example signal components of an example embodiment of a navigation signal in accordance with various embodiments;

FIGS. 12Y-12Z are logic diagrams illustrating example methods for execution in accordance with various embodiments;

FIGS. 13A-13F are schematic block diagrams of a GNSS receiver module in accordance with various embodiments;

FIGS. 13G-13M illustrate relationships between various parameters in accordance with various embodiments; and

FIGS. 13N-13O are logic diagrams illustrating example methods for execution in accordance with various embodiments.

### DETAILED DESCRIPTION OF THE INVENTION

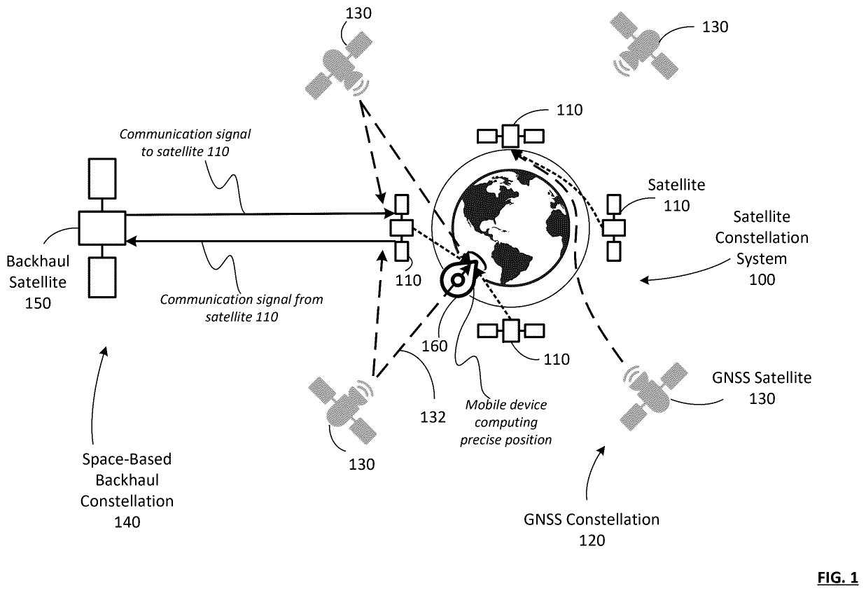

FIG. 1 illustrates an embodiment of a satellite constellation system 100. Satellite constellation system 100 can include a plurality of satellites 110, which can be implemented via combination of devoted purpose-built satellites, purpose built payloads on a standard satellite bus, and/or hosted payloads or services part of another satellite network. These satellite bus and navigation components can make use of commercial-of-the-shelf (COTS) components and be compatible with CubeSat and other standard bus architectures. In some embodiments, some or all of the plurality of satellites 110 of satellite constellation system 100 orbit in accordance with low earth orbit (LEO), and can be referred to as “LEO satellites”. Alternatively, some or all satellites of the first satellite constellation can orbit in accordance with medium earth orbit (MEO), and/or geostationary orbit (GEO). Satellite constellation system 100 is operable to provide secure precision location and time transfer services and/or monitoring atmospheric and environmental conditions.

Some or all of the satellites 110 can receive signals 132 from Global Navigation Satellite System (GNSS) satellites 130 of a GNSS constellation 120. The signals 132 include, for example, a ranging signal containing clock information and almanac and ephemeris information that can be used for precision positioning, navigation and timing. The GNSS constellation 120 can be implemented by utilizing one or more of the Global Positioning System (GPS) satellite constellation, the Quasi-Zenith Satellite System, the BeiDou Navigation Satellite System, the Galileo positioning system, the Russian Global Navigation Satellite System (GLONASS) the Indian Regional Navigation Satellite System and/or any other satellite constellation utilized for navigation services. In some embodiments, some or all of the plurality of GNSS satellites 130 of the GNSS constellation 120 can orbit in accordance with MEO, and/or some or all of the plurality of GNSS satellites 130 or otherwise can orbit in another outer orbit from the satellites 110 of the satellite constellation system 100. In either case, when the satellites 110 are LEO satellites, the GNSS satellites can be referred to as “non-LEO satellites”.

Some or all of the satellites 110 can send signals to and/or receive signals from one or more backhaul satellites 150. Backhaul satellite 150 can be implemented by utilizing a satellite in any orbit, such as (LEO), (MEO), and/or (GEO), provided satellite 150 is capable of transmitting and/or receiving data from satellite 110. In some embodiments, a backhaul satellite constellation 140 can include a plurality of backhaul satellites 150 operable to bidirectionally communicate with satellites 110. In various embodiments, one or more backhaul satellites include an atomic clock for transmitting a timing reference in communications to the satellites 110.

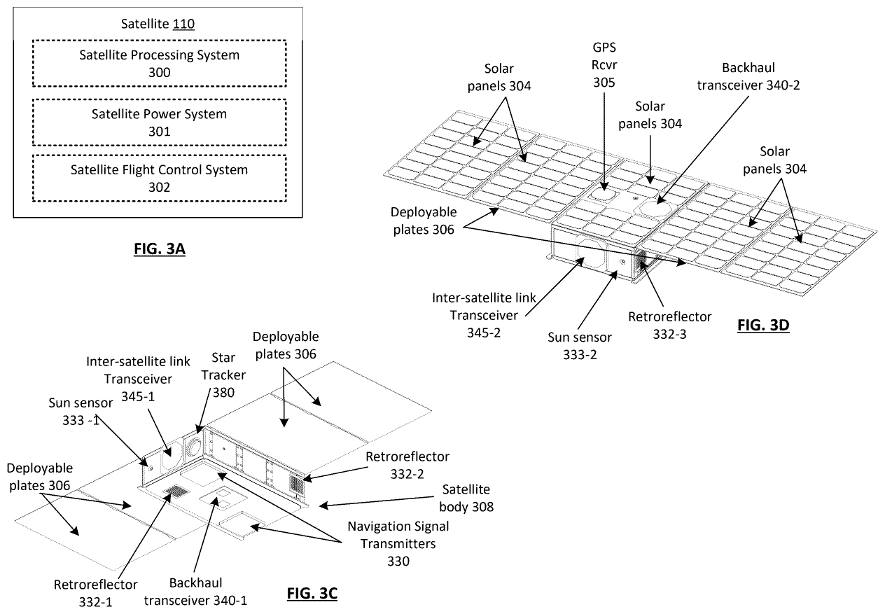

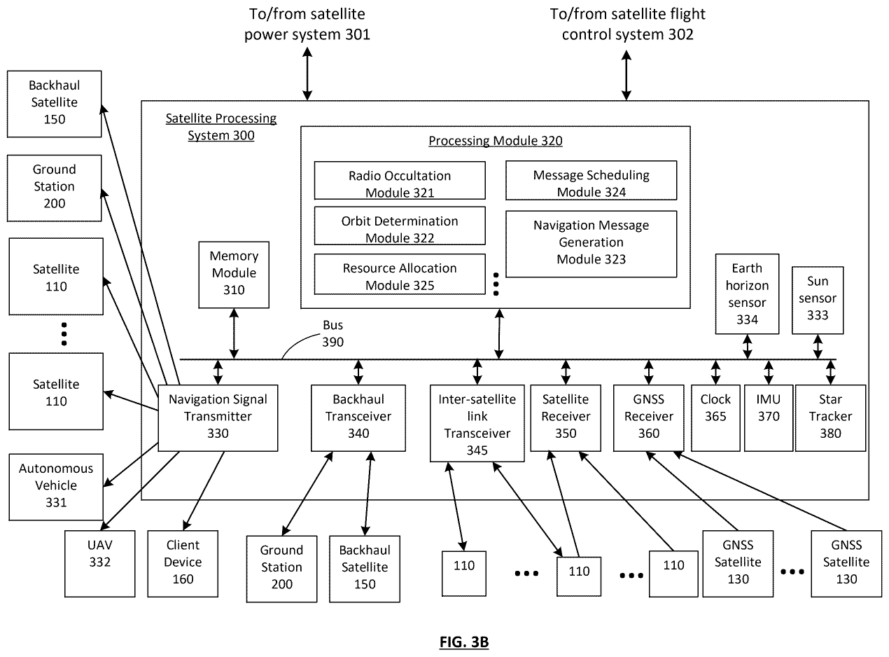

In various embodiments, the one or more backhaul satellites 150 can be selectively implemented via one or more of the satellites 110 that have been assigned this functionality, on a dedicated basis, when for example, the navigation functionality of a satellite 110 has degraded to the point where it is no longer useful to provide secure precision location and time transfer services and/or monitoring atmospheric and environmental conditions. Furthermore, one or more satellites 110 can be assigned the role of backhaul satellite based on its status such as its position in orbit, current utilization, battery capacity and/or other state or condition of the satellite 110 or otherwise, as will be discussed later, for example, in conjunction with the resource allocation of FIG. 3B.

The satellite constellation system 100 can be operable to provide navigation services through a space-based broadcast of encrypted and/or unencrypted navigation messages, atmospheric and/or other signal(s) which can include timing data and overlaid data for satellite identification and precision positioning and navigation. This data can include, but is not limited to, (i) precision orbit and clock data of both the precision satellite system and of the GNSS constellation; (ii) atmospheric data, models and/or other atmospheric monitoring data used for determining a current weather state, for weather prediction, for control of the satellites 110 and/or for further orbit or clock data correction; (iii) cryptographic parameters including encryption key management; (iv) integrity information concerning the backhaul satellites 150, satellite constellation system 100, the GNSS satellites 130 and/or their constellations; and (v) general messages to pass information (such as state, conditions, health, and other command and control information) between satellites 110 and the ground and/or other types of data discussed herein. This data can be derived based on some combination of measurements from (i) terrestrial monitoring stations; and (ii) GNSS measurements taken by the satellite constellation system 100 in-situ. In case (ii), precision orbit data of the GNSS satellites can be uploaded to the satellite constellation system 100 via space-based backhaul communications, reducing the need for ground links, though ground links and intersatellite links can also be used. This enables autonomous orbital position and clock determination in orbit.

Alternatively or in addition, the satellite constellation system 100 can be operable to collect atmospheric data by means of radio occultation (RO) through some combination of GNSS and other signals of opportunity including some broadcast by satellites 110 of the satellite constellation system 100 themselves. Higher broadcast power than GNSS utilized by the satellite constellation system 100 allows for deeper penetration into the atmosphere that enable processing to yield higher fidelity ionospheric and tropospheric models both in terms of spatial and temporal updates. These high density models can serve multiple purposes such as (i) data for weather prediction models on the ground or in situ in the satellite 110; and (ii) the construction of local, regional and/or global ionospheric and tropospheric corrections for use in precision navigation both by the satellite constellation system 100 and by standard GNSS. The raw or processed data can be transmitted back from the ground to the satellite constellation system 100 by some combination of ground stations or space-based backhaul communications.

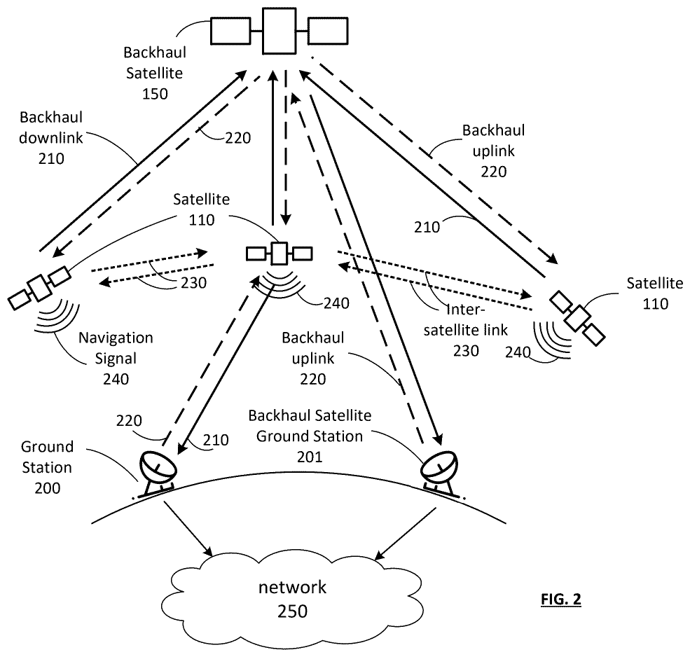

The GNSS satellites 130 can provide signals to satellites 110 for GNSS Radio Occultation for use in atmospheric monitoring, mapping and other atmospheric data generation. These measurements can, in turn, be sent to the ground through a combination of communication links, as discussed in further detail in conjunction with FIG. 2. Through this connection with the ground, precise orbits and clocks of the GNSS satellites 130 can be uploaded to the satellite constellation system 100. This orbit and clock data can be used along with measurements from GNSS, other correction data, sensors onboard, and/or other information to autonomously perform orbit and clock determination onboard satellite 110. Atmospheric models can be generated indicating signal delays in the ionosphere and troposphere and/or indicating weather data including a current weather state, a predictive weather model or other atmospheric data, can be broadcast along with precision orbit and clock data for use in precision navigation on Earth, included in backhaul and/or inter-satellite communication and used by the satellites 110 to further enhance the determination of their orbital position. The atmospheric data can include corrections created on the ground as part of the data products produced as part of atmospheric monitoring. Alternatively or in addition, these atmospheric data and corrections can be created autonomously by one or more satellites in situ, where data is shared between satellites in the satellite constellation system 100, and where, for example, edge computing on board one or more satellites 110 is used to create local, regional or global atmospheric and/or weather models.

At least one client device 160 can include a receiver configured to receive the signals transmitted by at least one satellite 110. The receiver can be configured to receive the signals directly from the satellites 110, and/or can be configured to receive this information from ground stations, server systems, and/or via a wired and/or wireless network. The client device 160 can include at least one memory that stores operational instructions for execution by at least one processor of the client device 160, enabling the client device 160 to process signals transmitted by the satellites 110 to extract the atmospheric models, precision orbit data, clock data, and/or other data from the signals. The client device 160 can be operable to process the signals and/or this data to compute its precise position (i.e., an “enhanced position” with greater accurate when compared with ordinary positioning provided by the GNSS system) and/or a precise time. This precise position and/or precise time can be further processed by client device 160 and/or can be otherwise utilized by the client device 160 for positioning, navigation and/or timing and/or otherwise to perform its functionality in conjunction with one or more of a range of applications discussed herein. A client device 160 can be operable to display, via a display device of the client device some or all of the atmospheric models, precision orbit data, and/or clock data received from the least one satellite 110 for review by a user of the client device 160.

Alternatively or in addition, this precise position and/or other data generated utilizing the signals received from satellites 110 can be transmitted, via a transmitter of the client device 160, to a server system or other computing device, for example via network 250. For example, this server system and/or other computing device can be associated with an entity responsible for tracking of client device 160 and/or responsible for monitoring secure performance of client device 160. Thus, storing, processing, and/or display of this information received from one or multiple client devices 160 can be facilitated by the server system and/or another computing device, for example, via its own at least one processor and/or at least one memory.

Client devices 160 can include, can be implemented within, and/or can be otherwise utilized by devices on the ground, devices near the earth's surface, devices within the atmosphere, and/or other space-based systems. Client devices 160 can include, can be implemented within, and/or can be otherwise utilized by mobile devices, cellular devices, wearable devices, autonomous or highly automated vehicles or other vehicles such as cars, planes, helicopters, boats, unmanned aerial vehicles (UAVs), fixed devices installed upon or within infrastructure, and/or other computing devices operable to receive and/or utilize the atmospheric models, precision orbit data, and/or clock data.

The LEO satellite 110 provides a reduced distance to earth, which, combined with the greater signal power compared with GNSS, provides client devices 160 with much stronger signals. The reduced orbital period of the LEO further provides faster signal convergence. The LEO satellite 110 includes many additional technological improvements and advantages including many functions, features and combinations thereof as described further herein.

FIG. 2 illustrates embodiments of the communication of various data via satellite constellation system 100. As part of satellite constellation system 100's task of generating a precision navigation signal and/or environmental monitoring, data can be transferred between the ground stations 200 and/or 201 and the satellites 110, between satellites 110 in satellite constellation system 100 and other satellites in space, and/or between any combination of entities capable of receiving or transmitting data of interest to satellite 110 as part of satellite constellation system 100.

This transfer can be facilitated via a plurality of nodes of the satellite constellation system 100. As used herein, nodes of the satellite constellation system 100 can correspond to any devices that generates, receives, transmits, modifies, stores, and/or relays messages or other data communicated by satellite constellation system 100 as discussed herein. Nodes of satellite constellation system 100 can include one or more satellites 110; one or more ground stations 200 and/or 201; one or more backhaul satellites 150; and/or one or more client devices operable to utilize information included in messages in its operation and/or operable to display information included in messages to a user.

The data communicated between nodes of the satellite constellation system 100 can be comprised of many different message types, including, but not limited to: navigation messages containing data to enable the determination of a precise position by an end user device or end user system; precise point positioning (PPP) correction messages containing precise orbit and clock data of GNSS satellites and/or other satellites in satellite constellation system 100; atmospheric correction messages containing temperature, humidity, and/or other atmospheric parameters that affect the precision of the navigation signal that can be corrected for; command and control messages containing command and control information for the physical direction and/or attitude of the satellite, satellite state management, and/or enabling and/or disabling different transmissions of satellite 110; measurement messages containing ground based and/or external space-based measurements that can augment the navigation filter (as part of the orbit determination module); status messages containing information about satellite 110's signal health, battery usage, power generation, memory usage and/or other information providing status information; cryptographic messages containing information providing encryption key updates along with any general encryption scheme updates; constellation monitoring messages contain GNSS satellite and/or constellation health information, estimated performance of each satellite and/or each constellation, and/or other information related to other GNSS satellites and/or constellations; and/or other messages containing information that can be transmitted to and/or from satellite 110 intended for users, ground segment, other satellites in the constellation, or any other desired start and/or end point for the communication.

Some or all of these message types can be included in the data transmitted as illustrated in FIG. 2. Some or all of these message types can be transmitted by satellite 110 and/or received by satellite 110, and/or can be generated onboard satellite 110 and/or can be generated by another entity, for example on the ground and/or received by a ground station 200 and/or 201, for example, via network 250.

The data can be transmitted and/or received over any one of these links, or any combination of these links, in an encrypted and/or unencrypted manner, and/or in any combination of encrypted and/or unencrypted manner. The encryption can be performed at the message level, where one or more individual messages are encrypted, for example, separately. Alternatively or in addition, the encryption can be performed at the data stream level, where the data stream that includes one or more messages of the same or different type is encrypted. In some embodiments, all of the messages can be encrypted. Alternatively, some or all of the messages are not encrypted. A message can be transmitted and/or received over a combination of links (e.g. from an inter-satellite link to the backhaul) and can change encryption state as it goes from one node in the communication chain to another. Encrypting the data transmitted by the satellite constellation system 100 allows more control over who can receive the necessary data for making radio occultation (RO) measurements and precision navigation, enabling the licensing of the usage of the data. In addition to encrypting the data itself, the spreading code of the navigation signal that is used for ranging can also be encrypted. This further allows controlling access to the information transmitted by satellite constellation system 100.

The data, which can comprise of any combination of the various messages, can be transmitted along any combination of links, for example, as illustrated in FIG. 2, between any combination of nodes of the satellite constellation system 100. These links can include different types of links, such as backhauls, inter-satellite links 230, and/or navigation signals 240.

As used herein, backhaul communications correspond to a link between satellite 110 and backhaul satellite 150, and/or a link between satellite 110 and ground station 200. The backhaul communications can be comprised of a transmit and/or receive component on each of the nodes. Communication from satellite 110 intended to be received to satellite 150, to ground station 200, and/or to ground station 201 through satellite 150, shown through backhaul downlink 210, is termed the downlink portion of the backhaul. The uplink portion, depicted as backhaul uplink 220 in FIG. 2, is the communication originating from ground station 200, and/or from ground station 201 through satellite 150 intended to be received by at least one of satellite 110 within satellite constellation system 100.

Backhaul downlink 210 can be designated to communicate one or more particular types of messages. Backhaul downlink 210 can communicate information such as RO measurement data, navigation message information, status information about each of the satellites, requested command and control of other satellites in satellite constellation system 100, and/or other information to be sent from the satellite in satellite constellation system 100 to another satellite or to the ground.

Backhaul uplink 220 can be designated to communicate one or more particular types of messages. Backhaul uplink 220 can communicate information such as PPP correction data, atmospheric map data, ground base measurements for the on-board filtering, command and control data, navigation message data of other satellites in satellite constellation system 100, and/or other information to be sent to the satellites in satellite constellation system 100 either from the ground or from another satellite.

Inter-satellite link 230 corresponds to a link between two or more satellites 110 within satellite constellation system 100. These inter-satellite links can be omni-directional links such that the transmission is one-to-many, dedicated links between satellite pairs in different orbital planes, and/or dedicated links between satellites pairs within the same orbital plane. A single satellite 110 can be capable of transmitting and/or receiving from any combination of these types of inter-satellite links. These inter-satellite links can either be dedicated data links or can be the data that is modulated onto the ranging signal if the ranging signal is being broadcast by the satellite at the full 180+ degree beamwidth of the satellite 110.

The inter-satellite links can contain any information to be sent between satellites or from one satellite with a backhaul connection to another satellite without a backhaul connection or from one satellite without a backhaul connection to another satellite with a backhaul, or the same process through multiple satellites. This can either be on top of and/or combined with the ranging signal, or can be a dedicated signal sent, for example by dedicated transceivers operating at differing frequencies.

Navigation signal 240 is the signal transmitted from satellite 110 containing at least a ranging signal, but can also contain other data corresponding to one or more of the various types of messages or other data discussed herein. Navigation signal 240 can be a one-to-many broadcast transmission, and any satellite 110, ground station 200, ground station 201, and/or satellite 150 can be equipped to receive the navigation signal.

Any data transmitted and/or received by satellite 110 can travel through any single set of links (e.g. backhaul only) and/or through any combination of links (e.g. backhaul to inter-satellite link). Any data can also be transmitted through any number of the nodes (station or satellite) in the communication chain for the purpose of being received by a specific node in the communication chain. In some embodiments, data such as correction messages can be sent from the ground to one or more satellite 110 via one or more of the following means:
Data can be transmitted from at least one ground station 200 directly to every satellite 110 on orbit.
Data can be transmitted from at least one ground station 200 to a subset of satellites (e.g. one in each orbital plane) and then across “along-links” through inter-satellite communication in the orbital plane with relatively low latency and without any stringent pointing requirements. “Along-links” inter-satellite links (either radio or optical) between a satellite and the satellite ahead and/or behind it in the orbital plane (an orientation where the angle between those satellites should remain fairly static). These “along-links” in orbit can be maintained through different flight procedures such as changes in the yaw angles needed in order to maintain solar panel orientation with respect to the sun by using omni-directional transceivers of the “along-link” data or steerable transceivers. In an example configuration where the orbital planes are polar orbits, the number of ground stations needed can be minimized by placing the ground stations at high latitudes, where it can “see” satellites from multiple planes simultaneously. Additionally, for this example configuration, the sequence of placing satellites in the orbital planes as satellite constellation system 100 is grown can be optimized to ensure that these “along-links” are used optimally.
Data can be transmitted from at least one ground station 200 and/or ground station 201 to at least one relay satellite 150 in orbits. These relay satellites 150 include communication satellites in GEO, in MEO, and/or in LEO. Satellites 110 can then receive the data from at least one satellite 150 that retransmits the data received from ground station 200 and/or ground station 201 to satellite 110.
For communication between satellites 110 in satellite constellation system 100, a dedicated inter-satellite link can be used with dedicated transceivers.
For communication between satellites 110, satellites 110 can add data messages to the data stream being modulated on the navigation signal in cases where satellite 110 are capable of receiving the navigation signal from another satellite 110 within satellite constellation system 100. A satellite can be in view if it is at a lower altitude than the broadcasting satellite or if it has line of sight to the satellite's transmission due to its orbital placement or if the broadcasting satellite beamwidth is large enough to reach the target satellite (e.g. 180+ degree beamwidth for neighboring satellites)

The ground stations 200 and/or 201 can be configured to communicate via a network 250, via at least one communication interface of the ground stations 200 and/or 201. The network 250 can be implemented by utilizing wired and/or wireless communication network and can include a cellular network, the Internet, and/or one or more local area networks (LAN) and/or wide area networks (WAN). Ground stations 200 and/or 201 can be operable to transmit and/or receive data from at least one server system. The at least one server system can include at least one processor and/or memory and can be operable to generate and/or store some or all of the data transmitted and/or received by ground stations 200 and/or 201. The at least one server system can be affiliated with an entity responsible for the satellite constellation system 100 and/or can be affiliated with a different entity, such as a weather service entity and/or navigation entity that generates and/or stores data transmitted and/or received by ground stations 200 and/or 201. Alternatively or in addition, client devices 160 can be operable to receive data via network 250.

FIG. 3A is a schematic block diagram of a satellite in accordance with various embodiments. In particular, an example of a satellite 110 is presented that includes a satellite processing system 300, a satellite power system 301 and a satellite flight control system 302.

In various embodiments, the satellite power system 301 includes an array of solar cells, a battery, a fuel cell or other chemical power generation system and/or a power management system that operates, for example, under control of the satellite processing system 300 to manage the production, storage and use of electrical power in conjunction with the operation of satellite 110. The satellite flight control system 302 includes one or more propulsion systems, an attitude controller, an inertial stabilizer and/or one or more other devices that operate under of the satellite processing system 300 to maintain, manage and otherwise adjust the orbital position and/or orientation of the satellite 110.

In various embodiments, the satellite processing system 300 includes memory that stores data, an operating system including several system utilities, and applications and/or other routines that include operational instructions. The satellite processing system 300 further includes one or more processors that are configured to execute the operational instructions to perform various the functions, features and other operations of the satellite 110 in conjunction with the satellite power system 301, the satellite flight control system 302, an on-board clock, one or more sensors, one or more transmitters, receivers and/or transceivers and one or more other devices.

FIG. 3B presents an embodiment of a satellite processing system 300. The same or different satellite processing system 300 can be onboard some or all of the satellites 110, and the functionality of some or all of the satellites 110 discussed herein can be enabled via satellite processing system 300. A bus 390 can be operably couple and/or facilitate communication between the various components of the satellite processing system 300. While a particular bus configuration is shown, other bus configurations can likewise be employed.

Satellite processing system 300 can include at least one memory module 310 which can be implemented by utilizing at least one memory. Satellite processing system 300 can include at least one processing module 320 which can be implemented utilizing one or more processors. The memory module 310 can store operational instructions that, when executed by the processing module 320, configure the satellite processing system 300 to execute some or all of the functionality of satellites 110 discussed herein.

In some embodiments, the processing module 320 is utilized to implement a radio occultation module 321 operable to perform some or all of the radio occultation functionality of satellite 110 discussed herein. Alternatively or in addition, the processing module 320 is utilized to implement an orbit determination module 322 operable to perform some or all of the radio occultation functionality of a satellite 110 as discussed herein. Alternatively or in addition, the processing module 320 is utilized to implement an orbit determination module 322 operable to perform some or all of the orbit determination functionality of a satellite 110 as discussed herein. Alternatively or in addition, the processing module 320 is utilized to implement a navigation message generation module 323 operable to perform some or all of the navigation message generating functionality of a satellite 110 as discussed herein. Alternatively or in addition, the processing module 320 is utilized to implement a message scheduling module 324 operable to perform some or all of the message scheduling functionality of a satellite 110 as discussed herein. Alternatively or in addition, the processing module 320 is utilized to implement a resource allocation module 325 operable to perform some or all of the resource allocation functionality of a satellite 110 as discussed herein. The memory can store operational instructions corresponding to the radio occultation module 321, the orbit determination module 322, the navigation message generation module 323, and/or the message scheduling module 324, and when these operational instructions are executed by the processing module 320, the satellite processing system 300 can perform the functionality of the radio occultation module 321, the orbit determination module 322, the navigation message generation module 323 the message scheduling module 324 and/or the resource allocation module 325 respectively.

Satellite processing system 300 can include one or more of sensors, which can include, but are not limited to: at least one star tracker 380; at least one inertial measurement unit (IMU) 370; at least one sun sensor 333; at least one earth horizon sensor 334, at least one GNSS receiver 360 operable to receive navigation signals transmitted by GNSS satellites 130; at least one clock 365, and/or at least one satellite receiver 350 operable to receive the navigation signal 240 transmitted by other satellite processing systems 300; and/or any other sensors operable to collect other types of measurement data and/or to receive signals transmitted by other entities. The measurements and/or signals collected by these sensors can be processed via processing module 320 and/or can be stored via memory module 310, for example, in a temporary cache.

In various embodiments, the clock 365 is implemented via a temperature compensated crystal oscillator (TCXO), oven-controlled crystal oscillator (OCXO) or other non-atomic clock that, for example, as adjusted and/or stabilized based on a timing signal from an atomic clock contained in the communications from a backhaul satellite, ground link or one or more of the GNSS satellites 130. In some embodiments, the same clock 365 is utilized by both GNSS receiver and the navigation signal transmitter. This allows the clock portion of the estimated state of the satellite using GNSS measurements to reflect the clock used to generate the navigation signal. Alternatively, one or more satellites 110 can implement the clock 365 via a stable atomic clock. In such a scenario, the non-atomic clock in other satellites 110 can be adjusted and/or stabilized based on a timing signal contained in inter-satellite communication from the satellite(s) 110 that contains the atomic clock.

Satellite processing system 300 can include at least one inter-satellite link transceiver 345 operable to transmit data to and/or receive data from one or more other satellite processing systems 300; a backhaul transceiver 340 operable to transmit data to and/or receive data from the backhaul satellites 150 and/or ground stations 200 and/or 201; and/or a navigation signal transmitter 330 operable to broadcast and/or otherwise transmit signals 240 including, for example, navigational signals including, a ranging signal, GNSS correction data, a navigation message and/or other navigational signal, radio occultation data, command and control data and/or data. Data transmitted by the navigation signal transmitter 330 can be received by one or more backhaul satellites 150, one or more ground stations 200 and/or 201, one or more satellite processing systems 300 onboard other satellites 110, and/or one or more client devices 160 which can include, for example, one or more automobiles, tablets, smartphones, smartwatches, laptop computers, desktop computers, other computers and computer systems, navigation devices, device location systems, weather systems, marine navigation systems, rail navigation systems, aircraft, agricultural vehicles, surveying systems, autonomous or highly automated vehicles 331, UAVs 332, and/or other client devices 160 as discussed herein.

While a configuration is shown having at least one inter-satellite link transceiver 345, in the alternative, the navigation signal transmitter 330 can be implemented via a transceiver having a fixed antenna beam pattern or an antenna beam pattern that can be dynamically adjusted to include both a main lobe that is directed toward the earth for the transmission of navigation signals 240 and one or more sidelobes in the direction of one or more other satellites. Such a configuration enables the inter-satellite communications to be integrated with or otherwise transmitted and received contemporaneously with the navigation signals 240.

In some embodiments, some or all ground stations 200 and/or 201 can include some or all of the components of satellite processing system 300, and/or can otherwise perform some or all of the functionality of the satellite processing system 300 as discussed herein. In such embodiments, the satellite constellation system 100 can include one or more ground stations 200 and/or 201 in addition to the plurality of satellites 110, where the ground stations 200 and/or 201 serve as additional nodes communicating in the satellite constellation system 100 in the same and/or similar fashion as the plurality of satellites 110 by generating, transmitting, receiving, and/or relaying some or all of the signals and/or data as discussed herein with regards to the satellites 110. In this fashion, some or all of ground stations 200 and/or 201 can effectively serve as a subset of the plurality of satellites 110, the only distinction being that these ground stations 200 and/or 201 that make up this subset of the plurality of satellites 110 are located on the ground and/or are located at a facility on the surface of the earth at a fixed position, while some or all of the remaining ones of the plurality of satellites 110 are orbiting in LEO.

Alternatively or in addition, at least one backhaul satellite 150 can similarly include some or all of the components of satellite processing system 300, and/or can otherwise perform some or all of the functionality of a satellite processing system 300 as discussed herein. In such embodiments, the satellite constellation system 100 can include one or more backhaul satellites 150 in addition to the plurality of satellites 110, where the backhaul satellites 150 serve as additional nodes communicating in the satellite constellation system 100 in the same and/or similar fashion as the plurality of satellites 110 by generating, transmitting, receiving, and/or relaying some or all of the signals and/or data as discussed herein with regards to the satellites 110. The at least one backhaul satellite 150 can be considered a subset of the plurality of satellites 110, with the only distinction being that the at least one backhaul satellite 150 is located in a more outer orbit than LEO and/or than the orbit of the other ones of the plurality of satellites 110.

Alternatively or in addition, at least one client device 160 that is operable to receive and utilize data transmitted by satellites 110 as discussed herein can similarly include some or all of the components of the satellite processing system 300, and/or can otherwise perform some or all of the functionality of a satellite processing system 300 as discussed herein. In such embodiments, the satellite constellation system 100 can include, in addition to the plurality of satellites 110, one or more mobile computing devices, cellular devices, vehicles, and/or other client devices 160 discussed herein. Thus, some or all of these types of devices can serve as additional nodes communicating in the satellite constellation system 100 in the same and/or similar fashion as the plurality of satellites 110 by utilizing their own processing module, memory module, receivers, transmitters, and/or sensors to generate, transmit, receive, and/or relay some or all of the signals and/or data as discussed herein with regards to the satellites 110. Some or all of these devices can be considered a subset of the plurality of satellites 110, with the only distinctions being that these devices are user devices that include a display and/or interface allowing a user to observe and/or interact with the data generated by and/or received from the satellites 110; that these devices are configured to further post-process received data in conjunction with the functioning of the client device 160 and/or in conjunction with one of the more of the applications discussed herein; that these devices are located on or near the surface of the earth; and/or that these devices are located at altitudes that are closer to the surface of the earth than LEO and/or the other orbit of the other ones of the plurality of satellites 110.

In some embodiments, the ground stations 200 and/or 201, the backhaul satellite 150, and/or some or all of these client devices 160 can receive application data associated with the satellite constellation system 100 for download. For example, the application data can be downloaded from a server system associated with the satellite constellation system 100 via the network 250. Alternatively or in addition, the application data can be transmitted, via one or more of the links discussed in conjunction with FIG. 2, to some or all of these devices for download via other satellites 110 orbiting in LEO. The application data can thus be received for download by a device for download in a signal, received by a receiver of the device, that was broadcasted by a satellite 110. The application data can be installed and stored in the memory of the device and can include operational instructions that, when executed by the processing module of the device, cause ground stations 200 and/or 201, backhaul satellite 150, and/or client devices 160 to operate in the same or similar fashion as satellite processing system 300 and/or to otherwise perform some or all of the functionality or other operations of the satellites 110 as discussed herein. Alternatively or in addition, some or all ground stations 200 and/or 201, backhaul satellite 150, and/or client devices 160 can be equipped with additional hardware to implement some or all of the processing module 320, memory module 310, and/or some or all of the sensors, transmitters, receivers, and/or transceivers of satellite processing system 300 of FIG. 3B to enable the device to perform some or all of the functionality of the satellites 110 as discussed herein.

Consider the following example, the processing module 320 is configured to generate navigation signals 240, such as ranging signals modulated and coded with navigation messages that contain timing, ephemeris and almanac data. In addition, the navigation messages can include, for example, PPP data associated with the satellites 130, command and control data, integrity data associated with satellites 130 and other satellite 110, RO data, atmospheric or weather data including a current weather state, a weather map and/or a predictive weather model, secure clock data, encryption and security information, any of the other types of data produced or transmitted by the satellite 110 in the navigation signals 240. In various embodiments, the data of the navigation signal 240 can be formatted in frames and subframes with a data rates exceeding 1 kbits/sec, however other data rates can be used. Navigations signals can be generated in two or more frequency channels at a signal power of 50 W, 100 W or more or at some lower power.

The operations of the processing module 320 can further include, for example, locking-in on the timing of the ranging signals of the signals 132 via the associated pseudo random noise (PRN) codes associated with each satellite 130 (that is not excluded based on integrity monitoring), demodulating and decoding the ranging signals to generate and extract the associated navigation messages from the GNSS satellites 130 in range of the receiver, applying correction data received via backhaul and/or inter-satellite communications and atmospheric data generated locally and/or received via backhaul and/or inter-satellite communications to the position and timing information from the navigation messages from the GNSS satellites 130.

In various embodiments, first-order ionospheric delay is mitigated using the combinations of dual-frequency GNSS measurements. Otherwise, ionospheric and tropospheric delay can be corrected using atmospheric models generated based on the RO data. Furthermore, the processing module 320 can use a Kalman filter such as an extended Kalman filter or other estimation technique where orbital position, clock error, ionospheric delay, tropospheric delay and/or carrier-phase errors are estimated filter states. The precise orbital position of the satellite 110 can be generated by positioning calculations that employ navigation equations to the corrected orbital positions and timing for each of the satellites 130.

In various embodiments, the operations of the satellite 110 include, for example, orbital control, attitude control, power management and control, temperature control, radio occultation, generating and/or maintaining tropospheric models, ionospheric models, weather models, atmospheric data generation, weather data generation, orbit determination, navigation message scheduling, navigation message generation, GPS reflectometry, sensor data collection, sensor data processing, GNSS reception, backhaul transmission and reception, inter-satellite transmission and reception, GNSS satellite integrity monitoring, LEO satellite integrity monitoring, secure timing generation and transmission, memory clean-up, health status monitoring of the components and systems of the satellite 110, receiving updates, processing updates and/or other operations described herein. The resource allocation module 325 operates to control the various operations of the satellite 110 based on reception of command data from a ground station, an amount of memory usage, an amount of processor utilization, the distance between the satellite 110 and a backhaul satellite 150, other satellites 110 and/or a ground station 200, the battery level of the satellite 110, when the satellite 110 will be in an orbital position to generate additional power, a fuel status, a health status of the satellite 110, atmospheric data, weather data including a current weather state, a predictive weather model and or other status or conditions determined by the satellite processing system 300.

The resource allocation module 325 can also operate to control the various operations of the satellite 110 based on the orbital position of the satellite 110 relative to positions above the earth corresponding to high population density, low population density, an ocean, a rainforest, a mountain range, a desert or other terrestrial condition or feature. The resource allocation module 325 can also operate to control the various operations of the satellite 110 based on the orbital position of the satellite 110 relative to the orbital positions of one or more other satellites 110 in the satellite constellation system 100. The resource allocation module 325 can also operate to control the various operations of the satellite 110 based on the state of the satellite constellation system 100 including, for example the number of satellites 110, the number of orbital paths, the number of satellites in each orbital path, the number and positions of satellites 110 that are on-line, off-line, are not currently generating navigation signals and/or navigation messages and/or other status of the various satellites 110 of the satellite constellation system 100.

The control of various satellite operations by the resource allocation module 325 can include determining when to enable or initiate an operation, when to disable or cease an operation and/or the percentage of time allocated to each of the operations during a time period such as a second, a minute, an hour, an orbital period, or a day. The control of various satellite operations by the resource allocation module 325 can also include selecting and assigning memory resources, processing resources, sensor resources, transmitter, receiver and/or transceiver resources, to the various operations selected to be performed. The control of various satellite operations by the resource allocation module 325 can also include selecting memory parameters such as queue sizes, cache sizes, and other memory parameters. The control of various satellite operations by the resource allocation module 325 can also include selecting processing parameters such as one or more processing speeds, or other processing parameters. The control of various satellite operations by the resource allocation module 325 can also include selecting transmitter, receiver and transceiver parameters, for example, encryption parameters, data protocol parameters, transmit power, transmission beamwidth, reception beamwidth, beam steering parameters, frequencies, the number of channels in use, data rates, modulation techniques, multiple access techniques, and other transmit and receive parameters. The control of various satellite operations by the resource allocation module 325 can also include selecting other parameters used by the satellite processing system including various thresholds used to determine whether or not two quantities compare favorably to one another.

The operations of the satellite 110 can be described further in conjunction with the examples and embodiments that follow. In various embodiments, the satellite 110 is a LEO satellite of a constellation 100 of LEO navigation satellites in LEO around the earth. A global positioning receiver, such as GNSS receiver 360, is configured to receive first signaling, such as signaling 132 from a first plurality of non-LEO navigation satellites, such as satellites 130 of a constellation 120 of non-LEO navigation satellites in non-LEO around the earth. An inter-satellite transceiver, such as inter-satellite link transceiver 345, is configured to send and receive inter-satellite communications with other LEO navigation satellites 110 in the constellation of LEO navigation satellites. At least one processor of the processing module 320 is configured to execute operational instructions that cause the processor(s) to perform operations that include: determining an orbital position of the LEO satellite based on the first signaling; and generating a navigation message based on the orbital position. A navigation signal transmitter, such as navigation signal transmitter 330, is configured to broadcast the navigation message to at least one client device 160. The navigation message facilitates the determination by these client device(s) of an enhanced position of these client device(s) based on the navigation message and further based on second signaling 132 received from a second plurality of non-LEO navigation satellites of the constellation of non-LEO navigation satellites.

In various embodiments the LEO satellite also includes a backhaul transceiver, such as backhaul transceiver 340, configured to receive correction data associated with the constellation of non-LEO navigation satellites, wherein the determining the orbital position of the LEO satellite is further based on based the correction data. The backhaul transceiver can be configured to receive the correction data from either a backhaul communication satellite in geostationary orbit around the earth or a terrestrial transmitter. The operations of the processor(s) can further include:
generating radio occultation data based on the inter-satellite communications with at least one of the other LEO navigation satellites in the constellation of LEO navigation satellites; and transmitting the radio occultation data via the backhaul transceiver. The correction data can include orbital correction data and timing correction data associated with the constellation of non-LEO navigation satellites. The navigation message can include a timing signal and the orbital position associated with the LEO satellite. The navigation message can further include the orbital correction data and the timing correction data associated with the constellation of non-LEO navigation satellites.

In various embodiments, the LEO satellite further includes a non-atomic clock configured to generate a clock signal, wherein the timing signal is generated by adjusting the clock signal based on the first signaling and further based on the timing correction data. The constellation of non-LEO navigation satellites can be associated with at least one of: a Global Positioning System of satellites, a Quasi-Zenith Satellite System, a BeiDou Navigation Satellite System, a Galileo positioning system, a Russian Global Navigation Satellite System (GLONASS) or an Indian Regional Navigation Satellite System. The navigation message can include correction data associated with the constellation of non-LEO navigation satellites in non-LEO around the earth, wherein the at least one client device determines the enhanced position of the client device by applying the correction data to the second signaling. The navigation message can further include a timing signal and the orbital position associated with the LEO satellite, wherein the at least one client device determines the enhanced position of the at least one client device further based on the timing signal and the orbital position associated with the LEO satellite.

In various embodiments, the inter-satellite communications include correction data associated with the constellation of non-LEO navigation satellites received via at least one of the other LEO navigation satellites in the constellation of LEO navigation satellites, wherein determining the orbital position of the LEO satellite is further based on based the correction data.

The inter-satellite communications can include at least one of: navigation signal 240, the navigation message and/or other state data needed to do the state estimation of the satellite 110 sent to at least one of the other LEO navigation satellites in the constellation of LEO navigation satellites; radio occultation; atmospheric data generated based on radio occultation; control information associated with satellite direction; control information associated with satellite attitude; control information associated with satellite status; control information associated with satellite inter-satellite transmit/receive condition; command information associated with satellite inter-satellite transmit/receive status; command information associated with inter-satellite transmit power or frequency; control information associated with encryption; constellation integrity information relating to the health of one or more LEO navigation satellites in the constellation of LEO navigation satellites; or constellation integrity information relating to the health of one or more non-LEO navigation satellites in the constellation of non-LEO navigation satellites. Furthermore, the inter-satellite communications can include one-to-many transmissions between the LEO satellite and two or more of the other LEO navigation satellites in the constellation of LEO navigation satellites.

In various embodiments, the first plurality of non-LEO navigation satellites can include four or more non-LEO navigation satellites of the constellation of non-LEO navigation satellites that are in reception range of the global positioning receiver, however signals 132 from fewer non-LEO satellites can be used when navigation signals 240 are received from one or more LEO satellites via inter-satellite communications. The second plurality of non-LEO navigation satellites can include three or more non-LEO navigation satellites of the constellation of non-LEO navigation satellites that are in reception range of the at least one client device, however signals 132 from fewer non-LEO satellites can be used when navigation signals 240 are received from more than one LEO satellites in reception range of the at least one client device.

In various embodiments, at least one processor of the processing module 320 is configured to execute operational instructions that cause the processor(s) to perform operations that include: determining an orbital position of the LEO satellite 110 based on the first signaling 132 and the correction data received via either the backhaul transceiver 340 or the inter-satellite link transceiver 345 and generating a navigation message based on the orbital position. The navigation signal transmitter 330 configured to broadcast the navigation message to at least one client device 160, the navigation message facilitating the at least one client device to determine an enhanced position of the at least one client device based on the navigation message.

In various embodiments, at least one processor of the processing module 320 is configured to execute operational instructions that cause the processor(s) to perform operations that include: determining an orbital position of the LEO satellite based determining, based on the first signaling 132, an error condition associated with one of the non-LEO navigation satellites of the constellation of non-LEO navigation satellites; and generating a navigation message based on the orbital position, wherein the navigation message includes a timing signal and the orbital position associated with the LEO satellite, correction data associated with the constellation of non-LEO navigation satellites, and integrity monitoring data that includes an alert signal that indicates the error condition associated with the one of the non-LEO navigation satellites of the constellation of non-LEO navigation satellites. The navigation signal transmitter is configured to broadcast the navigation message to at least one client device, the navigation message facilitating the client device(s) to determine an enhanced position of the at least one client device, based on the navigation message and further based on second signaling received from a second plurality of non-LEO navigation satellites of the constellation of non-LEO navigation satellites in the non-LEO around the earth while excluding signals from the one of the non-LEO navigation satellites. Furthermore, the satellite 110 itself can exclude signals from the one of the non-LEO navigation satellites when calculating its orbital position.

The alert signal and/or integrity monitoring data that indicates the error condition associated with the one of the non-LEO navigation satellites of the constellation of non-LEO navigation satellites can also be shared with the other LEO satellites 110 and/or one or more ground stations via inter-satellite and/or backhaul communications. This allows the other satellites 110 to exclude signals from the one of the non-LEO navigation satellites when calculating their orbital position. This also allows the other satellites 110 to include integrity monitoring data indicating the faulty satellite in their own navigation messages.

In various embodiments, at least one processor of the processing module 320 is configured to execute operational instructions that cause the processor(s) to perform operations that include: determining an orbital position of the LEO satellite based on the first signaling; determining, based on the inter-satellite communications, an error condition associated with one of the other LEO navigation satellites of the constellation of LEO navigation satellites; and generating a navigation message based on the orbital position, wherein the navigation message includes a timing signal and the orbital position associated with the LEO satellite, correction data associated with the constellation of non-LEO navigation satellites, and an alert signal that indicates the error condition associated with one of the other LEO navigation satellites of the constellation of LEO navigation satellites. The navigation signal transmitter is configured to broadcast the navigation message to at least one client device, the navigation message facilitating the at least one client device to determine an enhanced position of the at least one client device, while excluding signals from the one of the other LEO navigation satellites, for example, based on the navigation message and further based on second signaling received from a second plurality of non-LEO navigation satellites of the constellation of non-LEO navigation satellites in the non-LEO around the earth.

The alert signal and/or integrity monitoring data that indicates the error condition associated with the one of the LEO satellites of the constellation of LEO satellites can also be shared with the other LEO satellites 110 and/or one or more ground stations via inter-satellite and/or backhaul communications. This allows the other satellites 110 to include integrity monitoring data indicating the faulty satellite in their own navigation messages. It should be noted that, while the foregoing integrity monitoring operation have been described as being performed by the satellite 110 in-situ, in other embodiments, integrity monitoring activities involving the detection of faulty LEO or non-LEO satellites can instead be performed by one or more ground stations and the resulting integrity monitoring data can be shared with the satellites 110 via a combination of backhaul and inter-satellite communication. Furthermore, the function of integrity monitoring involving the detection of faulty LEO or non-LEO satellites can be assigned to a particular satellite 110 on a dedicated basis that is not tasked with, configured for and/or capable of, the generation of navigation signals 240.

In various embodiments, at least one processor of the processing module 320 is configured to execute operational instructions that cause the processor(s) to perform operations that include: determining a first orbital position of the LEO satellite at a first current time based on the first signaling; generating a plurality of first orbital position estimates of the LEO satellite for a plurality of first subsequent times associated within a first time window from the first current time; generating, based on a curve fitting technique, a first navigation message indicating the first orbital position at the first current time and the first plurality of orbital position estimates of the LEO satellite for the first plurality of subsequent times; broadcasting, via the navigation signal transmitter, the first navigation message to at least one client device; determining a second orbital position of the LEO satellite at a second current time based on the first signaling, the second current time corresponding to one of the first plurality of subsequent times associated with the first time window and the second current time corresponding to one of the first plurality of orbital position estimates; generating an error metric based a difference between the first orbital position of the LEO satellite at the second current time and the corresponding one of the first plurality of orbital position estimates. When the error metric compares unfavorable to an error threshold: generating, based on the curve fitting technique, a second plurality of updated orbital position estimates of the LEO satellite for a second plurality of subsequent times associated from the second current time; generating a second navigation message indicating the second orbital position at the second current time and the second plurality of orbital position estimates of the LEO satellite for the second plurality of subsequent times; and broadcasting, via the navigation signal transmitter, the second navigation message to the at least one client device. When the first time window expires at a third current time without a second navigation message generated: determining a third orbital position of the LEO satellite at the third current time based on the first signaling; generating, based on the curve fitting technique, a third plurality of updated orbital position estimates of the LEO satellite for a third plurality of subsequent times associated within a second time window from the third current time; generating a third navigation message indicating the third orbital position at the third current time and the third plurality of orbital position estimates of the LEO satellite for the third plurality of subsequent times; and broadcasting, via the navigation signal transmitter, the third navigation message to the at least one client device.

In various embodiments, at least one processor of the processing module 320 is configured to execute operational instructions that cause the processor(s) to perform operations that include: determining an orbital position of the LEO satellite based on the first signaling; generating a second timing signal by adjusting the clock signal based on the first signaling and further based on correction data associated with the constellation of non-LEO navigation satellites; and generating a navigation message based on the orbital position, wherein the navigation message includes the second timing signal and the orbital position of the LEO satellite and correction data associated with the constellation of non-LEO navigation satellites.

In various embodiments, at least one processor of the processing module 320 is configured to execute operational instructions that cause the processor(s) to perform operations that include: generating radio occultation data based on the inter-satellite communications with at least one of the other LEO navigation satellites in the constellation of LEO navigation satellites, the radio occultation data indicating atmospheric conditions associated with the ionosphere and the troposphere; transmitting the radio occultation data via a backhaul transceiver; receiving correction data associated with the constellation of non-LEO navigation satellites, the correction data generated based in part on the radio occultation data; determining an orbital position of the LEO satellite based on the first signaling and the correction data; and generating a navigation message based on the orbital position.

In various embodiments, at least one processor of the processing module 320 is configured to execute operational instructions that cause the processor(s) to perform operations that include: determining the transmit/receive status for the inter-satellite communications between the LEO satellite and at least one other of the plurality of other LEO navigation satellites in the constellation of LEO navigation satellites. For example, the transmit/receive status for the inter-satellite communications between the LEO satellite and at least one other of the plurality of other LEO navigation satellites in the constellation of LEO navigation satellites can be determined based on at least one of: a memory usage of the LEO satellite; a memory usage of the at least one other of the plurality of other LEO navigation satellites; a distance between the LEO satellite and a backhaul receiver; a distance between the at least one other of the plurality of other LEO navigation satellites and the backhaul receiver; a battery level of the LEO satellite; a different between the battery level of the LEO satellite and a battery level of the at least one other of the plurality of other LEO navigation satellites; an estimated time that the LEO satellite can generate more power; an estimated time that the at least one other of the plurality of other LEO navigation satellites can generate more power; or atmospheric data that indicates atmospheric conditions generated based on radio occultation.

In various embodiments, the inter-satellite communications include at least one of: the navigation message sent to at least one of the other LEO navigation satellites in the constellation of LEO navigation satellites; radio occultation; atmospheric data generated based on radio occultation; control information associated with satellite direction; control information associated with satellite attitude; control information associated with satellite status; control information associated with satellite inter-satellite transmit/receive condition; command information associated with satellite inter-satellite transmit/receive status; command information associated with inter-satellite transmit power or frequency; control information associated with encryption; constellation integrity information relating to the health of one or more LEO navigation satellites in the constellation of LEO navigation satellites; or constellation integrity information relating to the health of one or more non-LEO navigation satellites in the constellation of non-LEO navigation satellites.

FIG. 3C is a pictorial diagram of a satellite in accordance with various embodiments. In particular, a lower perspective view of a satellite, such as satellite 110, is presented. The satellite body is constructed in a modular fashion of six commercial off-the-shelf units such as CubeSat units or other units that are interconnected. The front face of the satellite body 308 includes a first sun sensor 333-1, a first inter-satellite link transceiver 345-1 and a star tracker 380. The bottom side of the satellite body 308 includes a first retroreflector 332-1, a first backhaul transceiver 340-1 and two navigation signal transmitters 330, for example, corresponding to two different frequency channels. The side of the satellite body includes a second retroreflector 332-2. The top of the satellite body is fitted with deployable plates 306 that fold out for use in orbit (as shown) to support an array of solar cells for powering the satellite.

FIG. 3D is a pictorial diagram of a satellite in accordance with various embodiments. In particular, an upper perspective view of a satellite, such as satellite 110. The rear face of the satellite body 308 includes a second sun sensor 333-2 and a second inter-satellite link transceiver 345-2. The top side of the satellite body 308 includes a GPS receiver 305, a second backhaul transceiver 340-2 and solar panels 304. Solar panels 304 are also arranged on the top of the deployable plates 306. The side of the satellite body includes a third retroreflector 332-3.

As discussed herein, components of the satellite processing system 300 operate to generate a precise orbital position of the satellite 110. In addition to the use of this orbital position in the generation of navigation signals 240, this orbital position can be used to determine when the satellite 110 needs to be repositioned and to aid in such repositioning by use of the satellite flight control system 302.

In various embodiments, the precise orbital position of the satellite 110 at a given time is compared with its desired orbital position at that time to determine the amount of deviation. Furthermore, the predicted path of the satellite 110 can be compared with the predicted paths of numerous other space objects including other satellites, spacecraft, space junk and other near-earth objects to predict a potential future collision. Such determinations and predictions can be generated via a ground station in backhaul communication with the satellite 110 of via the satellite itself. In either case, the satellite 110 can be repositioned to a desired location and orientation using of the satellite flight control system 302.

In various embodiments, the satellite flight control system 302 includes a multi-axis propulsion system. In the alternative, the satellite flight control system 302 includes merely a three-axis attitude controller that is used reposition the satellite 110. Consider the example satellite configuration shown in FIGS. 3C and 3D. Roll, pitch and/or yaw axis variations in the satellites attitude can cause multi-axis drag force vectors acting on the satellite body 308 and the deployable plates 306, in particular, that can be used in the repositioning process to vary the orbital path of the satellite 110.

It should be noted that the example shown in FIGS. 3C and 3D present but one of the many possible implementations of the satellite 110.

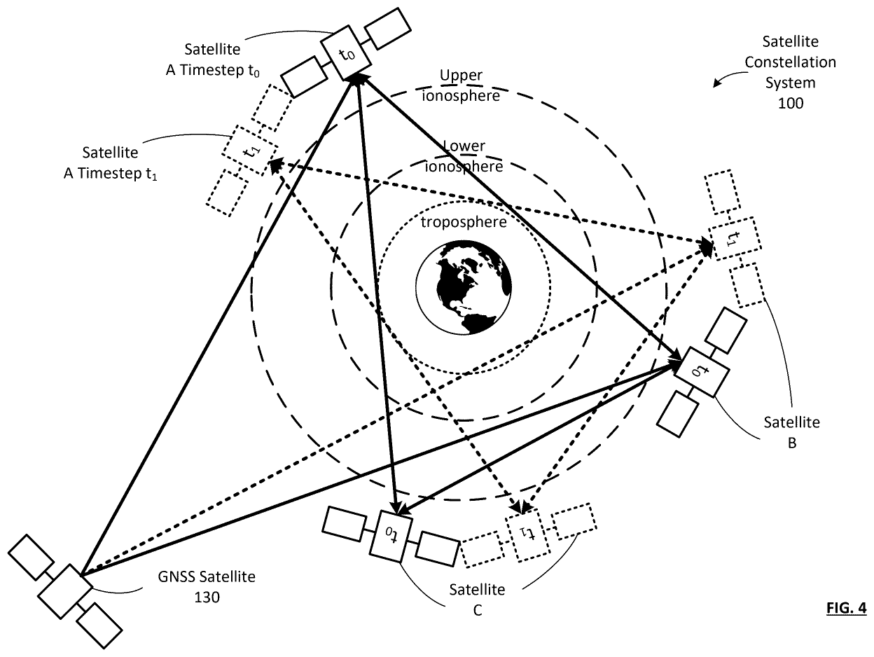

FIG. 4 presents an example embodiment of a satellite constellation system 100 that is implemented to perform atmospheric monitoring via radio occultation (RO). Radio occultation enables detailed monitoring of the Earth's atmosphere, which allows for more accurate weather forecasting. This is performed by characterizing elements of a transmitted signal as it passes through Earth's atmosphere. In particular, each satellite 110 can be operable to observe and/or generate RO data based on received signals transmitted by other satellites 110 and/or GNSS satellites 130, such as navigation signals 240 and/or GNSS signals. This RO data includes measurements and/or other data that characterizes a portion of the atmosphere that the received signal traversed in its transmission from the other satellite. A satellite 110's generation of RO data based on received signals, and/or a satellite 110's transmission of this generated RO data, can be accomplished by utilizing radio occultation module 321.

RO can be performed using Global Navigation Satellite System (GNSS) signals that are being transmitted from Medium Earth Orbit (MEO) and subsequently monitored from satellites in Low Earth Orbit (LEO). These GNSS signals provide RO information on the upper atmosphere, but due to their weak signal strength, these GNSS signals are unable to provide high quality measurements to the lower portions (altitudes) of the atmosphere. Furthermore, the GNSS signals come from a limited number of MEO satellites. This limitation on number and the relatively slow orbital period of these GNSS satellites 130 naturally constrains the rate of change of observation vectors and therefore the amount of atmosphere being observed. These factors limit both the spatial and temporal resolution of the atmosphere being monitored.

Satellite constellation system 100 presents improvements to current atmospheric monitoring techniques. In contrast to existing GNSS-based RO methods, satellite constellation system 100 can handle the transmission and/or reception of navigation signals 240 in addition to traditional GNSS signals received from GNSS satellites 130. The geometry of the line of sight vector, in this case a line of sight vector being a radio line of sight such that the receiving end can receive a transmission from the transmission end, between satellites 110 in a LEO orbit provides a unique geometry that gives rise to uncommon atmospheric cuts that are capable of providing a deeper understanding of the Earth's atmosphere, as depicted in FIG. 4. To further atmospheric modeling capabilities, navigation signal 240 is transmitted by satellites 110 in LEO, and can be delivered at higher power levels than those from MEO. This enables deeper penetration of the atmosphere down to the planetary boundary layer and/or to less than 5 km in altitude, even in heavy moisture conditions. This provides an unprecedented level of detailed information of all levels of the atmosphere.

Additionally, using LEO satellites for both transmission and reception in RO results in an unprecedented number of RO events due to the smaller LEO orbital period. This greatly increases the temporal and spatial resolution of atmospheric measurements, resulting in a higher fidelity model and in turn a better understanding of its dynamics. Furthermore, a LEO constellation with a high density of satellites, with groups spaced across different orbital planes will result in sections of the atmosphere between the orbital planes being observed with a very high frequency (e.g. 10 minutes between observations depending on the spacing in the orbital plane), providing near real time tomography of the atmosphere.

Furthermore, navigation signal 240 of satellite constellation system 100 can reside in one or more different frequency bands than GNSS signals used for RO today, enabling another dimension of atmospheric characterization than what is possible today.

The data links (Backhaul uplink 220, downlink 210, inter-satellite link 230, and/or navigation signal 240) permit the RO data obtained by the satellites to be transmitted down to the ground quickly for optimal use. The RO data can include the raw RO measurements observed by each satellite 110 and/or can include post-processed data that can, for example, contain already computed temperature and/or humidity profiles of the atmosphere. For example, satellites 110 can be operable to compute temperature and/or humidity profiles of the atmosphere based on the observed RO measurements.

In the example illustrated in FIG. 4, three satellites A, B, and C, are located in a LEO orbit, and a single GNSS satellite 130 is located in a MEO orbit. The satellites A, B, and C are each distinct satellites 110 of the satellite constellation system 100. The satellites A, B, and C and the single GNSS satellite 130 are depicted at two different time steps: t₀ and t₁.

At the first time step, t₀, all three satellites 110 can see, and/or can otherwise be operable to receive, each other's navigation signal 240. Since each satellite 110 is capable of transmitting and/or receiving navigation signal 240, each of the line of sight vectors, representing an ability to transmit and/or receive navigation signal 240, are shown as two-way vectors. Due to the placement of the satellites 110 in orbit and the properties of navigation signal 240 such as the broadcast power, each of these lines of sight traverse through different layers of the Earth's atmosphere, including layers that are close to the Earth's surface. The signal from GNSS satellite 130 can also be used by satellites A and B at the first time step, t₀, to get information through the uppermost part of the atmosphere. Note that while satellite C does have a line of sight to GNSS satellite 130, that signal does not traverse any layers of the atmosphere of interest for monitoring and is unable to produce RO measurements, and is therefore omitted from the figure.

At the second time step, t₁, which is shortly after the first time step, all three of satellites 110 have moved in their orbit. For this example, the time between t₀ and t₁ is such that GNSS satellite 130 has effectively not changed location due to the much longer orbital period of a MEO satellite compared to a LEO satellite. At time step t₁, once again all three of the satellites 110 are able to maintain their lines of sight, this time at slightly different locations in the atmosphere, providing new measurement data. Due to the placement of satellites 110 in their orbit in this example, only one of the satellites is able to use the signal from GNSS satellite 130 for RO purposes. The line of sight vector from GNSS satellite 130 and Satellite A no longer goes through the atmosphere to create observations and the line of sight vector from GNSS satellite 130 and Satellite C still does not go through the atmosphere. Note that while the line of sight vector from GNSS satellite 130 and Satellite B is maintained that measurement will be degraded due to how much atmosphere the signal must traverse. This exemplifies one of the drawbacks of RO systems today using existing GNSS signals unable to constantly provide information as there are some cases where the geometry is in such a way that does not allow high quality RO observations to be made.

Building from this example, considering a typical orbital period for a LEO satellite of 90 minutes, every 90 minutes a LEO satellite will complete a full sweep of its trajectory around Earth's atmosphere. Furthermore, with a dense constellation of satellites spread across a given number of orbital planes, the time between one pair of satellites passing through a part of the atmosphere and the following pair passing through nearly the same region of the atmosphere can be very short (e.g. tens of minutes). Thus, the satellites 110 of the satellite constellation system 100 allow for an unprecedented temporal revisit of regions of the atmosphere that can be used to better predict weather and improve models. When performing RO with MEO GNSS signals, the geometry change is much slower since a MEO satellite's orbital period is approximately 12 hours. Furthermore, the LEO and MEO satellite orbits are not in sync, which does not guarantee the ability to repeatedly pass through the same parts of the atmosphere and therefore cannot provide the spatially correlated temporal data that can be provided by this satellite system.

The raw RO measurements and/or processed data can be processed by one or more client devices 160 and/or other computing devices that receive the RO data from the satellites 110 and/or from ground station 200 and/or 201, for example, via network 250. The processing of this data can enable a range of applications, for example, by various other entities that benefit from improved characterizations and/or profiles of the atmospheric.

One example application of utilizing the received raw RO measurements and/or processed data includes generating weather forecasting data. For example, one or more client devices 160 can process the RO data to generate forecast models, to improve upon forecast models, and/or to generate other weather forecasting data.

As another example application, one or more client devices 160 can process the RO data to generate ionospheric data, such as ionospheric mappings and/or other data characterizing various portions of the ionosphere over time. This can include generating real-time and/or substantially close to real-time ionospheric mappings. This can include generating models that can be utilized to generate prediction data utilized predict and/or improve upon predictions of future states of the ionosphere. This can be utilized to improve performance of other systems that transmit through the ionosphere. For example, spaced-based communications systems can utilize the information from this real-time ionospheric mapping and/or other detailed ionospheric maps, and/or can utilize these models to better predict behavior of transmissions through the ionosphere and/or to improve performance and efficiency of their systems.

As another example application, one or more client devices 160 can process the RO data in conjunction with space measurement systems. In particular, the scientific measurement of stars and/or signals from space can be improved by utilizing ionospheric data generated based on the RO data. For example, the model can be utilized to predict ionospheric mappings at future times, to schedule the running of telescopes, and/or to otherwise facilitate scheduling and/or adjustment of measurements of stars and/or signals from space.

As another example application, one or more client devices 160 can process the RO data in conjunction with communication constellations, for example that rely on transmitting through the ionosphere. In particular, current ionosphere mappings or predicted future ionosphere mappings generated based on the received RO data can be utilized to aid in determining power levels that need to be broadcast based on current ionosphere mappings or predicted future ionosphere mappings. This can also be utilized to determine and/or predict current and/or future possible areas of outages, for example, enabling the communication constellations to adapt its transmissions accordingly.

As another example application, one or more client devices 160 can process the RO data in conjunction with space weather monitoring for early warning for high value space assets and/or ground infrastructure.

As another example application, one or more client devices 160 can process the RO data for improved GNSS, improved performance of satellite constellation system 100, and/or improvements for other third-party users interested in detailed real-time atmospheric models.

Some or all of these applications of received RO data can alternatively be facilitated via a processing module 320 of a satellite processing system 300 and/or via another processing system affiliated with the satellite constellation system 100. Models and/or other processed data in conjunction with these applications can be transmitted, for example via network 250 and/or directly from a satellite 110, to client devices 160 associated with end users of this data, for example, for display to the end users via a display device. Alternatively or in addition, the client devices 160 can download application data, for example via network 250, from a server system affiliated with the satellite constellation system 100. This application data, when executed by the client device, can cause the client device 160 to receive and/or process the RO data in conjunction with one or more of these applications.

The example demonstrated in FIG. 4 depicts each satellite 110 transmitting and receiving navigation signal 240. With these two-way links, each of the satellites in the link pair is capable of making RO observations for the same portion of the atmosphere and is capable of logging the necessary data, for example by generating and/or otherwise observing the RO data based on the received navigation signal 240, by temporarily storing the RO data in memory module 310 in a queue for transmission, and/or by transmitting the RO data via a backhaul link. Therefore, only one of the satellites need to be in view a ground station 200, and/or the backhaul satellite 150, or a backhaul node, such as one of the plurality of nodes of the satellite constellation system 100 in the transmission chain of backhaul links to the ground station 200 and/or the backhaul satellite 150. The satellite constellation system 100 can thus be configured such that only one of the satellites in a satellite pair transmit the RO data down to users on the ground, either directly or through a space-based satellite backhaul communication link, in real time. This allows the use of fewer resources, as only one of the two satellites needs to record the necessary measurements. To reduce power usage, the satellite system can be further configured in a such a way that optimizes a set of one way links such that only one satellite is transmitting navigation signal 240 and one is receiving the navigation signal 240 in a given pair.

As used herein, the satellite in a given pair that is designated to broadcast navigation signal 240 is designated the “transmitter satellite”, and the other satellite in designated to receive navigation signal 240 is designated the “receiver satellite.” The transmitter satellite can be configured to broadcast navigation signal 240. The transmitter satellite can be further configured to not receive navigation signal 240 from the other satellites 110, to not generate the RO data based on the navigation signal 240 received from the other satellites 110, and/or to not transmit the RO data via a backhaul link. The receiver satellite can be configured to receive navigation signal 240, to generate corresponding RO data and to transmit this RO data via a backhaul link. The receiver satellite can be configured to not transmit its own navigation signal 240. In some embodiments, the satellite in a given pair that is determined to be best placed for transmitting the data to ground users (either directly or through a space-based satellite backhaul communication link) can be selected as the receiver satellite, and the other satellite in the pair can be selected as the transmitter satellite. This optimization can further be performed across multiple sets of satellites where a single satellite is configured as the transmitter satellite to transmit to multiple satellites receiving and logging navigation signal 240.

Consider the pair of satellites A and B of FIG. 4. One of the satellites in the pair can be designated as the transmitter satellite at a particular time, while the other satellite in the pair is designated as the receiver satellite at the particular time. Which one of the satellites is designated as the transmitter satellite vs. the receiver satellite can be set and/or adjusted automatically via an adjustment process. The adjustment process can include determining the pair of satellites A and B should swap roles and/or determining the roles of the pair of satellites A and B to be reevaluated for potential swapping, in response to detection of a corresponding trigger condition. The adjustment process can be performed by utilizing processing module 320 of satellite A and/or satellite B, enabling the pair of satellites automatically determine roles amongst themselves. Alternatively, the adjustment process can be performed by another processing module 320 and/or other processing system of the satellite constellation system that is not included in the pair, where the roles are determined and received as instructions to satellite A and satellite B.

Performing the adjustment process can include determination of one or more trigger conditions that dictate the current roles should be swapped and/or otherwise be set. Example trigger conditions for automatic setting and/or adjustment of which satellite in the pair is designated as the transmitter satellite and which satellite in the pair is designated as the receiver satellite in a given pair of satellites 110 (Satellite A and Satellite B) include:
Determining satellite A's memory usage exceeds a given threshold such that it must stop recording RO measurements. As a result, satellite B is designated as the transmitter satellite and satellite A is designated as the receiver satellite.
Determining the distance between satellite A and a backhaul satellite 150 and/or a ground station 200 is greater than the distance between satellite B and backhaul satellite 150 and/or ground station 200 such that Satellite B is in a better position to record measurements. As a result, satellite B is designated as the receiver satellite and satellite A is designated as the transmitter satellite.
Determining the battery level of satellite A is below a given threshold such that it must stop transmitting a navigation signal. As a result, satellite B is designated as the transmitter satellite and satellite A is designated as the receiver satellite.
Determining the difference between battery level in satellite A and satellite B compares in such a way that Satellite A is determined to have more battery to use and/or is determined to have a more favorable battery level than satellite B. As a result, satellite A is designated as the transmitter satellite and satellite B is designated as the receiver satellite.
Determining that the difference between when satellite A will be able to generate power and when Satellite B will be able to generate power compares in such a way that satellite A is determined to be able to generate power sooner. As a result, satellite A is designated as the transmitter satellite and satellite B is designated as the receiver satellite.
Any other status changes, conditions or states of the individual satellites 110 or of the satellite constellation system 100 that may favor one satellite transmitting and/or receiving either in a paired configuration or in a one-to-many or many-to-one configuration.

While these trigger conditions illustrate examples between a specific pair of satellites, similar trigger conditions can be determined between any number of satellites when a one-to-many or many-to-one architecture is being used. In particular, consider a subset of three or more satellites 110. Similar trigger conditions can be utilized to determine a single one of the subset of three or more satellites 110 to be designated as the transmitter, and/or where a single one of the subset of three or more satellites 110 to be designated as the receiver. For example a single receiver in the subset can be selected in response to determining this satellite 110 is determined to have the least favorably battery level of the subset of satellites, in response to determining this satellite has a closest distance to backhaul satellite 150 and/or a ground station 200 of the subset of satellites, and/or a most favorable transmission path to backhaul satellite 150 and/or a ground station 200 of the subset of satellites. Alternatively, more than one of the subset of three or more satellites can be designated as transmitter satellites and/or receiver satellites. In some embodiments, all of the subset of three or more satellites 110 are designated as either a transmitter satellite or receiver satellite. Alternatively, at least one of the subset of three or more satellites can be designated to perform the functionality of both a transmitter satellite and a receiver satellite, and/or can be designated to not perform the functionality of either a transmitter satellite or a receiver satellite.

In performing the adjustment process, the automatic determination of which satellite in a pair of satellites and/or in a grouping of three or more satellites is designated as the receiver satellite requires communication between the satellites in the pair and/or grouping to relay status utilized to determine trigger conditions and/or to relay which satellite is designated to perform which role. Consider the following steps illustrating an example of performing the adjustment process between a pair of satellites A and B:
1. Satellite A's memory usage for storing RO measurements exceeds a given threshold and sends (through any link or combination of links in FIG. 2) a message to satellite B that it must stop receiving messages and that it is changing into transmission mode as a transmitter satellite.
2. Satellite A continues to log RO measurements and enables transmission of navigation signal (if not already enabled)
3. Satellite B can send (through any link or combination of links in FIG. 2) a status message to satellite A confirming that satellite B is in a mode corresponding to the receiver satellite and/or is otherwise logging measurements.
4. Satellite A can receive satellite B's status message and/or satellite A can detect that satellite B has changed state by receiving a navigation signal from satellite B (if it was not already receiving a navigation signal from satellite B)
5. Satellite A stops logging RO measurements.

A similar process can be performed in response to detection of another trigger condition described above. In particular, a satellite can determine to change its own state in response to detecting its battery level, memory capacity, other health status, distance from backhaul satellite and/or ground station, or other condition independent of other satellites compares favorably to a corresponding threshold dictating the satellite must change its state to be a transmitter satellite or a receiver satellite. In response to determining its own condition must change, the satellite can alert the other satellite in the pair and/or multiple satellites in the grouping of the change.

Alternatively or in addition, status information such as battery level, memory capacity, other health status, distance from backhaul satellite and/or ground station and/or other states and conditions can be exchanged between both satellites in a pair and/or between some or all satellites in a group, where a single satellite in the pair or grouping collects its own status information and the corresponding status information from the other one or more satellites in the pair or grouping, compares this status information and/or measures differences between statuses of the satellites and determines the optimal satellite to be selected as a transmitter satellite and/or the optimal satellite to be selected as a receiver satellite based on, for example, the corresponding trigger conditions. Once the selections have been made by the single satellite, this satellite can transmit one or more notifications indicating the assigned roles to the one or more other satellites in the pair or grouping. If one of the other satellites later determines its own condition must change based on monitoring its own status, the satellite can alert the other satellites in the grouping accordingly, and this process of collecting status data and reassigning roles by a single satellite can be triggered and repeated.

Alternatively or in addition, the decision for changing of the state can also be made by a ground monitor that is listening to all the status messages and send commands to the given satellites and/or can be made by another satellite that is not necessarily in the satellite pair but that can receive the status messages of the two satellites in the pair. This outside ground monitor and/or other satellite can generate and transmit notifications to the satellites in the pair or grouping indicating their newly assigned roles.

Alternatively or in addition, any of the changes to whether a satellite is a transmitter satellite and/or a receiver satellite can be performed in real time based on status messages or other command and control data and/or can be performed based on predetermined positions within the orbit based on known precomputed metrics that are a function of the satellite's placement within an orbit. For example, it can be precomputed that a satellite closer to a fixed ground station 200 should always be the receiver in a pair and therefore satellite 110 can be preconfigured to change to logging RO measurements when within a certain threshold distance of fixed ground station 200. This can correspond to a trigger condition that can be determined by a satellite monitoring its own status, where the change in role of the satellite can be relayed to the other satellites in the pair and/or grouping and can trigger the other satellites in the pair and/or grouping to change their roles accordingly.

In some embodiments, the broadcast signal from any satellite 110 in LEO can be used by any number of other satellites 110 in LEO. While lines of sight shown in FIG. 4 are representative of satellites 110 receiving each other's navigation signals, it's important to note that the signals transmitted are broadcast signals that can be received by any satellite.

Alternatively or in addition to dynamically and automatically being capable of changing role from transmitter satellite to receiver satellites, satellites 110 can be similarly operable to automatically adjust the transmission of navigation signal 240. Due to the fact that satellite constellation system 100 controls navigation signal 240 that can be used for RO measurements, the signal design can be dynamic to allow navigation signal 240 to change in cases where atmospheric conditions necessitate it (e.g. changes that make losses greater can result in a boost in the signal power, or changes that may require larger bandwidths can result in adjusting the bandwidth, or even frequency). When satellite constellation system 100 controls the broadcast, satellite constellation system 100 can have a feedback loop between the transmission and receiving ends to optimize the transmitted signal to get the best information possible. That optimization can change base signal characteristics such as frequency, bandwidth, power levels, waveform, and/or other signals characteristics.

The ability to control both the transmission and the receiving side allows satellite constellation system 100 to be a closed loop RO system in the sense that satellite constellation system 100 can adjust key transmit parameters, including but not limited to, frequency, power, and signal structure, to provide the best transmission for measuring atmospheric properties at the current moment. What is considered best transmission is a function of the receiving satellite's measurement performance which can be fed back to the transmitting satellite to adjust the signal parameters through any combination of the links in FIG. 2. Example signal characteristics of the navigation signal 240 that can be adjusted include frequency of the navigation signal; bandwidth of the navigation signal; waveform of the navigation signal; power of the navigation signal; and/or any other parameters that define the generation of a signal, the transmission of a signal, and/or other properties of the signal itself.

The feedback loop process that is utilized to determine when and/or how to adjust these parameters can be performed by utilizing the processing module 320 of one or more satellites. An example of this feedback loop process includes the following steps:
1. Satellite A receives signal from Satellite B and computes a raw measurement from the ranging signal (the raw measurement includes, but is not limited to, the range to the satellite, frequency and code offsets, carrier phase, signal receive power, etc.)
2. Satellite A evaluates performance metrics on the raw measurement (e.g. receive power compared to a desired threshold, ability to track the signal and compute carrier phase measurements, etc.) and decides if any threshold is not met.
3. If thresholds are not met (e.g. receive power is too low) Satellite A transmits a message, through any combination of links shown in FIG. 2, to request a signal characteristic change from Satellite B (e.g. if receive power is too low, then request a boost in the signal power)
   a. Alternatively to sending a request for a signal characteristic change, Satellite A can transmit the performance metrics and Satellite B can make the decision for what to change.
   b. Different performance metrics can be used to control different signal characteristics, but it does not have to be a one to one mapping between signal characteristic and performance metric.

As discussed, the satellite constellation system 100 is implemented as a LEO-LEO system due to the transmission and reception of signals between satellites 110 in LEO. Implementing satellite constellation system 100 as a LEO-LEO system can enable some or all of the functionality and/or improvements to existing systems listed below, for example, as a result of the fact that this system controls the broadcast and some due to the fact that various backhaul networks can be leveraged:
The geometry of satellite constellation system 100 results in line of sights between satellites 110 that traverse through a different portion of the atmosphere than a line of sight between a LEO satellite and a MEO satellite.
Faster motion on both the transmission and receiving sides means an increase in atmospheric measurement frequency and geometric diversity.
Leveraging a combination of the links in FIG. 2, the RO measurements can be transmitted from the satellites to users (Earth based and/or space based) in near real time.
Sufficient density of available tomography can allow for the creation of ionosphere and troposphere models derived for the creation of GNSS corrections without a need for ground infrastructure.
The above allows for not only the creation of corrections for GNSS satellites, but also for the precision satellite constellation itself, improving robustness and convergence times towards precision navigation.

With high spatial density ground monitoring stations and/or a LEO multifrequency satellite constellation, real-time, highly detailed maps of the ionosphere can be produced for both scientific, government, and industrial applications. Some applications include improved Earth weather prediction, GNSS corrections for improved stand-alone positioning and positioning augmented with this satellite system, protection of satellite assets from space weather events, and others. This unique approach would combine measurements from satellite constellation system 100 to the ground and/or from existing GNSS satellites to satellite constellation system 100. This allows for atmospheric model layer separation and finer granularity.

The RO tomography data generated through the RO measurements recorded by satellite constellation system 100 can be used to generate a map of the ionosphere and troposphere where appropriate navigation atmospheric correction messages are derivative products of this map. This data can be used in traditional GNSS Precise Point Positioning (PPP) approaches in addition to the navigation schemes presented here. The reduces the search space in carrier phase ambiguity resolution and can greatly accelerate convergence time.

Alternatively or in addition to providing atmospheric data, the satellite constellation system 100 can be implemented to provide precise navigation by giving users their precise position and time. One of the key elements to providing this information to users through a satellite based ranging signal includes performing precise orbit determination, or otherwise being able to precisely determine the location of the satellite in space. This information can then, along with a ranging signal, be broadcast down to users on the ground to enable precise positioning and/or timing. In addition to the complete solution, correction information can be provided to spatially “close” users, such as users in orbits near those of our satellites, to allow those users to get precision positioning and timing data. This enables this satellite system to be able to provide precise positioning to users at altitudes below this satellite system and users at altitudes at close (above) to this satellite system. The precision navigation section performed by satellites 110 includes orbit determination, autonomous constellational monitoring, and/or adjusting of signal characteristics for providing the best navigation signal.

Current methods for precision and high accuracy orbit determination require the use of ground monitoring stations to observe the location of satellites with specialized measuring equipment and perform heavy computation for determining orbits. Satellite constellation system 100 improves existing systems by performing autonomous in-situ distributed orbit determination, where processing is done onboard satellites 110 autonomously through edge computing. This significantly minimizes requirements on ground infrastructure. Autonomous orbit and clock estimation onboard the satellite in real-time allows for lower cost clocks as part of the satellite hardware. Temperature compensated crystal oscillators (TCXOs) and oven-controlled crystal oscillators (OCXOs) are lower cost than Chip Scale Atomic Clocks (CSACs) and other timekeeping technology, but are most stable over shorter periods of time. Real-time orbit determination and dissemination to the user makes the use of these clocks possible, whereas if orbit determination is done by the ground network, then longer periods between uploads would require higher performance clocks onboard.

Additionally, some embodiments of satellite processing system 300 use the same clock 365 in both the GNSS receiver and/or other elements that handle the analog to digital conversion of the signal and other elements within the receiver, and in the generation of the navigation signal carrier frequency. This usage of the same clock 365 results in the estimated clock state using GNSS measurements reflecting the state of the clock used to generate the navigation signal itself, which results in a more precise navigation signal and navigation message. In other embodiments, multiple clocks 365 may be present, where the clock generating the navigation signal carrier frequency is “disciplined” to the clock in the GNSS receiver or the clock in the GNSS receiver is “disciplined” to the clock generating the navigation signal carrier frequency.

The precise orbit determination, or the estimation of the satellite's precise state, which can contain information including, but not limited to: position, velocity, acceleration, clock bias, clock drift, clock drift rate, current time, attitude, attitude rates, carrier phase offsets, etc.), is performed on-board the satellite using a navigation filter that uses measurements from on-board and/or offboard sensors and/or correction data. This process is described below:
1. Raw data from a GNSS receiver, Inertial Measurement Unit (IMU), attitude determination instruments, and/or radio signals from neighboring satellites in this system are collected by and/or are otherwise available to each satellite 110. Measurements can also be ground based, where this data is transmitted to the satellite via a data link.
2. The raw GNSS measurements are fed into a tightly coupled navigation filter onboard the satellite 110. For example, the navigation filter can be implemented by utilizing orbit determination module 322. The filter uses GNSS orbit corrections and/or other correction data such as atmospheric corrections provided by any combination of the links in FIG. 2 to produce a tightly-coupled PPP carrier phase ambiguity-resolved navigation solution.
3. The navigation filter propagates the state estimate to the current epoch.
4. The navigation filter updates the position (of the satellite center of mass), attitude, clock, and/or other state estimates given the most recent measurements.
5. The position, attitude, and/or clock estimates are, using one or more models based on physics or other data driven models, propagated forward for a short period to produce predictions of the position of the broadcast antenna phase center.
6. This predicted path of the satellite orbit and clock (where the clock is the same clock generating the carrier for the navigation signal) are fit to a curve that will become the broadcast navigation message. This curve fit is packaged into a binary navigation message to be broadcast by the satellite to the users.
7. The broadcast orbit and clock message can be broadcast by the satellite 110 at regular intervals that meet the minimum time to first fix.
8. If the orbit and clock states computed by the physics-based propagation differ from the orbit and clock computed using the navigation message, a new navigation message will enter the broadcast queue, performing autonomous integrity monitoring.
9. The broadcast signal is received by users and/or user devices such as client devices 160, and the precise orbit data enables the user and/or client device 160 to compute a precise position and time solution.
10. The precise position and time solution can be displayed to the user (for example as a pin on a map with some bounds on the error that show that the user's position is very precise), for example, by utilizing a display device of client device 160. In the case of a robotic or autonomous or highly automated system, this position solution can be ingested natively, for example, to be used as a measurement for precision autonomy.

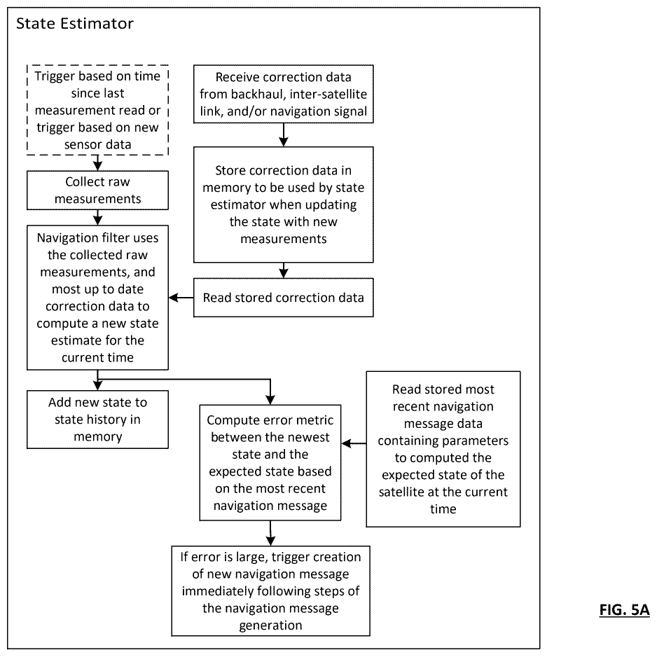

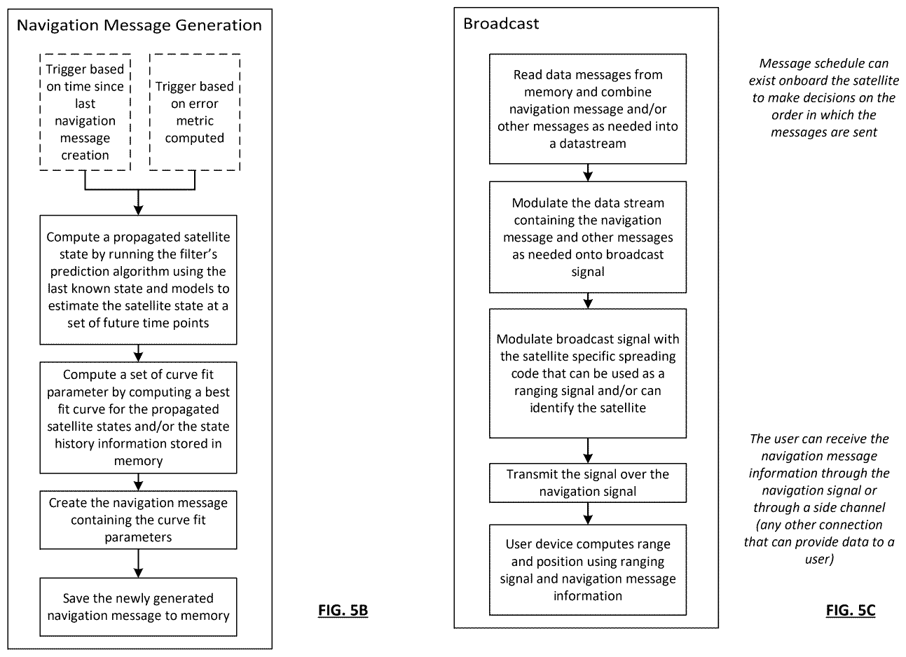

Each satellite 110 can perform process for the autonomous orbit determination via performance of a state estimation flow as illustrated in FIG. 5A, performance of a navigation flow as illustrated in 5B, and/or performance of a broadcast flow as illustrated in FIG. 5C. These separate depictions of the state estimation flow, navigation flow, and broadcast flow highlight the fact that process can be performed in several different loops triggered by different events. The satellite processing system 300 can be utilized to perform some or all of the steps illustrated in FIGS. 5A, 5B, and/or 5C, for example, by utilizing orbit determination module 322, navigation message generation module 323, and/or message scheduling module 324, respectively.

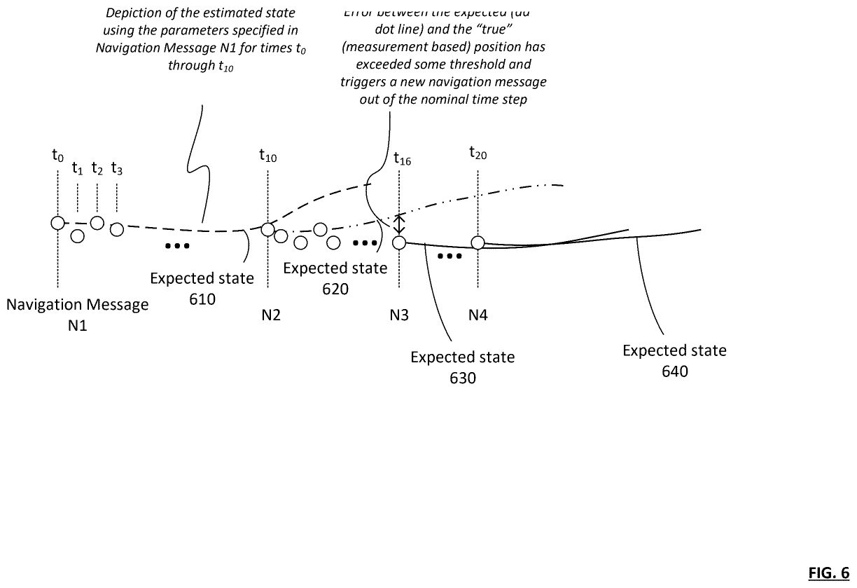

FIG. 5A illustrates an embodiment of a state estimation loop. The loop is configured to run at a specific rate or triggered based on new measurements from the sensors onboard the satellite. Upon the trigger, the new measurement from the onboard sensors, which can include, but is not limited to, inertial measurement units (IMUs), GNSS receivers, attitude sensors (e.g. star trackers, horizon sensor, etc.), radio signal receivers to signals from neighboring satellites in this satellite positioning system, and other sensors, are used by the navigation filter to compute the precise state. Note that measurements can also be made from ground-based sensors and the data of the measurement can be transmitted to the satellite via any combinations of the links in FIG. 2. These sensor measurements can be used in conjunction with precise GNSS orbit and clock data estimated by the ground segment (PPP correction data) and/or other correction data (such as atmospheric models) desired. This correction data can be uploaded via any combinations of the links in FIG. 2 and can be stored in memory onboard the satellite. The newly computed state can be saved to an onboard history vector of the current and/or past states. Additionally, this newly computed state can be compared to the expected state at the current time based on the last navigation message. If the error metric exceeds a given threshold then the navigation loop is triggered to generate a new navigation message as described in FIG. 5b. A more detailed example of the comparison with the expected state is depicted in FIG. 6.

Typical ground-based orbit and clock determination for GNSS only uses the signals received on the ground. Having the orbit and clock determination onboard, enables the satellite to make use of additional sensors that help decouple the attitude from the orbit as well as the orbit from the clock. Decoupling the attitude is important as it enables the use of this orbit and clock determination system to be used on a variety of satellites including small satellites where only minimal attitude control may be available. For example, in a satellite configuration where the broadcast signals are nadir pointing and the received GNSS L1/L2/L5 signals are received from a zenith antenna, a non-trivial offset will be present between these antennas which must be accounted for in user precise positioning. Inertial sensors, which are essentially only affected by orbital effects and not clock effects, can be integrated into the orbit determination and propagation process and help separate orbit and clock errors, especially as GNSS geometry worsens in polar regions.

The orbit determination can be aided by terrestrial stations, especially in polar regions, where not only would ground stations be typically visible to the greatest number of satellites, but the GNSS geometry is weakest on orbit. The ground stations can broadcast another ranging signal that can be received by satellites on orbit to aid in the orbit determination by providing more high accuracy range measurements. This allows for the measurements to very cleanly enter the estimator. This also allows for the ground station to be broadcast-only (one-to-many) rather than talking directly to a specific satellite, keeping orbit determination autonomous without need for direct communication to the ground station. The ground stations can also be capable of receiving the ranging signal broadcast by this satellite system, allowing the ground stations to either do some estimation on the ground and send the estimate back to the satellite or more simply send the measurements collected on the ground up to the satellites on orbit and let the satellite use the measurements in their onboard estimators. The latency between the collection of the measurement on the ground and the reception of that on orbit may introduce some complications in the estimation. Ground stations can also be equipped with a laser to point at a retroreflector on the satellite providing another accurate range measurement to the satellite. Once again, this measurement can then be used on the ground and estimates can be sent to the satellite, or the measurements can be directly sent to the satellites to be used in the onboard estimators.

The precise orbit determination computed onboard the satellites can use Precise Point Positioning (PPP) correction data, which consists of precise orbit and clock estimates of GNSS satellites. PPP data can be transmitted from the ground to the satellites via any combination of the links depicted in FIG. 2.

The navigation message creation is a second loop running onboard the satellite that can be set to its own rate independent of the precise orbit determination rate. The process flow for the navigation message creation is shown in FIG. 5B. This loop can be either triggered by timing for a fixed frequency of operation or by a trigger based on a computed error metric that is computed at the precise orbit determination rate. One manifestation is that the navigation message is generated by computing a best fit curve on the expected future state computed by running the filter's prediction step. Such a best fit curve has a set of parameters (e.g. that define the orbit and clock state) that can be put into a binary message to be sent as part of the navigation message.

The broadcast flow of FIG. 5C can be once again running at an independent rate, this time specified by the desired data rate for data to be transmitted on the ranging signal, handles the transmission of the navigation message, along with any other data messages that are desired. This transmission system reads a queue of messages and modulates the data contained in the messages onto the navigation signal (which in some embodiments has a ranging signal already modulated onto the carrier), which can be at various different frequencies. Note that in some cases only the ranging is modulated on the carrier to make the navigation signal.

Once modulated, that signal is transmitted from the satellite 110 and can be received by at least one client device 160 which can include, but is not limited to, devices on the ground (such as handheld devices, vehicles, etc.), devices in the air (such as planes, drones, etc.), devices in space, and/or other embodiments of client device 160 discussed herein. Client device 160 can compute a range to each satellite 110 in view with the ranging signal and, given the precise navigation message data, is able to compute a precise position.

In various embodiments, the orbit determination process onboard of each of the satellites 110 allows the satellites to monitor their own messages and/or those of the neighboring satellites. Satellites 110 can be operable to perform a self-monitoring process. In particular, at every time step that the navigation filter updates the precise state of the satellite, satellite processing system 300 can compare the newly computed precise state with the expected state as described in the most recent navigation message.

FIG. 6 demonstrates an example of this self-monitoring process. For this example, the rate of the estimation loop and the navigation message generation are such that a new navigation message is generated, nominally, every 10 measurement updates. Starting at time t₀, the navigation filter has computed a precise state, shown as a circle at time step t₀ on the figure, and a navigation message, N1, is generated as described in conjunction with FIG. 5B. Using the navigation message data, the expected state for all time steps in the time window between t₀ and t₁₀ is shown as a line, which corresponds to expected state 610. Note that the line, and therefore the message can be valid for a longer time period than the time period for the next triggered navigation message update. Moving forward in time, FIG. 6 shows the estimated states at time steps t₁, t₂, and t₃. At each one of these time steps, a comparison is computed between the estimated state and the expected state as given by navigation message N1. In this example, none of these comparisons compare unfavorably, so the system behaves nominally.

At the end of the time window at time t₁₀, the time-based trigger results in a new navigation message, N2, being generated as depicted in FIG. 5B. This new navigation message is now what is being transmitted at regular intervals over, for example, the navigation signal. The new expected state through time is once again shown as a curve, in this case expected state 620. A new time window is set between times t₁₀ and t₂₀.

Moving forward through time to time step t₁₆, the difference between the estimated state (shown as a circle) and the expected state as computed using navigation message N2, exceeds a given threshold, resulting in a trigger of the generation of a new navigation message, N3. This new message has a new curve for future expected states, in this case expected state 630.

As time continues to move forward to the end of the new time window at step t₂₀, the generation of a new navigation message, N4, is triggered by the nominal time based trigger behavior. This new message has a new curve for future expected states, in this case expected state 640. Other variations are possible, for example, a new time window can be set between times t₁₆ and t₂₆ upon the transmission of navigation message N3. In the absence of deviation from the expected state 630 during this time window, the next navigation message (N4) could then be sent at step t₂₆ when this updated time window expires.

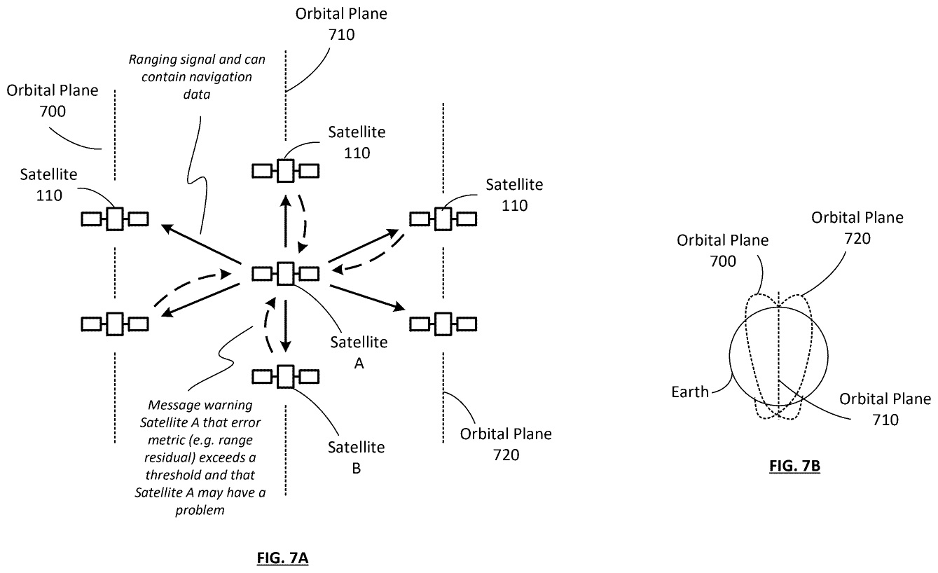

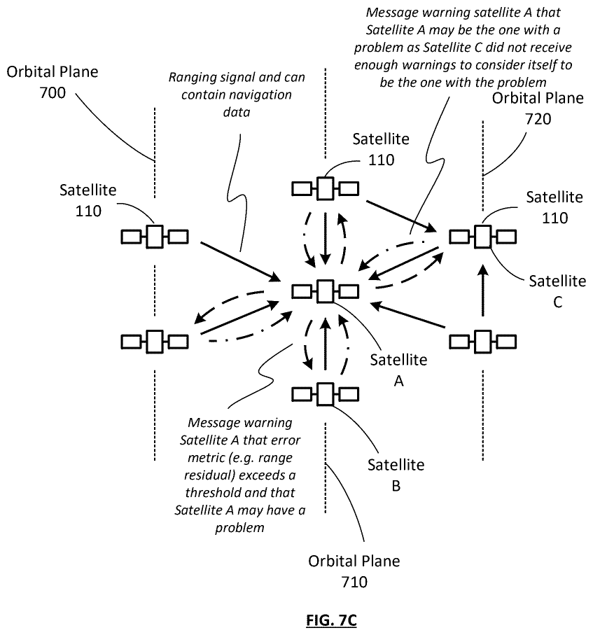

Alternatively and/or additionally to performing this self-monitoring, satellites 110 can be configured to perform neighborhood monitoring, where satellites 110 are operable to monitor some or all physically neighboring satellites in constellation. Through an ability to transmit and/or receive navigation signals, a consistency check based on in-situ measurements can be used to identify upsets on any one particular satellite or group of satellites to quickly resolve any issues and maintain integrity of the system. Each satellite 110 can be equipped to transmit and/or receive navigation signal 240 and the corresponding navigation message data through any link depicted in FIG. 2 to and/or from its neighbors both within its orbital plane, and/or in neighboring orbital planes, as depicted in the configuration in FIGS. 7A and 7B.

FIG. 7A illustrates a two-dimensional depiction of a subset of the plurality of satellites 110, including satellite A and satellite B. This subset can constitute a “neighborhood” with respect to satellite A, where all satellites 110 are in view of satellite A and/or where satellite A can otherwise transmit and/or receive navigation signal 240 from its neighboring satellites. These neighboring satellites of satellite A can include satellites 110 on the same orbital plane 710 as satellite A, and can include one or more satellites on either side of satellite A along orbital plane 710. These neighboring satellites of satellite A can alternatively or additionally include satellites 110 on different orbital planes 700 and 720. As illustrated in the three-dimensional depiction of orbital planes 700, 710, and 720 with respect to earth of FIG. 7B, orbital planes 700 and 720 can be neighboring orbital planes of orbital plane 710. Some or all of the other satellites 110, such as satellite B, can have their own neighborhood of neighboring satellites, which can include a proper subset of the satellites 110 in the neighborhood of satellite A and/or can include at least satellite A.

In this example embodiment, navigation signal 240 contains both the ranging signal and data containing at least the navigation message data. However, in other embodiments, navigation signal 240 can contain only the ranging signal with each satellite either already knowing the navigation message data for its neighboring satellites and/or receiving the navigation message data through any combination of the links depicted in FIG. 2.

In the example embodiment depicted in FIG. 7A, the neighboring satellites (e.g. satellite B) to satellite A can compute the expected range measurement to satellite A as each satellite knows its own estimated state and can compute the expected state of satellite A using the corresponding navigation message data for satellite A. Satellite B can also compute the measured range using navigation signal 240 from satellite A. From these two ranges, an error metric can be computed (e.g. a range residual). If that error metric exceeds a given threshold then satellite B can send a message, through any combination of the links in FIG. 2, to satellite A notifying satellite A that it may be broadcasting incorrect navigation message data. This notification can be in the form of a status message that can send a flag, the error metric data, and/or any data that can be used by Satellite A as a notification of possible error or other anomalies. If satellite A receive messages from more than a threshold number or percentage of neighboring satellites, satellite A can update its status information in the navigation message to notify users (including the neighboring satellites) that its navigation message data should not be trusted and therefore that the satellite should not be used. In addition to notifying satellite A, the neighboring satellites can also send error information that satellite A can use to verify and update its state estimate to correct for errors in the estimator, provided that each of the neighboring satellites are performing nominally.

FIG. 7C depicts a further example case with a neighborhood of satellites on orbital planes 700, 710, and 720 of FIG. 7B. If Satellite A computes an error metric that exceeds a given threshold value to a number of neighboring satellites above a threshold number or percentage, it can either self-detect that it may have an error in its state estimate, and/or the neighboring satellites can alert Satellite A that Satellite A may have a problem. Satellite A can notify each of the neighbors that they may be wrong (e.g. Satellites B and C) in response to computing the error metric that exceeds a given threshold for these neighboring satellites. If the neighbors (e.g. Satellites B and C) have not received enough warning messages to put it over a threshold number or percentage, they can each respond to Satellite A indicating Satellite A may be the satellite in the neighborhood with an error.

Satellites 110, as part of satellite constellation system 100, can also adjust signal parameters, for example as described previously, for the purpose of improving the performance of the reception and/or use of navigation signal 240 by users in space and/or users on Earth. Trigger conditions for adjusting signal parameters (such as beamwidth, power levels, and/or other signal characteristics of interest) can include the following, alternatively or in addition to the trigger conditions discussed in previous sections:
Determining the location of satellite 110 above the Earth is, for example, over a major city or otherwise compares favorably to a location range for a trigger condition. As a result, satellite 110 can narrowing the beamwidth and/or increasing the signal power to aid in increasing the received signal strength of navigation signal 240.
Determining proximity and/or density of one or more satellites 110 in orbit (such as over the polar regions if the satellite orbits are polar orbits) that result in a very high density of transmissions of navigation signal 240. As a result, some or all satellites 110 can autonomously decide to turn off transmissions, for example based on remaining battery capacity and/or power margins left in satellites 110.
Determining other location based and/or monitoring based triggers that are deemed to affect the quality of navigation signal 240 received by users.

The setting of these parameters can be adjusted autonomously by satellites 110 by utilizing satellite processing system 300 based on information received from neighboring satellites and/or ground measurements, adjusted by a ground segment with a human in the loop and/or autonomously based on monitoring data of satellite constellation system 100, and/or can be configured before launch of the satellite and fixed for a given satellite 110 and given orbit.

In various embodiments, forces on the satellite can be calculated based on satellite orientation and precise measurements, which can be utilized to build an atmospheric density model. Many LEO satellites at lower altitudes feel forces due to atmospheric drag. While the upper atmosphere is very thin, it still provides an appreciable amount of force that eventually leads to the de-orbit of these satellites unless preventative measures are taken. While existing rough models can be used for the density of air in the upper atmosphere, it is known that this density is not temporally or spatially constant. Satellite constellation system 100 can be capable of taking precise GNSS measurements, as described in conjunction with FIGS. 5A-5C, and thus can have precisely known positions and velocities. Satellite 110 can also know its orientation (pose) precisely and can therefore calculate the expected forces due to solar and/or albedo radiation pressure, among other forces acting on the satellite. Once all other large orbital perturbations are taken into account, this information can be processed on board the satellite and/or on the ground and used to determine the magnitude of the atmospheric drag force acting on a given satellite 110. Once this drag force is calculated, the density of the atmosphere at these specific satellite 110 positions can be calculated. With a dense constellation of satellite 110 and this data from each satellite 110, models of the upper atmospheric density can be generated by either interpolating values spatially and/or temporally, or through other means. The resulting atmospheric density models can be used to help with on-orbit trajectory prediction for satellite 110 and/or any other satellite in similar orbits that are capable of receiving the atmospheric density model data. Additionally, these models can form the foundation for creating forecasts of upper atmosphere density.

In various embodiments, certain users can become nodes transmitting navigation signals to expand the network of satellite constellation system 100, giving rise to substantially more navigation signals and an improved service. These additional nodes can be implemented utilizing hardware and/or software of any of the client devices 160 discussed herein, for example, equipped with its own satellite processing system 300 and/or operable to perform some or all of the functionality of a satellite 110 as discussed herein. These additional nodes can be static, for example, fastened to infrastructure and/or otherwise installed in a particular constant and/or known location. These additional nodes can alternatively be mobile, for example, corresponding to a mobile device and/or vehicle with a changing location.

Similar to how orbit determination is performed in this navigation constellation scheme with satellites in low Earth orbit to deliver an additional navigation signal on the ground, all other aerial and ground receivers can employ the same precise positioning scheme and can in turn transmit similar navigation signals to create a much larger and more comprehensive navigation network. Each additional receiver works as a node in a more substantial network of navigation signals, aiding both in collaborative positioning and in current GNSS-challenged environment.

Employing similar estimation processes as satellites 110 from satellite constellation system 100, user devices or other devoted ground or aerial navigation nodes can create and/or transmit their own navigation signals. This gives rise to substantially more signals for more robust positioning in traditionally challenging GNSS environments. In one embodiment, these navigation signals can be nearly identical to those transmitted by satellites as part of satellite constellation system 100. In other implementations, different schema maybe be considered for specific applications or use cases. This may include the usage of different electromagnetic spectrum or other transmission modalities including but not limited to, optical and/or ultrasonic. This can also include a different number of transmission frequencies or signal modulations.

As an example, consider a dense urban environment with several aerial and ground-based robotic systems in operation. Aerial systems flying above buildings can utilize the line of sight signals to a combination of GNSS satellite and satellite constellation system 100 satellite navigation signals for precise and secure positioning. With its position solution computed, this aerial platform can broadcast its own navigation message, in much the same way as the satellites in satellite constellation system 100. This, along with aerial and other navigation nodes in the network, including potentially as stationary infrastructure, adds significant diversity in line of sight in urban canyons, substantially aiding ground vehicle navigation. For example, the top corners of certain tall buildings can be good candidates for infrastructure node locations, having a clear line of sight to the sky and the road below. To further aid in this problem, ground vehicles can broadcast their own navigation signals to improve collaborative localization at the street level where now relative range measurements help the multi-agent navigation system.

In various embodiments, the satellite constellation system 100 can provide secure data to its users. Current GNSS signals that are available for civilian use are broadcast unencrypted with known signal and data structures. This was pivotal in the global adoption of GNSS as the standard bearer for positioning, but as the number of those that depend on GNSS services has grown, the vulnerabilities of GNSS have become more apparent. GNSS being at such low power is often jammed unintentionally and since its signal structure is publicly available it is subject to malicious spoofing attacks.

The satellite constellation system 100 improves upon traditional GNSS services by performing full encryption of the spreading code along with the navigation data. In this case, there can be several channels that offer different data at different rates. This is accomplished using a combination of code shift keying along with encrypted data modulated at a lower rate. Where appropriate, the data is encoded using a Low Density Parity Check scheme that allows for forward error correction, enabling the satellites to deliver data to ground users at a high, robust data rate.

The encryption keys can be locally stored in memory of client devices 160, for example, in some manifestation of tamper-resistant hardware within the receiver utilized by some or all client devices 160 to receive navigation signals 240 from satellites 110. Each client device's key can be leaf that belongs to a layered Merkle-Damgard tree, giving this satellite constellation system 100 the ability to provide service to any number of client devices 160 while denying service to anyone who breaks the terms of service. These keys can be changed collectively at predetermined intervals that allow for a subscription plan alongside permanent users. These changeovers can be carried out using secure one-way functions.

There can be several acquisition methods for the encrypted signal. Any client devices 160 with preexisting knowledge of their location and time within reason can carry out direct acquisition of the signal using a parallel search strategy. All other client devices 160 can directly acquire these signals as the required computational resources are available to them. Once a single satellite from the constellation has been acquired, a coarse almanac is recovered that allows the user to find any other satellites that may also be in view along while anticipating the satellites that will soon be in view.

With a single satellite in view, a client device 160 in a known location can have secure knowledge of their time. Likewise, any users that know 3 out of 4 position domain parameters (latitude, longitude, height, clock-bias) can securely determine the fourth with this satellite system. In a secure time example, a receiver is surveyed and has a known latitude, longitude, and height. In order to provide a secure timing service, the receiver need only acquire a single satellite signal. The pseudo range calculated from the user to the satellite can be subtracted by the predicted range to the satellite knowing the surveyed receiver location. The clock bias can be calculated from this difference. Since the signals and data are encrypted, the user can trust that the signal came from a trusted satellite in this constellation and thus the clock bias calculation can be trusted. With four satellites in view, an unambiguously secure position and time solution can be solved for using these satellite signals.

Application data corresponding to a secure service of the satellite constellation system 100 can be stored in at least one memory of the client device 160. For example, the application data can be received by the client device 160 for download from a server system associated with the satellite constellation system 100 via network 250 and/or can be received in a signal transmitted by a satellite 110. When this application data, and/or other executable instructions stored in memory of the client device 160, are executed by at least one processor of the client device 160, this can cause the client device 160 to securely obtain and/or update their key, to utilize their key to securely determine their position and/or time based on encrypted signals received from satellites 110, and/or to utilize their key to confirm authenticity of received signals as being transmitted by received from satellites 110 as opposed to a spoofing entity.

In various embodiments, the satellite constellation system 100 can be operable to perform space-based GNSS Constellation Monitoring. A GNSS satellite fault can produce serious positioning errors if incorporated into a calculated position. In order for GNSS signals to be incorporated in safety-critical applications, such as aviation, their performance must be constantly monitored for such fault events. Many receivers used in these applications incorporate autonomous monitoring techniques such as Receiver Autonomous Integrity Monitoring (RAIM) to detect and exclude signals that may be faulty, but autonomous integrity techniques for receivers using code-phase positioning have severe limitations in that they cannot easily observe some satellite faults. These techniques may be enough to ensure that the true position is within one-third of a mile from the calculated position, but in order to obtain tighter bounds, also known as protection levels, on true position, local or wide area monitoring techniques must be employed. Satellite monitoring can be accomplished through systems known as Satellite Based Augmentation Systems (SBAS). In existing systems, reference stations in a region of interest can use these measurements to estimate the different error sources that may be present. These error estimates are then passed to central processing facilities where they are then then broadcast to users via a satellite link from a geostationary satellite. These systems are able to detect satellite faults and broadcast alerts to users, for example, within 6 seconds of the beginning of such faults.

Similar GNSS satellite fault monitoring can be carried out by satellite 110 in LEO when satellite 110 is using carrier phase precise positioning techniques, such as described in conjunction with FIGS. 5A-5C. Autonomous integrity monitoring techniques can be utilized to achieve precise protection levels, for example, by calculating position solutions using subsets of GNSS satellites running in parallel. For instance, if there are N satellites in view, there are N+1 position solutions calculated for the case that one GNSS satellite is excluded. These solutions are compared with each other in order to derive protection levels for the calculated position. If a single GNSS satellite is faulted, all N+1 solutions will begin to deviate from the true position except for the subset solution that has excluded that GNSS satellite. If the solutions become separated by an amount set by a threshold, then it can be determined that there is a fault in the GNSS signal emanating from the GNSS satellite. By computing these subsets and comparing the solutions to a given threshold, satellite 110 can know that a GNSS satellite was producing a faulty measurement if the solutions separated by more than the given threshold and can then transmit alert information for the faulted GNSS satellite.

A single satellite 110 in LEO can use the above method to detect a faulty GNSS measurement. Satellite constellation system 100 can have multiple satellites 110 in view of the same faulted GNSS satellite. Because of this, there will be larger observability of such a GNSS satellite fault and this will allow all satellite 110 observing the faulted GNSS satellite to form a consensus and thus have higher confidence in a decision to alert users. This technique differs from existing services in that all current GNSS satellite health monitoring is carried out by terrestrial reference stations whereas this provides a satellite-based solution that carries out this task autonomously. Satellite constellation system 100 can also be capable of transmitting alerts via navigation messages or other alert data to users in the event that there is an observed GNSS satellite fault through any combination of links in FIG. 2.

Beyond GNSS faults, satellite constellation system 100 can also transmit parameters describing the performance of the GNSS satellites. Satellite constellation system 100 can provide multiple simultaneous precise observations of the GNSS satellites using the methods outlined above. These observations can then be compiled and transmitted as corrections and confidence parameters to be used by GNSS receivers.

By utilizing satellites 110 in this fashion to detect GNSS faults and/or to determine parameters describing the performance of the GNSS satellites for transmission, GNSS systems can be monitored entirely in space. This presents an improvement to existing systems by facilitating this GNSS monitoring without any dependence on ground-based reference stations or ground based central processing facilities. Existing systems are further improved due to the better geometry, higher signal strength, and greater number of satellites more satellites in view as a result of utilizing the satellites 110 rather than ground-based facilities.

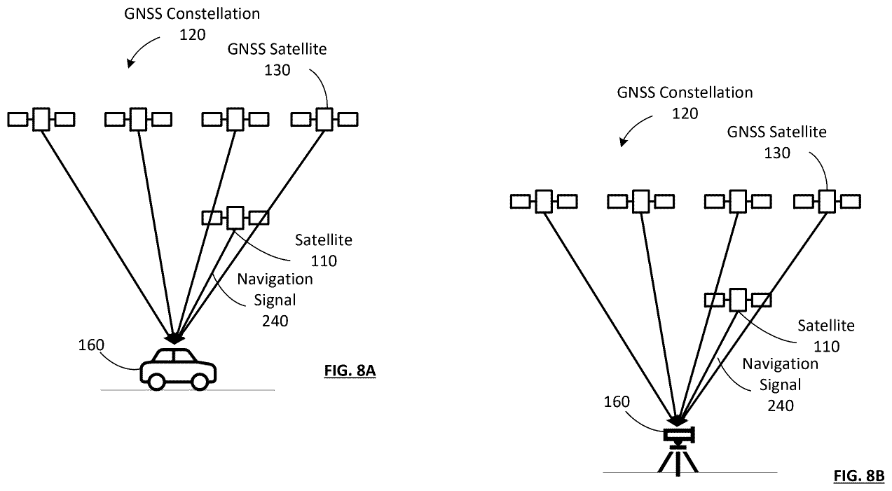

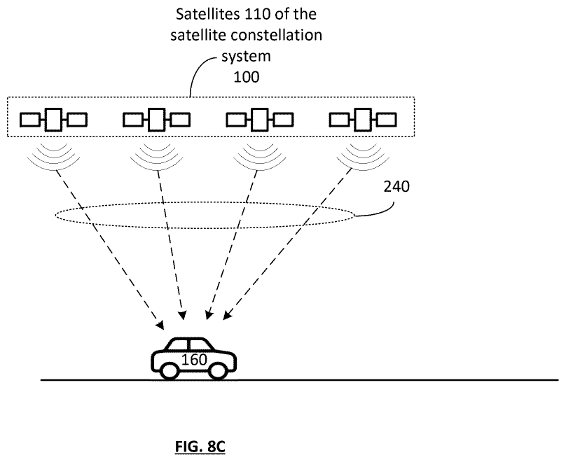

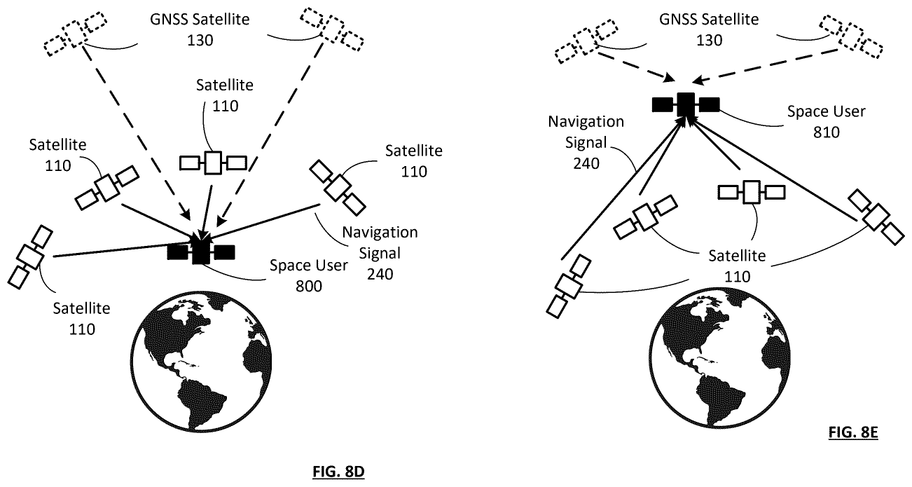

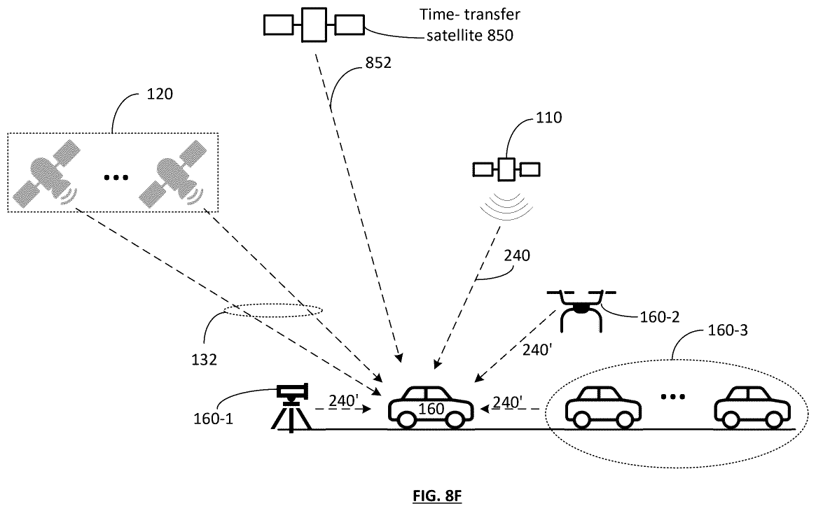

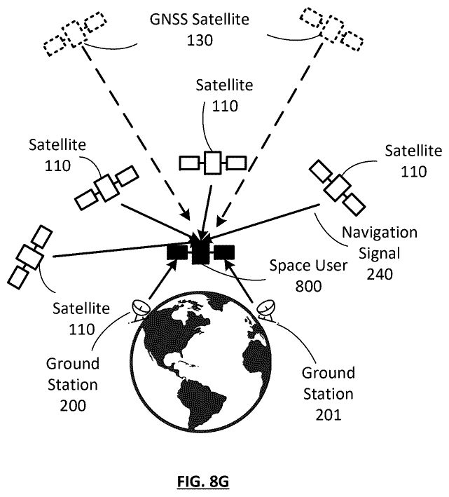

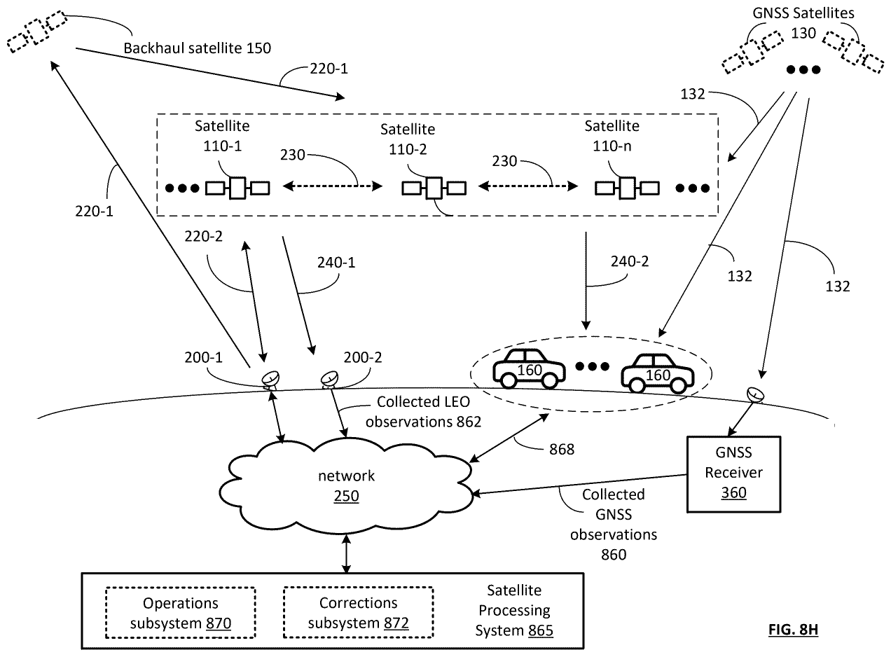

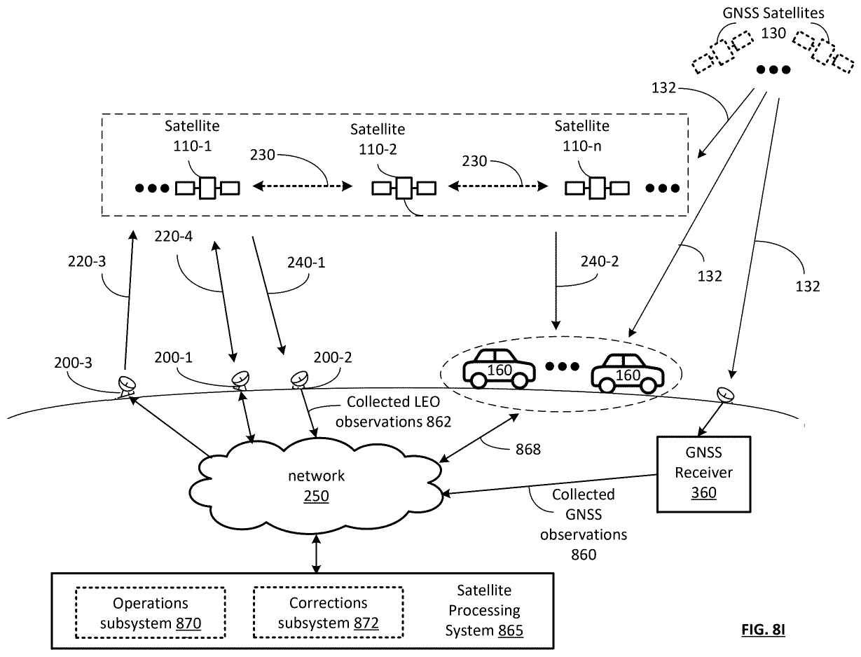

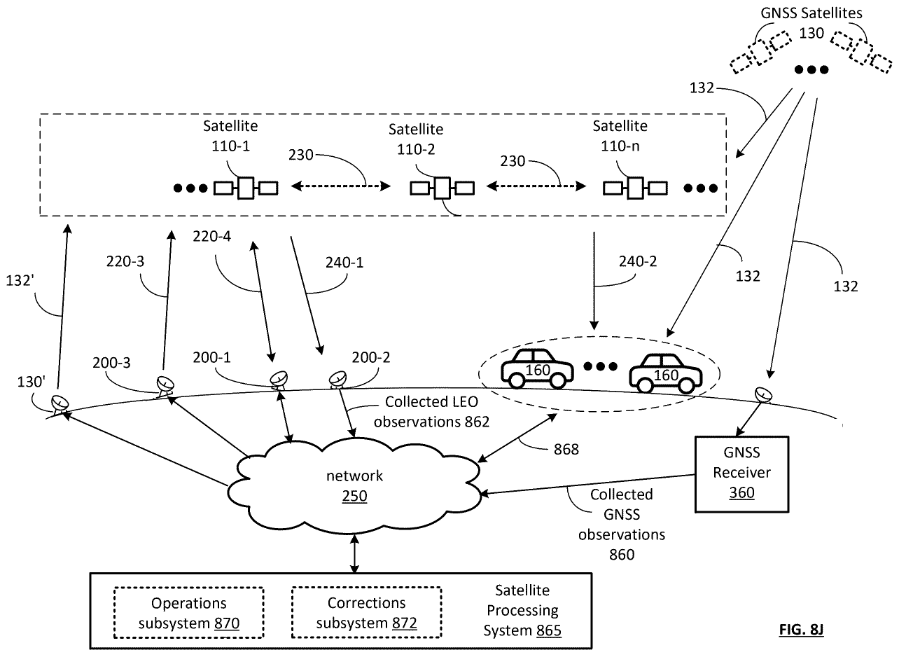

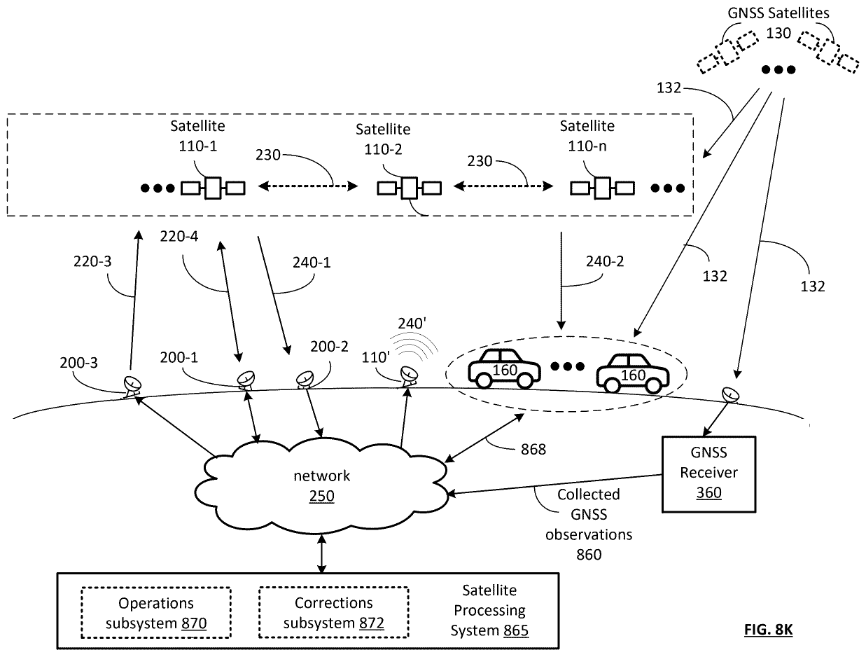

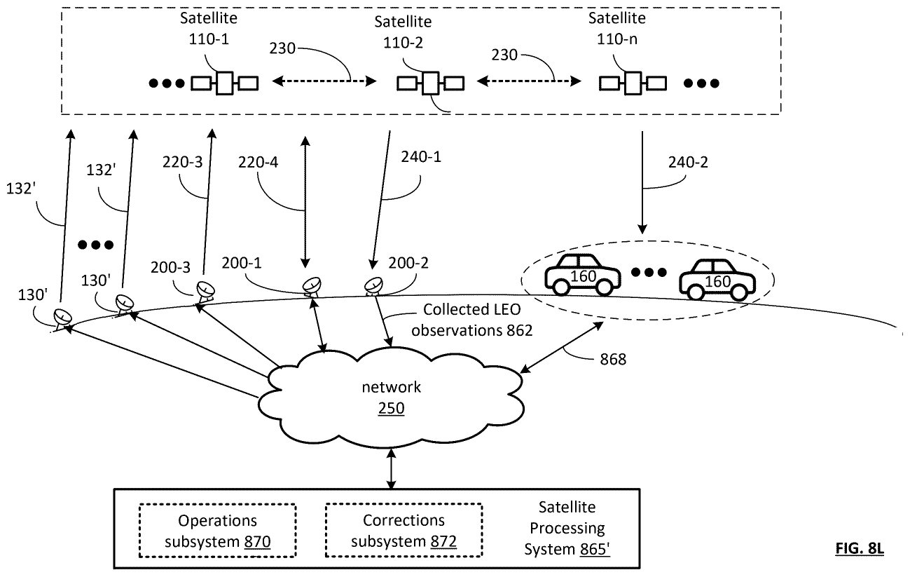

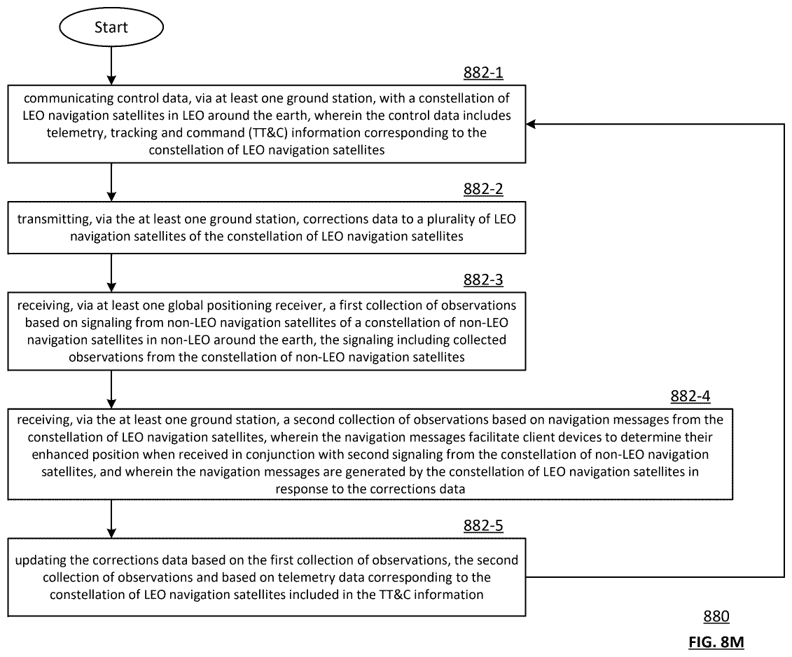

FIGS. 8A, 8B, and 8C illustrate the service levels available to ground and/or aerial users as a function of the number of satellites 110 in view from satellite constellation system 100. FIG. 8A shows the scenario with one satellite 110 in view with a client device 160 corresponding to a mobile user such as a vehicle. When used in conjunction with GNSS satellites, satellite 110 can provide data to increase the precision of GNSS. Satellite 110 further adds a navigation signal to provide additional range and range rate information. The rapid geometry change associated with satellite 110 allows for fast initialization of precise positioning. Hence, this augments GNSS, improving precision. FIG. 8B shows the case for a client device 160 corresponding to a static user with one satellite 110 in view. In this case, because the position of static user is known, satellite 110 provides a secure source of timing information when the navigation signal is provided with encryption, which can be used without GNSS.

FIG. 8C shows the scenario where satellite constellation system 100 has sufficient satellites such that four or more satellites 110 are in view to the client device 160, such as the automobile represented. In this scenario, a sufficient number of independent navigation signals 240 from satellite constellation system 100 are available such that a highly precise can be supported by exclusive use of navigation signals 240, and/or such that highly secure position solution with full encryption can be supported when navigation signals are provided with encryption.

The various functionality of the satellite constellation system 100 discussed can be utilized to implement one or more other applications. For example, satellite constellation system 100 can be utilized by maritime systems, where one or more client devices 160 is onboard and/or otherwise corresponds to one or more boats or other maritime systems. Satellite constellation system 100 can provide precision positioning to maritime systems, which can be utilized by the maritime systems for mapping, ice navigation, ice routing, and port operation. The precise position information can further be shared with neighboring maritime systems to improve maritime situational awareness. This can greatly improve the safety of these systems (e.g. in bad weather) due to the much better precision (especially in the arctic where signals 132 are harder to receive) if that information is shared between different ships, or between static maritime elements (e.g. lighthouses) and ships. Authentication and/or encryption can be utilized to protect against GNSS spoofing. Position security provided satellite constellation system 100 by can be utilized by maritime systems for asset tracking, for example, to be utilized by autonomous or highly automated ships that operate without a crew onboard. Boats and/or other maritime systems can thus be implemented as client devices 160.

Alternatively or in addition, satellite constellation system 100 can be utilized by banking systems or other entities to perform transaction authentication. Location-based security can be provided for entities that perform financial transactions and/or other transactions. For example, position security can be used as a form of two step authentication in banking and other password-protected critical functions. This can also be utilized by voting systems to provide protection against voter fraud in elections. ATM machines, voting machines, and/or other equipment utilized to perform secure transactions can be implemented as client devices 160.

Alternatively or in addition, satellite constellation system 100 can be utilized to enable infrastructure time synchronization. Satellite constellation system 100 can provide an additional source of secure timing to infrastructure systems that provide timing. Client devices 160 across different infrastructure entities can be utilized to synchronize timing across power stations, data centers, telecommunications hubs, cellular towers, financial institutions and/or other critical infrastructure.

Alternatively or in addition, satellite constellation system 100 can be utilized as a source for timing traceability for financial transactions. Satellite constellation system 100 can provide an additional source for timing traceability required for proof-of-payment systems and applications that require accurate and reliable timing traceability. For example, transactions on the New York Stock Exchange require timing traceability for legal purposes. Timing for these transactions is typically traced through GPS measurements to national timing centers like those managed at the USNO. Measurements taken from a client device 160 using the satellite constellation 100 can aid or replace these methods of timing traceability.

Alternatively or in addition, satellite constellation system 100 can be utilized in supply chain management to provide secure tracking of individual shipping containers, packages, vehicle assets, and/or vessel assets, allowing management with finer granularity and/or confirmation of arrival at destination. The individual shipping containers, packages, vehicle assets, and/or vessel assets can be implemented as client devices 160 and/or can be coupled to client devices 160 to enable the secure tracking of these assets by an entity that owns these assets or otherwise oversees the transportation and/or delivery of and/or by these assets.

Alternatively or in addition, satellite constellation system 100 can be utilized in surveying and/or mapping. In particular, satellite constellation system 100 can be utilized to provide precision, integrity, and/or security while enabling high definition mapping for autonomous or highly automated applications and/or safety critical applications. Surveying and/or mapping equipment can be implemented as client devices 160.

Alternatively or in addition, satellite constellation system 100 can be utilized by autonomous or highly automated road vehicles. Autonomous or highly automated road vehicles require high integrity (safety-critical), precise, and secure positioning, as provided by the satellite constellation system 100. Autonomous or highly automated road vehicles can be implemented as client devices 160, and satellite constellation system 100 can enable geofencing, lane determination, and vehicle control of the autonomous or highly automated road vehicles.

Alternatively or in addition, satellite constellation system 100 can be utilized by autonomous or highly automated mobile robotic platforms. The satellite constellation system 100 can provide location precision and/or security for mobile robotic platforms targeted at the movement/delivery of goods within small areas, shipping yards, or cities, where the autonomous or highly automated mobile robotic platforms are implemented as client devices 160.

Alternatively or in addition, satellite constellation system 100 can be utilized by autonomous or highly automated aerial vehicles, urban air mobility vehicles, drones, and/or UAVs. Autonomous or highly automated aerial vehicles require high integrity (safety-critical), precise, and secure positioning, as provided by the satellite constellation system 100. Autonomous or highly automated road vehicles can thus be implemented as client devices 160. The satellite constellation system 100 can enabled services such as autonomous or highly automated navigation and management of the airspace, and/or full automated takeoff, taxi, and landing.

Alternatively or in addition, satellite constellation system 100 can be utilized in asset tracking and/or Fleet Tracking. This can include the tracking of assets such UAVs, truck and vehicle fleets, as well as bike, scooter, and/or other ‘last mile’ device services. These assets can thus be implemented as client devices 160. Precision and security is required for utilization of these services, for example to unlock a bike at a given depot and/or to return the user's deposit upon return of the asset.

Alternatively or in addition, satellite constellation system 100 can be utilized by transportation services. In ride sharing scenarios, the satellite constellation system 100 provides both precision and security. Precision is needed to aid in passenger-vehicle pairing where, especially in a robo-taxi environment, precise navigation is required to correctly determine the vehicle in question. Furthermore, location security prevents drivers from spoofing rides or misleading customers and similarly prevents riders from misleading drivers (or robo-taxis) in terms of pick up location. Thus, these vehicles can be implemented as client devices 160.

Alternatively or in addition, satellite constellation system 100 can be utilized in robotic Agriculture. The agricultural industry pioneered precise GNSS corrections for machine control and it is still the primary sensor for localization in featureless environments, e.g. an open field. Currently, tractors require a driver, but as they become more autonomous or highly automated, a driver may no longer be present and security in positioning will be critical. Other robotic platforms in agriculture may include UAVs, mobile robotic platforms with wheels, legs, tracks, and/or articulated manipulator arms. Thus, some or all of this agricultural equipment can be implemented as client devices 160.

Alternatively or in addition, satellite constellation system 100 can be utilized in the Internet of Things (IoT) and/or ‘Big Data’ Security. As IoT devices become more prevalent, tying data to the world in a geospatial sense, the criticality of this data will increase. Even if stationary, as a periodic security check, devices of an IoT network can check its location, perhaps even indoors, to verify the installation location has not been tampered with, inadvertently or otherwise. Thus, IoT devices can be implemented as client devices 160.

Alternatively or in addition, satellite constellation system 100 can be utilized in insurance entities. For example, as autonomous or highly automated system interaction increases, who is responsible for what will become more important, and secure geolocation will be critical in resolution.

Alternatively or in addition, satellite constellation system 100 can be utilized in environmental monitoring, as discussed herein. Through radio occultation data, improved spatial and temporal resolution of atmospheric maps can be built for improving scientific models as well as weather prediction models.

Alternatively or in addition, satellite constellation system 100 can be utilized in various space applications, as illustrated in FIGS. 8D and 8E. Client device 160 can be implemented by space-based devices, such as space user 800 and space user 810. Users in orbit at altitudes both higher (Space User 810) and lower (Space User 800) than the satellite constellation system 100 can utilize satellite constellation system 100, either in conjunction with GNSS or independently as shown by FIG. 8D and FIG. 8E, to obtain a secure and/or precision location for use in orbit determination. The beamwidth of navigation signal 240 can be designed and/or adjusted to be an omni-directional signal to enable users higher than satellite constellation system 100 and/or multiple antennas onboard satellite 110 can support transmitting navigation signal 240 with a more directional beamwidth pointed in various directions.

As previously discussed, the nodes of the satellite constellation system 100 can correspond to any devices that generates, receives, transmits, modifies, stores, and/or relays messages or other data communicated by satellite constellation system 100 as discussed herein. Nodes of satellite constellation system 100 can include one or more satellites 110; one or more ground stations 200 and/or 201; one or more backhaul satellites 150; and/or one or more client devices operable to utilize information included in messages in its operation and/or operable to display information included in messages to a user. To illustrate this, FIG. 8G includes the ground stations 200 and 201. Similar features could be added in FIG. 8E.

In various examples, a node of a satellite constellation system includes a global positioning receiver configured to receive first signaling from a first plurality of non-LEO navigation satellites of a constellation of non-LEO navigation satellites in non-LEO, wherein the first plurality of non-LEO navigation satellites include four or more non-LEO navigation satellites of the constellation of non-LEO navigation satellites that are in reception range of the global positioning receiver. A transceiver is configured to send and receive inter-node communications with other nodes of the satellite constellation system. A backhaul transceiver is configured to receive precise point positioning (PPP) correction data associated with the constellation of non-LEO navigation satellites, wherein the PPP correction data includes orbital correction data and timing correction data associated with the constellation of non-LEO navigation satellites, and wherein the PPP correction data is received separately from the first signaling. At least one processor is configured to execute operational instructions that cause the at least one processor to perform operations that include: determining, based on the PPP correction data, a state of the node of the satellite constellation system; and generating a navigation message based on the state of the node of the satellite constellation system, wherein the navigation message includes a timing signal and a position of the node of the satellite constellation system and the navigation message further includes the orbital correction data and the timing correction data associated with the constellation of non-LEO navigation satellites. A navigation signal transmitter is configured to broadcast the navigation message to at least one client device, wherein the at least one client device is space-based, the navigation message facilitating the at least one client device to determine an enhanced position of the at least one client device based on the navigation message.

In various examples, a node of a satellite constellation system includes a global positioning receiver configured to receive first signaling from a first plurality of non-LEO navigation satellites of a constellation of non-LEO navigation satellites in non-LEO around the earth. A transceiver is configured to send and receive inter-node communications with other nodes of the satellite constellation system. At least one processor is configured to execute operational instructions that cause the at least one processor to perform operations that include: determining a state of the node of the satellite constellation system based on applying precise point positioning (PPP) correction data to the first signaling, wherein the PPP correction data is received separately from the first signaling; and generating a navigation message based on the state of the node. A navigation signal transmitter is configured to broadcast the navigation message to at least one client device, wherein the client device is space-based, the navigation message facilitating the at least one client device to determine an enhanced position of the at least one client device based on the navigation message.

FIG. 8F presents another scenario with one satellite 110 in view with a client device 160 corresponding to a mobile client device such as a vehicle. When used in conjunction with GNSS satellites of constellation 120, satellite 110 can provide data to increase the precision of GNSS signaling 132. As previously discussed, satellite 110 further adds a navigation signal 240 to provide additional range and range rate information. The rapid geometry change associated with satellite 110 allows for fast initialization of precise positioning.

In this example, however, additional navigation signals 240′ are received from a ground station 160-1 such as a terrestrial navigation station, an aircraft, such as UAV 160-2, and one or more other vehicles 160-3. In various embodiments, the navigation signals 240′ are formatted similarly to the navigation signal 240 and further augment GNSS accuracy, improving precision in the position, navigation and timing of the mobile device 160. Furthermore, the presence of many vehicles 160-3 in close proximity, each of which is determining its position on a precision basis provides the vehicles the opportunity to operate in a mesh navigation network to share their positions and collectively enhance the accuracy of position, navigation and/or timing as a group. Furthermore, sharing of the navigation messages 240′ in such a mesh network configuration can be used to identify, model the signal characteristics of, and track, a mobile jammer in proximity to the client devices 160-1, 160-2 and 160-3. In various embodiments, the client devices 160-1, 160-2 and/or 160-3 respond to stored user preferences that indicate, for example, whether or not a user of the corresponding device opts-in or opts-out of the generation of its own navigation messages 240′.

As further illustrated, a time-transfer satellite 850 is provided that transmits a secure timing signal 852, such as an encrypted signal or other secure signal that provides a ground truth timing reference. The time-transfer satellite 850 can be implemented via a special satellite dedicated to the purpose. Consider a spoofing scenario where one or more spoofing stations capture and repeat valid signals 132 and/or 140. The secure timing signal 852 can be used by the client device 160 to detect the spoofing stations by determining that the timing in the signals 132 and/or 140 repeated by these stations varies from the ground truth timing of the secure timing signal 852 by more than some acceptable timing threshold.

In a further example, the time-transfer satellite 850 can be implemented via one or more other satellites 110 that has been dedicated to this purpose via command and control signaling sent via inter-satellite links 230. The role of time-transfer satellite 850 can be assigned to any of the satellites 110, based on the memory usage of the satellite; the memory usage other satellites; the distance between the satellite and a backhaul receiver; the battery level of the satellite; a difference between the battery level of the satellite and the battery level other satellites; an estimated time that the satellite can generate more power; an estimated time that other satellites can generate more power; atmospheric data that indicates atmospheric conditions; and/or other state of the particular satellite, particularly when compared to the state or states of the other satellites 110.

Consider another example where integrity monitoring of the LEO constellation 100 determines that one or more particular satellites 110 are no longer capable of generating accurate orbital positioning. The role of these particular satellites 110 can be relegated to the reduced functionality of providing the secure timing signal 852.

FIGS. 8H and 8I present additional examples of the satellite constellation system that can be implemented in addition to or in the alternative of any of the foregoing, without (FIG. 8H) and with (FIG. 8I) a broadcast gateway that operates as an addition node of the satellite constellation system 100 as previously described. Each of these examples include a satellite processing system 865 that includes at least one processor (not specifically shown) and at least one memory (not specifically shown) along with at least one interface (not specifically shown), such as a wired or wireless network interface that facilitates communication with ground stations 200-1 and 200-2, GNSS receiver 360 and/or client devices 160 via the network 250. While the client devices 160 are shown as vehicles for the purposes of illustration, one or more of the client devices 160 can be implemented via smart phones, tablets, smart watches, laptop computers, autonomous aerial vehicles and/or other mobile devices described herein.

In various examples, the satellite processing system 865 acts as a terrestrial node of the LEO satellite navigation system and can include some or all of the functionality of the satellite processing system 300. In the example shown, the satellite processing system 865 further includes an operations subsystem 870 that assists in control of the LEO satellites 110-i (where i=1, 2, . . . n) via the generation and processing of control data such as telemetry, tracking and command (TT&C) information and/or key management information relating to secure access to the constellation by the operator and by users of the system.

As used herein, satellite TT&C refers to the processes and systems used to track, monitor, and control satellites in space. It involves the transmission and reception of signals between the satellite and ground station(s). TT&C is used for maintaining the health, safety, security and functionality of satellites, as well as enabling efficient data transmission and command execution. TT&C includes the following components:
Satellite Tracking: Satellite tracking involves accurately determining the position and movement of a satellite in space. This information is essential for various purposes, such as predicting the satellite's orbit, ensuring it stays within its designated operational zone, and calculating precise pointing directions for antennas on the ground that communicate with the satellite. Tracking data is acquired through ground-based tracking stations equipped with sensitive antennas and advanced tracking systems.
Telemetry: Telemetry refers to the process of collecting and transmitting data from a satellite back to Earth. Satellites continuously generate telemetry data, including information about their health, performance, environmental conditions, power systems, and payload status. This data is used for monitoring the satellite's well-being, detecting anomalies, and making informed decisions regarding its operation and maintenance.
Command: Commanding a satellite involves sending instructions from ground stations to the satellite in space. These commands are transmitted using specialized communication protocols and systems. Ground controllers use command signals to control various aspects of a satellite's operations, such as adjusting its orbit, activating or deactivating specific systems, or reconfiguring its communication settings.

Satellite TT&C contributes to:
Operational Efficiency: TT&C ensures that satellites are functioning optimally, allowing them to provide reliable services and collect valuable data.
Orbit Control: By accurately tracking satellites, ground controllers can monitor and adjust their orbits as necessary, ensuring they stay within designated operational zones and avoid collisions with other satellites or space debris.
Anomaly Detection and Troubleshooting: Telemetry data received through TT&C provides valuable insights into the health and performance of a satellite. Any anomalies detected can be investigated promptly, allowing for quick troubleshooting and resolution of potential issues.
Security and Safety: TT&C enables ground controllers to implement security measures, such as encryption, to protect satellite systems from unauthorized access or interference. It also facilitates emergency procedures in case of critical situations, allowing for remote shutdown or reconfiguration if required.

The satellite processing system 865 also includes a corrections subsystem 872 that generates the corrections data that is transmitted (e.g., broadcast) to the LEO satellites 110-i via one or more ground stations 200-1, either directly or via backhaul satellite 150 (in the case of FIG. 8H) or via one or more ground stations 200-3 acting as a broadcast gateway (in the case of FIG. 8I). The broadcast gateway has the following advantages:
Reduces real-time requirement for the TT&C segment.
Potentially removes the need for TT&C ground stations in the US.
Provides a step in the direction of GNSS independence. However, other nodes may require a separate receiver for this channel and the payload can be directly in charge of real-time correction information.
Cross links (e.g., inter-satellite links 230) would still be beneficial, both for the standard accuracy correction distribution and for propagating the broadcast information outside of the coverage area.
Provides high accuracy service where either in view of the gateways (and beyond based on cross links).

In the embodiments shown, the operations subsystem 870 and corrections subsystem 872 are implemented via operational instructions that can be executed by different processors of the satellite processing system 865. While the GNSS receiver 360, and various ground stations 200-j are shown as separate from the satellite processing system 865 and coupled via network 250, one or more of these devices could likewise be implemented as components of the satellite processing system 865.

In various examples, the satellite processing system 865 operates as a ground-based node of a satellite system and includes: an interface, such as a network interface configured to communicate with at least one ground station 200-j via network 250; at least one memory configured to store operational instructions; and at least one processor configured to execute the operational instructions, wherein the operational instructions, when executed, cause the at least one processor to perform operations that include:
(a) communicating control data, via the at least one ground station, with a constellation of LEO navigation satellites 110-I in LEO around the earth, wherein the control data includes telemetry, tracking and command (TT&C) information corresponding to the constellation of LEO navigation satellites;
(b) transmitting, via the at least one ground station, corrections data to a plurality of LEO navigation satellites of the constellation of LEO navigation satellites;
(c) receiving, via at least one global positioning receiver, a first collection of observations based on signaling from non-LEO navigation satellites 130 of a constellation of non-LEO navigation satellites in non-LEO around the earth, the signaling including collected observations from the constellation of non-LEO navigation satellites;
(d) receiving, via the at least one ground station, a second collection of observations based on navigation messages from the constellation of LEO navigation satellites, wherein the navigation messages facilitate client devices to determine their enhanced position when received in conjunction with second signaling from the constellation of non-LEO navigation satellites, and wherein the navigation messages are generated by the constellation of LEO navigation satellites in response to the corrections data;
(e) updating the corrections data based on the first collection of observations, the second collection of observations and based on telemetry data corresponding to the constellation of LEO navigation satellites included in the TT&C information; and
(f) repeating steps (a)-(e).

In addition or the alternative to any of the foregoing, the LEO navigation satellites of the constellation of LEO navigation satellites are configured to determine corresponding states based on the correction data and further based on signaling from non-LEO navigation satellites of the constellation of non-LEO navigation satellites and wherein the navigation messages are generated by the LEO navigation satellites of the constellation of LEO navigation satellites based on the corresponding states and where in the navigation messages each include a timing signal and a LEO navigation satellite position and the navigation messages further includes orbital correction data and timing correction data associated with the constellation of non-LEO navigation satellites.

In addition or the alternative to any of the foregoing, the corrections data includes precise point positioning (PPP) correction data corresponding to the constellation of non-LEO navigation satellites and can further include additional corrections data corresponding to the constellation of LEO navigation satellites.

In addition or the alternative to any of the foregoing, the control data includes at least one of: radio occultation; atmospheric data generated based on radio occultation; control information associated with satellite direction; control information associated with satellite attitude; control information associated with satellite status; control information associated with satellite inter-satellite transmit/receive condition; command information associated with satellite inter-satellite transmit/receive status; command information associated with inter-satellite transmit power or frequency; control information associated with encryption; constellation integrity information relating to health of one or more other nodes of the satellite system; or constellation integrity information relating to health of one or more non-LEO navigation satellites in the constellation of non-LEO navigation satellites.

In addition or the alternative to any of the foregoing, the control data and corrections data are communicated between ones of the constellation of LEO navigation satellites via inter-satellite links.

In addition or the alternative to any of the foregoing, the at least one ground station transmits the corrections data to the plurality of LEO navigation satellites via a backhaul satellite.

In addition or the alternative to any of the foregoing, the at least one ground station that transmits the corrections data to the plurality of LEO navigation satellites includes a broadcast gateway that is separate from the at least one ground station that communicates the control data.

In addition or the alternative to any of the foregoing, the at least one ground station that receives the second collection of observations is co-located with the at least one ground station that communicates the control data.

In addition or the alternative to any of the foregoing, the operations further include: transmitting the corrections data to ones of the client devices connected to the ground-based node via a wireless terrestrial network.

In addition or the alternative to any of the foregoing, the constellation of non-LEO navigation satellites are associated with at least one of: a Global Positioning System of satellites, a Quasi-Zenith Satellite System, a BeiDou Navigation Satellite System, a Galileo positioning system, a Russian Global Navigation Satellite System (GLONASS) or an Indian Regional Navigation Satellite System.

In addition or the alternative to any of the foregoing, the LEO navigation satellites of the constellation of LEO navigation satellites are configured to determine the corresponding states further based on signaling from GNSS signals transmitted by a plurality of GNSS ground stations.

In addition or the alternative to any of the foregoing, the operations further include: transmitting, via the plurality GNSS ground stations, the GNSS signals to the plurality of LEO navigation satellites of the constellation of LEO navigation satellites.

In addition or the alternative to any of the foregoing, the operations further include: transmitting additional navigation messages from at least one additional ground station, wherein the navigation messages also facilitate the client devices to determine their enhanced position when received in conjunction with the second signaling from the constellation of non-LEO navigation satellites, and wherein the additional navigation messages are generated by the ground-based node in response to the corrections data.

Consider the further examples of operation as follows. The operations subsystem 870 communicates telemetry, tracking and command (TT&C) information and key management information with the satellites 110-i via link 220-2 from ground station 200-1. Ground station 200-2 (which may or may not be collocated with ground station 200-1) receives navigation messages 240-1 from the LEO satellites 110 as collected LEO observations 862. Because this ground station 200-2 is located at a fixed (e.g., precisely known location) these collected LEO observations 862 can be used along with telemetry data in determining errors/corrections in orbital position, timing and/or other state of the LEO satellites 110-i. Similarly, GNSS receiver 360 can generate collected GNSS observations 860 via links 132 that can be used in determining GNSS errors such as PPP correction messages and/or other corrections to orbital position and/or timing of the non-LEO satellites 130. In particular, the corrections subsystem 872 receives the collected GNSS observations 860, the collected LEO observations 862 along with LEO satellite telemetry data from the operations subsystem 870 and generates corrections data in response thereto. The collections data can that include corrections to orbital position and/or timing of the non-LEO satellites 130—and in some examples, further corrections to orbital position and timing corresponding to the LEO satellites 110-i themselves.

In various examples, the corrections subsystem 872 generates the corrections data based on curve fitting techniques, timing and/or state estimation techniques, AI methodologies that are training based on a training data that includes a large set of past observations and associated corrections and/or other estimation or optimization algorithm. This corrections data can be transmitted (e.g., broadcast) to the LEO satellites 110-i via one or more ground stations 200-1, either directly via link 220-2 or via link 220-1 to backhaul satellite 150 (in the case of FIG. 8H) or via link 220-3 from one or more ground stations 200-3 acting as a broadcast gateway (in the case of FIG. 8I). In this later case, the link 220-4 to/from ground station 200-1 can be dedicated to the communication of control data. In various examples, client devices may be connected to the satellite processing system 865 via network 250 (e.g., the Internet) and receive correction data wirelessly via link 868.

In accordance with these examples, the LEO navigation satellites 110-i are configured to determine their corresponding states based on the correction data and further based on signaling from non-LEO navigation satellites 130 that is used to generate navigation messages 240-1 that are collected by ground station 200-2 and furthermore navigation messages 240-2 that are received by client devices 160 associated with various users. These navigation messages can each include a timing signal and a LEO navigation satellite position (e.g., ranging data) and the navigation messages further include correction data such as PPP correction data and/or orbital correction data and timing correction data associated with the constellation of non-LEO navigation satellites that are used by client devices 160 in conjunction with signaling from non-LEO satellites 130 to determine their enhanced position. As discussed above, client devices 160 connected to the satellite processing system 865 via network 250 (e.g., the Internet) can receive correction data wirelessly via link 868 and need not rely on correction data received via the navigation messages 240-2.

Reiterating again, the nodes of the satellite constellation system 100 can correspond to any devices that generates, receives, transmits, modifies, stores, and/or relays messages or other data communicated by satellite constellation system 100 and can include one or more satellites 110; one or more ground stations 200 and/or 201; one or more backhaul satellites 150; and/or one or more client devices operable to utilize information included in messages in its operation and/or operable to display information included in messages to a user. In addition or in the alternative to any of the forgoing examples, and particularly the examples presented in conjunctions with FIGS. 8H and 8I, FIG. 8J presents an example where the non-LEO satellite constellation (e.g., the GNSS system) is supplemented by one or more ground stations 130′ that operate similarly to satellites 130 to transmit similar signals 132′ (e.g., that are similar to signals 132) to the satellites 110 in LEO. Given their fixed and accurately determined positions and the shorter range to the LEO satellites 110, these terrestrial nodes can provide a viable alternative with greater stability, less dependence on atmospheric anomalies and higher signal power.

In addition or in the alternative to any of the forgoing examples, and particularly the examples presented in conjunctions with FIGS. 8H, 8I, and 8J, FIG. 8K presents an example where the LEO satellite constellation is supplemented by one or more ground stations 110′ (a further example of ground stations 200 or 201) that operate similarly to satellites 110-1 to transmit similar signals 240′ (e.g., that include navigation messages similar to signals 240) for use by the client devices 160.

FIG. 8L presents a similar example, but with more or total independence from GNSS satellites 130. In this case, the nodes of the satellite system implemented by one or more of the GNSS satellites 130 are replaced by (and/or supplemented by) terrestrial nodes implemented by ground stations 130′ that provide signals 132′—e.g., that are formatted in a similar fashion to signals 132.

In various examples, the satellite processing system 865′ operates as a ground-based node of a satellite system and includes: an interface configured to communicate with at least one ground station 200-j; at least one memory that stores operational instructions; and at least one processor configured to execute the operational instructions, wherein the operational instructions, when executed, cause the at least one processor to perform operations that include:
(a) communicating control data, via the at least one ground station, with a constellation of LEO navigation satellites 110-i in LEO around the earth, wherein the control data includes telemetry, tracking and command (TT&C) information corresponding to the constellation of LEO navigation satellites;
(b) transmitting, via a plurality of other ground stations 130′, navigation signaling 132′ to the constellation of LEO navigation satellites;
(c) transmitting, via the at least one ground station, corrections data to a plurality of LEO navigation satellites of the constellation of LEO navigation satellites;
(d) receiving, via the at least one ground station, a collection of observations based on navigation messages from the constellation of LEO navigation satellites, wherein the navigation messages facilitate client devices to determine their enhanced position, and wherein the navigation messages are generated by the constellation of LEO navigation satellites in response to the corrections data and the navigation signaling from the plurality of other ground stations;
(e) updating the corrections data based on the collection of observations and based on telemetry data corresponding to the constellation of LEO navigation satellites included in the TT&C information; and
(f) repeating steps (a)-(e).

In addition or the alternative to any of the foregoing, the LEO navigation satellites of the constellation of LEO navigation satellites are configured to determine corresponding states based on the correction data and further based on the navigation signaling from the plurality of second ground stations and wherein the navigation messages are generated by the LEO navigation satellites of the constellation of LEO navigation satellites based on the corresponding states and where in the navigation messages each include a timing signal and a LEO navigation satellite position and the navigation messages further includes orbital correction data and timing correction data.

In addition or the alternative to any of the foregoing, the navigations signals are formatted as GNSS signals.

In addition or the alternative to any of the foregoing, the control data includes at least one of: radio occultation; atmospheric data generated based on radio occultation; control information associated with satellite direction; control information associated with satellite attitude; control information associated with satellite status; control information associated with satellite inter-satellite transmit/receive condition; command information associated with satellite inter-satellite transmit/receive status; command information associated with inter-satellite transmit power or frequency; control information associated with encryption; constellation integrity information relating to health of one or more other nodes of the satellite system; or constellation integrity information relating to health of one or more non-LEO navigation satellites in the constellation of non-LEO navigation satellites.

In addition or the alternative to any of the foregoing, the control data and corrections data are communicated between ones of the constellation of LEO navigation satellites via inter-satellite links.

In addition or the alternative to any of the foregoing, the at least one ground station transmits the corrections data to the plurality of LEO navigation satellites via a backhaul satellite.

In addition or the alternative to any of the foregoing, the at least one ground station that transmits the corrections data to the plurality of LEO navigation satellites includes a broadcast gateway that is separate from the at least one ground station that communicates the control data.

In addition or the alternative to any of the foregoing, the at least one ground station that receives the collection of observations is co-located with the at least one ground station that communicates the control data.

In addition or the alternative to any of the foregoing, the operations further include: transmitting the corrections data to ones of the client devices connected to the ground-based node via a wireless terrestrial network.

In addition or the alternative to any of the foregoing, the steps (a)-(f) can be performed as a method, with or without any of the foregoing additions or alternatives.

FIG. 8M is a flowchart diagram illustrating an example of a method in accordance with various embodiments. In particular, a method 880 is presented for use with the satellite processing system 865 or other ground-based node of a satellite system and/or one or more of the other functions and features discussed herein. Step 882-1 includes communicating control data, via at least one ground station, with a constellation of LEO navigation satellites in LEO around the earth, wherein the control data includes telemetry, tracking and command (TT&C) information corresponding to the constellation of LEO navigation satellites. Step 882-2 includes transmitting, via the at least one ground station, corrections data to a plurality of LEO navigation satellites of the constellation of LEO navigation satellites.

Step 882-3 includes receiving, via at least one global positioning receiver, a first collection of observations based on signaling from non-LEO navigation satellites of a constellation of non-LEO navigation satellites in non-LEO around the earth, the signaling including collected observations from the constellation of non-LEO navigation satellites. Step 882-4 includes receiving, via the at least one ground station, a second collection of observations based on navigation messages from the constellation of LEO navigation satellites, wherein the navigation messages facilitate client devices to determine their enhanced position when received in conjunction with second signaling from the constellation of non-LEO navigation satellites, and wherein the navigation messages are generated by the constellation of LEO navigation satellites in response to the corrections data. Step 882-5 includes updating the corrections data based on the first collection of observations, the second collection of observations and based on telemetry data corresponding to the constellation of LEO navigation satellites included in the TT&C information. The method can repeat steps 882-1 through 882-5 for continuous operation.

In addition or the alternative to any of the foregoing, the LEO navigation satellites of the constellation of LEO navigation satellites are configured to determine corresponding states based on the correction data and further based on signaling from non-LEO navigation satellites of the constellation of non-LEO navigation satellites and wherein the navigation messages are generated by the LEO navigation satellites of the constellation of LEO navigation satellites based on the corresponding states and where in the navigation messages each include a timing signal and a LEO navigation satellite position and the navigation messages further includes orbital correction data and timing correction data associated with the constellation of non-LEO navigation satellites.

In addition or the alternative to any of the foregoing, the corrections data includes precise point positioning (PPP) correction data corresponding to the constellation of non-LEO navigation satellites and additional corrections data corresponding to the constellation of LEO navigation satellites.

In addition or the alternative to any of the foregoing, the control data includes at least one of: radio occultation; atmospheric data generated based on radio occultation; control information associated with satellite direction; control information associated with satellite attitude; control information associated with satellite status; control information associated with satellite inter-satellite transmit/receive condition; command information associated with satellite inter-satellite transmit/receive status; command information associated with inter-satellite transmit power or frequency; control information associated with encryption; constellation integrity information relating to health of one or more other nodes of the satellite system; or constellation integrity information relating to health of one or more non-LEO navigation satellites in the constellation of non-LEO navigation satellites.

In addition or the alternative to any of the foregoing, the control data and corrections data are communicated between ones of the constellation of LEO navigation satellites via inter-satellite links.

In addition or the alternative to any of the foregoing, the at least one ground station transmits the corrections data to the plurality of LEO navigation satellites via a backhaul satellite.

In addition or the alternative to any of the foregoing, the at least one ground station that transmits the corrections data to the plurality of LEO navigation satellites includes a broadcast gateway that is separate from the at least one ground station that communicates the control data.

In addition or the alternative to any of the foregoing, the at least one ground station that receives the second collection of observations is co-located with the at least one ground station that communicates the control data.

In addition or the alternative to any of the foregoing, the method further includes: transmitting the corrections data to ones of the client devices connected to the ground-based node via a wireless terrestrial network. This step can also be repeated for continuous operation.

In addition or the alternative to any of the foregoing, the constellation of non-LEO navigation satellites are associated with at least one of: a Global Positioning System of satellites, a Quasi-Zenith Satellite System, a BeiDou Navigation Satellite System, a Galileo positioning system, a Russian Global Navigation Satellite System (GLONASS) or an Indian Regional Navigation Satellite System.

In addition or the alternative to any of the foregoing, the LEO navigation satellites of the constellation of LEO navigation satellites are configured to determine the corresponding states further based on signaling from GNSS signals transmitted by a plurality of GNSS ground stations.

In addition or the alternative to any of the foregoing, the method further includes: transmitting, via the plurality GNSS ground stations, the GNSS signals to the plurality of LEO navigation satellites of the constellation of LEO navigation satellites.

In addition or the alternative to any of the foregoing, the method further includes: transmitting additional navigation messages from at least one additional ground station, wherein the navigation messages also facilitate the client devices to determine their enhanced position when received in conjunction with the second signaling from the constellation of non-LEO navigation satellites, and wherein the additional navigation messages are generated by the ground-based node in response to the corrections data.

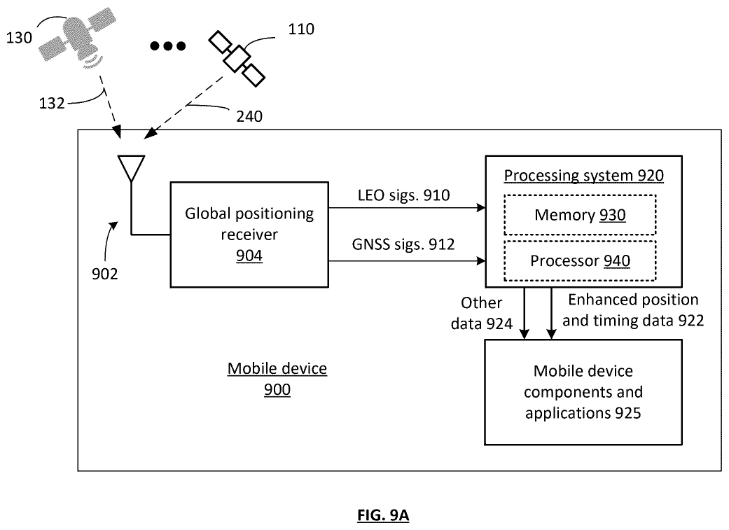

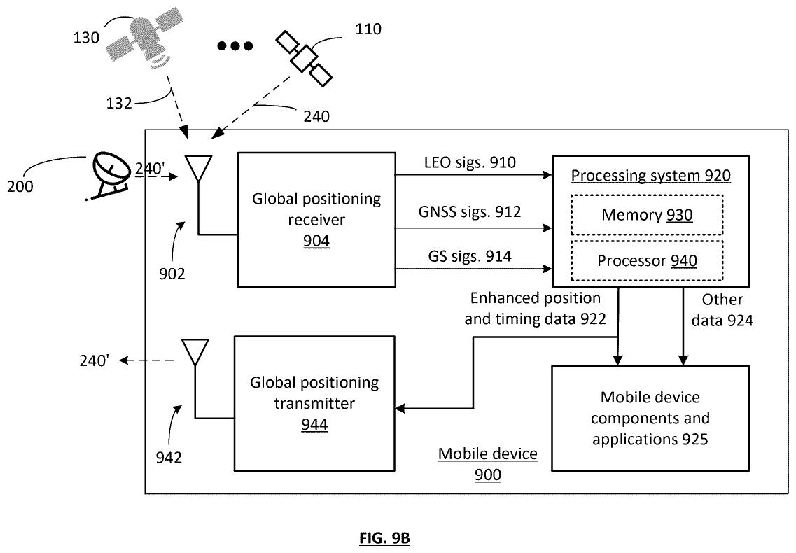

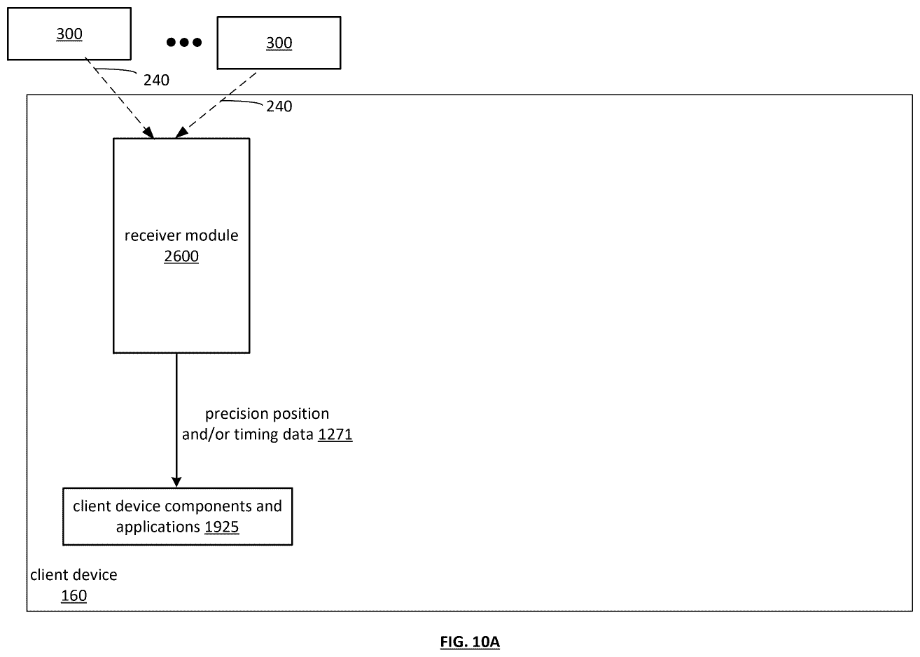

FIGS. 9A-9D, present further functions and features that can be used In addition or the alternative to any of the foregoing, in in particular can be used in addition or the alternative to any of the functions and features described herein.

FIG. 9A is a schematic block diagram illustrating an example client device in accordance with various embodiments. In particular, a mobile device 900 is presented that includes a global positioning receiver 904 having an antenna 902, a processing system 920 having a memory 930 and one or more processors 940 and further having additional mobile device components and applications 925 that round out the specific functionality of the mobile device. For example, the mobile device 900 can be an automobile, a tablet, a smartphone, a smartwatch, a laptop computer, another mobile computer or computer system, a navigation device, a device location system, a weather system, a marine navigation system, a rail navigation system, an aircraft, an agricultural vehicles, a surveying system, an autonomous or highly automated vehicle, a UAV or other mobile device that operates by generating timing, navigation and/or positioning.

In various embodiments, the global positioning receiver 904 includes an RF section configured to receive signals 132 in one or more frequency channels from Global Navigation Satellite System (GNSS) satellites 130 of a GNSS constellation 120 and to downconvert these signals to GNSS signals 912, each having a ranging signal containing clock information and ephemeris information for each of the GNSS satellites 130 in range. Similarly, the RF section is configured to receive one or more navigation signals 240 in one or more frequency channels from satellites 110 of constellation 100 and to downconvert these signals to LEO signals 910, each having a ranging signal containing a navigation message that includes clock information and ephemeris information for each of the satellites 110 in range. In addition, the navigation message can contain correction data associated with the GNSS satellites 130, such as PPP correction messages, other clock and orbital correction data, constellation integrity information relating to the health of one or more satellites 110 and/or constellation integrity information relating to the health of one or more GNSS satellite 130. Furthermore, the LEO signals 910 can contain other data contained in the navigation signals 240 including, for example, command and control data, RO data, atmospheric or weather data, secure clock data, encryption and security information, and/or any of the other types of data produced or transmitted by the satellites 110 as discussed herein.

The processing system 920 is configured to generate enhanced position and timing data 922 based on the GNSS signals 912 and/or the LEO signals 910 for use by the mobile device components and applications 925 that use such information, for example, for precision position, navigation and timing. In addition, the other data 924 can be demodulated, or otherwise extracted, from the LEO signals 910 by the processing system 920 that includes, for example, command and control data, RO data, atmospheric or weather data including a current weather state, a weather map and/or a predictive weather model, secure clock data, encryption and security information, any of the other types of data produced or transmitted by the satellites 110 or can be generated by the processing system 920 based on the navigation signals 240 and/or the signals 132. In various embodiments, the constellation integrity information is used by the processing system 920 to exclude or otherwise ignore signals 132 and/or navigation signals 240 that correspond to satellites that have been identified as faulty.

The operations of the processing system 920 can further include, for example, locking-in on the timing of the ranging signals via the associated pseudo random noise (PRN) codes associated with each satellite 110 and 130 (that is not excluded), demodulating and decoding the ranging signals from the GNSS signals 912 to generate and extract the associated navigation messages from the GNSS satellites 130 in range of the receiver, demodulating and decoding navigation messages contained in the ranging signals of the LEO signals 910 to extract the precise position and timing data associated with each satellite 110 along with the correction data for the GNSS signals 912, and applying the correction data and atmospheric data to the position and timing information from the navigation messages from the GNSS satellites 130. In various embodiments, the first-order ionospheric delay is mitigated using the combinations of dual-frequency GNSS measurements. Otherwise, ionospheric and tropospheric delay can be corrected using atmospheric models generated based on the RO data. Furthermore, the processing system 920 can use closed loop state estimation techniques such as a Kalman filter, extended Kalman filter or other estimation technique where, for example orbital position, clock error, ionospheric delay, tropospheric delay and/or carrier-phase errors are estimated states. The precise position of the generate enhanced position and timing data 922 can be generated by positioning calculations that employ navigation equations to the orbital positions and timing for each of the satellites 110 and 130.

It should be noted, that when encryption is employed to the navigation signals 240, decryption can be employed by the global positioning receiver 904 and or the processing system 920 in order to securely lock on to the ranging signal and/further to extract the data therefrom.

Consider the following example. The global positioning receiver 904 receives navigation signals 240 that includes a navigation message from at least one satellite 110 containing correction data associated with a non-LEO constellation of satellites, such as non-LEO satellites 130. The global positioning receiver 904 also receives signals 132 from the non-LEO satellites 130. One or more processors 940 is configured to execute operational instructions that cause the processor(s) to perform operations that include: applying the correction data to the signals 132 to generate corrected signaling; and generating enhanced position data corresponding to a position of the mobile device based on the navigation message and the corrected signaling. In this fashion, PPP correction messages, other clock and orbital correction data, constellation integrity information relating to the health of one or more satellites 110 and/or constellation integrity information relating to the health of one or more satellites GNSS satellite 130 can be used be used to generate more precise position, navigation and timing from the signals 132 received from satellites of the non-LEO constellation and further based on the timing signal and the orbital position associated with the satellite 110.

Consider a further example. The global positioning receiver 904 receives navigation signals 240 that include navigation messages from four or more satellites 110. One or more processors 940 is configured to execute operational instructions that cause the processor(s) to perform operations that include: generating enhanced position data corresponding to a position of the mobile device based on the navigation messages. In this fashion, navigation messages that may include constellation integrity information relating to the health of one or more satellites 110 can be used be used to generate more precise position, navigation and timing based on the timing signals and the orbital positions associated with the satellites 110.

FIG. 9B is a schematic block diagram illustrating an example client device in accordance with various embodiments. In particular, another mobile device 900 is presented that includes many common elements of presented in conjunction with FIG. 9A that are referred to by common reference numerals. In this example, however, an additional navigation signal 240′ is received from a ground station 200 and/or 201 such as a terrestrial GPS station, terrestrial station implemented as a node of the satellite constellation system 100, or other ground station that provides a source of a navigation signal 240′. The navigation signal 240′ reside in one of the frequency channels of navigation signal 240. Other frequency channels can likewise be employed to avoid interference with navigation signals 240 and/or signals 132.

In various embodiments, the navigation signal 240′ is formatted similarly to the navigation signal 240 and the GPS receiver generates ground station (GS) signals 914 that can include any or all of the information contained in the LEO signals 910. The processing system 920 is configured to generate enhanced position and timing data 922 based on the GNSS signals 912, GS signals 914 and/or the LEO signals 910 for use by the mobile device components and applications 925 that use such information, for example, for precision position, navigation and timing. In addition, the other data contained in the navigation signals 240 and/or 240′ is processed by the processing system 920 to generate other data 924 that includes, for example, command and control data, RO data, atmospheric or weather data, secure clock data, encryption and security information, any of the other types of data produced or transmitted by the satellites 110 or can be generated by the processing system 920 based on the navigation signals 240, 240′ and/or the signals 132. In this fashion, the ground station 160-1 operates as an additional satellite with a fixed, and therefore, precise location.

As discussed in conjunction with FIG. 8F the navigation signals 240′ can be generated by mobile client devices 160. Furthermore, the mobile device 900 can include a global positioning transmitter 944 that operates similar to the corresponding functionality of satellite 110 in generating its own navigation signal 240′ that is transmitted via antenna 942. In various embodiments, the memory 930 includes stored user preferences that indicate, for example, whether or not a user of the mobile device 900 opts-in or opts-out of the generation of its own navigation messages 240′.

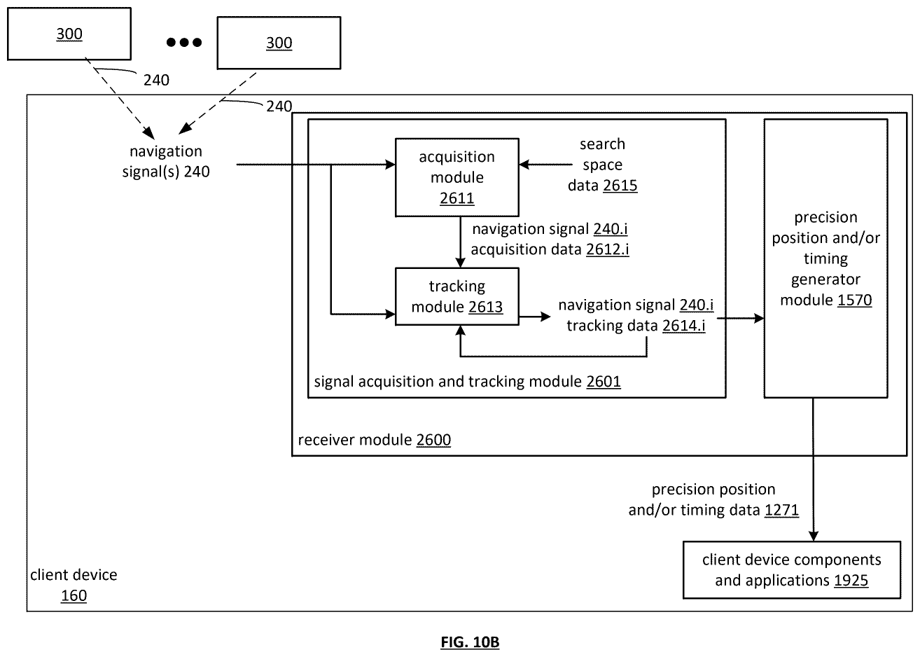

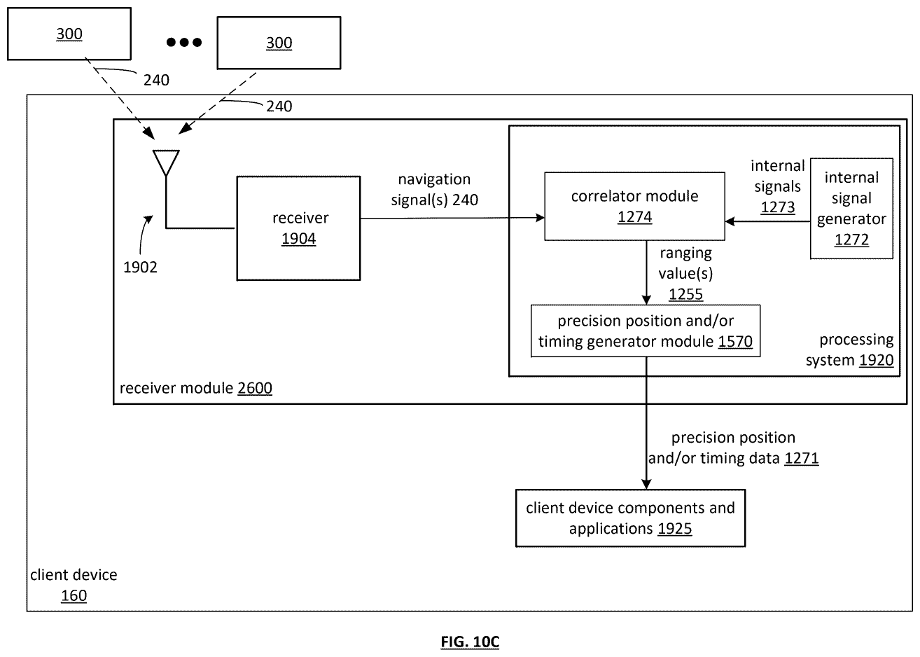

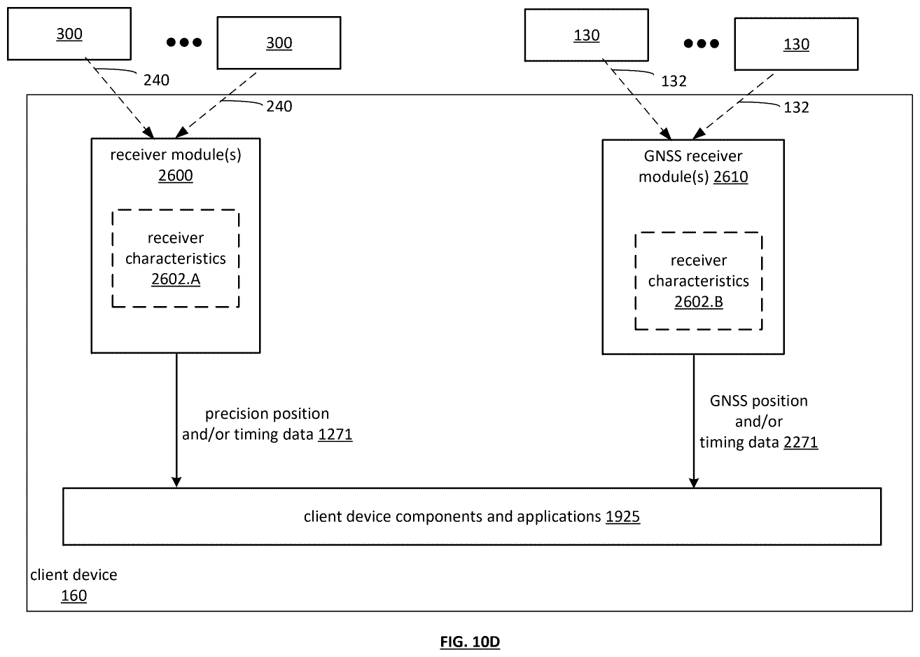

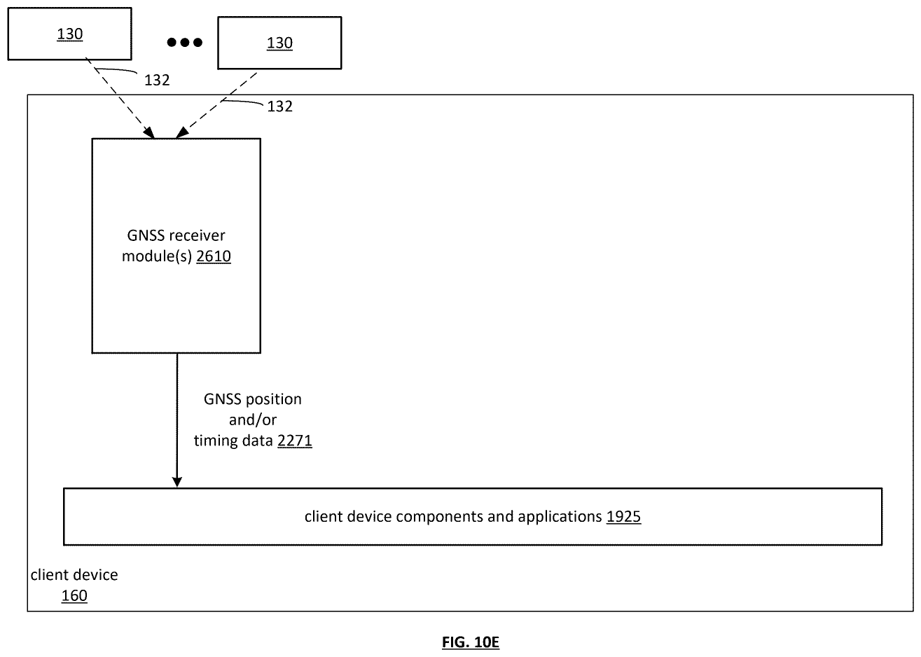

FIGS. 10A-10E present embodiments of a receiver module of a client device 160 operable to receive and process incoming signals, for example, via acquiring, tracking, and/or decoding/extracting data from corresponding signals received from satellites. Some or all features and/or functionality of any receiver module and/or client device 160 of FIGS. 10A-10E can implement any embodiment of a client device 160, receiver, node, computing device, and/or receiving and/or processing of navigation signals and/or any other signals described herein.

As described herein, a receiver module can optionally be implemented as particular hardware and/or software, for example, implemented via at least one processor and/or at least one memory (e.g. implementing corresponding radio technology/equipment and/or other receiver technology/equipment). For example, a receiver module can be implemented via a corresponding physical receiver (e.g. a corresponding device) that is manufactured (e.g. by a receiver manufacturer). As a particular example, the receiver module is a physical unit that is manufactured by a receiver manufacturer that is then installed in a client device (e.g. based on a manufacturer of the client device, such as the manufacturer of a corresponding vehicle, cellular device, mobile device, wearable device, fixed infrastructure, etc., purchasing or otherwise acquiring the corresponding physical receiver from the receiver manufacturer for inclusion in the respective client device when manufacturing the respective client device. As another particular example, the receiver module is a physical component of a client device that is manufactured by the manufacturer of the client device, in conjunction with manufacturing the client device to include the receiver module. The receiver module can operate via distinct processing and/or memory resources separate from some or all other processing and/or memory resources of the client device. The receiver module can optionally operate via shared processing and/or memory resources shared from some or all other processing and/or memory resources of the client device. A client device can include one or more receiver modules (e.g. configured to receive and process the same or different types of signals).

Some or all embodiments of receiver module described herein can optionally be implemented in a same or similar fashion a GNSS receiver, such as a GPS receiver, a Galileo receiver, or other receiver for another GNSS system. For example, some embodiments of receiver modules described herein (e.g. some or all embodiments of receiver module 2610) can be implemented as GPS, Galileo, or other GNSS receivers, for example, optionally based on implementing a custom, improved configuration of such receivers, for example, to perform more optimally via resource optimization and/or to perform anti-spoofing techniques. Other embodiments of receiver modules described herein (e.g. some or all embodiments of receiver module 2600) can be strictly configured as non-GNSS receivers configured to receive and process non-GNSS signals. In such cases where the receiver module is implemented to process signals that are different from GNSS navigation signals (e.g. navigation signals 240 and/or other non-GNSS signals), the receiver module can be implemented in a similar fashion a GNSS receiver (e.g. in the sense that is operable to receive and process incoming signals, for example, via acquiring, tracking, and/or decoding/extracting data from corresponding signals received from satellites for use to generate state data such as timing and/or position data), but can be configured differently to account for/leverage differences in a corresponding signal from GNSS signals (e.g. receiver module is configured to leverage/account for properties of navigation signals 240, which are configured differently from GNSS signals) and/or to account for/leverage differences in a corresponding satellite constellation from GNSS constellations (e.g. receiver module is configured to leverage/account for properties of satellite constellation system 100, which is in LEO vs. in MEO and/or has other differences from GNSS satellite constellations). Such differences can require novel, custom configuration of a corresponding receiver module implemented to process these particular, non-GNSS signals of the particular, non-GNSS satellite constellation.

FIG. 10A illustrates an embodiment of a client device that implements a receiver module 2600. Receiver module 2600 can be operable to receive and process signals 240 (e.g. navigation signals or optionally other types of signals) generated and transmitted by one or more satellite processing systems 300, for example, of satellites 110 and/or nodes of satellite constellation system 100 and/or of any system (e.g. a satellite constellation in LEO orbit, a satellite constellation implemented in conjunction with providing a navigation service, a satellite constellation implemented in conjunction with providing a different kind of service, etc. Some or all features and/or functionality of the receiver module and/or client device of FIG. 10B can implement any embodiment of a receiver module or client device described herein.

For example, receiver module 2600 is configured based on known properties of signals 240 and/or satellite constellation system 100, where such configuration renders receiver module 2600 operable to receive, acquire, track, decode, extract data from, and/or otherwise process incoming navigation signals 240, for example, to output state data such as precision position and/or timing data 1271 and/or intermediate data (e.g. ranging data, extracted data from navigation messages, etc.) that are utilized via other processing components (e.g. of a given client device implementing the receiver module 2600) to generate the respective state data such as precision position and/or timing data 1271 as discussed herein. Such precision position and/or timing data 1271 can be further processed by client device components and applications 1925 to render corresponding functionality of the client device 160 (e.g. generating further data derived from further processing of the precision position and/or timing data 1271; display of the precision position and/or timing data 1271 and/or further data derived from further processing of the precision position and/or timing data 1271; storage of the precision position and/or timing data 1271 and/or further data derived from further processing of the precision position and/or timing data 1271; transmission of the precision position and/or timing data 1271 and/or further data derived from further processing of the precision position and/or timing data 1271; etc.).

FIG. 10B illustrates an embodiment of a receiver module 2600 that implements a signal acquisition and tracking module 2601 to acquire and track incoming navigation signals 240. Some or all features and/or functionality of the receiver module and/or client device of FIG. 10B can implement any embodiment of a receiver module or client device described herein.

An acquisition module 2611 can process search space data 2615 to acquire incoming navigation signals (e.g. received via a corresponding antenna). In some embodiments, the search space data 2615 can indicate which PRNs/overlay codes to search, which frequencies to apply (e.g. in accounting for Doppler shift), which delays to apply to PRNs/overlay codes, and/or other properties, for example, utilized to generate corresponding internal signals for correlation with the navigation signals, where acquisition is achieved when correlation peaks are found (e.g. having magnitude of a least a threshold value and/or otherwise deemed as denoting the signals correlate favorably).

Once a given navigation signal 240.i is acquired, it can be tracked via tracking module 2613 (e.g. over some duration of time, for example, while the signal 240.i is still in range and/or otherwise available), for example, based on acquisition data 2612.i relating to the signal generated by the acquisition module 2611. The navigation signal 2613 that is tracked via tracking module 2613, and/or other tracking data 2614.i generated via the tracking module 2613 in conjunction with tracking the navigation signals 240.i, can be processed via precision position and/or timing generator module 1570, which can be operable to decode, extract data from, and/or otherwise process the navigation signal 240.i to generate: precision position and/or timing data 1271 and/or other corresponding state data over time; and/or intermediate data over time that is further processed by other processing resources of the client device, optionally separate from receiver module, to generate the precision position and/or timing data 1271 and/or other corresponding state data over time.

FIG. 10C illustrates an embodiment of a receiver module 2600 that implements the antenna 1902, receiver 1904, and/or processing system 1920 implementing correlator module 1274 to correlate incoming navigation signals 240 with internally generated signals (e.g. internal signals 1273) generated via internal signals generator 1274 to generate ranging values 1255 processed via precision position and/or timing module 1570 as discussed previously. For example, the signal acquisition and tracking module 2601 and/or precision position and/pr timing generator module 1570 implement some or all features and/or functionality of the antenna 1902, receiver 1904, and/or processing system 1920. Some or all features and/or functionality of the receiver module and/or client device of FIG. 10C can implement any embodiment of a receiver module or client device described herein.

FIG. 10D illustrates an embodiment of a client device 160 implementing multiple different receiver modules. In particular, a client device can be operable to: receive and process a first type of signal (e.g. signals 240 and/or non-GNSS navigation signals, for example, transmitted via satellites 100 and/or other nodes of a satellite constellation system 100 and/or non-GNSS satellite constellation, for example, in LEO orbit) via one or more receiver modules 2600 (e.g. at least one non-GNSS receiver module) based on the one or more receiver modules 2600 implementing receiver characteristics 2602.A; and/or receive and process a second type of signal (e.g. signals 132 and/or GNSS navigation signals, for example, transmitted via GNSS satellites 130 a GNSS satellite constellation, for example, in MEO orbit) via one or more receiver modules 2610 (e.g. at least one GNSS receiver module). Client device component and applications 1925 can be operable to process (e.g. further process, display, transmit, store, etc.): precision position and/or timing data 1271 (e.g. non-GNSS precision position and/or timing data) and/or other state data generated by (or derived from intermediate data generated by) the one or more receiver modules 2600 based on the one or more receiver modules 2600 implementing receiver characteristics 2602.B (e.g. different from receiver characteristics 2602.A); and/or GNSS position and/or timing data 2271 and/or other state data generated by (or derived from intermediate data generated by) the one or more receiver modules 2610. Some or all features and/or functionality of the receiver module 2600, receiver module 2610, and/or client device of FIG. 10D can implement any embodiment of a receiver module or client device described herein. Some or all particular features and/or functionality of receiver module 2600 described herein (e.g. distinguishing the receiver module 2600 from existing GNSS receivers) can implement some or all of the receiver characteristics 2602.A implemented by the one or more receiver modules 2600.

FIG. 10E illustrates an embodiment of a GNSS receiver module 2610 implemented by a client device 160. For example, any embodiment of a client module 160 herein can be implemented to include only GNSS receiver module 2610, for example, optionally without also implementing a receiver module 2600. Some or all features and/or functionality of the receiver module and/or client device of FIG. 10E can implement any embodiment of a receiver module or client device described herein. Any embodiment of GNSS receiver module 2610 described herein can be implemented based on implementing any embodiment of receiver module 2600 and/or corresponding receipt and/or processing of signals described herein (e.g. where GNSS signals are processed via GNSS receiver module 2610 in a same or similar fashion as any receipt and/or processing of navigation signals 240 or any other type of signal descried herein.

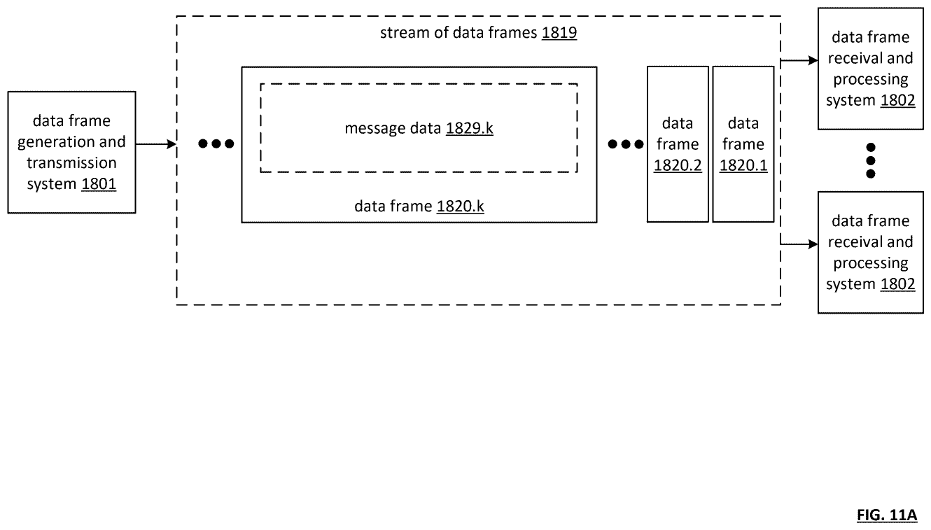

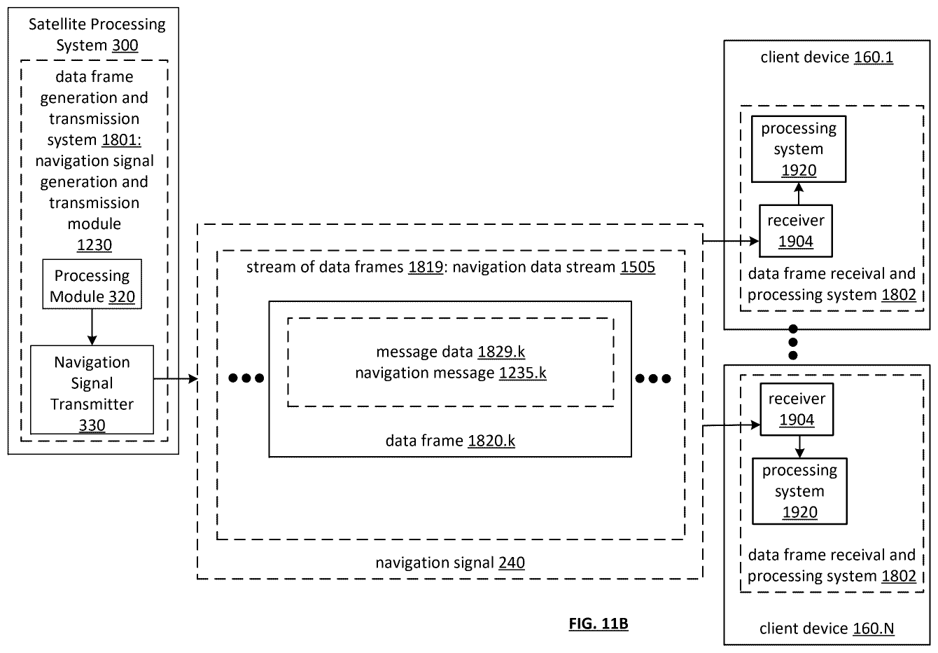

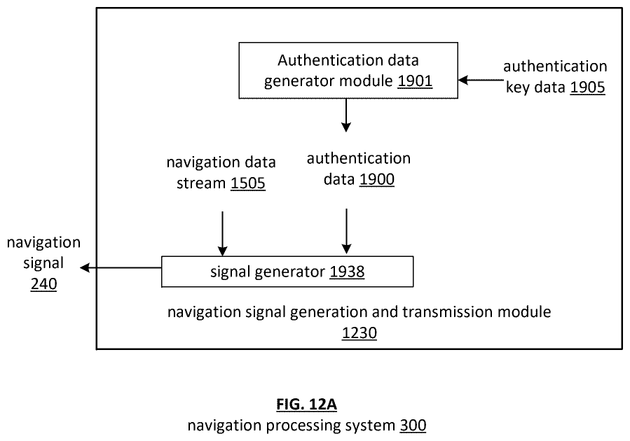

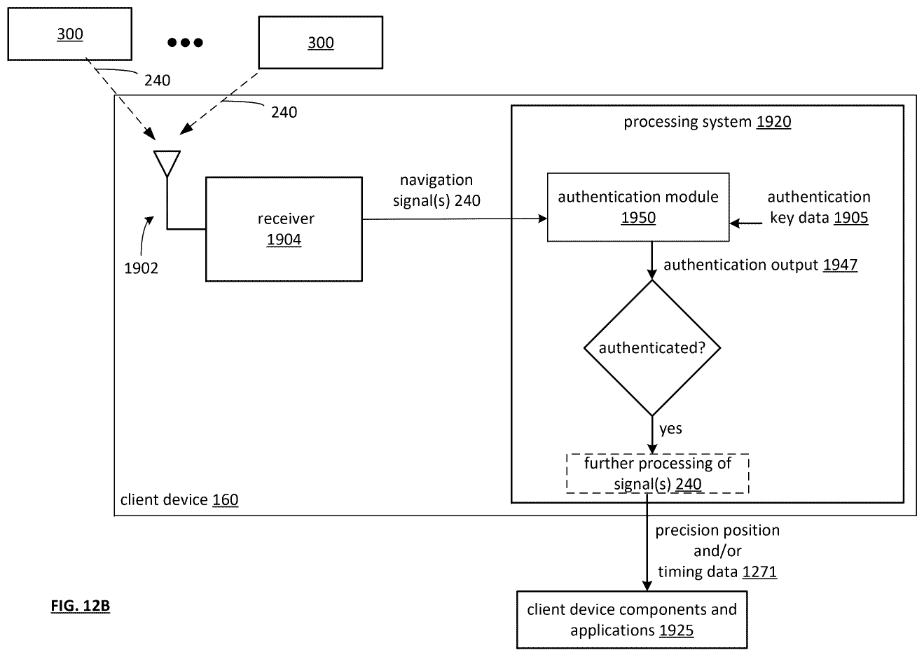

FIGS. 11A-11B present embodiments of a data frame generation and transmission system 1801 operable to generate and transmit of data frames 1820 included in a stream of data frames 1819, and further presents embodiments of a data frame receival and processing system 1802 operable to receive and process the data frames 1820 included in the stream of data frames 1819.

FIG. 11A presents an embodiment of a data frame generation and transmission system 1801 that generates a stream of data frames 1819 that includes a plurality of data frames 1820.1, 1820.2, etc. For example, the data frame generation and transmission system 1801 includes at least one processor and/or at least one memory (e.g. of a corresponding computing device) operable to generate the stream of data frames. Alternatively or in addition, the data frame generation and transmission system 1801 includes at least one transmitter (e.g. that includes at least one antenna) configured to transmit the stream of data frames 1819 (e.g. as part of a signal broadcast by the data frame generation and transmission system).

A given data frame 1820.k in the stream of data frames 1819 can include corresponding message data 1829.k, which can be encrypted or unencrypted message data. Some or all other data frames can also include their own corresponding message data 1829.

A plurality of different data frame retrieval and processing systems can receive and process the data frames 1820 received in the stream of data frames 1819. Such processing can include authenticating the data frames 1820 and/or decrypting the encrypted message data included in the data frames 1820. For example, the data frame receival and processing system 1802 includes at least one processor and/or at least one memory (e.g. of a corresponding computing device) operable to process the stream of data frames. Alternatively or in addition, the data frame receival and processing system 1802 includes at least one receiver (e.g. that includes at least one antenna) configured to receive the stream of data frames 1819 (e.g. as part of receiving a signal broadcast by the data frame generation and transmission system).

Some or all features and/or functionality of the data frame generation and transmission system 1801, the data frame receival and processing system 1802, and/or data frames 1820 of the stream of data frames 1819 of FIG. 11A can implement any embodiment of the data frame generation and transmission system 1801, the data frame receival and processing system 1802, and/or data frames 1820 of the stream of data frames 1819 described herein.

FIG. 11B presents an embodiment where the data frame generation and transmission system 1801 is implemented via a satellite processing system 300, for example, of a satellite 110 or any node of the satellite constellation system 100 implementing satellite processing system 300 as described herein. For example, any embodiment of the processing module 320, navigation signal transmitter 330, and/or other attributes of any embodiment of the satellite processing system 300 can be adapted to implement some or all features and/or functionality of the data frame generation and transmission system 1801 described herein. For example, the data frame generation and transmission system 1801 can implement some or all features of the navigation signal generation and transmission module 1230 described herein. The data frame generation and transmission system 1801 can otherwise be operable to generate any embodiment of navigation signal 240 described herein, where the stream of data frames are included in navigation data stream 1505 (e.g. via modulation upon a corresponding carrier signal and/or ranging signal, for example, via applying spreading code 1237 and/or overlay code 1539) and/or where the message data 1829 of a given data frame indicates a corresponding navigation message 1235 (e.g. where this navigation message is encrypted, for example, as an encrypted navigation message, and/or where this navigation message is unencrypted).

As illustrated in FIG. 11B, the plurality of data frame receival and processing systems 1802 receiving the stream of data frames 1819 can be implemented via a plurality of corresponding client devices 160.1-160.N, which can be implemented via any embodiment of client devices receiving and processing navigation signals 240 described herein. For example, any embodiment of the receiver 1904, processing system 1920, and/or other attributes of any embodiment of client device 160 can be adapted to implement some or all features and/or functionality of the data frame receival and processing system 1802 described herein. In particular, resolving of a precise position and/or time solution by a given client device 160 as described herein can be based on their processing of navigation messages 1235 received in one or more navigation signals 240 from one or more satellite processing systems 300, where the data frame receival and processing system 1802 is configured to extract the navigation message 1235 from incoming data frames 1820, for example, via decryption in the case where message data 1829 is encrypted.

Some or all features and/or functionality of the data frame generation and transmission system 1801, the data frame receival and processing system 1802, and/or data frames 1820 of the stream of data frames 1819 of FIG. 11B can implement any embodiment of the data frame generation and transmission system 1801, the data frame receival and processing system 1802, and/or data frames 1820 of the stream of data frames 1819 described herein. Some or all features and/or functionality of the satellite processing system 300, client devices 160, and/or navigation signal 240 of FIG. 11B can implement any embodiment of the satellite processing system 300, client devices 160, and/or navigation signal 240 described herein.

The encryption of navigation messages 1235 can be useful in providing a navigation service that enables client devices to resolve precise position and/or timing solutions via navigation signals transmitted via a satellite constellation system 100. In particular, such a navigation service can be offered to paying subscribers of the service, where non-subscribed (e.g. unauthorized) users in range of signals 240 and/or having client devices with receivers/processors capable of receiving and demodulating the signals 240 cannot resolve their position and/or timing solutions without decrypting the encrypted message data. For example, only paying subscribers are provided encryption keys enabling decryption of the encrypted message data and thus the ability to generate precise position and/or timing data as described herein (e.g. encryption keys are issued to such users and/or their respective client device in conjunction with confirming proof of payment for the service).

In other embodiments, the data frame generation and transmission system 1801, the data frame receival and processing system 1802, and/or data frames 1820 of the stream of data frames 1819 are implemented via a different type of system, for example, corresponding to a type of service distinct from a navigation service that enables client devices to resolve precise position and/or timing solutions via navigation signals transmitted via a satellite constellation system 100. For example, the message data 1829 included in various data frames 1820 of the stream of data frames do not correspond to navigation messages of a navigation signal, but instead correspond to different types of data of a different type of signal associated with a different type of service (e.g. another type of service where encryption of messages is favorable, such as a service only available to paying subscribers to which encryption keys are provided in conjunction with proof of payment enabling only subscribers of the service to decrypt and read/process/use the underlying data, and/or a service limited to a select group of users for security reasons). Such services can include services relating to and/or implementing television, radio, music, and/or video streaming services; access to data files such as multimedia files broadcast in signals; telecommunication service, satellite encryption services; government communication services; financial/banking services; and/or other services.

The data frame generation and transmission system 1801 can otherwise be implemented via any computing device/processor/transmitter distinct from satellite processing system 300, satellite 110, and/or navigation signal generation and transmission module 1230 (e.g. data frame generation and transmission system 1801 can be otherwise implemented upon/within: any type of satellite; any type of aerial or ground vehicle; any type of mobile device; any type of ground station, building, and/or fixed infrastructure; and/or any other equipment in a fixed or non-fixed location). The data frame receival and processing system 1802 can similarly be otherwise implemented via any computing device/processor/receiver distinct from client device 160, receiver 1904, and/or processing system 1920 (e.g. data frame receival and processing system 1802 can similarly be otherwise implemented upon/within: any type of satellite; any type of aerial or ground vehicle; any type of mobile device; any type of ground station, building, and/or fixed infrastructure; and/or any other equipment in a fixed or non-fixed location). The stream of data frames 1819 can otherwise be broadcast via modulation upon any signal, and/or can be otherwise transmitted by data frame generation and transmission system 1801 to some or all data frame receival and processing systems 1802/client devices 160/other computing devices via any wired and/or wireless communication medium/protocol (e.g. via direct or non-direct communication links/pathways to different data frame receival and processing systems 1802).

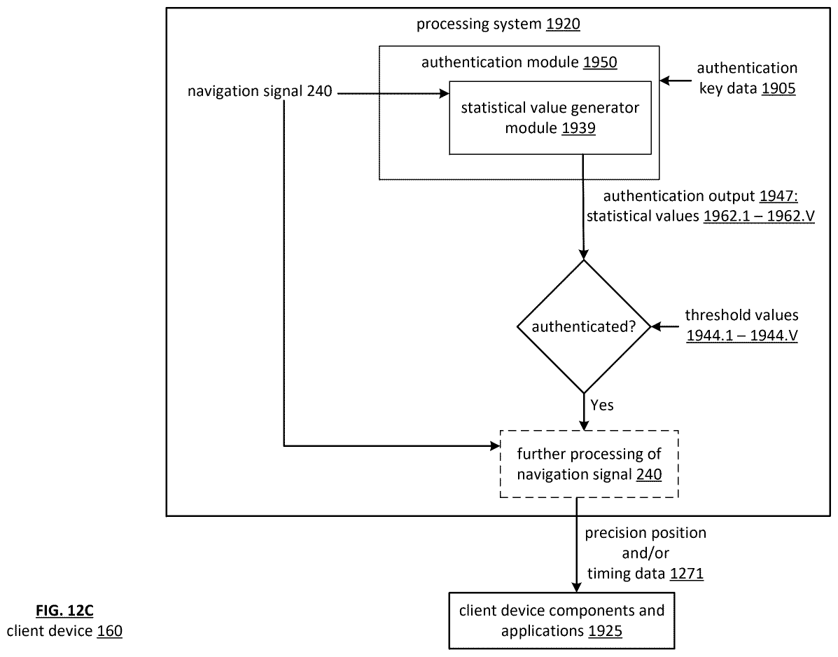

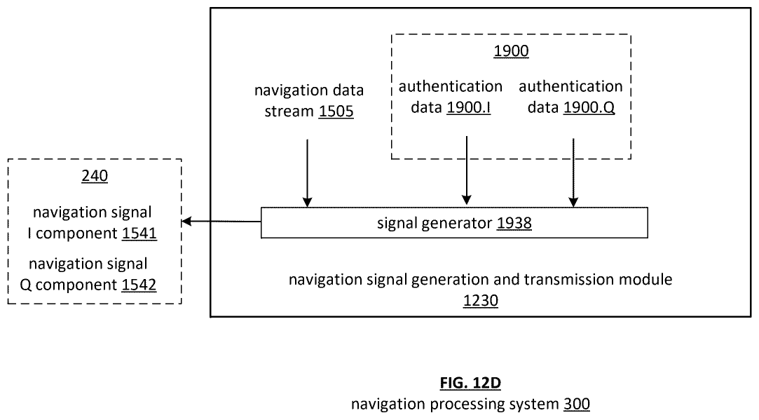

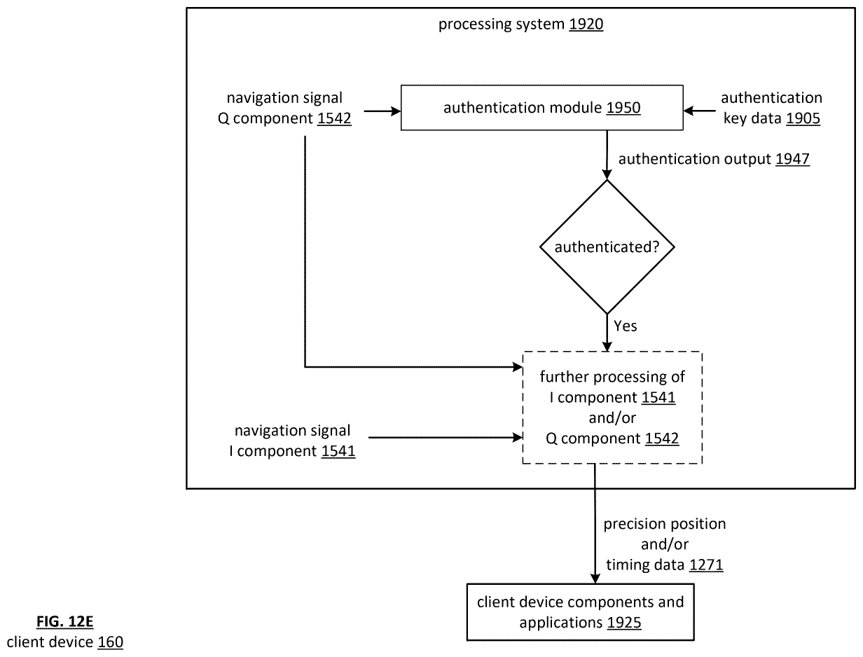

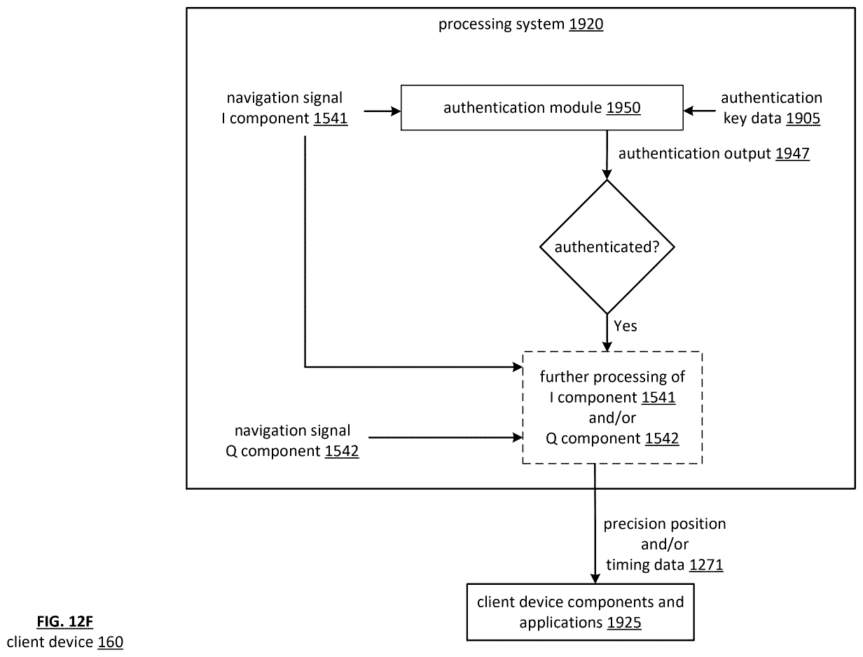

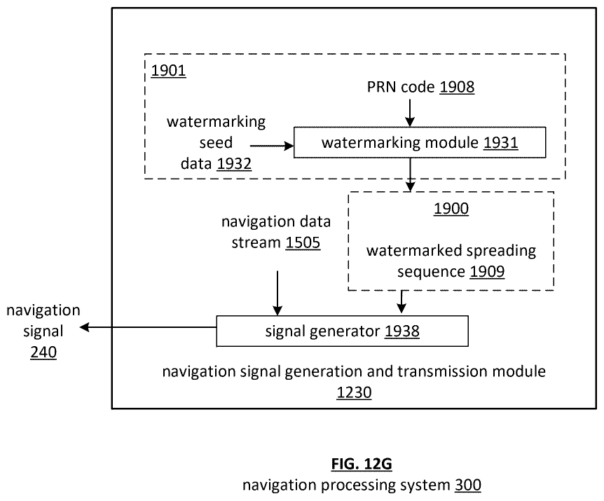

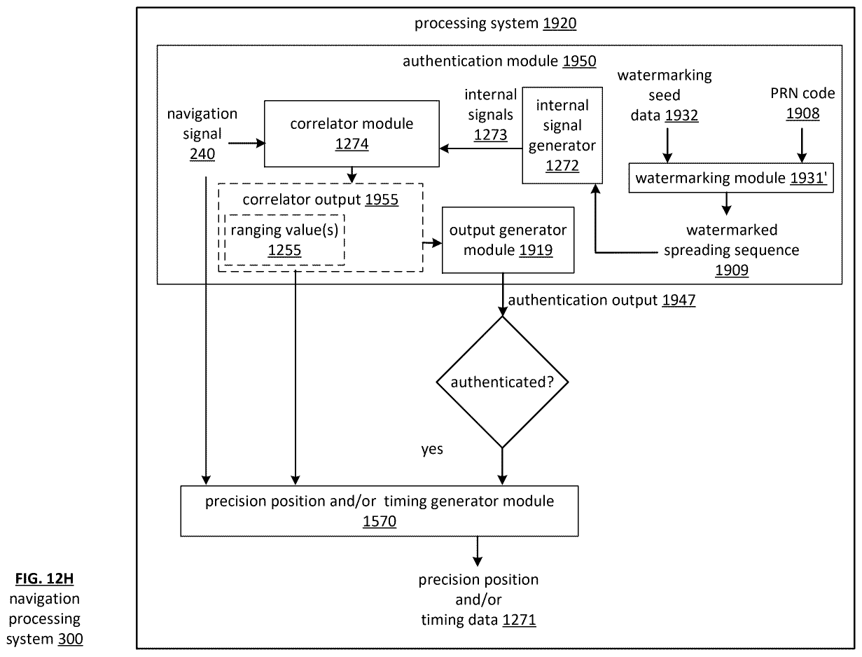

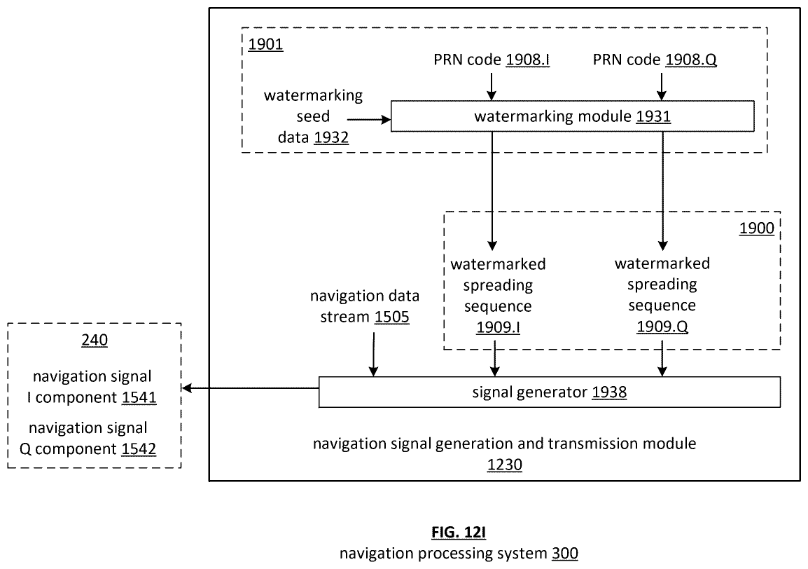

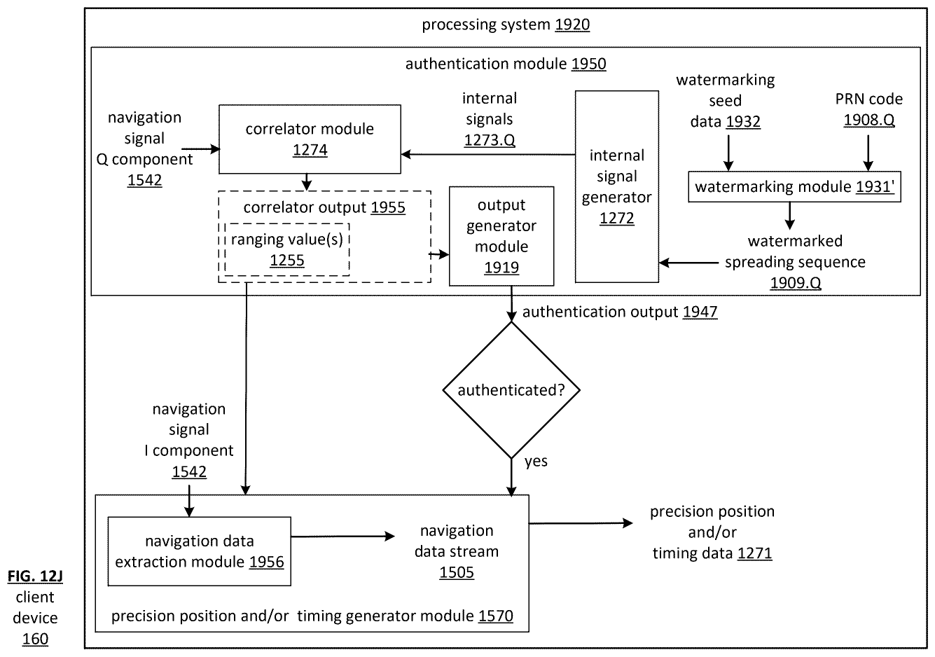

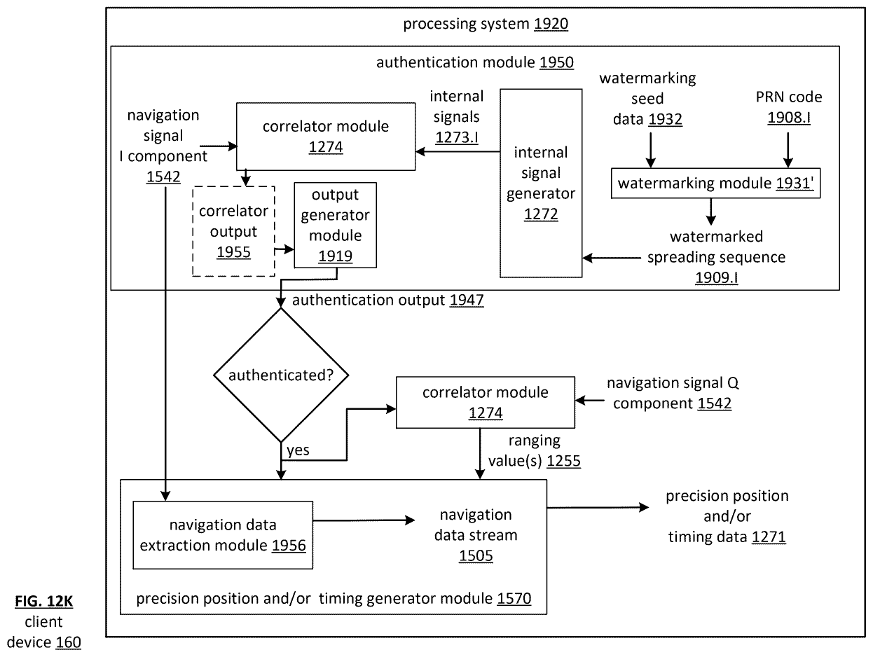

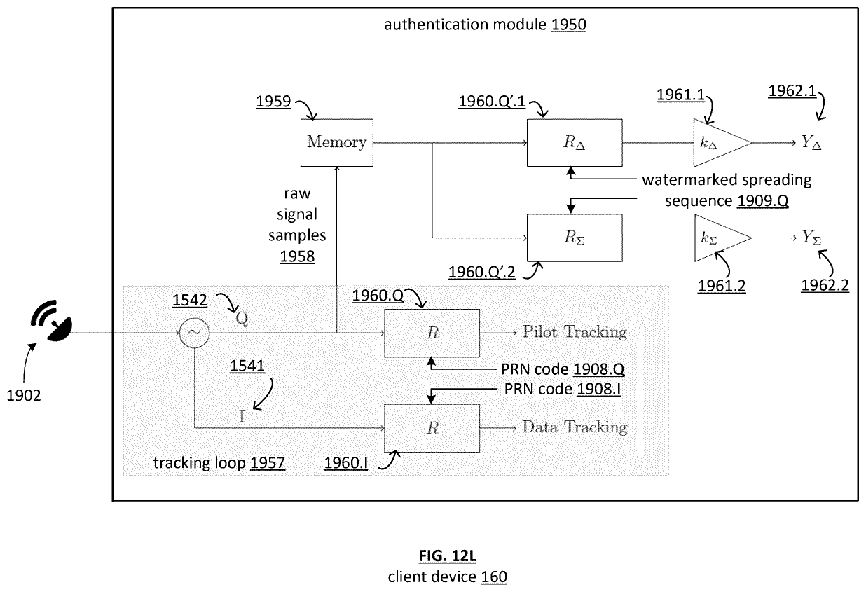

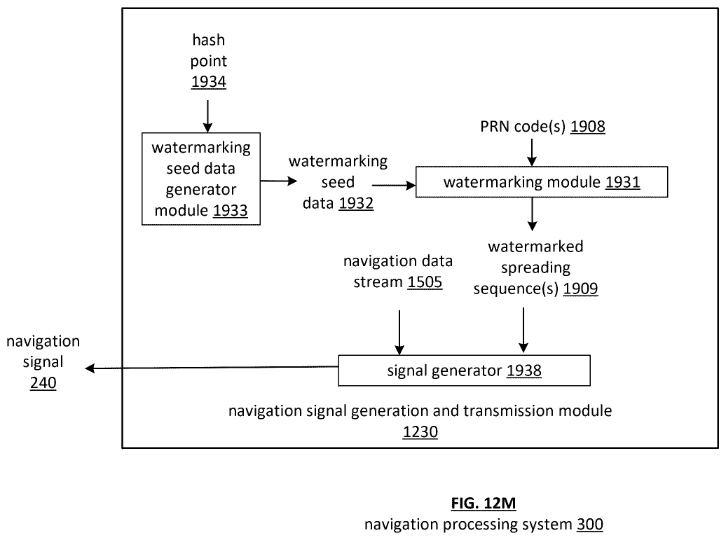

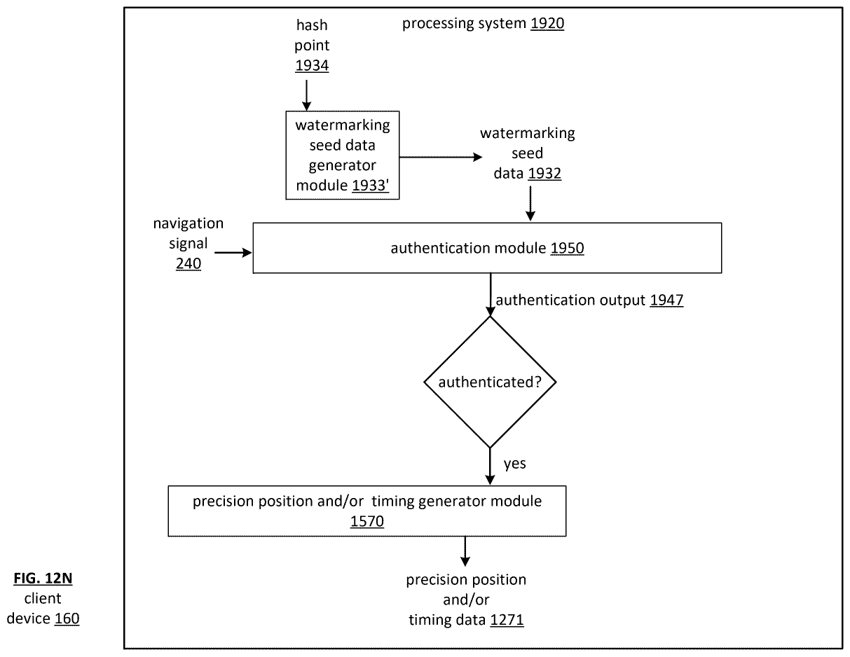

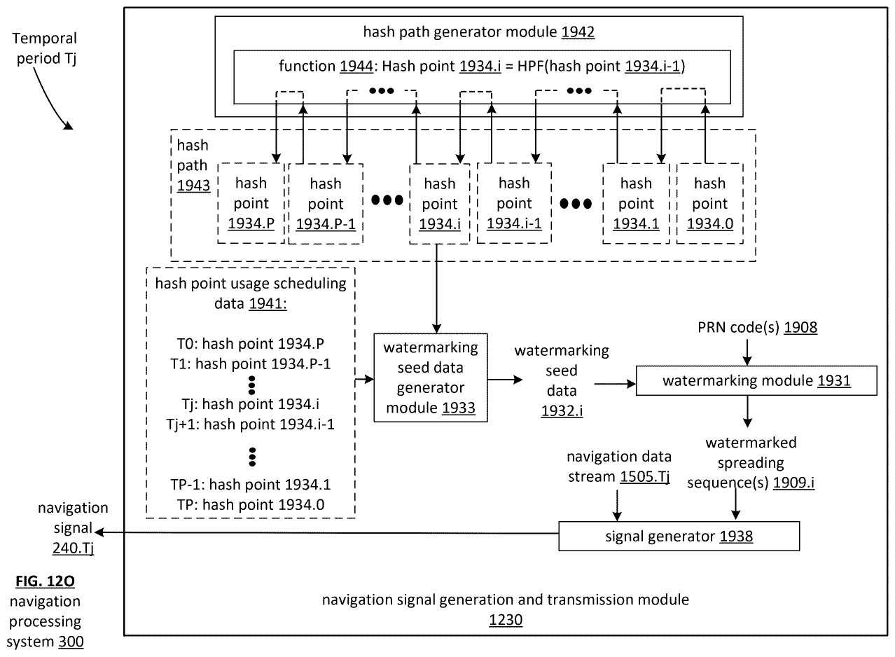

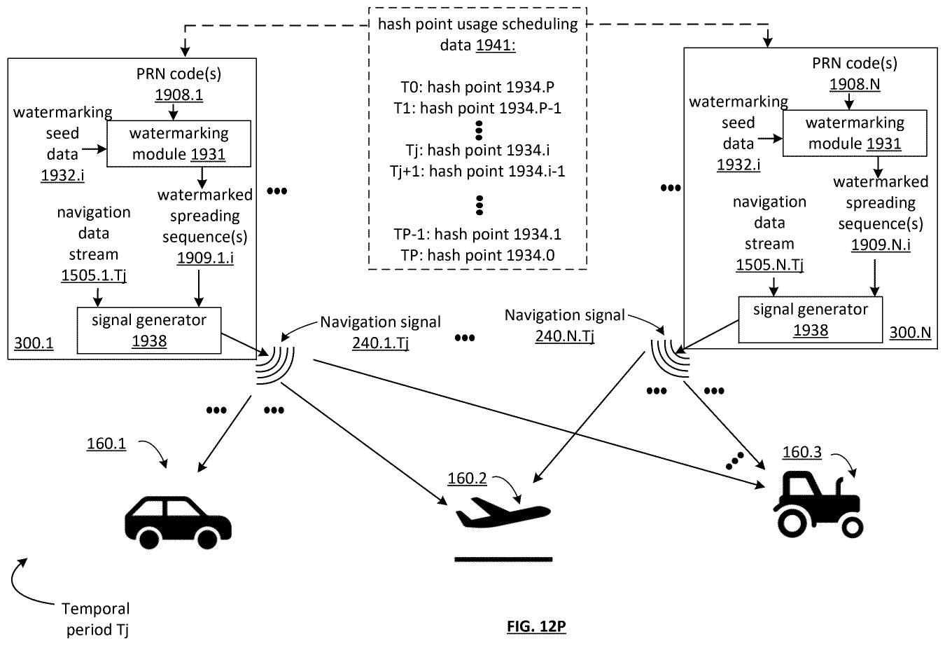

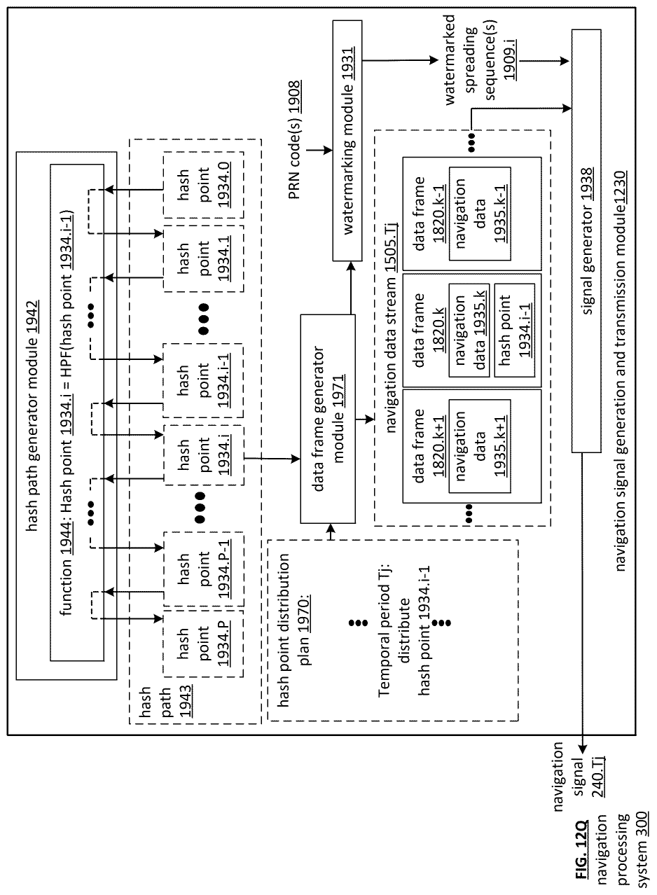

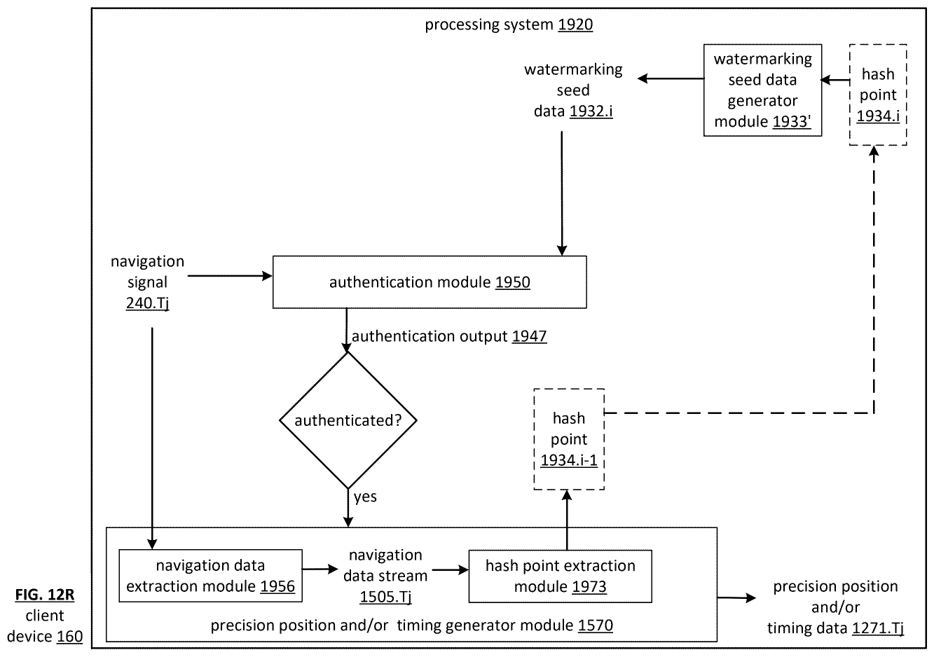

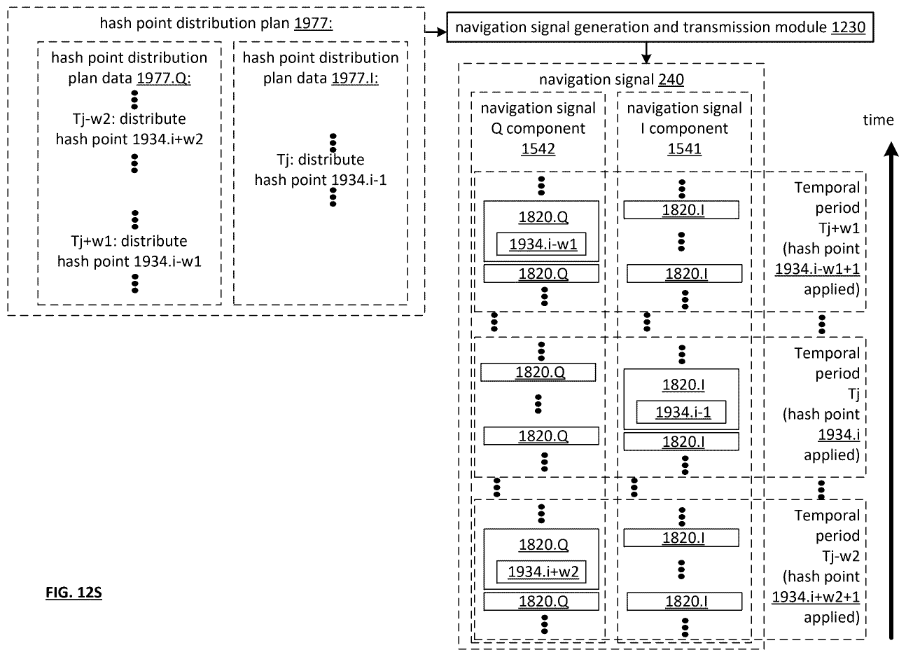

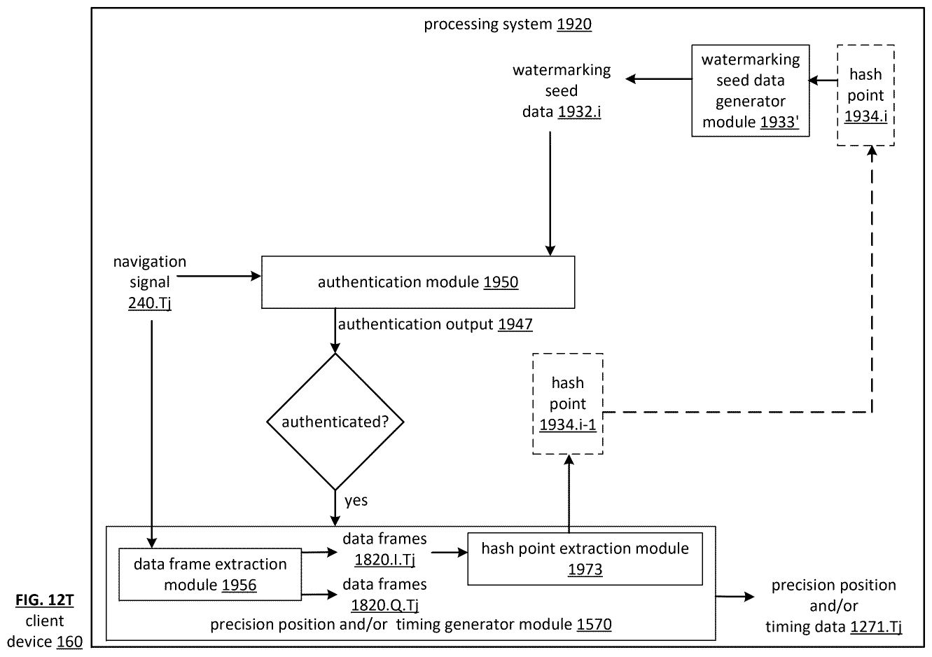

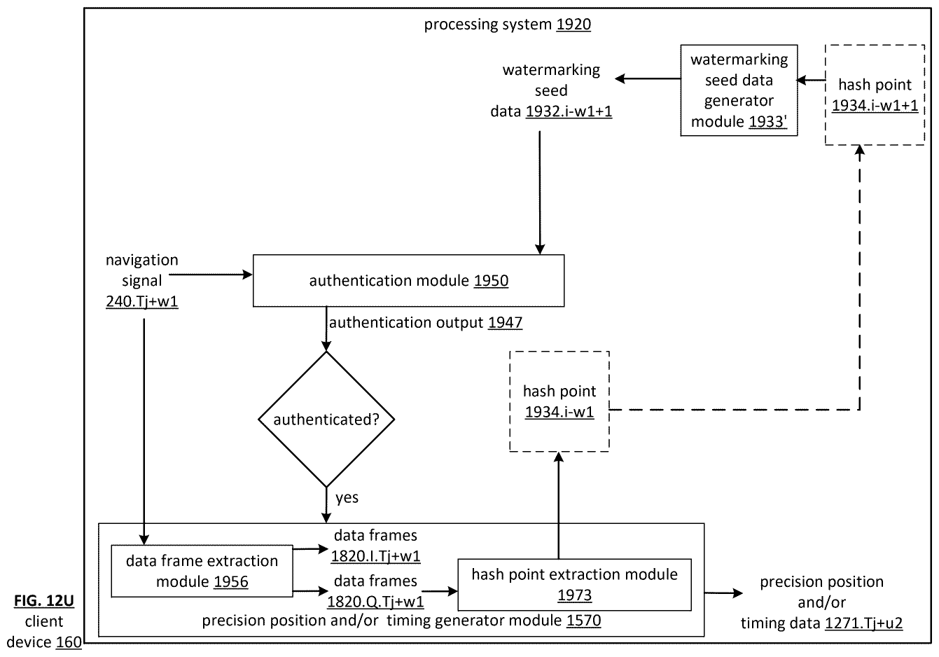

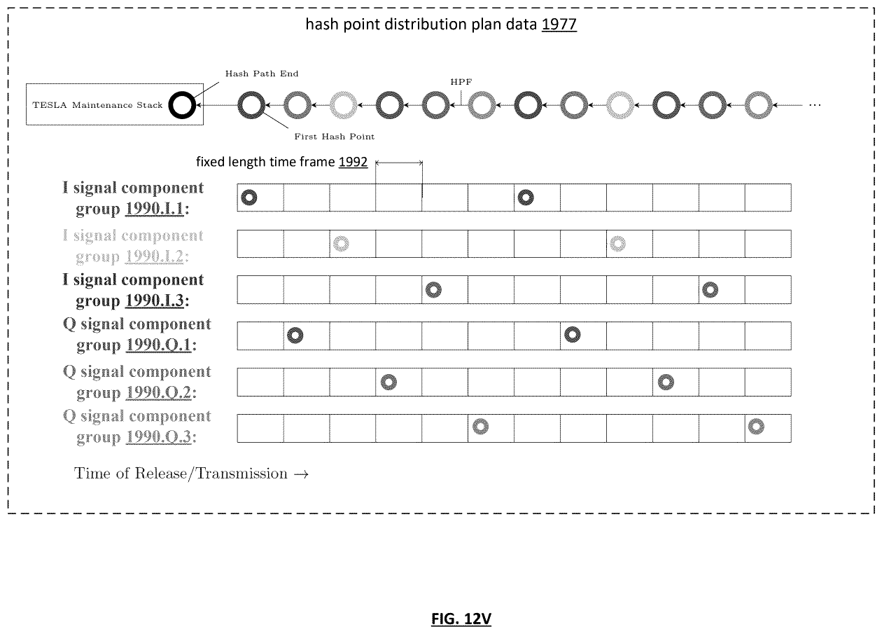

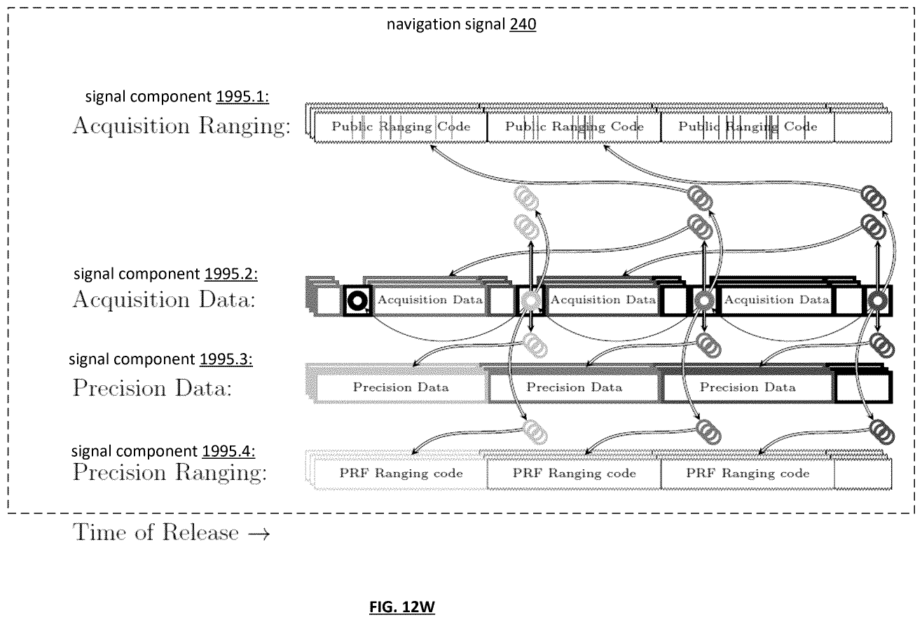

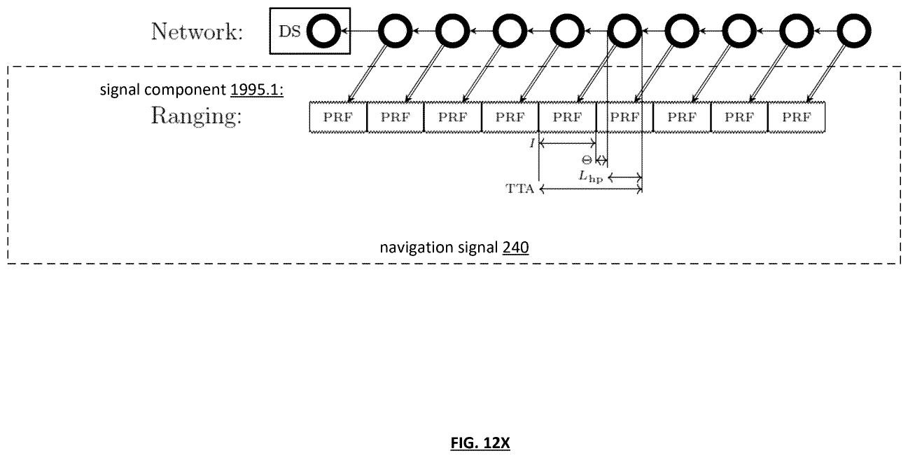

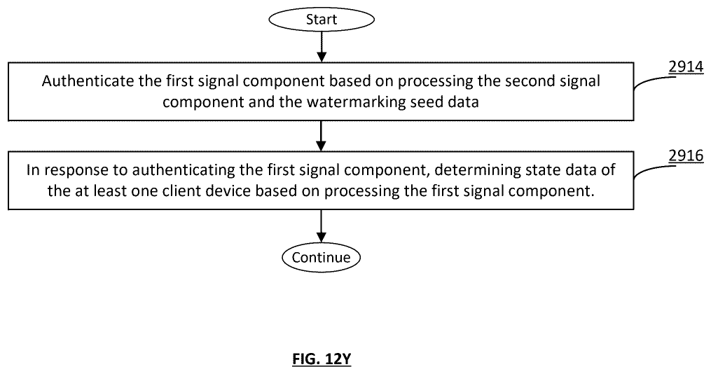

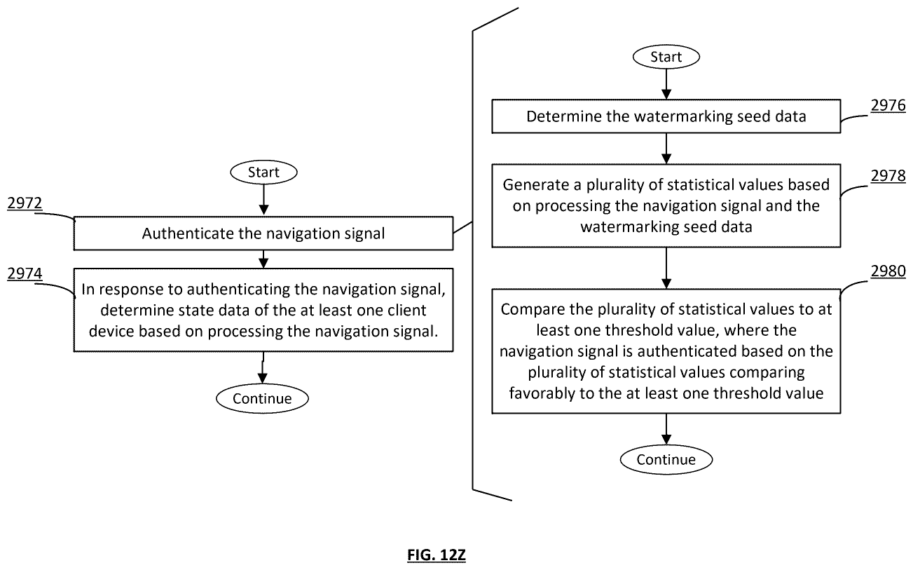

FIGS. 12A-12V illustrate example embodiments of implementing authentication for navigation signals 240, such as navigation signals 240 generated and/or transmitted via satellites 110, satellite processing systems and/or navigation processing systems 300, navigation generation and transmission systems 1230, and/or nodes as described herein and/or navigation signals 240 received and/or processed by client devices 160, receivers, and/or nodes as described herein. Some or all embodiments of the navigation signal 240, satellite 110, satellite processing system and/or navigation processing systems 300, navigation generation and transmission system 1230, client device 160, and/or implementation of authentication presented in conjunction with FIGS. 12A-12V can implement any features and/or functionality of any embodiment of navigation signal 240, satellite 110, satellite processing system and/or navigation processing systems 300, navigation generation and transmission system 1230, client device 160, node, and/or implementation of authentication described herein.

Some or all functionality of the authentication of navigation signals 240 presented in conjunction with FIGS. 12A-12V can be adapted to facilitate generation and/or processing of GNSS signals 132 in a same or similar fashion to render same or similar authentication. For example, client devices 160 can be adapted to perform same or similar types of authentication of any GNSS signals (e.g. GPS signals, Galileo signals, etc.), regardless of whether they are configured to receive and/or process navigation signals 240 transmitted by satellite constellation system 100 and/or navigation signals 204 transmitted via satellites in LEO orbit.

FIG. 12A presents an embodiment of a navigation signal generation and transmission module 1230 of a navigation processing system 300 (and/or satellite processing system 300). Some or all features and/or functionality of navigation processing system 300 of FIG. 12A can implement any embodiment of a navigation processing system, satellite processing system, satellite, and/or node described herein. Some or all features and/or functionality of navigation signal 240 of FIG. 12A can implement any embodiment of a navigation signal described herein.

A signal generator can generate navigation signal 240 based on a navigation data stream 1505 and/or authentication data 1900. The navigation data stream 1505 can implement some or all features and/or functionality of any navigation data and/or any data stream described herein. The signal generator can implement some or all features and/or functionality of any generation of navigation signals and/or any modulation scheme described herein. The authentication data 1900 can be generated via an authentication data generator module 1901 based on applying authentication key data 1905. The authentication data 1900 can include, can be utilized to generate, and/or can be derived from watermarking data, message authentication code data, and/or other authentication data. The authentication key data 1905 include, can be utilized to generate, and/or can be derived from some or all features and/or functionality of authentication key 1805 of FIGS. 11A-11B and/or some or all features and/or functionality of the derivation, generation, and/or origin of authentication key 1805 and/or corresponding hash point data 1869.

FIG. 12B illustrates an embodiment of a client device 160. Some or all features and/or functionality of client device 160 of FIG. 12B can implement any embodiment of a client device, receiver, and/or node described herein. Some or all features and/or functionality of navigation signal 240 of FIG. 12B can implement the navigation signal 240 of FIG. 12A and/or any embodiment of a navigation signal described herein. For example, the client device 160 is operable to receive, authenticate, and/or further process navigation signals received from one or more navigation processing systems 300 of one or more satellites and/or nodes, where some or all of these navigation processing systems 300 implement some or all features and/or functionality of the navigation processing system 300 of FIG. 12A and/or of any other navigation processing system described herein.

Receiver 1904 of processing system can receive incoming navigation signals 240 (e.g. via an antenna 1902) and/or a processing system 1920 (e.g. associated with and/or implementing a corresponding receiver and/or otherwise implementing the client device 160) can process the incoming navigation signals 240.

Processing system 1920 can implement an authentication module 1950 operable to generate authentication output 1947 which can indicate whether a corresponding navigation signal 240 is authenticated and/or can include data which is further processed to determine whether the corresponding navigation signal 240 is authenticated. In the case that the navigation signal 240 is authenticated, it can be further processed to render generation of precision position and/or timing data 1271, which can be utilized by various client device components and applications 1925 as described herein. In the case that the navigation signal 240 is not authenticated, it is optionally not further processed, where generation of precision position and/or timing data 1271 from this navigation signal is foregone, for example, to prevent harm/otherwise unfavorable results, such as incorrect precision position and/or timing data 1271 and/or other undesirable outcomes, for example, intended by a spoofer/malicious entity generating false navigations signals 240.

In some embodiments, the client device applies the authentication key data 1905 in response to receiving the authentication key data and/or otherwise deriving the authentication key data from other data, for example based on the authentication key data being shared with the authentication module 1950 in data generated and/or transmitted by: the satellite 110 and/or other node implementing the navigation system 300 from which the navigation signal 240 is received (e.g. in data previously extracted from navigation signal 240); a different satellite 110 and/or node implementing another navigation system 300 (e.g. in data previously extracted from another navigation signal 240); a network connection (e.g. via the Internet), for example, with a server associated with a navigation service, for example, implementing the satellite constellation system 100 that includes the satellite 110 and/or other node implementing the navigation system 300 from which the navigation signal 240 is received; and/or other computing device. As a particular example, the watermarking seed data and/or corresponding authentication key data is shared with the authentication module 1950 based on the client device corresponding to a user that is a subscriber and/or confirmed user of the system (e.g. the watermarking seed data and/or corresponding authentication key data is received in encrypted communications for decryption by the client device via a key issued to and/or already known to the client device based on being a subscriber of the service, for example, via implementing some or all features and/or functionality of encryption applied in conjunction with authentication presented in conjunction with FIGS. 11A-11B, etc.

FIG. 12C presents an embodiment of a processing system 1920 that generates authentication output 1947 to include a set of V statistical values 1962.1-1962.V generated via a statistical value generator module 1939 implemented via authentication module 1950. Some or all features and/or functionality of client device 160 of FIG. 12C can implement the client device of FIG. 12B or any embodiment of a client device, receiver, and/or node described herein. For example, the client device 160 of FIG. 12C is configured to receive, authenticate, and/or otherwise process the navigation signal 240 generated and transmitted via the navigation processing system 300 of FIG. 12A and/or any other embodiment of a navigation signal described herein.

The set of V statistical values 1962.1-1962.V can include a single value or optionally a plurality of values. Authentication of the navigation signal 240 can be based on whether some or all of the statistical values compare favorably to threshold values 1944.1-1944.V (e.g. a statistical value 1962.i compares favorably to a corresponding threshold value 1944.i based on being greater than, greater than or equal to, less than, and/or less than or equal to the respective threshold values, for example, depending on whether the values are threshold maximums or threshold minimums). Some or all statistical values 1962 can all be compared to a same threshold value 1944 and/or different threshold values 1944 can be set for some or all different statistical values 1962.

In some embodiments, a first value 1962.1 of the set of statistical values 1962.1-1962.V corresponds to a probability of missed detection computed via the statistical value generator module 1939 and/or a second value 1962.2 of the set of statistical values 1962.2 corresponds to a probability of false alarm computed via the statistical value generator module 1939. In some embodiments, the set of statistical values 1962.1-1962.V optionally only includes these two values and no additional statistical values, where authentication is only based on whether or not these two values compare favorably to a same respective threshold (e.g. a threshold maximum probability value) or whether or not these to values each compare favorably to different respective thresholds (e.g. two different threshold maximum probability values).

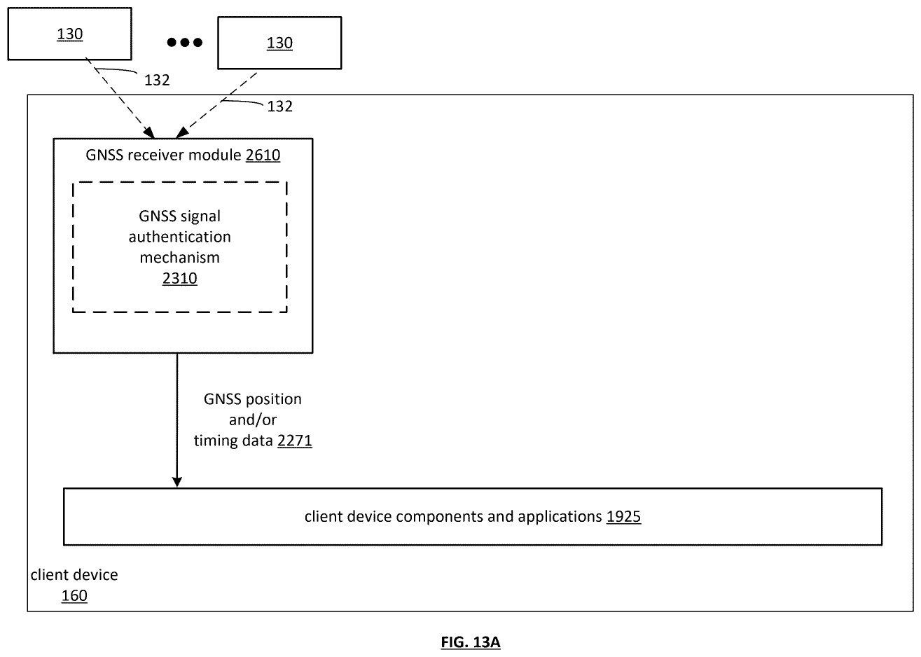

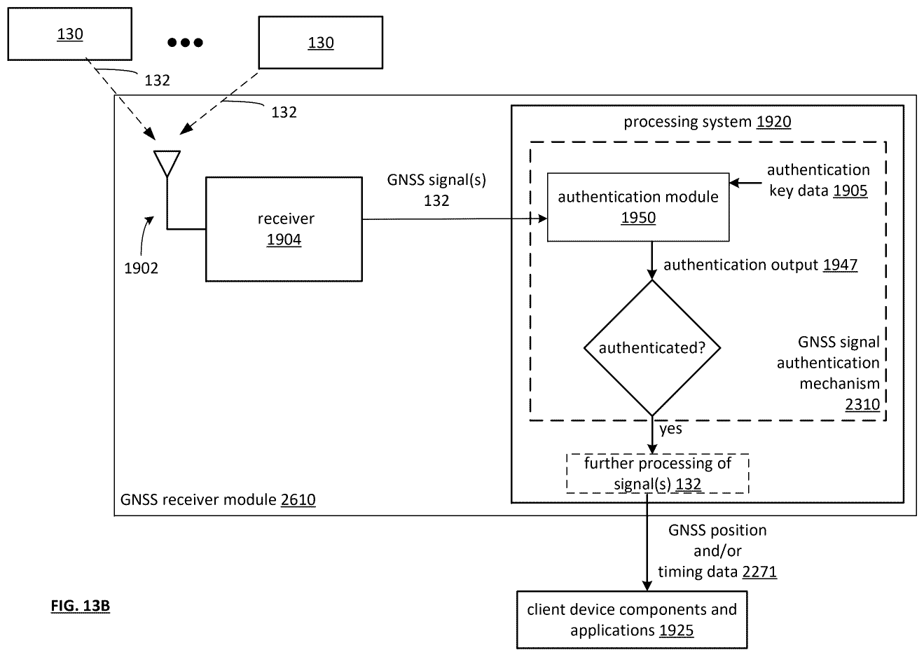

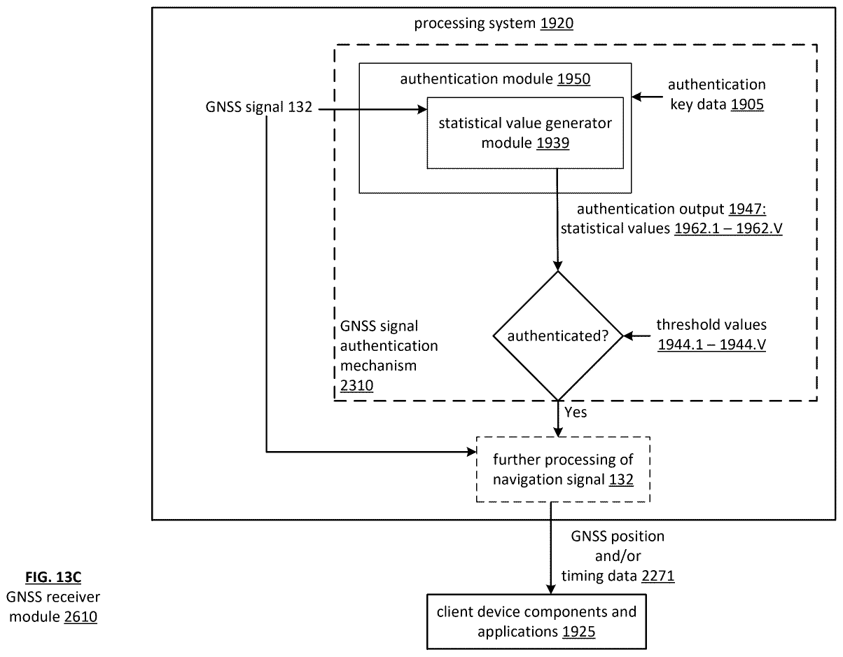

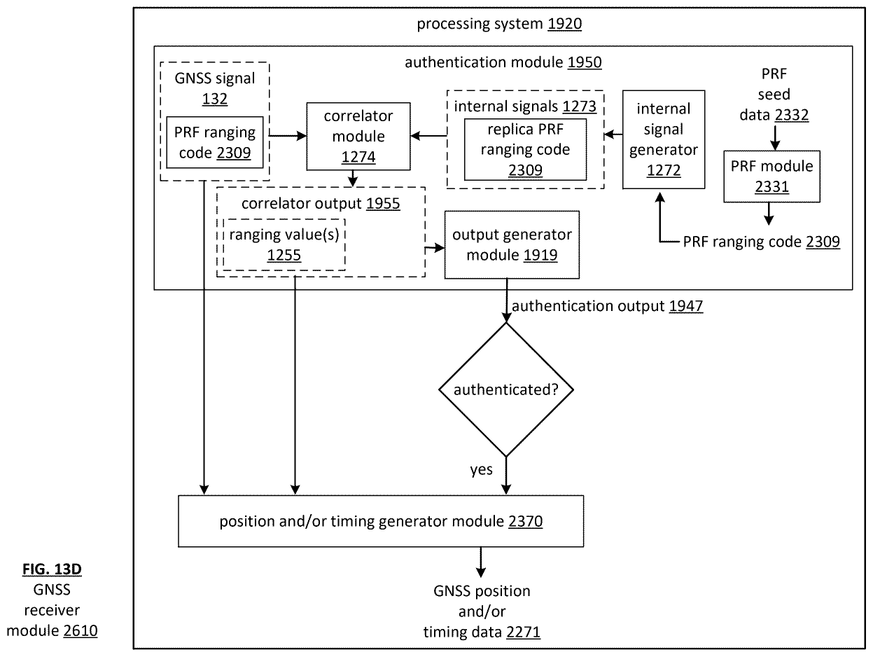

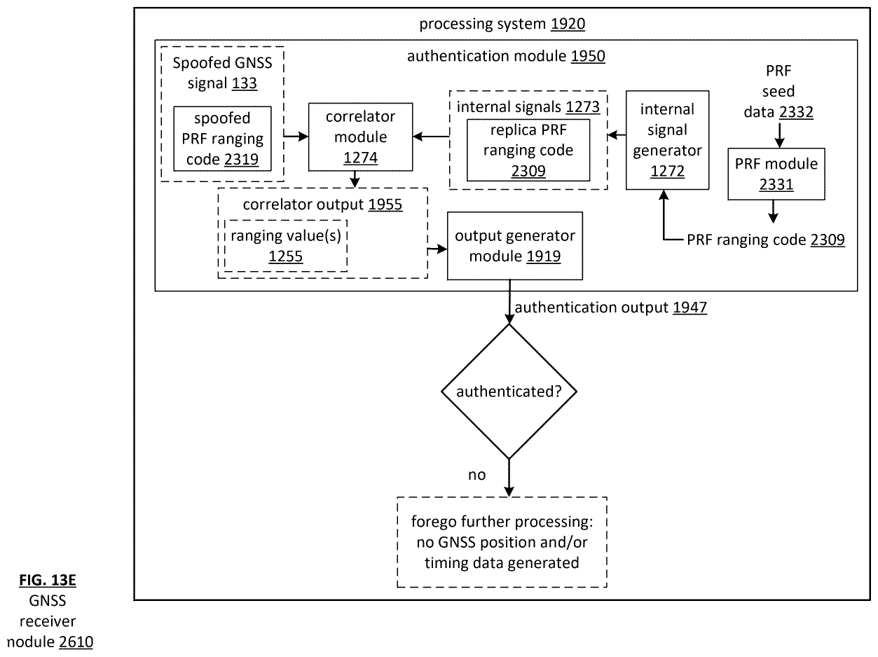

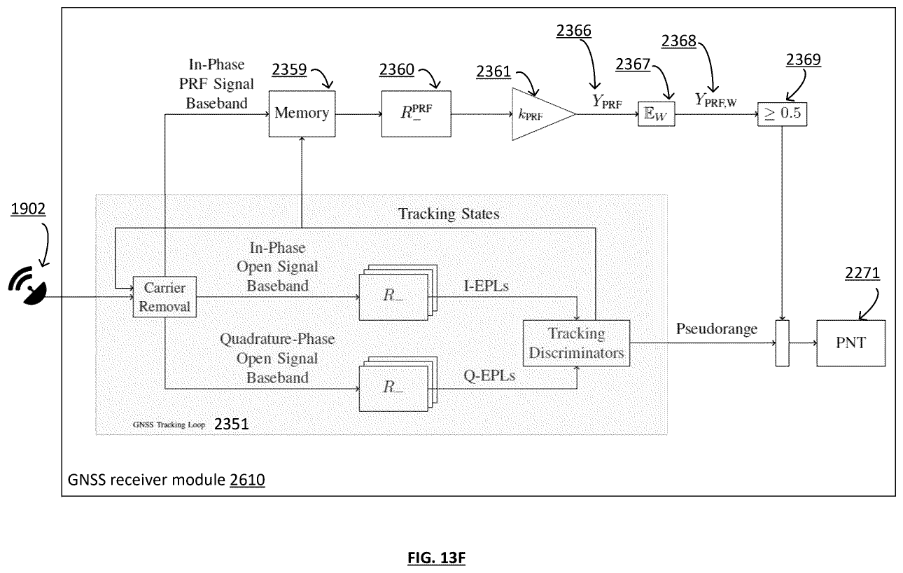

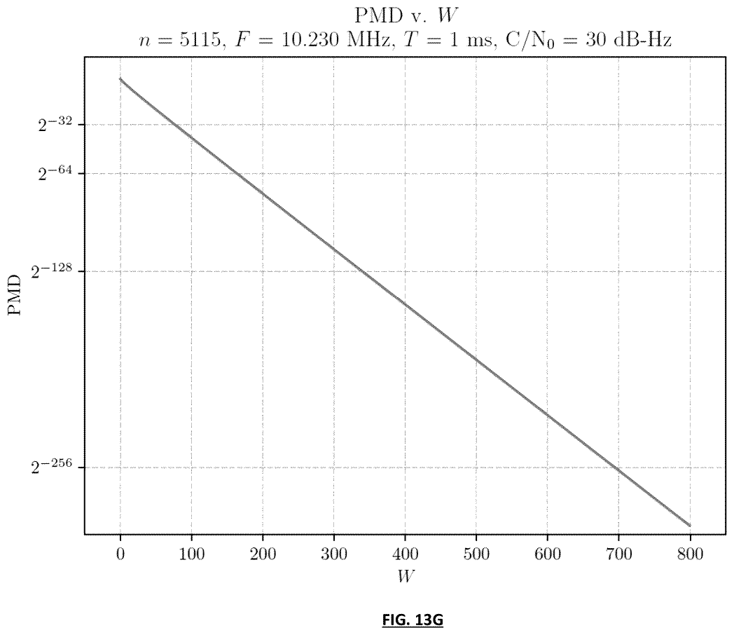

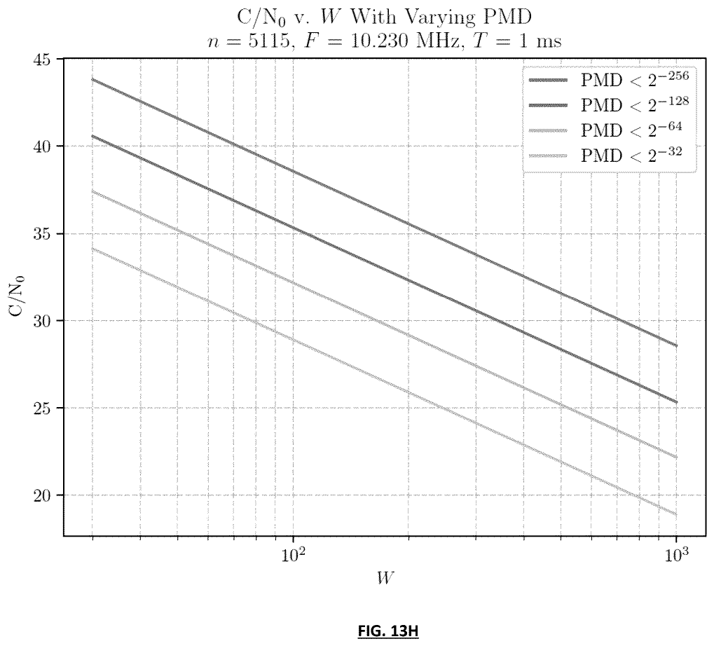

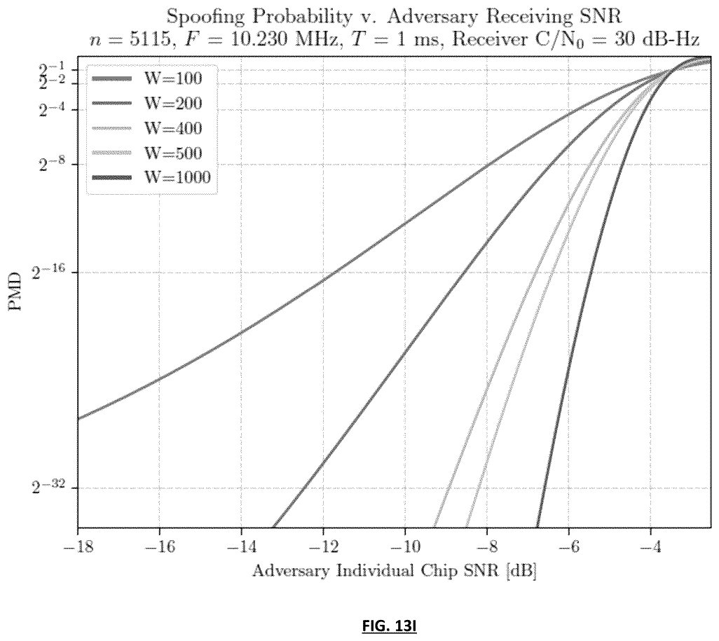

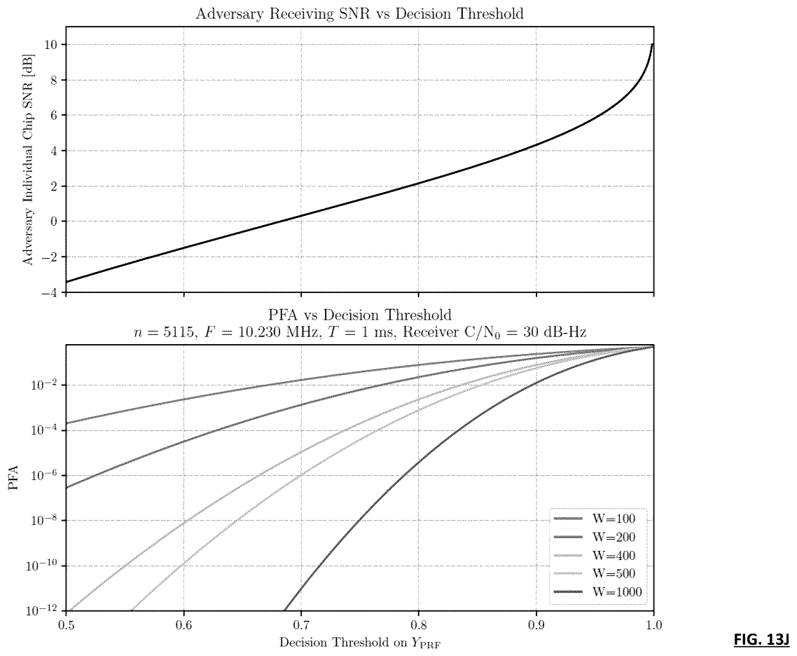

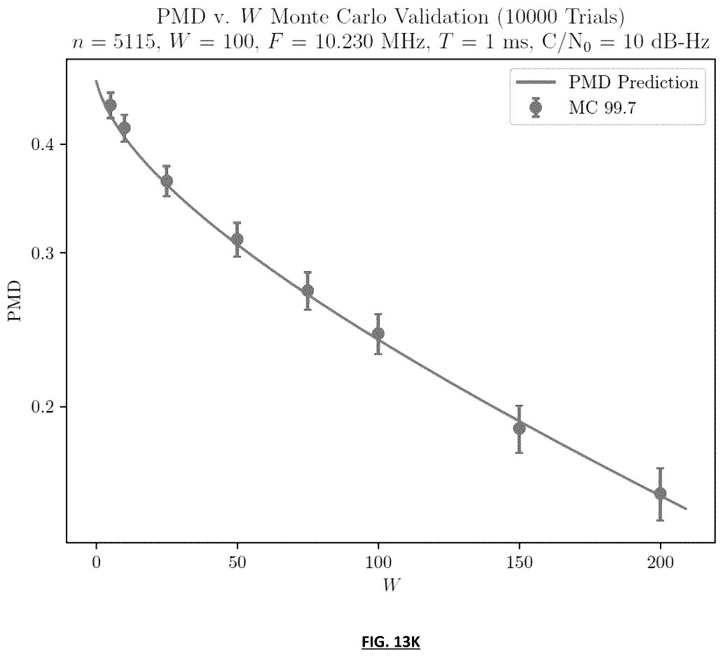

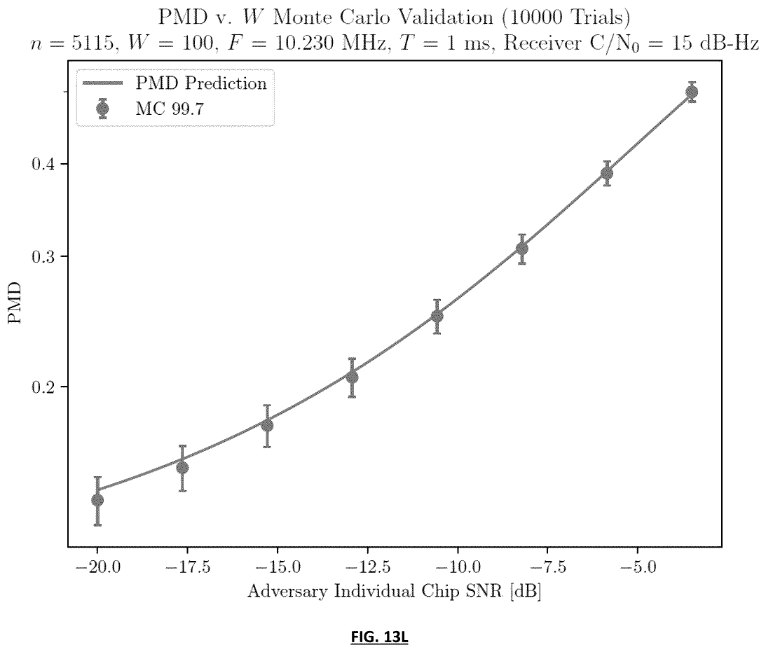

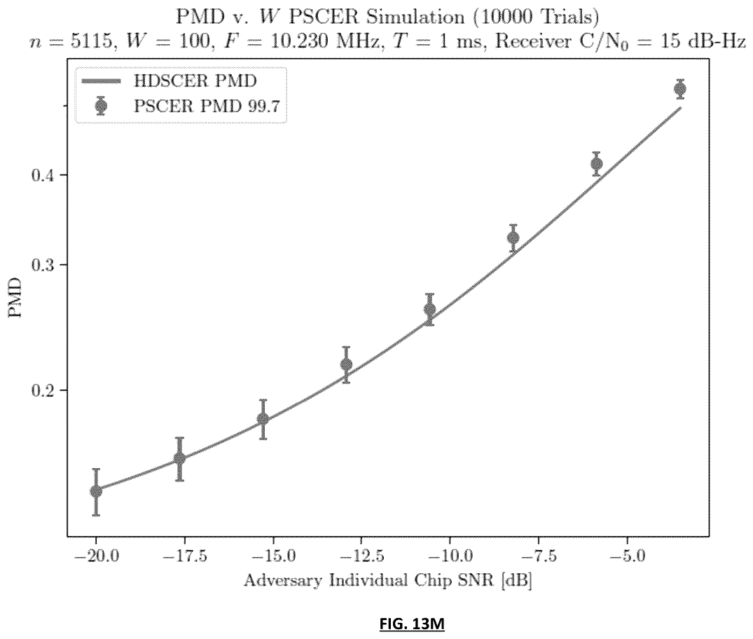

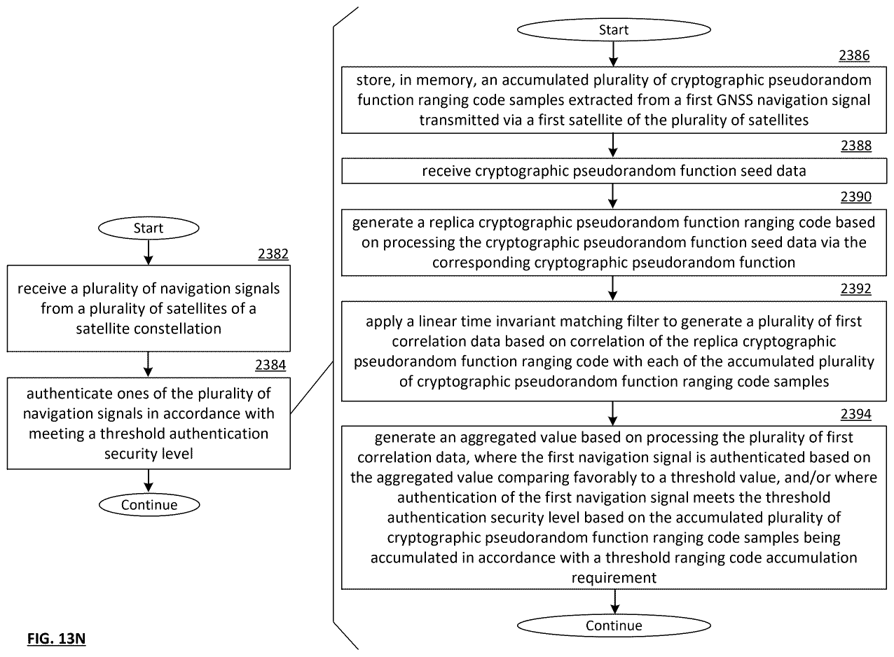

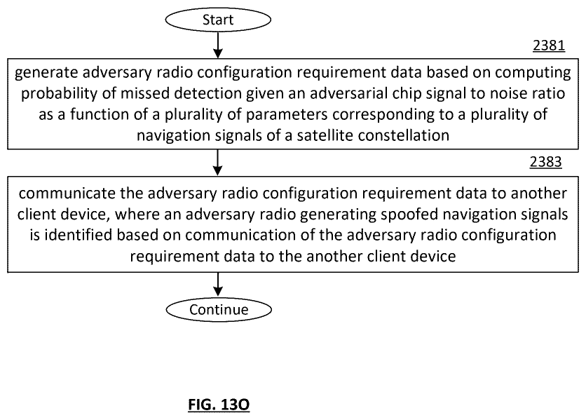

While not illustrated in FIG. 12C, same or similar statical values 1962 can be generated via a same or similar process in other embodiments of client device 160 in authenticating any other type of GNSS signal 132 (e.g. GPS signals and/or Galileo signals). For example some or all features and/or functionality of FIG. 12C is implemented and/or adapted to perform authentication of GNSS signals via some or all features and/or functionality presented in FIG. 13C.

FIG. 12D illustrates an embodiment of a navigation processing system 300 that generates navigation signal 240 to include a first signal component associated with a first phase (e.g. in-phase) and a second signal component associated with a second phase (e.g. quadrature phase and/or a 90 degree offset), such as a navigation signal I component 1541 and a navigation signal Q component, respectively. The navigation signal I component 1541 can be generated based on first corresponding authentication data 1900.I and/or the navigation signal Q component 1542 can be generated based on second corresponding authentication data 1900.Q. Some or all features and/or functionality of navigation processing system 300 of FIG. 12D can implement the navigation processing system 300 of FIG. 12A and/or any embodiment of a navigation processing system, satellite processing system, satellite, and/or node described herein. Some or all features and/or functionality of navigation signal 240 of FIG. 12D can implement the navigation signal of FIG. 12A and/or any embodiment of a navigation signal described herein. Some or all features and/or functionality of navigation signal I component 1541 and/or navigation signal Q component 1542 can any different signal components of different phases described herein.

While the example of FIG. 12D illustrates authentication data for navigation signal I component 1541 and navigation signal Q component 1542 of navigation signal 240 of navigation signal 240, any embodiment of the navigation signal 240 described herein can include any plurality of signal components and/or any embodiment of authentication data 1900 described herein can include any plurality of authentication data 1900 for any plurality of signal components of the navigation signal 240. In some embodiments, the navigation signal 240 includes other types of navigation signal components instead or in addition to navigation signal I component 1541 and navigation signal Q component 1542. In some embodiments, the navigation signal 240 includes a plurality of signal components that includes any number of signal components, such as three or more signal components, where the authentication data 1900 includes a plurality of authentication that includes any number of authentication data, such as three or more authentication data, where some or all of the plurality of signal components are constructed via their own authentication data 1900 of the plurality of authentication data.

In some embodiments, the navigation signal 240 includes at least one additional signal component (e.g. an authentication signal component utilized for authentication), which can be implemented as a low-power signal and/or PRN signal (e.g. implemented as a pseudorandom function (PRF) signal), which can be implemented instead of or in addition to a data signal component (e.g. the navigation signal I component 1541) and/or a pilot signal component (e.g. navigation signal Q component 1542). For example, the at least one additional signal component is implemented via some or all features and/or functionality of one or more signal components of FIGS. 12W and/or 12X, and/or any other signal component described herein.

As a particular example, the additional signal component is perfectly in phase or quadrature with the pilot signal component (e.g. navigation signal Q component 1542) and/or the data signal component (e.g. navigation signal I component 1542). Some or all features and/or functionality of any embodiment of generating and/or processing of navigation signal I component 1541 and navigation signal Q component 1542 described herein can be applied to implement generating and/or processing of any additional signal component of navigation signal 240, such as a low power signal, PRF signal, and/or any other signal component (e.g. implemented as an authentication signal component utilized for authentication).

In some embodiments, the signal includes three or more signal components, which can include at least one data signal component (e.g. the navigation signal I component 1541) and/or at least one pilot signal component (e.g. navigation signal Q component 1542) and/or at least one additional signal component. For example, the three or more signal components of navigation signal 240 are applied to implement majority vote and interplexing signals. Some or all features and/or functionality of any embodiment of generating and/or processing of navigation signal I component 1541 and navigation signal Q component 1542 described herein can be applied to implement generating and/or processing of number of signal components of navigation signal 240, for example, utilized to implement majority vote and interplexing signals.

FIGS. 12E-12F illustrate embodiments of a client device that processes one signal component via authentication module 1950 to authenticate the other signal component (e.g. to enable safe use of the other signal component in generating precision position and/or timing data 1271). Some or all features and/or functionality of client device 160 of FIG. 12E and/or 12F can implement the client device of FIG. 12B or any embodiment of a client device, receiver, and/or node described herein. For example, the client device 160 of FIG. 12E and/or 12F is configured to receive, authenticate, and/or otherwise process the navigation signal 240 generated and transmitted via the navigation processing system 300 of FIG. 12D and/or any other embodiment of a navigation signal described herein.

As illustrated in FIG. 12E, the authentication module 1950 can perform authentication-based processing of navigation signal Q component 1542 to generate authentication output 1947, which can be utilized to determine whether both navigation signal Q component 1542 and navigation signal I component 1541 are authenticated (e.g. without necessitating the authentication-based processing of navigation signal I component 1541). When authentication output 1947 indicates navigation signal Q component is authenticated, both the navigation signal Q component 1542 and the navigation signal I component 1541 can be processed to generate the precision position and/or timing data 1271.

Alternatively or in addition to the embodiment of FIG. 12E, as illustrated in FIG. 12F, the authentication module 1950 can perform authentication-based processing of navigation signal I component 154I to generate authentication output 1947, which can be utilized to determine whether both navigation signal I component 1541 and navigation signal Q component 1542 are authenticated (e.g. without necessitating the authentication-based processing of navigation signal Q component 1542). When authentication output 1947 indicates navigation signal I component is authenticated, both the navigation signal I component 1541 and the navigation signal Q component 1542 can be processed to generate the precision position and/or timing data 1271.

Alternatively or in addition to the embodiments of FIG. 12E and/or FIG. 12F, in the case where the navigation signal 240 includes a plurality of signal components that include at least one other signal component alternatively or in addition to the navigation signal I component 1541 and the navigation signal Q component 1542, the authentication module 1950 can perform authentication-based processing of a first signal component of any plurality signal components of the navigation signal to generate authentication output 1947, which can be utilized to determine whether this first signal component and/or some or all other signal components of the plurality of signal components of the navigation signal are authenticated (e.g. without necessitating the authentication-based processing of all other signal components of the navigation signal). When authentication output 1947 indicates the first signal component is authenticated, some or all signal components of the navigation signal can be processed to generate the precision position and/or timing data 1271. In some embodiments, the authentication module 1950 can perform authentication-based processing of a second signal component of this plurality signal components of the navigation signal (e.g. at a later time) to generate authentication output, which can be utilized to determine whether this second signal component and/or some or all other signal components of the plurality of signal components of the navigation signal are authenticated (e.g. without necessitating the authentication-based processing of all other signal components of the navigation signal). When authentication output 1947 indicates the second signal component is authenticated, some or all signal components of the navigation signal can be processed to generate the precision position and/or timing data 1271. Any other signal component of the plurality of signal components can be processed in a similar fashion to this first and/or second component to similarly undergo authentication-based processing (e.g. during different temporal periods) to facilitate authentication of some or all other signal components.

FIG. 12G illustrates an embodiment of a navigation processing system 300 that implements authentication data generator module 1901 via a watermarking module 1931 that applies watermarking seed data 1932 to a PRN code 1908 to generate a watermarked spreading sequence 1909 to be applied in generating the navigation signal 240 via signal generator 1938, for example, based on implementing the authentication data 1900 to include the watermarked spreading sequence 1909. For example, the watermarking seed data 1932 implements some of all of the authentication key data 1905 and/or is derived from the authentication key data 1905. Some or all features and/or functionality of navigation processing system 300 of FIG. 12G can implement the navigation processing system 300 of FIG. 12A and/or any embodiment of a navigation processing system, satellite processing system, satellite, and/or node described herein. Some or all features and/or functionality of navigation signal 240 of FIG. 12G can implement the navigation signal of FIG. 12A and/or any embodiment of a navigation signal described herein.

Some or all features and/or functionality of PRN code 1908 can implement any embodiment of a PRN code, ranging code, spreading code, and/or spreading sequence described herein. The PRN code 1908 can uniquely identify a corresponding satellite of a satellite constellation (e.g. satellite constellation system 100) that includes the respective satellite 110 and/or can identify a corresponding plane of the satellite constellation (e.g. in embodiments where all satellites 110 of satellite constellation system 100 in a same orbital plane are configured to share a same PRN code 1908).

Some or all features and/or functionality of watermarked spreading sequence 1909 can implement any embodiment of a PRN code, ranging code, spreading code, and/or spreading sequence described herein. The watermarked spreading sequence 1909 can be implemented as a modified version of the PRN code (e.g. very similar with small differences as defined by the watermarking seed data 1932). The watermarked spreading sequence 1909 can be repetitively applied to generate the navigation signal 240 over time.

As a particular example, the PRN code 1908 includes an ordered set of chips that includes a fixed total number of chips total (e.g. n=total number of chips). The watermarking seed data 1908 can indicate a particular proper subset of chips in the ordered set of chips that includes another fixed number of chips to be inverted (e.g. r=a number of chips for inversion), where the watermarked spreading sequence 1909 is generated via inverting is particular set of r chips of the n total chips of the PRN code 1908. The particular set of r chips can be a pseudorandomly selected subset of the total set of chips n, and which particular r chips are flipped can be defined by the watermarking seed data 1908, for example, in accordance with applying a combinatorial watermarking scheme.

Various embodiments can implement different values of n and/or r. The number of chips inverted r can be configured to be sufficiently small with respect to n such that the watermarked spreading sequence 1909 is similar enough to the PRN code 1908 to enable the client device 160 to correlate and/or otherwise identify the PRN code 1908 to enable tracking of the navigation signal 240 (e.g. in conjunction with adhering to a threshold maximum signal loss requirement). Meanwhile, the number of chips inverted r can also be configured to be sufficiently large with respect to n such that a sufficient number of different combinations of r chips selected from the n total chips are possible to render sufficient authentication security (E.g. in conjunction with adhering to a threshold minimum security requirement).

FIG. 12H illustrates an embodiment of a client device that implements authentication module 1950 based on implementing a watermarking module 1931′, which can be implemented in a same or similar fashion as the watermarking module 1931 of FIG. 12G. Some or all features and/or functionality of client device 160 of FIG. 12H can implement the client device of FIG. 12B or any embodiment of a client device, receiver, and/or node described herein. For example, the client device 160 of FIG. 12H is configured to receive, authenticate, and/or otherwise process the navigation signal 240 generated and transmitted via the navigation processing system 300 of FIG. 12G and/or any other embodiment of a navigation signal described herein.

The authentication module 1950 can implement internal signal generator 1272 to generate internal signals 1273 for processing by correlator module 1974 to generate correlator output 1955 for navigation signal 240 that includes ranging values 1255, for example, via implementing some or all features and/or functionality discussed in conjunction with FIG. 15J. In particular, the internal signal generator 1272 generates internal signals 1273 constructed based on the watermarked spreading sequence 1909 generated via implementing watermarking module 1931′ to apply the watermarking seed data 1932 to the PRN code 1908. For example, the client device generates the watermarked spreading sequence to be applied in generating the internal signals 1273 for use by the correlator module 1274 in response to receiving the watermarking seed data 1932 and/or otherwise deriving the watermarking seed data from other received data, such as corresponding authentication key data 1905, for example based on the watermarking seed data and/or information utilized to derive the watermarking seed data being shared with the authentication module 1950.

The correlation output 1955 can be processed via output generator module of authentication module 1950 to generate the authentication output indicating whether the signal is authenticated. For example, the correlator output indicates a measured magnitude of a convolution peak and/or other measure of strength of correlation of the internal signals with the received signal, which can be utilized to determine whether the respective correlation denotes that a watermarked spreading sequence 1909 is applied in the incoming navigation signal 240 matches that of the watermarked spreading sequence 1909 generated by the client device via the watermarking seed data 1932 (e.g. the convolution peak and/or other measure of strength of correlation is stronger when the watermarked spreading sequence 1909 is applied in the incoming navigation signal 240 matches that of the watermarked spreading sequence 1909 than cases when a different watermarking seed data 1932 is applied to the PRN code 1908 of the incoming navigation signal than that applied by the client device to generate its internal signals).

In the case where the authentication output 1947 indicates the signal is authenticated, the ranging values 1255 generated in the correlator output 1955 can be safely applied to generate the precision position and/or timing data 1271 and/or the navigation signal 240 can otherwise be further processed to safely generate the precision position and/or timing data 1271. In some embodiments, prior to authentication of an incoming navigation signal 240 received during a particular temporal period, raw samples of the signal, corresponding ranging values, and/or other data received and/or generated in conjunction with receiving and/or correlating the signal are cached in memory, which are then accessed and processed once the navigation signal 240 is authenticated.

In some embodiments, while not illustrated, the authentication module 1950 generates and/or utilizes correlator output 1955 generated via applying other internal signals 1273 generated from the PRN code 1908 without applying the watermarking seed data 1932 (e.g. based on correlating the incoming navigation signal 240 prior to receiving and/or deriving the watermarking seed data 1932). In some embodiments, the respective correlator output 1955 for these watermark-free internal signals applied to the navigation signal 240 are processed in conjunction with generating the authentication output. For example, after applying correlator module 1274 utilizing the watermark-free internal signals, the watermarked spreading sequence 1909 is then applied by correlator module 1274 to the incoming navigation signal 240 to generate the authentication output 1947, for example, where the authentication output is based on a difference between first correlator output 1255 generated from the utilizing first, watermark-free internal signals and second correlator output 1255 generated from utilizing second, watermarked internal signals 1273 (e.g. the authentication output 1947 indicates the navigation signal is authenticated when the second correlator output 1255 indicates a magnitude of a convolution peak and/or other greater correlation measure greater than that of the first correlator output, for example, by at least a threshold amount and/or having an increase in correlation otherwise indicative of a matching watermarking spreading sequence 1909 being applied).

FIG. 12I illustrates an embodiment of a navigation processing system 300 that implements authentication data generator module 1901 via a watermarking module 1931 that applies watermarking seed data 1932 to both a PRN code 1908.I and 1908.Q, corresponding to I and Q components of the navigation signal, respectively, to generate watermarked spreading sequences 1909.I and 1909.Q to be applied in generating the navigation signal I component 1541 and navigation signal Q component 1542, respectively, via signal generator 1938. Some or all features and/or functionality of navigation processing system 300 of FIG. 12I can implement the navigation processing system 300 of FIG. 12A, 12D, 12G and/or any embodiment of a navigation processing system, satellite processing system, satellite, and/or node described herein. Some or all features and/or functionality of navigation signal 240 of FIG. 12G can implement the navigation signal of FIG. 12A, 12D, 12G and/or any embodiment of a navigation signal described herein.

While the example of FIG. 12I illustrates watermarked spreading sequences 1909 for navigation signal I component 1541 and navigation signal Q component 1542 of navigation signal 240, any embodiment of the navigation signal 240 described herein can include any plurality of signal components (e.g. including any number of signal components and/or any types of signal components), and/or any embodiment of watermarked spreading sequences 1909 described herein can include any plurality of watermarked spreading sequences 1909 for any plurality of signal components of the navigation signal 240.

FIGS. 12J and 12K illustrates an embodiment of a client device that implements authentication module 1950 based on implementing watermarking module 1931′ to generate internal signals corresponding to one signal component at one phase for correlation with the corresponding signal component of that phase in the incoming navigation signal 240 to generate the authentication output to generate the authentication output for the navigation signal 240 as a whole, for example, based on dictating authentication of both the one signal component processed by the authentication module 1950 as well as the other signal component not processed by the authentication module 1950 (e.g. based on the same watermarking seed data being applied to generate both signal components). Some or all features and/or functionality of client device 160 of FIG. 12J and/or 12K can implement the client device of FIG. 12B, 12E, 12F, 12H or any embodiment of a client device, receiver, and/or node described herein. For example, the client device 160 of FIG. 12J and/or 12K is configured to receive, authenticate, and/or otherwise process the navigation signal 240 generated and transmitted via the navigation processing system 300 of FIG. 12I and/or any other embodiment of a navigation signal described herein.

As illustrated in FIG. 12J, navigation signal Q component can be processed via correlator module 1274 to generate correlation output based on applying internal signals 1273.Q generated via watermarked spreading sequence 1909.Q generated based on applying the watermarking seed data 1932 to PRN code 1908.Q. When the authentication output 1947 indicates authentication is achieved based on this processing of the navigation signal Q component 1542, the ranging values 1255 generated in by authentication module 1950 in processing the navigation signal Q component 1542 can be processed via precision position and/or timing generator module 1570 to generate the precision position and/or timing data 1271 and/or processing of the navigation signal I component 1542 can be performed, for example, to extract and/or process navigation data stream 1505 via a navigation data extraction module 1956 applied to the navigation signal I component to generate the precision position and/or timing data. While not illustrated, in the case where the navigation signal Q component also includes a data stream to be processed, this data stream can similarly be extracted and processed to generate the precision position and/or timing data once authentication is achieved.

Alternatively or in addition to the embodiments of FIG. 12J and/or FIG. 12K, in the case where the navigation signal 240 includes a plurality of signal components that include at least one other signal component alternatively or in addition to the navigation signal I component 1541 and the navigation signal Q component 1542, the authentication module 1950 can perform authentication-based processing of a first signal component of any plurality signal components of the navigation signal to generate authentication output 1947 (e.g. via corresponding applying first internal signals 1273 generated via a first watermarked spreading sequence generated based on applying the watermarking seed data 1932 to a first corresponding PRN code 1908 and/or other known spreading sequence for the first signal component), which can be utilized to determine whether this first signal component and/or some or all other signal components of the plurality of signal components of the navigation signal are authenticated (e.g. without necessitating the authentication-based processing of all other signal components of the navigation signal). When authentication output 1947 indicates the first signal component is authenticated, some or all signal components of the navigation signal can be processed to generate the precision position and/or timing data 1271. In some embodiments, the authentication module 1950 can perform authentication-based processing of a second signal component of this plurality signal components of the navigation signal (e.g. at a later time) to generate authentication output 1947 (e.g. via corresponding applying second internal signals 1273 generated via a second watermarked spreading sequence generated based on applying the watermarking seed data 1932 to a first corresponding PRN code 1908 and/or other known spreading sequence for the second signal component), which can be utilized to determine whether this second signal component and/or some or all other signal components of the plurality of signal components of the navigation signal are authenticated (e.g. without necessitating the authentication-based processing of all other signal components of the navigation signal). When authentication output 1947 indicates the second signal component is authenticated, some or all signal components of the navigation signal can be processed to generate the precision position and/or timing data 1271. Any other signal component of the plurality of signal components can be processed in a similar fashion to this first and/or second component to similarly undergo authentication-based processing (e.g. during different temporal periods) to facilitate authentication of some or all other signal components.

Alternatively or in addition, as illustrated in FIG. 12K, navigation signal I component can be processed via correlator module 1274 to generate correlation output based on applying internal signals 1273.I generated via watermarked spreading sequence 1909.I generated based on applying the watermarking seed data 1932 to PRN code 1908.I. When the authentication output 1947 indicates authentication is achieved based on this processing of the navigation signal I component 1541, navigation data extraction module 1956 applied to this navigation signal I component to generate the precision position and/or timing data and/or a same or different correlator module 1274 can be applied to navigation signal Q component 1542 to generate ranging values 1255 for processing to generate the precision position and/or timing data 1271. While not illustrated, processing of the navigation signal I component 1541 via authentication module 1950 can render generation of ranging values 1255 that can be similarly processed to generate the precision position and/or timing data once authentication is achieved.

FIG. 12L illustrates an example embodiment of an authentication module 1950 of a client device that generates statistical values 1962.1 and 1962.2 of authentication output 1947 via processing raw signal samples 1958 of the navigation signal Q component 1542 stored in a memory 1959. Some or all features and/or functionality of client device 160 of FIG. 12L can implement the client device of FIG. 12B, 12C, 12J, or any embodiment of a client device, receiver, and/or node described herein. For example, the client device 160 of FIG. 12L is configured to receive, authenticate, and/or otherwise process the navigation signal 240 generated and transmitted via the navigation processing system 300 of FIG. 12I and/or any other embodiment of a navigation signal described herein.

As illustrated in FIG. 12L, the client device (e.g. via implementing a corresponding receiver) can process the signal to assert authentication based on applying a tracking loop 1957 (e.g. utilized for tracking the navigation signal 240, for example, to track navigation signal I component 1541 and/or navigation signal Q component 1542). While awaiting generation/derivation of the watermarking seed data 1932 (e.g. based on awaiting distribution of/receival of the corresponding authentication key data 1905), raw baseband samples of the watermarking ranging code (i.e., before correlation) can be stored, via memory 1959 (e.g. within a converged tracking loop). After the watermarking seed data 1932 is determined (e.g. based on the corresponding data having been received, for example, due to having been distributed for receipt and use by the client device), the authentication module 1950 can correlate with two replicas: filter 1960.Q′.1 (RΔ) and filter 1960.Q′.1 (RΣ), to generate statistical values 1962.1 (YΔ) and 1962.2 (YΣ). The authentication module 1950 can then make an authentication determination based on thresholds of YΔ and YΣ, for example, to generate the corresponding authentication output 1947.

In some embodiments, the statistical values 1962.1 (YΔ) and 1962.2 (YΣ) can be generated as a function of some or all of the following information, for example, based on the client device receiving, generating, computing, and/or deriving some or all of the following information of the following table:

| Notation | Definition and Short Description |
|---|---|
| n | Number of chice over a single watermark (i.e, the number of chips in a |
| | ranging code or section or group of ranging codes). |
| r | Number of chips inverted is a single watermark. r can vary to meet specific |
| | design concerns. |
| W | Number of individual watermarks considered together for a single |
| | authentication determination. |
| R | Replica of the original, unwatermarked ranging code. |
| R^{w} | Replica of the authentic watermarked ranging code. |
| R^{-SCER} | Replies elected by the Non-SCER spoofer. |
| R^{HDSCER} | Replies elected by the BDSCER spoofer. |
| R_^{w} | Replica reversed in time for use in a matching convolution filter. |
| F | Sampling rate of the radio involved with the authentication determination. |
| T | Coherent integration time of a single watermark measurement. |
| S | Signal measured over T with sampling to F immediately proceeding |
| | correlation. |
| P | Power of the signal witten a receiver radio immediately proceeding |
| | correlation. |
| σ² | Noise power within a receiver radio immediately proceeding correlation. |
| N | Nomud distribution. |
| Y_{Δ}, Y_{Σ} | Receiver statistical filters utilized for authentication determination and their |
| | random variables |
| s | Number of chips a Non-SCER adversary may elect to invert when attempting |
| | to spool a receiver. |
| H | Hypergeometric random variable relevant to the Non-SCER adversarial |
| | defense. |
| [symbol] (n, r, s) | Hypergeometric distribution. A Non-SCER adversary engaged in a spoofing |
| | attack generating false signals with a randomly selected chips inverted will |
| | guess [symbol] ~ [symbol] (n, r, s) correctly for each watermark. |
| α | Clap estimation decision boundary elected by the adversary when utilizing a |
| | BPSK model during chip estimation of the signal. |
| B(r, p) | The binomial distribution with r draws with draw success probability p. |
| [symbol] | Adversary's error probability when estimating an inverted chip. |
| [symbol] | Adversary's error probability when estimating a noninverted chip. |
| B [symbol] | Binomial random variable of the inverted chip estimation successes. |
| B [symbol] | Binomial random variable of the noninverted chip estimation failures. |
| [symbol] Δ,-SCER, | Linear functions that transform the support of H to Y for mathematical |
| [symbol] Σ,-SCER | conciseness, conditioned on the scheme parameters |
| [symbol] Δ.HDSCER, | Linear functions that transform the support of B to Y for mathematical |
| [symbol] Σ.HDSCER | conciseness, conditioned on the scheme parameters. |

[symbol]

indicates data missing or illegible when filed

For example, filters 1960.Q′.1 and 1960.Q′.2 are linear time-invariant filters where a corresponding receiver samples evenly with frequency F over a coherent integration T. Filters 1960.I and 1960.Q (e.g. implemented via applying a corresponding internal signal 1273) can be implemented as a replica of the unmodified ranging code (e.g. unmodified PRN codes 1908.I and 1908.Q, respectively, for example, implemented as resamplings of and/or sections of these PRN codes 1908) for examination, which can be implemented as R, where R∈{−1, 1}_{FT}. R can cover a single watermark, for example, based on deriving from the original ranging code containing n chips (or chip sections).

The authentic watermarked signal can have r chips inverted among the n chips, where R_{w}∈{−1, 1}_{FT} is the watermarked replica. R_{w} is optionally known to any entity except the navigation processing system 300 (and/or other satellites/nodes implementing satellite constellation system 100 and/or of a corresponding navigation service) until after the distribution of the authentication key data (e.g. via distribution of a corresponding hash point as described in further detail herein).

In some embodiments, filter 1960.Q′.1 (RΔ) and filter 1960.Q′.1 (RΣ) are assembled as two linear time-invariant (LTI) filters, for example, defined as follows:

R_{Δ}=R_^{w}−R_;

R_{Σ}=R_^{w}+R_.

The statistical values 1962.1 (YΔ) and 1962.2 (YΣ) can be based on a corresponding correlation of the signal with each of these two replicas (e.g. implemented via two corresponding internal signals 1273), which can be the impulse responses of the respective filters 1960.Q′.1 and 1960.Q′.2. In some embodiments, these are implemented as LTI filters producing matching convolutions (e.g. each replica as a _ subscript to note that the filter convolves a reversed-in-time replica).

In some embodiments, gain 1961.1 (kΔ) and gain 1962.2 (kΣ) can be applied in generating the respective statistical values, for example, defined as a function of power (P), which can be estimated via a corresponding estimation process. For example, gains 1961.1 (kΔ) and 1962.2 (kΣ) are defined as follows:

$${k}_{Δ} = \frac{1}{{‖ {R}^{w} - R ‖}_{1}} \frac{1}{\sqrt{P}} = \frac{1}{2 r} \frac{n}{FT} \frac{1}{\sqrt{P}} ;$$

$${k}_{\sum } = \frac{1}{{‖ {R}^{w} - R ‖}_{1}} \frac{1}{\sqrt{P}} = \frac{1}{2 ( n - r )} \frac{n}{FT} \frac{1}{\sqrt{P}} .$$

In some embodiments, a digital receiver is implemented to convert the signal analog measurement into quantization levels, and, or a gain stage is applied prior to this conversion to ensure the digital representation avoids saturation. In some embodiments, these effects can be accounted for based on assuming that the signal can be any real number for mathematical conciseness purposes.

The statistical values 1962.1 (YΔ) and 1962.2 (YΣ) can be generated based on applying these gains 1961.1 (kΔ) and 1962.2 (kΣ) to the respective filters 1960.Q′.1 (RΔ) and filter 1960.Q′.1 (RΣ), respectively, in processing the raw signal samples 1958 of the navigation signal Q component 1542 stored memory 1959. For example, statistical value 1962.1 (YΔ) is generated based on applying kΔ·RΔ to the raw signal samples 1958 of the navigation signal Q component 1542 and/or 1962.2 (YΣ) is generated based on applying kΣ·RΣ to the raw signal samples 1958 of the navigation signal Q component 1542.

While not illustrated, alternatively or additionally to processing raw signal samples 1958 of the navigation signal Q component 1542 stored in memory 1959 to perform the authentication of FIG. 12L, the processing raw signal samples 1958 of the navigation signal I component 1541 are stored in memory 1959 for processing by authentication module 1950 in a same or similar fashion, instead of or in addition to performing such processing on the raw signal samples 1958 of the navigation signal Q component 1542.

FIG. 12M illustrates an embodiment of a navigation processing system 300 that implements authentication data generator module 1901 via a watermarking module 1931 that generates watermarking seed data 1932 via applying a watermarking seed generator module 1933 to a hash point 1934, where this watermarking seed data 1932 is applied to one or more PRN codes 1908 (e.g. PRN codes 1908.I and 1908.Q) to generate one or more respective spreading sequences 1909 (e.g. watermarking spreading sequences 1909.I and/or 1909.Q), for example, as discussed in conjunction with FIG. 12G and/or 12I. For example, the hash point 1934 implements some of all of the authentication key data 1905, is derived from the authentication key data 1905, and/or is utilized to generate the authentication key data. For example, the corresponding watermarking seed data 1932 is generated as output of deterministic function performed upon the hash point 1934 (e.g. the particular set of r chips of the total set of chips n to be inverted in generated the watermarked spreading sequence 1909 is thus selected as output of a deterministic function performed upon the hash point 1934, for example, in accordance with applying the combinatorial watermarking scheme). The hash point 1934 can be implemented in accordance with applying a TESLA authentication scheme and/or can implement any embodiment of a hash point described herein.

Some or all features and/or functionality of navigation processing system 300 of FIG. 12M can implement the navigation processing system 300 of FIG. 12A, 12G, and/or any embodiment of a navigation processing system, satellite processing system, satellite, and/or node described herein. Some or all features and/or functionality of navigation signal 240 of FIG. 12M can implement the navigation signal of FIG. 12A, 12G, and/or any embodiment of a navigation signal described herein.

FIG. 12N illustrates an embodiment of a client device that implements authentication module 1950 based on implementing a watermarking seed data generator module 1933′, which can be implemented in a same or similar fashion as the watermarking seed data generator module 1933′ of FIG. 12M to generate the watermarking seed data 1932 utilized by the authentication module 1950. Some or all features and/or functionality of client device 160 of FIG. 12N can implement the client device of FIG. 12B, 12H, and/or any embodiment of a client device, receiver, and/or node described herein. For example, the client device 160 of FIG. 12N is configured to receive, authenticate, and/or otherwise process the navigation signal 240 generated and transmitted via the navigation processing system 300 of FIG. 12M and/or any other embodiment of a navigation signal described herein.

FIG. 12O illustrates an embodiment of a navigation processing system 300 that implements a hash path generator module 1942 to generate a hash pash 1943 that includes a plurality of hash points 1934, where watermarking seed data generator module 1913 can generate watermarking seed data 1932.i for a given hash point 1934.i for use in generating navigation signal 240 during a given corresponding temporal period Tj, for example, as defined in hash point usage scheduling data 1941. Some or all features and/or functionality of navigation processing system 300 of FIG. 12O can implement the navigation processing system 300 of FIG. 12A, 12M, and/or any embodiment of a navigation processing system, satellite processing system, satellite, and/or node described herein. Some or all features and/or functionality of navigation signal 240 of FIG. 12O can implement the navigation signal of FIG. 12A, 12M, and/or any embodiment of a navigation signal described herein.

Hash path generator module 1942 can generate the plurality of hash points 1934.0-1934.P via iteratively applying a hash point function (HPF) 1944 to an initial hash point 1934.0. The hash point function 1944 can be implemented as a predetermined deterministic function 1944 (e.g. a hash function and/or another one-way function). Each subsequently generated hash point 1934.i+1 is generated via performing the hash point function 1944 upon an immediately prior hash point 1934.i. A length of the hash path can include a predetermined fixed number of hash points. A forward ordering of the hash path 1943 as used herein can correspond to an ordering from hash point 1934.0 to hash point 1934.P, corresponding to the ordering in which the respective hash points 1934 were generated via the iterative performance of the hash point function 1944. The hash path can be generated in accordance with applying a TESLA authentication scheme and/or can implement any embodiment of a hash point described herein.

During a given time span, the navigation processing system 300 can update which given hash point 1934 of the hash path 1943 is bused to generate its navigation signal 240 during different temporal periods within the time span (e.g. based on updating the corresponding watermarking spreading sequence 1909 utilized to generate the navigation signal 240 as a function of which hash point is to be applied during the respective temporal period). For example, the given time span corresponds to a fixed length time span, such as day or other fixed length of time. Such scheduling of which hash point is used over different temporal periods of the time span can be dictated in hash point usage scheduling data 1941, indicating which of the plurality of hash points 1934 of the hash path 1943 is to be applied during each of a plurality of temporal periods T0-TP (e.g. a contiguous plurality of temporal periods that collectively make up the time span, such as a contiguous plurality of fixed length time frames all of the same length of time). Each of the plurality of hash points of the hash path can be applied in a corresponding one of the plurality of temporal periods. In particular, the plurality of hash points can be scheduled to be applied over the time span in an ordering corresponding to the reverse ordering of the forward ordering in which they were generated (e.g. the last generated hash point 1934.P is applied first in the first temporal period T0, the penultimately generated hash point 1934.P−1 is applied second in the second temporal period T1, etc., until the second generated hash point 1934.1 is applied penultimately in the penultimate temporal period TP−1, and finally the first generated hash point 1934.0 is applied last in the last temporal period TP). Based on the hash point function 1944 being implemented as a one way function, client devices can derive prior-utilized hash points from prior temporal periods from a given hash point of the current temporal period (and/or most recently received hash point issued to the client device) due to being later in the forward ordering of the hash path and thus being reproducible via one or more executions of the given current/most recently received hash point, but cannot derive any future hash points for future temporal periods from the given current/most recently received hash point due to being earlier in the forward ordering of the hash path (e.g. the client device thus must wait until such hash points for future temporal periods are shared to be able to apply these hash points for authenticating the navigation signal). The navigation signal 240 can be generated over subsequent time spans via applying new hash paths over their plurality of temporal periods, where such new hash paths based are generated from different initial hash points 1934.0.

FIG. 12P illustrates an embodiment where some or all satellites 110/nodes of satellite constellation system 100 and/or a corresponding navigation service implement the same hash path 1943 and same hash path usage scheduling data 1941 in conjunction with applying a constellation-wide hash path usage scheduling data 1941 over the time span. For example, all satellites 110/nodes of satellite constellation system 100 and/or a corresponding navigation service implement navigation processing module 300 of FIG. 12O to each determine the hash path 1943 from a same initial hash point 1934.0 (e.g. the initial hash point 1934.0 for a given time span is received by/determined by all of the navigation processing modules 300 via a same mechanism). Some or all navigation processing systems 300 of FIG. 12P can be separately implemented via some or all features and/or functionality of the navigation processing system 300 of FIG. 12A, 12O and/or any other embodiment of a navigation processing system, satellite processing system, satellite, and/or node described herein. Some or all client devices of FIG. 12P can be separately implemented via some or all features and/or functionality of the client device of FIG. 12B, FIG. 12N and/or any other embodiment of a client device, receiver, and/or node described herein.

In a given temporal period Tj of a given time span, all satellites 110/nodes of satellite constellation system 100 and/or a corresponding navigation each apply the same hash point 1934.i of the given hash path 1943 in generating their respective navigation signal 240. Any given client device 160 having knowledge of the hash point 1934.i can thus utilize this same hash point 1934.i to authenticate all navigation signals 240 it receives (e.g. based on which respective nodes/satellites are in range at the given time). A given client device can optionally utilize this hash point 1934.i to derive previously utilized hash points 1934.i+1, 1934.i+2, etc. (e.g. in the case that these prior hash points were not received directly by the client device 160), via application of the hash path function 1944, for use in retroactively authenticating previously received navigation signals 240 (e.g. based on having cached some or all of the corresponding signal).

Some or all different navigation processing systems 300 of the different satellites/nodes can have different corresponding PRN codes (and/or different sets of corresponding PRN codes for their different signal components), for example, based on whether or not they are on the same orbital plane. Thus, while two different navigation processing systems apply the same hash point 1934.i during a given temporal period, their respective watermarked spreading sequences 1909.i can be different due to the respective watermarking seed data 1932.i being applied to different PRN codes 1908 (e.g. due to the respective satellites being on different orbital planes). Any given client device 160 can utilize a plurality of PRN codes 1908 of the satellite constellation system and/or corresponding navigation service in authenticating and processing respective navigation signals 240, enabling the given client device to identify a corresponding orbital plane from which a given navigation signal is received and/or otherwise distinguish between different nodes/satellites transmitting different navigation signals with different PRN codes.

FIG. 12Q illustrates an embodiment of a navigation processing system 300 that implements a data frame generator module 1971 to include a hash point 1934.i−1 (e.g. scheduled for an upcoming temporal period Tj+1 as dictated by the ordering of the hash path and/or the hash point usage scheduling data 1941) in one or more data frames 1820 for inclusion in a navigation data stream 1505.Tj for inclusion in navigation signal 240.Tj transmitted during a given temporal period Tj (e.g. the temporal period Tj during which an immediately subsequent hash point 1934.i in the forward ordering of the hash path is utilized to generate watermarking seed data 1932.i to generate navigation signal 240.Tj). The data frames 1820 can alternatively or additionally include navigation data 1935 (e.g. of corresponding navigation messages) and/or can be implemented via some or all features and/or functionality of any embodiment of data frames described herein to implement some or all features and/or functionality of any embodiment of navigation data stream 1505 described herein. Such distribution of hash points for future temporal periods in data frames of navigation data stream 1505 navigation signal 240 can be dictated by a hash point distribution plan 1970, indicating if and/or when some or all hash points of the hash path be included in navigation data stream 1505 of the navigation data transmitted via the navigation processing system 300. Some or all features and/or functionality of navigation processing system 300 of FIG. 12Q can implement the navigation processing system 300 of FIG. 12A, 12O, and/or any embodiment of a navigation processing system, satellite processing system, satellite, and/or node described herein. Some or all features and/or functionality of navigation signal 240 of FIG. 12Q can implement the navigation signal of FIG. 12A, 12O, and/or any embodiment of a navigation signal described herein.

In some embodiments, multiple data streams are implemented across multiple data signal components, for example, as discussed in conjunction with FIG. 12W, where data frames of the navigation data stream 1505 of one data signal component (e.g. a precision data signal component) include only the navigation data 1935 and no hash points, and where data frames of a different data signal component (e.g. an acquisition data signal component) include the hash points 1934 and no navigation data 1935.

FIG. 12R illustrates an embodiment of a client device that implements watermarking seed data generator module 1933′ based on applying a given hash point 1934.i (e.g. to authenticate navigation signals 240 generated and/or received during a corresponding temporal period Tj) based on this given hash point 1934.i having been previously extracted from a navigation data stream (e.g. based on having been received and/or transmitted in a navigation signal 240 during temporal period Tj−1 by the same or different navigation processing system from which the hash point 1934.i was received). In processing navigation signal 240 in response to its authentication via hash point 1934.i, a navigation data extraction module 1956 can be applied to process navigation data stream 1505, from which a hash point 1934.i−1 to be applied to authenticate subsequently received navigation data can be extracted from a given data frame 1820.k. This updated hash point 1934.i−1 can similarly be applied to authenticate subsequent navigation data (e.g. navigation data 240.Tj+1 generated and/or transmitted in temporal period Tj+1 by the same or different navigation processing system from which the hash point 1934.i−1 was received), which can be processed (in response to being successfully authenticated via applying hash point 1934.i−1) to extract a further updated hash point for a further subsequent temporal period, and so on. Some or all features and/or functionality of client device 160 of FIG. 12R can implement the client device of FIG. 12B, 12N, and/or any embodiment of a client device, receiver, and/or node described herein. For example, the client device 160 of FIG. 12R is configured to receive, authenticate, and/or otherwise process the navigation signal 240 generated and transmitted via the navigation processing system 300 of FIG. 12Q and/or any other embodiment of a navigation signal described herein.

FIG. 12S illustrates a navigation signal generation and transmission system 1230 of a navigation processing system 300 applies a hash point distribution plan 1977 dictating when different hash points 1934 of the hash path be distributed via inclusion in different signal components of the navigation signal 240. Some or all features and/or functionality of navigation processing system 300 of FIG. 12S can implement the navigation processing system 300 of FIG. 12A, 12Q, and/or any embodiment of a navigation processing system, satellite processing system, satellite, and/or node described herein. Some or all features and/or functionality of navigation signal 240 of FIG. 12S can implement the navigation signal of FIG. 12A, 12Q, and/or any embodiment of a navigation signal described herein.

For example, a first proper subset of the plurality of hash points 1934 of the hash path 1943 are included in the hash point distribution data 1977.I for distribution in data frames of a first data stream included in the navigation signal I component 1541 during a first proper subset of the plurality of temporal periods, and a second proper subset of the plurality of hash points 1934 of the hash path 1943 are included in the hash point distribution data 1977.Q for distribution in data frames of a second data stream included in the navigation signal Q component 1542 during a second proper subset of the plurality of temporal periods. The first proper subset and second proper subset can be mutually exclusive, where each hash point 1934 distributed by the navigation processing system 300 are distributed in the data stream of only one of the signal components (e.g. during only one respective temporal period of the time span). In some embodiments, the first and second proper subset are optionally collectively exhaustive based on the navigation processing system 300 distributing all of the hash points of the hash path in its navigation signal. Alternatively, in other embodiments, a set difference between the full plurality of hash points of the hash path and a set union of the first and second proper subset is optionally non-null based on the navigation processing system 300 not distributing all of the hash points of the hash path in its navigation signal (e.g. the hash points not distributed by a given navigation processing system 300 are distributed by one or more other navigation processing systems).

In this example, a given navigation processing system 300 distributes at least hash points 1934.i, 1934i+w1, and 1934.i−w2. Hash points 1934.i−1 is distributed in navigation signal I component 1541 (e.g. in a corresponding data frame 1820 of a corresponding data stream of the navigation signal I component 1541, such as navigation data stream 1505) during temporal period Tj (e.g. where the hash point 1934.i is applied to the navigation signal during this temporal period Tj). Hash points 1934.i−w1 and 1934.i−w2 are distributed in navigation signal Q component 1542 (e.g. in a corresponding data frame 1820 of a corresponding data stream of the navigation signal Q component 1542, for example, based on both the navigation signal I component 1541 and navigation signal Q component 1542 being implemented to include their own data stream, where the corresponding data stream of the navigation signal Q component 1542 optionally includes navigation data as well as the corresponding data stream of the navigation signal I component 1541 and/or where the corresponding data stream of the navigation signal Q component 1542 optionally does not include navigation data based on only the navigation signal I component being implemented to include the navigation data), for example, where w1 and w2 are positive integers, where hash point 1934.i+w2 is distributed before hash points 1934.i−1 and 1934.i−w1 in temporal period Tj−w2 (e.g. where the hash point 1934+w2+1 is applied to the navigation signal during this temporal period Tj−w2) and/or where hash point 1934.i−w1 is distributed after hash points 1934.i−1 and 1934.i−w1 in temporal period Tj+w1 (e.g. where the hash point 1934−w1+1 is applied to the navigation signal during this temporal period Tj+w1).

FIGS. 12T and 12U illustrate an embodiment of a client device that extracts different hash points from different signal components of one or more navigation signals 240 received over time. Some or all features and/or functionality of client device 160 of FIG. 12T and/or 12U can implement the client device of FIG. 12B, 12R, and/or any embodiment of a client device, receiver, and/or node described herein. For example, the client device 160 of FIG. 12T and/or 12U is configured to receive, authenticate, and/or otherwise process the navigation signal 240 generated and transmitted via the navigation processing system 300 of FIG. 12S and/or any other embodiment of a navigation signal described herein.

As illustrated in FIG. 12T, in processing navigation signal 240 in response to its authentication via hash point 1934.i, a navigation data extraction module 1956 can be applied to process data frames 1820.I of a data stream of the navigation signal I component 1541 generated and/or received during temporal period Tj, from which a hash point 1934.i−1 to be applied to authenticate subsequently received navigation data can be extracted from a given data frame. This updated hash point 1934.i−1 can similarly be applied to authenticate subsequent navigation data (e.g. navigation data 240.Tj+1 generated and/or transmitted in temporal period Tj+1 by the same or different navigation processing system from which the hash point 1934.i−1 was received), which can be processed (in response to being successfully authenticated via applying hash point 1934.i−1) to extract a further updated hash point for a further subsequent temporal period, and so on. In some embodiments, the navigation data extraction module 1956 is applied to extract hash point 1934.i−1 from the navigation signal I component 1541 in response to the authentication module 1950 having authenticated the navigation signal 240 via processing only the navigation signal Q component 1542, for example, as discussed in conjunction with the embodiment of FIG. 12J. In some embodiments, the navigation data extraction module 1956 is applied to extract hash point 1934.i−1 from the navigation signal I component 1541 in response to the authentication module 1950 having authenticated the navigation signal 240 via processing only the navigation signal I component 1541, for example, as discussed in conjunction with the embodiment of FIG. 12K.

As illustrated in FIG. 12U, in processing navigation signal 240 in response to its authentication via hash point 1934.i−w1+1, a navigation data extraction module 1956 can be applied to process data frames 1820.Q of a data stream of the navigation signal Q component 1542 generated and/or received during temporal period tj+w1, from which a hash point 1934.i−w1 to be applied to authenticate subsequently received navigation data can be extracted from a given data frame. This updated hash point 1934.i−w1 can similarly be applied to authenticate subsequent navigation data (e.g. navigation data 240.Tj+w1+1 generated and/or transmitted in temporal period Tj+w1+1 by the same or different navigation processing system from which the hash point 1934.i−w1 was received), which can be processed (in response to being successfully authenticated via applying hash point 1934.i−w1) to extract a further updated hash point for a further subsequent temporal period, and so on. In some embodiments, the navigation data extraction module 1956 is applied to extract hash point 1934.i−w1 from the navigation signal Q component 1542 in response to the authentication module 1950 having authenticated the navigation signal 240 via processing only the navigation signal Q component 1542, for example, as discussed in conjunction with the embodiment of FIG. 12J. In some embodiments, the navigation data extraction module 1956 is applied to extract hash point 1934.i−w1 from the navigation signal Q component 1542 in response to the authentication module 1950 having authenticated the navigation signal 240 via processing only the navigation signal I component 1541, for example, as discussed in conjunction with the embodiment of FIG. 12K.

FIG. 12V illustrates an embodiment of hash point distribution data 1977 shared across multiple navigation processing systems 300 to coordinate constellation-wide distribution of hash points over time across different signal components of navigation signals transmitted via different satellites and/or nodes. For example, the satellite constellation system 100 is divided into a plurality of groups, for example, by satellite/node, by phase (i.e. signal component), and/or, while not illustrated, by frequency (e.g. high band navigation signal vs low band navigation signal). Members of a given group all distribute a corresponding subset of the set of hash points (e.g. in a respective data stream of a respective signal component of the group and/or of a respective frequency band of the group) within a corresponding subset of the plurality of temporal periods (e.g. implemented as a plurality of fixed length time frames 1992). Some or all features and/or functionality of the hash point distribution plan 1977 of FIG. 12V can implement any embodiment of the hash point distribution plan described herein.

For example, a first group corresponds to an I signal component group 1990.I.1 and includes a first subset of satellites/nodes of the constellation; a second group corresponds to an I signal component group 1990.I.2 and includes a second subset of satellites/nodes of the constellation; and/or a third group corresponds to an I signal component group 1990.I.3 and includes a third subset of satellites/nodes of the constellation. The first, second, and third subsets can be mutually exclusive and/or collectively exhaustive with respect to the plurality of nodes/satellites of the satellite constellation system 100. The first, second, and third groups release their respective hash points in the respective temporal periods in their navigation signal I component 1541.

Continuing with this example, a fourth group corresponds to a Q signal component group 1990.Q.1 and includes a fourth subset of satellites/nodes of the constellation (which can be the same or different from the first, second, or third subset of satellites/nodes); a fifth group corresponds to a Q signal component group 1990.Q.2 and includes a second subset of satellites/nodes of the constellation (which can be the same or different from the first, second, or third subset of satellites/nodes); and/or a sixth group corresponds to a Q signal component group 1990.Q.3 and includes a third subset of satellites/nodes of the constellation (which can be the same or different from the first, second, or third subset of satellites/nodes). The fourth, firth, and sixth subsets can be mutually exclusive and/or collectively exhaustive with respect to the plurality of nodes/satellites of the satellite constellation system 100. The fourth, firth, and sixth groups each release their respective hash points in the respective temporal periods in their navigation signal Q component 1542.

FIGS. 12W and 12X present embodiments of a navigation signal 240 that implements example signal components 1995, for example, in conjunction with implementing a dual-channel architecture. Some or all features and/or functionality of some or all example signal components 1995 of FIGS. 12W and/or 12X can implement any embodiment of a navigation signal 240 described herein and/or any embodiment of a particular navigation signal component described herein. For example, some or all features and/or functionality of generating and/or processing navigation signal I component 1541 and/or navigation signal Q component described herein can be applied to generate and/or process any signal components 1995 of FIGS. 12W and/or 12X, where navigation signal 240 is implemented to implement some or all signal components 1995 of FIGS. 12W and/or 12X: instead of navigation signal I component 1541 and/or navigation signal Q component 1542; as navigation signal I component 1541 and/or as navigation signal Q component 1542; and/or in addition to navigation signal I component 1541 and/or navigation signal Q component 1542. As a particular example, at least one additional signal component of navigation signal 240 is implemented as an additional signal component utilized for authentication (e.g. processed via authentication module 1950 to perform authentication-based processing as described herein) for inclusion in navigation signal 240 in addition to a data signal component (e.g. navigation signal I component 1541, for example, implemented as precision data signal component 1995.3) and/or a pilot signal component (e.g. navigation signal Q component 1542, for example, implemented as precision ranging signal component 1995.4), for example, based on this at least one additional signal component being perfectly in-phase or quadrature with the data signal component and/or a pilot signal component, where this at least one additional signal component implements some or all features and/or functionality of any of the acquisition ranging signal component 1995.1, the acquisition data signal component 1995.2 of FIG. 12W, the signal component of FIG. 12X, and/or any other signal component 1995.

As illustrated in FIG. 12W, multiple signal components 1995.1, 1995.2, 1995.3 and 1995.4 are modulated together. For example, this plurality of signal components includes two data signals (e.g. 1995.2 and 1995.3) and two ranging signals (e.g. 1995.1 and 1995.4).

In some embodiments a receiver (e.g. implemented via client device 160) uses a public acquisition ranging code (e.g., a corresponding PRN code 1908 and/or other spreading code) to acquire and/or and track an acquisition signal (e.g. that includes acquisition ranging signal component 1995.1 and/or acquisition data signal component 1995.2) From the data on the acquisition signal 1995.2, the receiver can recover a hash point that enables the receiver to track the authenticated ranging signal 1995.1 and receive the data on the precision signal (e.g. that includes precision data signal component 1995.3 and/or precision data signal component 1995.4). From each hash point, the receiver derives some or all of the PRF ranging codes of the entire constellation to compute authenticated ranges. In some embodiments, as much data is moved from the acquisition data to the precision data as possible so that the hash point cadence can be as fast as possible, decreasing TTA. In some embodiments, the acquisition data only contains hash points and the precision data includes all other data (e.g. navigation data).

In some embodiments, multiple acquisition data signals are implemented, where hash points are distributed in multiple signal components (e.g. via hash point distribution plan data 1977) implemented via multiple data signal components, such as multiple data signal components of the acquisition signal (e.g. an in-phase acquisition data signal component 1995.2.I and a quadrature acquisition data signal component 1995.2.Q) and/or between the acquisition data signal component 1995.2 and the precision data signal component 1995.3).

Alternatively or in addition, some or all hash points can be distributed via a network service as illustrated in FIG. 12X, for example, to reduce bandwidth requirements needed to distribute hash points within the navigation signal 240 itself. The signal 240 signal can include signal component 1995.1, for example, corresponding to acquisition ranging, for example, alternatively or in addition to the precision signal components 1995.3 and 1995.4 of FIG. 12W, where the signal 240 does not include acquisition data signal component 1995. In some embodiments, the signal 240 includes the signal component 1995.2 of FIG. 12W to include some or all of the hash points (e.g. only some hash points as assigned for distribution as illustrated in FIG. 12V), where some or all other hash points are distributed by the network service only and/or by the network service in addition to other acquisition data signal components transmitted via other satellites. For example, the plurality of groups distributing hash points at different times includes a network group, and/or the network is included in one or more of the groups.

FIGS. 12Y-12Z illustrate example methods for execution. Some or all steps of FIGS. 12Y and/or 12Z can be executed by: a data frame receival and processing system such as data frame receival and processing system 1802, a client device such as client device 160, a receiver module, a processing system 1920, a node of a systems such as a node of satellite constellation system 100, and/or via at least one processor, at least one memory, and/or at least one receiver (e.g. of any computing device). Some or all steps of FIGS. 12Y and/or 12Z can be performed in conjunction with implementing some or all features and/or functionality presented in conjunction with one or more of the FIGS. 12A-12V, and/or in in conjunction with implementing some or all features and/or functionality presented in conjunction with one or more of the FIGS. 1-11B.

In addition or the alternative to any of the foregoing examples (including examples of a satellite, a client device, performing operations and/or implementing the method of FIGS. 12Y and/or 12Z), a satellite (e.g. of a of a Low Earth Orbit (LEO) satellite constellation) comprises: at least one processor configured to execute operational instructions that cause the at least one processor to perform operations; and/or a navigation signal transmitter configured to broadcast the navigation signal for receipt by at least one client device.

In addition or the alternative to any of the foregoing examples (including examples of a satellite, a client device, performing operations and/or implementing the method of FIGS. 12Y and/or 12Z), a client device (e.g. comprises: at least one receiver antenna configured to receive at least one navigation signal transmitted by at least one satellite (e.g. of a LEO satellite constellation); and/or at least one processor configured to execute operational instructions that cause the at least one processor to perform operations. In addition or the alternative to any of the foregoing examples (including examples of a satellite, a client device, performing operations and/or implementing the method of FIGS. 12Y and/or 12Z), the client device is configured to perform some or all steps of FIGS. 12Y, and/or 12Z (e.g. in conjunction with receiving the at least one navigation signal and/or performing some or all of its operations).

In addition or the alternative to any of the foregoing examples (including examples of a satellite, a client device, performing operations and/or implementing the method of FIGS. 12Y and/or 12Z), multiple different client devices, processing systems, receivers and/or nodes (e.g. of a same system/service) can each be implemented to perform some or all steps of FIGS. 12Y, and/or 12Z, independently and/or simultaneously, with or without coordination.

In addition or the alternative to any of the foregoing examples (including examples of a satellite, a client device, performing operations and/or implementing the method of FIGS. 12Y and/or 12Z), some or all of step 2914 and/or step 2916 of FIG. 12Y can be performed, for example, by and/or via utilizing a client device 160, processing system 1904, a receiver 1920, and/or a node. In addition or the alternative to any of the foregoing examples (including examples of a satellite, a client device, performing operations and/or implementing the method of FIGS. 12Y and/or 12Z), some or all of step 2914 and/or step 2916 of FIG. 12Y can be performed (e.g. by client device 160, processing system 1904, a receiver 1920, and/or a node) to process a navigation signal transmitted in step 2912 of FIG. 29X1 (e.g. by a satellite, a satellite processing system, and/or a navigation signal generation and transmission module 1230) and/or transmitted in any other step and/or via any other process described herein. Step 2914 includes authenticating the first signal component based on processing the second signal component and the watermarking seed data. Step 2916 includes, in response to authenticating the first signal component, determining state data of the at least one client device based on processing the first signal component.

In addition or the alternative to any of the foregoing examples (including examples of a satellite, a client device, performing operations and/or implementing the method of FIGS. 12Y and/or 12Z), a client device comprises at least one receiver antenna configured to receive a navigation signal transmitted by a satellite system, wherein the navigation signal is generated based on based on modulating the first signal component and the second signal component, where the first signal component corresponding to a first phase is generated based on navigation data and a first watermarked spreading sequence, where the second signal component corresponding to a second phase is generated based on a second watermarked spreading sequence; wherein the first watermarked spreading sequence and the second watermarked spreading sequence are generated based on watermarking seed data, and/or where the navigation data is generated based on orbital state data.

In addition or the alternative to any of the foregoing examples (including examples of a satellite, a client device, performing operations and/or implementing the method of FIGS. 12Y and/or 12Z), the client device further comprises at least one processor configured to execute operational instructions that cause the at least one processor to perform operations that include: authenticating the first signal component based on processing the second signal component and the watermarking seed data; and/or, in response to authenticating the first signal component, determining state data of the at least one client device based on processing the first signal component.

In addition or the alternative to any of the foregoing examples (including examples of a satellite, a client device, performing operations and/or implementing the method of FIGS. 12Y and/or 12Z), the first signal component and the second signal component are modulated based on applying a bandwidth-efficient modulation scheme to cross-correlate the first signal component and the second signal component.

In addition or the alternative to any of the foregoing examples (including examples of a satellite, a client device, performing operations and/or implementing the method of FIGS. 12Y and/or 12Z), the first signal component corresponds to an in-phase (I) signal component. In addition or the alternative to any of the foregoing examples (including examples of a satellite, a client device, performing operations and/or implementing the method of FIGS. 12Y and/or 12Z), the second signal component corresponds to a quadrature (Q) signal component. In addition or the alternative to any of the foregoing examples (including examples of a satellite, a client device, performing operations and/or implementing the method of FIGS. 12Y and/or 12Z), the second phase corresponds to a 90 degree shift from the first phase.

In addition or the alternative to any of the foregoing examples (including examples of a satellite, a client device, performing operations and/or implementing the method of FIGS. 12Y and/or 12Z), generating the first watermarked spreading sequence is based on applying the watermarking seed data to a first PRN code associated with the first phase. In addition or the alternative to any of the foregoing examples (including examples of a satellite, a client device, performing operations and/or implementing the method of FIGS. 12Y and/or 12Z), generating the second watermarked spreading sequence is based on applying the watermarking seed data to a second PRN code associated with the second phase.

In addition or the alternative to any of the foregoing examples (including examples of a satellite, a client device, performing operations and/or implementing the method of FIGS. 12Y and/or 12Z), the first PRN code includes a first ordered plurality of chips. In addition or the alternative to any of the foregoing examples (including examples of a satellite, a client device, performing operations and/or implementing the method of FIGS. 12Y and/or 12Z), the second PRN code includes a second ordered plurality of chips. In addition or the alternative to any of the foregoing examples (including examples of a satellite, a client device, performing operations and/or implementing the method of FIGS. 12Y and/or 12Z), applying the watermarking seed data to the first PRN code and the second PRN code to generate the first watermarked spreading sequence and the second watermarked spreading sequence is based on performing an inverted chip selection function upon the watermarking seed data to select a proper subset of the first ordered plurality of chips for inversion and to select a proper subset of the second ordered plurality of chips for inversion. In addition or the alternative to any of the foregoing examples (including examples of a satellite, a client device, performing operations and/or implementing the method of FIGS. 12Y and/or 12Z), the first watermarked spreading sequence is generated via inverting the proper subset of the first ordered plurality of chips of the first PRN code, and/or the second watermarked spreading sequence is generated via inverting the proper subset of the second ordered plurality of chips of the second PRN code.

In addition or the alternative to any of the foregoing examples (including examples of a satellite, a client device, performing operations and/or implementing the method of FIGS. 12Y and/or 12Z), the watermarking seed data is generated as a function of one of a sequential plurality of hash points of a hash path.

In addition or the alternative to any of the foregoing examples (including examples of a satellite, a client device, performing operations and/or implementing the method of FIGS. 12Y and/or 12Z), the navigation signal is transmitted over a plurality of consecutive temporal periods based on navigation data generated over the plurality of consecutive temporal periods. In addition or the alternative to any of the foregoing examples (including examples of a satellite, a client device, performing operations and/or implementing the method of FIGS. 12Y and/or 12Z), a plurality of watermarking seed data is generated over the plurality of consecutive temporal periods. In addition or the alternative to any of the foregoing examples (including examples of a satellite, a client device, performing operations and/or implementing the method of FIGS. 12Y and/or 12Z), different ones of the plurality of watermarking seed data are generated based on applying different ones of the sequential plurality of hash points. In addition or the alternative to any of the foregoing examples (including examples of a satellite, a client device, performing operations and/or implementing the method of FIGS. 12Y and/or 12Z), different ones of the plurality of watermarking seed data are applied to generate the first watermarked spreading sequence and the second watermarked spreading sequence during different ones of the plurality of consecutive temporal periods.

In addition or the alternative to any of the foregoing examples (including examples of a satellite, a client device, performing operations and/or implementing the method of FIGS. 12Y and/or 12Z), the sequential plurality of hash points of the hash path are generated based on iterative performance of a predetermined function upon an initial hash point of the sequential plurality of hash points to generate the plurality of hash points one at a time in accordance with a forward ordering of the sequential plurality of hash points from a first hash point in the sequential plurality of hash points to a last hash point in the sequential plurality of hash points. In addition or the alternative to any of the foregoing examples (including examples of a satellite, a client device, performing operations and/or implementing the method of FIGS. 12Y and/or 12Z), each subsequently generated hash point in the sequential plurality of hash points is generated based on iteratively performing a predetermined function upon a previous one of the sequential plurality of hash points. In addition or the alternative to any of the foregoing examples (including examples of a satellite, a client device, performing operations and/or implementing the method of FIGS. 12Y and/or 12Z), the different ones of the plurality of watermarking seed data are applied over the different ones of the plurality of consecutive temporal periods based on, in each subsequent one of the plurality of consecutive temporal periods, applying a subsequent one of the plurality of the plurality of watermarking seed data in an ordering of the plurality of watermarking seed data from a first ordered one of the plurality of watermarking seed data to a last ordered one of the plurality of watermarking seed data. In addition or the alternative to any of the foregoing examples (including examples of a satellite, a client device, performing operations and/or implementing the method of FIGS. 12Y and/or 12Z), the first ordered one of the plurality of watermarking seed data is generated from the last hash point, and/or the last ordered one of the plurality of watermarking seed data is generated from the first hash point, and/or each subsequent one of the plurality of watermarking seed data is generated from a prior one of the sequential plurality of hash points in the forward ordering based on utilizing a reverse ordering of the sequential plurality of hash points to generate the plurality of watermarking seed data.

In addition or the alternative to any of the foregoing examples (including examples of a satellite, a client device, performing operations and/or implementing the method of FIGS. 12Y and/or 12Z), the at least one client device authenticates the first signal component based on determining the one of the sequential plurality of hash points and/or deriving the watermarking seed data based on applying the one of the sequential plurality of hash points. In addition or the alternative to any of the foregoing examples (including examples of a satellite, a client device, performing operations and/or implementing the method of FIGS. 12Y and/or 12Z), the one of the plurality of hash points is determined based on one of: receiving the one of the sequential plurality of hash points; or receiving another one of the sequential plurality of hash points and, based on the another one of the sequential plurality of hash points being serially before the one of the plurality of hash points in a forward ordering of the plurality of hash points computing the one of the sequential plurality of hash points via applying the predetermined function to the another one of the sequential plurality of hash points.

In addition or the alternative to any of the foregoing examples (including examples of a satellite, a client device, performing operations and/or implementing the method of FIGS. 12Y and/or 12Z), the at least one client device authenticates the first signal component during one of the consecutive plurality of temporal periods. In addition or the alternative to any of the foregoing examples (including examples of a satellite, a client device, performing operations and/or implementing the method of FIGS. 12Y and/or 12Z), a plurality of data frames of a data stream are generated to include the navigation data and at least some of the sequential plurality of hash points over the consecutive plurality of temporal periods. In addition or the alternative to any of the foregoing examples (including examples of a satellite, a client device, performing operations and/or implementing the method of FIGS. 12Y and/or 12Z), the first signal component is generated to include the data stream. In addition or the alternative to any of the foregoing examples (including examples of a satellite, a client device, performing operations and/or implementing the method of FIGS. 12Y and/or 12Z), based on processing the first signal component of the navigation signal received during a prior one of the consecutive plurality of temporal periods, one of: the one of the sequential plurality of hash points is extracted from one of the plurality of data frames of the data stream via processing the first signal component received during the prior one of the consecutive plurality of temporal periods; or the another one of the sequential plurality of hash points is extracted from the one of the plurality of data frames via processing the first signal component received during the prior one of the consecutive plurality of temporal periods.

In addition or the alternative to any of the foregoing examples (including examples of a satellite, a client device, performing operations and/or implementing the method of FIGS. 12Y and/or 12Z), each of the plurality of watermarking seed data is applied for a corresponding one of the plurality of consecutive temporal periods based on: inverting a proper subset of chips of a first ordered plurality of chips of a first PRN code associated with the first phase to generate the first watermarked spreading sequence based on the proper subset of chips being selected via performing an inverted chip selection function upon the each of the plurality of watermarking seed data; and/or inverting a second proper subset of chips of a second ordered plurality of chips of a second PRN code associated with the second phase to generate the second watermarked spreading sequence based on the proper subset of chips being selected via performing the inverted chip selection function upon of the each of the plurality of watermarking seed data. In addition or the alternative to any of the foregoing examples (including examples of a satellite, a client device, performing operations and/or implementing the method of FIGS. 12Y and/or 12Z), a same fixed number of chips of the first ordered plurality of chips and the second ordered plurality of chips are inverted for all of the plurality of consecutive temporal periods, and wherein different proper subsets of the first ordered plurality of chips and second ordered plurality of chips are inverted for different ones of the plurality of consecutive temporal periods based on applying the inverted chip selection function upon to different watermarking seed data of the plurality of watermarking seed data corresponding to the different ones of the plurality of consecutive temporal periods.

In addition or the alternative to any of the foregoing examples (including examples of a satellite, a client device, performing operations and/or implementing the method of FIGS. 12Y and/or 12Z), a plurality of satellites of the Low Earth Orbit (LEO) satellite constellation each broadcast a corresponding navigation signal. In addition or the alternative to any of the foregoing examples (including examples of a satellite, a client device, performing operations and/or implementing the method of FIGS. 12Y and/or 12Z), the at least one client device is configured to receive a plurality of navigation signals from the plurality of satellites. In addition or the alternative to any of the foregoing examples (including examples of a satellite, a client device, performing operations and/or implementing the method of FIGS. 12Y and/or 12Z), the wherein the plurality of satellites includes the satellite, wherein the plurality of navigation signals includes the navigation signal, wherein the state data for the client device is generated based on processing the plurality of navigation signals, wherein each of the plurality of satellites derives corresponding watermark seed data from constellation-wide watermark seed data utilized by all of the plurality of satellites, and wherein the satellite derives the watermark seed data from the constellation-wide watermark seed data.

In addition or the alternative to any of the foregoing examples (including examples of a satellite, a client device, performing operations and/or implementing the method of FIGS. 12Y and/or 12Z), a same watermarking seed of the watermarking seed data is applied to the first watermarked spreading sequence and the second watermarked spreading sequence.

In addition or the alternative to any of the foregoing examples (including examples of a satellite, a client device, performing operations and/or implementing the method of FIGS. 12Y and/or 12Z), a first watermarking seed of the watermarking seed data is applied to the first watermarked spreading sequence, and/or a second watermarking seed of the watermarking seed data is applied to the second watermarked spreading sequence.

In addition or the alternative to any of the foregoing examples (including examples of a satellite, a client device, performing operations and/or implementing the method of FIGS. 12Y and/or 12Z), the navigation signal further facilitates the at least one client device to: authenticate the second signal component based on processing the first signal component and the watermarking seed data.

In addition or the alternative to any of the foregoing examples (including examples of a satellite, a client device, performing operations and/or implementing the method of FIGS. 12Y and/or 12Z), the navigation signal corresponds to a low band navigation signal at a first frequency. In addition or the alternative to any of the foregoing examples (including examples of a satellite, a client device, performing operations and/or implementing the method of FIGS. 12Y and/or 12Z), the first signal component corresponds to a low band first signal component at the first frequency and/or the second signal component corresponds to a low band second signal component at the first frequency and/or the watermarking seed data corresponds to low band watermarking seed data for the low band navigation signal. In addition or the alternative to any of the foregoing examples (including examples of a satellite, a client device, performing operations and/or implementing the method of FIGS. 12Y and/or 12Z), the operations further include: generating a high band first watermarked spreading sequence and a high band second watermarked spreading sequence based on high band watermarking seed data; generating a high band first signal component corresponding to the first phase based on the navigation data and the high band first watermarked spreading sequence; and/or generating a high band second signal channel component corresponding to the second phase based on the high band second watermarked spreading sequence.

In addition or the alternative to any of the foregoing examples (including examples of a satellite, a client device, performing operations and/or implementing the method of FIGS. 12Y and/or 12Z), the navigation signal transmitter is further configured to broadcast the high band navigation signal. In addition or the alternative to any of the foregoing examples (including examples of a satellite, a client device, performing operations and/or implementing the method of FIGS. 12Y and/or 12Z), the high navigation signal facilitates the at least one client device to authenticate the high band first signal component based on processing the high band second signal component and the high band watermarking seed data. In addition or the alternative to any of the foregoing examples (including examples of a satellite, a client device, performing operations and/or implementing the method of FIGS. 12Y and/or 12Z), the state data of the at least one client device is generated further based on processing the high band first signal component in response to authenticating the high band first signal component.

In addition or the alternative to any of the foregoing examples (including examples of a satellite, a client device, performing operations and/or implementing the method of FIGS. 12Y and/or 12Z), the first signal component is authenticated by the at least one client device during a first temporal period based on processing the second signal component and the watermarking seed data. In addition or the alternative to any of the foregoing examples (including examples of a satellite, a client device, performing operations and/or implementing the method of FIGS. 12Y and/or 12Z), after the first temporal period, subsequent generation and of the navigation signal is based on utilizing subsequent watermarking seed data to generate the first watermarked spreading sequence and the second watermarked spreading sequence. In addition or the alternative to any of the foregoing examples (including examples of a satellite, a client device, performing operations and/or implementing the method of FIGS. 12Y and/or 12Z), the navigation signal further facilitates the at least one client device to, after the first temporal period: authenticate the second signal component based on processing the first signal component and subsequent watermarking seed data; and/or in response to authenticating the first signal component, determine state data of the at least one client device based on processing the second signal component.

In addition or the alternative to any of the foregoing examples (including examples of a satellite, a client device, performing operations and/or implementing the method of FIGS. 12Y and/or 12Z), processing the first signal component includes extracting a hash point from the first signal component at a first time after the first temporal period to compute the subsequent watermarking seed data, wherein the second signal component is authenticated at a second time after the first time based on applying the subsequent watermarking seed data at the second time.

In addition or the alternative to any of the foregoing examples (including examples of a satellite, a client device, performing operations and/or implementing the method of FIGS. 12Y and/or 12Z), modulating the first signal component and the second signal component includes cross-correlating the first signal component and the second signal component in accordance with applying a bandwidth-efficient modulation scheme (e.g. FQPSK, EFQPSK, etc.).

In addition or the alternative to any of the foregoing examples (including examples of a satellite, a client device, performing operations and/or implementing the method of FIGS. 12Y and/or 12Z), determining the state data of the at least one client device is based on extracting the navigation data from the first signal component and processing the navigation data.

In addition or the alternative to any of the foregoing examples (including examples of a satellite, a client device, performing operations and/or implementing the method of FIGS. 12Y and/or 12Z), some or all of step 2972, step 2974, step 2976, step 2978, and/or step 2980 of FIG. 12Z can be performed, for example, by and/or via utilizing a client device 160, processing system 1904, a receiver 1920, and/or a node. In addition or the alternative to any of the foregoing examples (including examples of a satellite, a client device, performing operations and/or implementing the method of FIGS. 12Y and/or 12Z), some or all of step 2972, step 2974, step 2976, step 2978, and/or step 2980 of FIG. 12Z can be performed (e.g. by client device 160, processing system 1904, a receiver 1920, and/or a node) to process a navigation signal transmitted in step 2912 of FIG. 29X1 (e.g. by a satellite, a satellite processing system, and/or a navigation signal generation and transmission module 1230) and/or transmitted in any other step and/or via any other process described herein. Step 2972 includes authenticating the navigation signal. Step 2974 includes, in response to authenticating the navigation signal, determine state data of the at least one client device based on processing the navigation signal. In addition or the alternative to any of the foregoing examples (including examples of a satellite, a client device, performing operations and/or implementing the method of FIGS. 12Y and/or 12Z), performing step 2972 can include performing step 2976, step 2978, and/or step 2980. Step 2976 includes determining the watermarking seed data. Step 2978 includes generating a plurality of statistical values based on processing the navigation signal and the watermarking seed data. Step 2980 includes comparing the plurality of statistical values to at least one threshold value, where the navigation signal is authenticated based on the plurality of statistical values comparing favorably to the at least one threshold value.

In addition or the alternative to any of the foregoing examples (including examples of a satellite, a client device, performing operations and/or implementing the method of FIGS. 12Y and/or 12Z), a first statistical value of the plurality of statistical values corresponds to a probability of missed detection probability, and/or a second statistical value of the plurality of statistical values corresponds to a probability of false alarm.

In addition or the alternative to any of the foregoing examples (including examples of a satellite, a client device, performing operations and/or implementing the method of FIGS. 12Y and/or 12Z), the plurality of statistical values are generated as function of: sampling rate; integration time of a single watermark measurement; signal power; and/or noise power.

In addition or the alternative to any of the foregoing examples (including examples of a satellite, a client device, performing operations and/or implementing the method of FIGS. 12Y and/or 12Z), the PRN code includes an ordered plurality of chips. In addition or the alternative to any of the foregoing examples (including examples of a satellite, a client device, performing operations and/or implementing the method of FIGS. 12Y and/or 12Z), applying the watermarking seed data to the PRN code to generate the watermarked spreading sequence is based on: performing an inverted chip selection function upon the watermarking seed data to select a proper subset of the ordered plurality of chips for inversion as a pseudorandom combination selection. In addition or the alternative to any of the foregoing examples (including examples of a satellite, a client device, performing operations and/or implementing the method of FIGS. 12Y and/or 12Z), the watermarked spreading sequence is generated via inverting the proper subset of the ordered plurality of chips of the PRN code.

In addition or the alternative to any of the foregoing examples (including examples of a satellite, a client device, performing operations and/or implementing the method of FIGS. 12Y and/or 12Z), the operations further include: generating the watermarking seed data based on applying a key distribution function to one of a sequential plurality of hash points of a hash path.

In addition or the alternative to any of the foregoing examples (including examples of a satellite, a client device, performing operations and/or implementing the method of FIGS. 12Y and/or 12Z), the navigation signal is transmitted over a plurality of consecutive temporal periods based on navigation data generated over the plurality of consecutive temporal periods. In addition or the alternative to any of the foregoing examples (including examples of a satellite, a client device, performing operations and/or implementing the method of FIGS. 12Y and/or 12Z), a plurality of watermarking seed data is generated over the plurality of consecutive temporal periods. In addition or the alternative to any of the foregoing examples (including examples of a satellite, a client device, performing operations and/or implementing the method of FIGS. 12Y and/or 12Z), different ones of the plurality of watermarking seed data are generated based on applying different ones of the sequential plurality of hash points, and/or different ones of the plurality of watermarking seed data are applied to generate the watermarked spreading sequence during different ones of the plurality of consecutive temporal periods.

In addition or the alternative to any of the foregoing examples (including examples of a satellite, a client device, performing operations and/or implementing the method of FIGS. 12Y and/or 12Z), the operations further include: generating the sequential plurality of hash points of the hash path based on iterative performance of a predetermined function upon an initial hash point of the sequential plurality of hash points to generate the sequential plurality of hash points one at a time in accordance with a forward ordering of the sequential plurality of hash points from a first hash point in the sequential plurality of hash points to a last hash point in the sequential plurality of hash points. In addition or the alternative to any of the foregoing examples (including examples of a satellite, a client device, performing operations and/or implementing the method of FIGS. 12Y and/or 12Z), each subsequently generated hash point in the sequential plurality of hash points is generated based on iteratively performing a predetermined function upon a previous one of the sequential plurality of hash points. In addition or the alternative to any of the foregoing examples (including examples of a satellite, a client device, performing operations and/or implementing the method of FIGS. 12Y and/or 12Z), the different ones of the plurality of watermarking seed data are applied over the different ones of the plurality of consecutive temporal periods based on, in each subsequent one of the plurality of consecutive temporal periods, applying a subsequent one of the plurality of the plurality of watermarking seed data in an ordering of the plurality of watermarking seed data from a first ordered one of the plurality of watermarking seed data to a last ordered one of the plurality of watermarking seed data. In addition or the alternative to any of the foregoing examples (including examples of a satellite, a client device, performing operations and/or implementing the method of FIGS. 12Y and/or 12Z), the first ordered one of the plurality of watermarking seed data is generated from the last hash point, and/or the last ordered one of the plurality of watermarking seed data is generated from the first hash point, and/or each subsequent one of the plurality of watermarking seed data is generated from a prior one of the sequential plurality of hash points in the forward ordering based on utilizing a reverse ordering of the sequential plurality of hash points to generate the plurality of watermarking seed data.

In addition or the alternative to any of the foregoing examples (including examples of a satellite, a client device, performing operations and/or implementing the method of FIGS. 12Y and/or 12Z), the at least one client device authenticates the navigation signal based on: determining the one of the sequential plurality of hash points and/or deriving the watermarking seed data based on applying the one of the sequential plurality of hash points. In addition or the alternative to any of the foregoing examples (including examples of a satellite, a client device, performing operations and/or implementing the method of FIGS. 12Y and/or 12Z), the one of the sequential plurality of hash points is determined based on one of: receiving the one of the sequential plurality of hash points; or receiving another one of the sequential plurality of hash points and, based on the another one of the sequential plurality of hash points being serially before the one of the sequential plurality of hash points in a forward ordering of the sequential plurality of hash points computing the one of the sequential plurality of hash points via applying the predetermined function to the another one of the sequential plurality of hash points.

In addition or the alternative to any of the foregoing examples (including examples of a satellite, a client device, performing operations and/or implementing the method of FIGS. 12Y and/or 12Z), the at least one client device authenticates the navigation signal during one of the consecutive plurality of temporal periods. In addition or the alternative to any of the foregoing examples (including examples of a satellite, a client device, performing operations and/or implementing the method of FIGS. 12Y and/or 12Z), a plurality of data frames of the data stream are generated to include the navigation data and at least some of the sequential plurality of hash points over the consecutive plurality of temporal periods. In addition or the alternative to any of the foregoing examples (including examples of a satellite, a client device, performing operations and/or implementing the method of FIGS. 12Y and/or 12Z), based on processing the navigation signal received during a prior one of the consecutive plurality of temporal periods, one of: the one of the sequential plurality of hash points is extracted from one of the plurality of data frames via processing the navigation signal received during the prior one of the consecutive plurality of temporal periods; or the another one of the sequential plurality of hash points is extracted from the one of the plurality of data frames via processing the navigation signal received during the prior one of the consecutive plurality of temporal periods.

In addition or the alternative to any of the foregoing examples (including examples of a satellite, a client device, performing operations and/or implementing the method of FIGS. 12Y and/or 12Z), the PRN code includes an ordered plurality of chips. In addition or the alternative to any of the foregoing examples (including examples of a satellite, a client device, performing operations and/or implementing the method of FIGS. 12Y and/or 12Z), applying the watermarking seed data to the PRN code to generate the watermarked spreading sequence is based on performing an inverted chip selection function upon the watermarking seed data to select a proper subset of the ordered plurality of chips for inversion. In addition or the alternative to any of the foregoing examples (including examples of a satellite, a client device, performing operations and/or implementing the method of FIGS. 12Y and/or 12Z), the watermarked spreading sequence is generated via inverting the proper subset of the ordered plurality of chips of the PRN code. In addition or the alternative to any of the foregoing examples (including examples of a satellite, a client device, performing operations and/or implementing the method of FIGS. 12Y and/or 12Z), a same fixed number of chips of the ordered plurality of chips are inverted for all of the plurality of consecutive temporal periods. In addition or the alternative to any of the foregoing examples (including examples of a satellite, a client device, performing operations and/or implementing the method of FIGS. 12Y and/or 12Z), different proper subsets of the ordered plurality of chips are inverted for different ones of the plurality of consecutive temporal periods based on applying the inverted chip selection function to different watermarking seed data of the plurality of watermarking seed data corresponding to the different ones of the plurality of consecutive temporal periods.

In addition or the alternative to any of the foregoing examples (including examples of a satellite, a client device, performing operations and/or implementing the method of FIGS. 12Y and/or 12Z), the PRN code contains a total number of chips. In addition or the alternative to any of the foregoing examples (including examples of a satellite, a client device, performing operations and/or implementing the method of FIGS. 12Y and/or 12Z), a proportion of the same fixed number of chips over the total number of chips is based on ensuring the navigation signal adheres to: a threshold maximum signal loss; and/or a threshold minimum security requirement.

In addition or the alternative to any of the foregoing examples (including examples of a satellite, a client device, performing operations and/or implementing the method of FIGS. 12Y and/or 12Z), the watermarked spreading sequence is repetitively applied over a temporal period to render a consecutive plurality of watermarked spreading sequence instances applied to the navigation signal over the temporal period.

In addition or the alternative to any of the foregoing examples (including examples of a satellite, a client device, performing operations and/or implementing the method of FIGS. 12Y and/or 12Z), authenticating the navigation signal is further based on: processing the navigation signal over a time frame to observe a consecutive subset of watermarked spreading sequence instances of the consecutive plurality of watermarked spreading sequence instances that includes exactly a threshold number of watermarked spreading sequence instances; computing, for each of the plurality of statistical values, a corresponding plurality of statistical sub-values that includes exactly the threshold number of statistical sub-values based on computing a corresponding statistical sub-values for each watermarked spreading sequence instance of the consecutive subset of watermarked spreading sequence instances; and/or generating the each of the plurality of statistical values based on applying an aggregation function to the corresponding plurality of statistical sub-values.

In addition or the alternative to any of the foregoing examples (including examples of a satellite, a client device, performing operations and/or implementing the method of FIGS. 12Y and/or 12Z), authenticating the navigation signal is further based on: storing a plurality of raw samples of the plurality of watermarked spreading sequence instances; and/or applying a plurality of linear time-invariant filters to the plurality of raw samples to generate the plurality of statistical values. In addition or the alternative to any of the foregoing examples (including examples of a satellite, a client device, performing operations and/or implementing the method of FIGS. 12Y and/or 12Z), each of the plurality of statistical values is generated via one of the plurality of linear time-invariant filters.

In addition or the alternative to any of the foregoing examples (including examples of a satellite, a client device, performing operations and/or implementing the method of FIGS. 12Y and/or 12Z), the PRN code corresponds to a first phase. In addition or the alternative to any of the foregoing examples (including examples of a satellite, a client device, performing operations and/or implementing the method of FIGS. 12Y and/or 12Z), the operations further include: generating a first signal component corresponding to the first phase based on the data stream and the watermarked spreading sequence; generating a second watermarked spreading sequence based on applying the watermarking seed data to a second PRN code corresponding to a second phase; generating a second signal component corresponding to the second phase based on the second watermarked spreading sequence; and/or generating the navigation signal based on modulating the first signal component and the second signal component.

In addition or the alternative to any of the foregoing examples (including examples of a satellite, a client device, performing operations and/or implementing the method of FIGS. 12Y and/or 12Z), the watermarked spreading sequence is repetitively applied over a temporal period to render a consecutive plurality of watermarked spreading sequence instances applied to the navigation signal over the temporal period. In addition or the alternative to any of the foregoing examples (including examples of a satellite, a client device, performing operations and/or implementing the method of FIGS. 12Y and/or 12Z), the second watermarked spreading sequence is repetitively applied over the temporal period to render the consecutive plurality of watermarked spreading sequence instances. In addition or the alternative to any of the foregoing examples (including examples of a satellite, a client device, performing operations and/or implementing the method of FIGS. 12Y and/or 12Z), the plurality of statistical values are generated based on a plurality of processing exactly one of: a plurality of samples of the plurality of watermarked spreading code instances of the first signal component; and/or a plurality of samples of the plurality of watermarked spreading code instances of the second signal component.

In addition or the alternative to any of the foregoing examples (including examples of a satellite, a client device, performing operations and/or implementing the method of FIGS. 12Y and/or 12Z), the first signal component corresponds to an in-phase (I) signal component, wherein the second signal component corresponds to a quadrature (Q) signal component, and wherein the second phase corresponds to a 90 degree shift from the first phase.

In addition or the alternative to any of the foregoing examples (including examples of a satellite, a client device, performing operations and/or implementing the method of FIGS. 12Y and/or 12Z), the plurality of statistical values includes exactly two statistical values.

In addition or the alternative to any of the foregoing examples (including examples of a satellite, a client device, performing operations and/or implementing the method of FIGS. 12Y and/or 12Z), the plurality of statistical values are each compared to a single threshold value based on the at least one threshold value including only the single threshold value.

In addition or the alternative to any of the foregoing examples (including examples of a satellite, a client device, performing operations and/or implementing the method of FIGS. 12Y and/or 12Z), the plurality of statistical values are each compared to a different threshold value of a set of multiple different threshold values based on the at least one threshold value including the set of multiple different threshold values.

In addition or the alternative to any of the foregoing examples (including examples of a satellite, a client device, performing operations and/or implementing the method of FIGS. 12Y and/or 12Z), authenticating the navigation signal is further based on, before determining the watermarking seed data. computing a first convolution peak based on correlating the navigation signal with a signal replica generated based on the PRN code. addition or the alternative to any of the foregoing examples, including examples of performing operations or otherwise implementing the method of FIGS. 12Y and/or 12Z, authenticating the navigation signal is further based on, after determining the watermarking seed data: generating a modified signal replica based on applying the watermarking seed data to the PRN code; and/or computing a second convolution peak based on correlating the navigation signal with the modified signal replica. In addition or the alternative to any of the foregoing examples (including examples of a satellite, a client device, performing operations and/or implementing the method of FIGS. 12Y and/or 12Z), the navigation signal is authenticated based on a magnitude of the second convolution peak being greater than a magnitude of the first convolution peak.

FIGS. 13A-13O present example embodiments of a client device (and/or a GNSS receiver module of a corresponding client device) operable to receive, authenticate, and/or process GNSS signals 132, such as signals received from satellites from a GNSS satellite constellation such as GPS satellites, Galileo satellites, or other satellites of another GNSS satellite constellation. This can include applying same or similar authentication techniques discussed in conjunction with any of the features and/or functionality of authenticating navigation signals 240 and/or any other signal and/or data stream described herein.

In various examples, client device 160 is operable to derive the authentication security of pseudorandom function (PRF) GNSS ranging under one or more GNSS spoofing models, such as the Security Code Estimation and Replay (SCER) spoofer. For example, when GNSS ranging codes derive from a PRF utilizing a secret known only to the broadcaster, the spoofer cannot predict the ranging code before broadcast. In such examples, PRF ranging can be used to establish trust in the GNSS pseudoranges and the resulting receiver position, navigation, and timing (PNT) solution. As a particular example, such methodology can be applied to Galileo's Signal Authentication Service (SAS) utilizing the encrypted Galileo E6-C signal to compute that, at most, a threshold amount of Galileo E6-C data (e.g. 400 ms of Galileo E6-C data) is needed to assert a threshold authentication security (e.g. 128-bit authentication security), for example, under non-SCER models. Such thresholds can dictate the design of a corresponding GNSS receiver, for example, by dictating design of a corresponding PRF GNSS ranging protocol to meet useful authentication security requirements by computing the probability of missed detection. For the SCER adversary, the adversary's receiving radio equipment needed to break authentication security can be predicted and/or characterized.

In various examples, GNSS signal 132 provides two signal component types: a data component and a ranging component. For example, the data component can provide information related to broadcasting satellites' position and/or clock bias. Alternatively or in addition, as another example, the ranging component can enable receivers to measure their range to satellites by transmitting a high-auto-correlative, low-cross-correlative ranging code. These two components together can enable GNSS receivers to solve a trilateration problem to deduce its position and time (e.g. as GNSS position and/or timing data 2271). Cryptographic ranging authentication involves augmenting the ranging components with cryptographic elements. The cryptographic construction asserts that these elements are not predictable by GNSS spoofers before broadcast. When the receiver observes these cryptographic elements, it establishes trust in the measured pseudoranges that determine the receiver's position and time.

In various examples, cryptographic ranging authentication can come in two forms. For example, the first form of cryptographic ranging authentication can involve inducing a watermark within the ranging code, for example, where the watermark enacts a cryptographic perturbation on the ranging code chips that is designed to be small. For example, because the watermark is a small perturbation, receivers can still track the signal and “ignore” the watermark's existence. Examples of cryptographic ranging authentication via inducing a watermark within the ranging code are discussed in conjunction with FIGS. 11A-12Z.

In various examples, the second form of cryptographic ranging authentication can instead require the entire ranging code derive from a cryptographic pseudorandom function (PRF). For example, when the ranging code is a PRF, the receiver cannot track the signal until it has the cryptographic seeds used to generate the PRF ranging code. This second form of cryptographic ranging authentication can be implemented in some or all of the examples of FIGS. 13A-13O, for example, based on corresponding GNSS signals 132 being generated to include ranging codes derived from such PRFs.

In various examples, both watermark and PRF ranging authentication systems enact a bit-commitment authentication protocol, for example, under a Timed Efficient Stream Loss-tolerant Authentication (TESLA) framework. As a particular example, Galileo's SAS and/or Galileo's Open Service Navigation Message Authentication (OSNMA) utilizes TESLA, and authentication of Galileo signals via client device 160 is based on the TESLA framework.

In various examples, the authentication procedure is based on some or all of the following steps: first, the GNSS provider commits to a secret from which the watermarked or the PRF ranging code derives; second, after a time, the GNSS provider will reveal that commitment secret to receiver; and/or third, the receiver can retrieve the corresponding radio measurements in the past and process the watermark or PRF ranging code to determine a pseudorange's authenticity utilizing the revealed secret.

In various examples, some or all features and/or functionality presented in conjunction with FIGS. 13A-13O can improve the technology of GNSS receivers based on enabling receivers to achieve higher rates of detecting spoofed signals, for example, when performing authentication of signals that include ranging codes derived from a PRF, for example, based on being configured via the second form of authentication. For example, such functionality can be highly relevant as GNSS signal spoofing becomes a common nuisance in conflict zones and nearby public infrastructure. For example, for a cryptographic ranging authentication system to be useful, there must be a receiver signal processing procedure that is sensitive and specific. As a particular example, the probability a spoofer could produce a signal that would fool a receiver authenticity determination, called the Probability of Missed Detection (PMD), should be small. Alternatively or in addition, as another particular example, the probability an authentic signal would raise an alarm, called the Probability of False Alarm (PFA), should also be small.

In various examples, the examples presented in conjunction with FIGS. 13A-13O can be implemented to render the small PMD and/or PFA in a corresponding GNSS receiver, which can constitute an improvement over other GNSS receivers performing authentication via other means and/or other authentication security mechanisms applied to GNSS signals. For example, the examples presented in conjunction with FIGS. 13A-13O can be implemented to render improved authentication security in GNSS receivers (e.g. via higher rates of spoofer detection and/or lower rates of false alarms) over other GNSS receivers implementing other forms of authentication security, such as other GNSS receivers that simply process statistics based on the pseudorange differences between authenticating PRF pseudoranges and non-authenticated pseudoranges to authenticate the non-authenticated, which can fall short of the higher levels of authentication security achieved by the novel examples presented herein based on being subject to environmental effects unrelated to spoofing threats interfere with this methodology's specificity (i.e., the observed PFA) and/or based on not providing mathematical proof of security by bounding the PMD. As another example, the examples presented in conjunction with FIGS. 13A-13O can be implemented to render improved authentication security in GNSS receivers (e.g. via higher rates of spoofer detection and/or lower rates of false alarms) over other GNSS receivers implementing other forms of authentication security, such as other GNSS receivers that simply utilize statistic arguments on multiple chip measurements, but do not exploit the relationship among many unpredictable chips and the quickly-decaying tails of the binomial distribution to provide mathematical arguments of the levels of standard cryptographic security. As another example, the examples presented in conjunction with FIGS. 13A-13O can be implemented to render improved authentication security in GNSS receivers (e.g. via higher rates of spoofer detection and/or lower rates of false alarms) over other authentication mechanisms employed via other systems, for example, associated with corresponding GNSS satellite constellations.

As a particular example, the examples presented in conjunction with FIGS. 13A-13O can be implemented to render improved authentication security (e.g. via higher rates of spoofer detection and/or lower rates of false alarms) over authentication mechanisms currently proposed, tested, and/or employed via Galileo's SAS and/or Galileo's OSNMA. In various examples, Galileo's SAS (e.g. applied in conjunction with Galileo's E6-C service, for example, via assistance from and/or Galileo's OSNMA applied to Galileo's E1-B signals) can be adapted to implement some or all functionality of the examples presented in conjunction with FIGS. 13A-13O to improve its authentication security of Galileo signals.

In various examples, the improved authentication security for the second case where GNSS signals are generated to include ranging codes derived from a PRF can be achieved based on employing some or all features and/or functionality of FIGS. 12C and/or 12L, for example, via generating statistical values and/or processing statistical values 1962.1-1962.V in a same or similar fashion as discussed in conjunction with one or more examples described previously herein. However, while some or all examples of FIGS. 12A-12Z involve applying authentication security in conjunction with the first form of authentication that is implemented via applying a watermark to navigation signals, the improved authentication security can be rendered via adapting some or all functionality discussed in conjunction with FIGS. 12A-12Z to the second form of authentication implemented via a ranging code derived via a PRF, for example, via some or all of the examples described in further detail herein.

In various examples, the improved authentication security for the second case where GNSS signals are generated to include ranging codes derived from a PRF can be achieved based on implementing a signal processing procedure (e.g. implemented as some or all of GNSS signal authentication mechanism 2310) operable to bound the PMD and PFA of receiver statistics of PRF ranges to standard cryptographic security levels (e.g. 128-bit security or another standard cryptographic security level). For example, such standard cryptographic security levels achieved via such a signal processing procedure can be verified mathematically and/or via Monte Carlo experiments. A particular example of the GNSS signal authentication mechanism 2310 can be applied to Galileo's SAS, for example, with Galileo's E6-C service, an upcoming PRF ranging authentication provider.

FIG. 13A presents an example embodiment of a GNSS receiver module 2610 of a client device 160 that is operable to process incoming GNSS signals 132 transmitted via satellites 130 of at least one GNSS satellite constellation. As a particular example, the GNSS signals 132 are Galileo signals (e.g. Galileo E6-C signals and/or Galileo E1-B signals), and/or the GNSS receiver module 2610 implements a Galileo receiver. The GNSS signals can be any other signals of any other satellite constellation. As another particular example, the GNSS signals of FIGS. 13A-13N can optionally be implemented as navigation signals 240 of satellite constellation system 100, where construction and/or authentication of navigation signals 240 is optionally performed via some or all features and/or functionality presented in conjunction with FIGS. 13A-13M, alternatively or in addition to implementing some or all features and/or functionality of construction and/or authentication of navigation signals 240 described in accordance with any other examples described herein, and/or wherein some or all features and/or functionality of receiver 2610 presented in conjunction with FIGS. 13A-13M can implement any embodiment of receiver 2600 described herein. As another particular example, the GNSS signals of FIGS. 13A-13N can optionally be implemented as Pulsar signals, for example, transmitted by satellite payloads and/or corresponding satellites in LEO orbit generated by Xona Space Systems (e.g. where embodiment of navigation signals 240 described herein are optionally implemented as Pulsar signals, where satellite constellation system 100 and/or corresponding satellites 110 are implemented via corresponding satellites and/or satellite payloads designed, built, and/or deployed, in full or in part, by Xona Space Systems, where receiver module 2600 and/or client device 160 is optionally configured to receive and/or process Pulsar signals via any features and/or functionality of receiving and/or processing navigation signals 240 described herein, and/or where any embodiment of a Pulsar signal described herein can be implemented via any features and/or functionality of navigation signal 240 described herein).

In various examples, any GNSS signals 132 that are constructed, authenticated, and/or processed as discussed in conjunction with FIGS. 13A-13M can be transmitted via a satellite in LEO orbit (e.g. a satellite of satellite constellation 100 in LEO orbit, a Galileo satellite associated with the Galileo GNSS service located in LEO orbit, another satellite associated with a corresponding GNSS/navigation service located in LEO orbit, etc.). In various examples, any GNSS signals 132 that are constructed, authenticated, and/or processed as discussed in conjunction with FIGS. 13A-13M can be transmitted via a satellite in MEO orbit (e.g. via a GNSS satellite such as a GPS satellite or Galileo satellite in MEO orbit).

In various examples, any GNSS signals 132 that are constructed, authenticated, and/or processed as discussed in conjunction with FIGS. 13A-13M can be transmitted via a satellite in LEO orbit. As a particular example, any GNSS signals 132 that are constructed, authenticated, and/or processed as discussed in conjunction with FIGS. 13A-13M can be transmitted via a satellite 110 of satellite constellation system 100 in LEO orbit (e.g. where GNSS signals 132 are implemented via some or all features and/or functionality of navigation signal 240 described herein). As another particular example, any GNSS signals 132 that are constructed, authenticated, and/or processed as discussed in conjunction with FIGS. 13A-13M can be transmitted via a GNSS satellite in LEO orbit, for example, where this LEO-orbit GNSS satellite is a GNSS satellite of the Galileo service, GPS service, or other GNSS navigation service, for that optionally implements some of its GNSS satellites of its GNSS satellite service/GNSS satellite constellation in MEO orbit and other satellites of its GNSS satellite service/GNSS satellite constellation in LEO orbit.

The GNSS receiver module can be operable to generate GNSS position and/or timing data 2271 (e.g. a position, navigation, and/or timing solution derived from Galileo signals), for example, for processing via client device components and applications 1925. Such processing of signals 130 to generate GNSS position and/or timing data 2271 can be based on GNSS receiver module 2610 implementing a GNSS signal authentication mechanism 2310 to implement corresponding authentication security (e.g. where some or all spoofed signals are detected and ignored in generating GNSS position and/or timing data 2271, for example, with sufficiently low probability of missed detection and/or with sufficiently low probability of false alarm). Some or all features and/or functionality of the client device 160, GNSS receiver module 2610, and/or GNSS signal authentication mechanism 2310 of FIG. 13A can implement some or all features and/or functionality of any client device, receiver module, GNSS signal authentication mechanism, and/or signal authentication described herein.

In various examples, a client device (e.g. client device 16) includes at least one receiver module (e.g. receiver module 2610) that includes; at least one receiver antenna configured to receive a plurality of navigation signals (e.g. a plurality of GNSS navigation signals, and/or a plurality of other navigation signals such as navigation signals 240) from a plurality of satellites of a satellite constellation (e.g. a GNSS satellite constellation such as the Galileo or GPS satellite constellation, and/or another satellite constellation such as satellite constellation system 100; and/or at least one processor operable to authenticate ones of the plurality of GNSS navigation signals in accordance with meeting a threshold authentication security level.

In various examples, a receiver module (e.g. receiver module 2610) includes; at least one receiver antenna configured to receive a plurality of navigation signals (e.g. a plurality of GNSS navigation signals, and/or a plurality of other navigation signals such as navigation signals 240) from a plurality of satellites of a satellite constellation (e.g. a GNSS satellite constellation such as the Galileo or GPS satellite constellation, and/or another satellite constellation such as satellite constellation system 100; and at least one processor operable to authenticate ones of the plurality of GNSS navigation signals in accordance with meeting a threshold authentication security level.

In addition or the alternative to any of the foregoing examples (including examples of a client device or a receiver module), at least a subset of the plurality of navigation signals are generated to include a cryptographic pseudorandom function ranging code generated via applying a corresponding cryptographic pseudorandom function.

In addition or the alternative to any of the foregoing examples (including examples of a client device or a receiver module), the at least one processor is operable to authenticate ones of the plurality of navigation signals in accordance with meeting a threshold authentication security level based on: storing, in memory, an accumulated plurality of cryptographic pseudorandom function ranging code samples extracted from a first navigation signal (e.g. first GNSS navigation signal or other navigation signal such as first navigation signal 240) transmitted via a first satellite of the plurality of satellites; receiving cryptographic pseudorandom function seed data; generating a replica cryptographic pseudorandom function ranging code based on processing the cryptographic pseudorandom function seed data via the corresponding cryptographic pseudorandom function; applying a linear time invariant matching filter to generate a plurality of first correlation data based on correlation of the replica cryptographic pseudorandom function ranging code with each of the accumulated plurality of cryptographic pseudorandom function ranging code samples; and/or generating an aggregated value based on processing the plurality of first correlation data.

In addition or the alternative to any of the foregoing examples (including examples of a client device or a receiver module), the first GNSS navigation signal is authenticated based on the aggregated value comparing favorably to a threshold value. In addition or the alternative to any of the foregoing examples (including examples of a client device or a receiver module), authentication of the first navigation signal meets the threshold authentication security level based on the accumulated plurality of cryptographic pseudorandom function ranging code samples being accumulated in accordance with a threshold ranging code accumulation requirement.

In addition or the alternative to any of the foregoing examples (including examples of a client device or a receiver module), the plurality of navigation signals include a plurality of Galileo signals transmitted by a plurality of Galileo satellites of the Galileo satellite constellation.

In addition or the alternative to any of the foregoing examples (including examples of a client device or a receiver module), the at least one receiver antenna is configured to receive the plurality of Galileo signals.

In addition or the alternative to any of the foregoing examples (including examples of a client device or a receiver module), the accumulated plurality of cryptographic pseudorandom function ranging code samples of the first GNSS navigation signal correspond to an accumulated plurality of Galileo E6-C ranging code samples of a first Galileo E6-C signal of the plurality of Galileo signals transmitted via a first Galileo satellite of the plurality of Galileo satellites.

In addition or the alternative to any of the foregoing examples (including examples of a client device or a receiver module), the at least one processor is operable to authenticate the ones of the plurality of navigation signals further based on: receiving second-encrypted ranging data in the first Galileo E6-C signal; and/or producing the accumulated plurality of Galileo E6-C ranging code samples based on decrypting the second-encrypted ranging data via a corresponding key distinct from the cryptographic pseudorandom function seed data. In addition or the alternative to any of the foregoing examples (including examples of a client device or a receiver module), the accumulated plurality of Galileo E6-C ranging code samples are still encrypted via the cryptographic pseudorandom function seed data after decryption of the second-encrypted ranging data via the corresponding key.

In addition or the alternative to any of the foregoing examples (including examples of a client device or a receiver module), the at least one processor is further operable to generate, in response to authenticating the first navigation signal, position navigation and timing data based on processing the accumulated plurality of cryptographic pseudorandom function ranging code samples of the first navigation signal. In addition or the alternative to any of the foregoing examples (including examples of a client device or a receiver module), the client device further includes at least one additional processor separate from the receiver module and operable to process position navigation and timing data generated by the receiver module in conjunction with executing corresponding functionality of the client device.

In addition or the alternative to any of the foregoing examples (including examples of a client device or a receiver module), the at least one processor is operable to authenticate the ones of the plurality of navigation signals further based on: authenticating a second navigation signal (e.g. a second GNSS navigation signal or other second navigation signal such as a second navigation signal 240) in response to the aggregated value, generated via processing the accumulated plurality of cryptographic pseudorandom function ranging code samples extracted from the first navigation signal, comparing favorably to the threshold value.

In addition or the alternative to any of the foregoing examples (including examples of a client device or a receiver module), the first navigation signal and the second navigation signal are both received from the first satellite.

In addition or the alternative to any of the foregoing examples (including examples of a client device or a receiver module), the plurality of navigation signals include a plurality of signal components transmitted by each of the plurality of satellites that includes: at least one data signal component; and/or at least one pilot signal component. In addition or the alternative to any of the foregoing examples (including examples of a client device or a receiver module), the first satellite of the plurality of satellites transmits a navigation signal (e.g. a GNSS navigation signal or other navigation signal such as navigation signal 240) that includes the first navigation signal as a pilot signal component and the second navigation signal as a data signal component. In addition or the alternative to any of the foregoing examples (including examples of a client device or a receiver module), the data signal component of the navigation signal transmitted by the first satellite is authenticated in response to the aggregated value, generated via processing the accumulated plurality of cryptographic pseudorandom function ranging code samples extracted from the pilot signal component, comparing favorably to the threshold value.

In addition or the alternative to any of the foregoing examples (including examples of a client device or a receiver module), the pilot signal component is an encrypted signal component. In addition or the alternative to any of the foregoing examples (including examples of a client device or a receiver module), the data signal component is an unencrypted signal component.

In addition or the alternative to any of the foregoing examples (including examples of a client device or a receiver module), the pilot signal component corresponds to a Galileo E6-C signal. In addition or the alternative to any of the foregoing examples (including examples of a client device or a receiver module), the data signal component corresponds to one of: a Galileo E6-B signal or a Galileo E1-B signal.

In addition or the alternative to any of the foregoing examples (including examples of a client device or a receiver module), the plurality of navigation signals include: a first plurality of navigation signals (e.g. a first plurality of GNSS navigation signals or first plurality of other navigation signals such as a first plurality of navigation signals 240) at a first frequency; and/or a second plurality of navigation signals (e.g. a second plurality of GNSS navigation signals or a second plurality o other navigation signals such a second plurality of navigation signals 240) at a second frequency different from the first frequency.

In addition or the alternative to any of the foregoing examples (including examples of a client device or a receiver module), the first satellite of the plurality of satellites transmits the first navigation signal the first frequency and further transmits the second navigation signal at the second frequency. In addition or the alternative to any of the foregoing examples (including examples of a client device or a receiver module), the second navigation signal at the second frequency is authenticated in response to the aggregated value, generated via processing the accumulated plurality of cryptographic pseudorandom function ranging code samples extracted from the first navigation signal at the first frequency, comparing favorably to the threshold value.

In addition or the alternative to any of the foregoing examples (including examples of a client device or a receiver module), the first plurality of navigation signals at the first frequency each include a first plurality of signal components that includes an encrypted signal component and at least one other signal component. In addition or the alternative to any of the foregoing examples (including examples of a client device or a receiver module), the second plurality of navigation signals at the second frequency each include a second plurality of signal components that includes an unencrypted signal component and at least one other signal component. In addition or the alternative to any of the foregoing examples (including examples of a client device or a receiver module), the accumulated plurality of cryptographic pseudorandom function ranging code samples are extracted from the encrypted signal component of the first navigation signal at the first frequency. In addition or the alternative to any of the foregoing examples (including examples of a client device or a receiver module), the unencrypted signal component of the second navigation signal at the second frequency is authenticated in response to the aggregated value, generated via processing the accumulated plurality of cryptographic pseudorandom function ranging code extracted from the encrypted signal component of the first navigation signal at the first frequency, comparing favorably to the threshold value.

In addition or the alternative to any of the foregoing examples (including examples of a client device or a receiver module), the encrypted signal component of the first navigation signal at the first frequency corresponds to a Galileo E6-C signal. In addition or the alternative to any of the foregoing examples (including examples of a client device or a receiver module), the unencrypted signal component of the second navigation signal at the second frequency corresponds to a Galileo E1-B signal.

In addition or the alternative to any of the foregoing examples (including examples of a client device or a receiver module), the cryptographic pseudorandom function ranging code is implemented as a non-watermarked ranging code based on the cryptographic pseudorandom function ranging code being generated via applying the cryptographic pseudorandom function to the cryptographic pseudorandom function seed data.

In addition or the alternative to any of the foregoing examples (including examples of a client device or a receiver module), the threshold ranging code accumulation requirement includes at least one of: a predetermined threshold number of ranging code samples; or a predetermined threshold amount of time over which cryptographic pseudorandom function ranging code samples are accumulated. In addition or the alternative to any of the foregoing examples (including examples of a client device or a receiver module), the at least one processor is configured to meet the threshold authentication security level based on at least one of: being configured to accumulate at least the predetermined threshold number of ranging code samples in the accumulated plurality of cryptographic pseudorandom function ranging code samples, or being configured to accumulate the accumulated plurality of cryptographic pseudorandom function ranging code samples over at least the predetermined threshold amount of time.

In addition or the alternative to any of the foregoing examples (including examples of a client device or a receiver module), based on the at least one processor being configured to meet the threshold authentication security level based on the at least one of: being configured to accumulate at least the predetermined threshold number of ranging code samples in the accumulated plurality of cryptographic pseudorandom function ranging code samples, or being configured to accumulate the accumulated plurality of cryptographic pseudorandom function ranging code samples over at least the predetermined threshold amount of time: the plurality of first correlation data includes at least the predetermined threshold number of correlation data based on the linear time invariant matching filter being applied to the accumulated plurality of cryptographic pseudorandom function ranging code samples that includes the at least the predetermined threshold number of ranging code samples; the aggregated value is generated based on processing the at least the predetermined threshold number of correlation data; and/or the threshold authentication security level is met based on the aggregated value being generated based on processing the at least the predetermined threshold number of correlation data.

In addition or the alternative to any of the foregoing examples (including examples of a client device or a receiver module), the at least one processor is configured to accumulate at least the predetermined threshold number of ranging code samples in the accumulated plurality of cryptographic pseudorandom function ranging code samples based on being configured to accumulate the accumulated plurality of cryptographic pseudorandom function ranging code samples over at least the predetermined threshold amount of time based on the at least the predetermined threshold amount of time being configured to render accumulation of the at least the predetermined threshold number of ranging code samples based on the at least the predetermined threshold amount of time being configured as a function of length of time covering a single ranging code.

In addition or the alternative to any of the foregoing examples (including examples of a client device or a receiver module), the predetermined threshold number of ranging code samples is configured based on the threshold ranging code accumulation requirement being configured to meet a 128-bit authentication security level.

In addition or the alternative to any of the foregoing examples (including examples of a client device or a receiver module), the accumulated plurality of cryptographic pseudorandom function ranging code samples of the first navigation signal correspond to an accumulated plurality of Galileo E6-C ranging code samples of a first Galileo E6-C signal of the plurality of Galileo signals transmitted via a first Galileo satellite of a plurality of Galileo satellites. In addition or the alternative to any of the foregoing examples (including examples of a client device or a receiver module), the predetermined threshold number of ranging code samples is configured as a number of ranging code samples between 300 and 400 samples further based on construction of the Galileo E6-C signal.

In addition or the alternative to any of the foregoing examples (including examples of a client device or a receiver module), the predetermined threshold amount of time over which cryptographic pseudorandom function ranging code samples are accumulated is configured based on the threshold ranging code accumulation requirement being configured to meet a 128-bit authentication security level.

In addition or the alternative to any of the foregoing examples (including examples of a client device or a receiver module), the accumulated plurality of cryptographic pseudorandom function ranging code samples of the first navigation signal correspond to an accumulated plurality of Galileo E6-C ranging code samples of a first Galileo E6-C signal of the plurality of Galileo signals transmitted via a first Galileo satellite of a plurality of Galileo satellites. In addition or the alternative to any of the foregoing examples (including examples of a client device or a receiver module), the predetermined threshold amount of time over which cryptographic pseudorandom function ranging code samples are accumulated is configured as a number of milliseconds between 300 and 400 milliseconds further based on construction of the Galileo E6-C signal.

In addition or the alternative to any of the foregoing examples (including examples of a client device or a receiver module), the predetermined threshold number of ranging code samples is configured based on the threshold ranging code accumulation requirement being configured to meet a 32-bit authentication security level.

In addition or the alternative to any of the foregoing examples (including examples of a client device or a receiver module), the accumulated plurality of cryptographic pseudorandom function ranging code samples of the first navigation signal correspond to an accumulated plurality of Galileo E6-C ranging code samples of a first Galileo E6-C signal of the plurality of Galileo signals transmitted via a first Galileo satellite of a plurality of Galileo satellites. In addition or the alternative to any of the foregoing examples (including examples of a client device or a receiver module), the predetermined threshold number of ranging code samples is configured as a number of ranging code samples between 50 and 100 ranging code samples further based on construction of the Galileo E6-C signal.

In addition or the alternative to any of the foregoing examples (including examples of a client device or a receiver module), the predetermined threshold amount of time over which cryptographic pseudorandom function ranging code samples are accumulated is configured based on the threshold ranging code accumulation requirement being configured to meet a 32-bit authentication security level.

In addition or the alternative to any of the foregoing examples (including examples of a client device or a receiver module), the accumulated plurality of cryptographic pseudorandom function ranging code samples of the first navigation signal correspond to an accumulated plurality of Galileo E6-C ranging code samples of a first Galileo E6-C signal of the plurality of Galileo signals transmitted via a first Galileo satellite of a plurality of Galileo satellites. In addition or the alternative to any of the foregoing examples (including examples of a client device or a receiver module), the predetermined threshold amount of time over which cryptographic pseudorandom function ranging code samples are accumulated is configured as a number of milliseconds between 50 and 100 milliseconds further based on construction of the Galileo E6-C signal.

In addition or the alternative to any of the foregoing examples (including examples of a client device or a receiver module), the threshold ranging code accumulation requirement is configured based on a conservative maximum threshold ranging code accumulation requirement generated based on processing a plurality of parameters corresponding to construction of the plurality of navigation signals that includes at least one of: a first parameter corresponding to a number of chips within a single cryptographic pseudorandom function ranging code; a second parameter corresponding to a length of time covering the single cryptographic pseudorandom function ranging code; a third parameter corresponding to frequency of the plurality of navigation signals; and/or a fourth parameter corresponding to received maximum power for the plurality of navigation signals.

In addition or the alternative to any of the foregoing examples (including examples of a client device or a receiver module), the conservative maximum threshold ranging code accumulation requirement is generated based on computing probability of missed detection given an adversarial chip signal to noise ratio as a function of at least some of the plurality of parameters.

In addition or the alternative to any of the foregoing examples (including examples of a client device or a receiver module), the threshold ranging code accumulation requirement is configured based on a conservative maximum threshold ranging code accumulation requirement generated based on processing a plurality of parameters corresponding to construction of a receiver module implementing the at least one processor that includes at least one of: a first parameter corresponding to a frequency of the receiver module making the authentication determination; or a second parameter corresponding a threshold minimum signal to noise ratio.

In addition or the alternative to any of the foregoing examples (including examples of a client device or a receiver module), generating the conservative maximum threshold ranging code accumulation requirement is based on setting the first parameter as a Nyquist frequency determined based on frequency of the plurality of navigation signals.

In addition or the alternative to any of the foregoing examples (including examples of a client device or a receiver module), the threshold ranging code accumulation requirement is configured based on processing Hard-decision Security Code Estimation and Replay modelling data.

In addition or the alternative to any of the foregoing examples (including examples of a client device or a receiver module), the threshold ranging code accumulation requirement is configured based on processing at least one of: Hard-decision Security Code Estimation and Replay modeling data; or non-Security Code Estimation and Replay modeling data.

In addition or the alternative to any of the foregoing examples (including examples of a client device or a receiver module), the threshold ranging code accumulation requirement is configured based on at least one of: a probability of false alarm, or a probability of missed detection.

In addition or the alternative to any of the foregoing examples (including examples of a client device or a receiver module), the threshold value is configured based on at least one of: a configured tradeoff between probability of false alarm and probability of missed detection; a first expectation value for the aggregated value given the first navigation signal is authentic; and/or a second expectation value of the aggregated value given the first navigation signal is spoofed.

In addition or the alternative to any of the foregoing examples (including examples of a client device or a receiver module), the first expectation value and the second expectation value are computed as one and zero, respectively, based on assuming a predetermined threshold number of ranging code samples are utilized to generate the aggregated value. In addition or the alternative to any of the foregoing examples (including examples of a client device or a receiver module), the threshold ranging code accumulation requirement is configured as the predetermined threshold number of ranging code samples. In addition or the alternative to any of the foregoing examples (including examples of a client device or a receiver module), the first navigation signal is authenticated based on the aggregated value being greater than or equal to the threshold value.

In addition or the alternative to any of the foregoing examples (including examples of a client device or a receiver module), the configured tradeoff is equal to 0.5 based on the first expectation value and the second expectation value being computed as one and zero, respectively, and/or based on applying an unweighted tradeoff between probability of false alarm and probability of missed detection.

In addition or the alternative to any of the foregoing examples (including examples of a client device or a receiver module), the second expectation value of the aggregated value given the first navigation signal is spoofed is based on an assumption that the first navigation signal is spoofed by a non-Security Code Estimation and Replay adversary.

In addition or the alternative to any of the foregoing examples (including examples of a client device or a receiver module), generating the aggregated value based on processing the plurality of first correlation data includes: generating a plurality of intermediate values based on processing the plurality of first correlation data. In addition or the alternative to any of the foregoing examples (including examples of a client device or a receiver module), each of the plurality of intermediate values is generated via processing a corresponding one of the plurality of first correlation data; and/or generating the aggregated value based on processing the plurality of intermediate values.

In addition or the alternative to any of the foregoing examples (including examples of a client device or a receiver module), the at least one processor is operable to authenticate the ones of the plurality of navigation signals in accordance with meeting the threshold authentication security level further based on generating a plurality of signal power measurements based on measuring signal power over each of a plurality of fixed time periods in which each corresponding one of the accumulated plurality of cryptographic pseudorandom function ranging code samples is received. In addition or the alternative to any of the foregoing examples (including examples of a client device or a receiver module), the each of the plurality of intermediate values are generated based on further processing a corresponding signal power measurement of the plurality of signal power measurements corresponding to one of the accumulated plurality of cryptographic pseudorandom function ranging code samples for which the corresponding one of the plurality of first correlation data is generated.

In addition or the alternative to any of the foregoing examples (including examples of a client device or a receiver module), the aggregated value is generated based on computing an average of the plurality of intermediate values.

In addition or the alternative to any of the foregoing examples (including examples of a client device or a receiver module), the plurality of intermediate values are generated as a plurality of identically distributed statistics.

In addition or the alternative to any of the foregoing examples (including examples of a client device or a receiver module), a first one of the accumulated plurality of cryptographic pseudorandom function ranging code samples is received and stored prior to receiving of the cryptographic pseudorandom function seed data. In addition or the alternative to any of the foregoing examples (including examples of a client device or a receiver module), the plurality of first correlation data is generated after receiving the cryptographic pseudorandom function seed data based on the cryptographic pseudorandom function seed data being required to generate the replica cryptographic pseudorandom function ranging code.

In addition or the alternative to any of the foregoing examples (including examples of a client device or a receiver module), the threshold ranging code accumulation requirement is configured based on the threshold authentication security level.

In addition or the alternative to any of the foregoing examples (including examples of a client device or a receiver module), the threshold authentication security level is one of: a 32-bit security level, a 64-bit security level, or a 128-bit security level. In addition or the alternative to any of the foregoing examples (including examples of a method for execution), the threshold authentication security level is another security level, for example, between the 32-bit security level and the 128-bit security level, or optionally greater than the 128-bit security level.

In addition or the alternative to any of the foregoing examples (including examples of a client device or a receiver module), the client device further includes at least one additional processor separate from the receiver module operable to process position navigation and timing data generated by the receiver module.

In addition or the alternative to any of the foregoing examples (including examples of a client device or a receiver module), the aggregated value compares favorably to the threshold value based on the first navigation signal being transmitted via the first satellite of the satellite constellation. In addition or the alternative to any of the foregoing examples (including examples of a client device or a receiver module), the at least one processor operates in accordance with meeting a threshold authentication security level further based on: storing, in memory, an accumulated plurality of spoofed cryptographic pseudorandom function ranging code samples extracted from a spoofed navigation signal (e.g. spoofed GNSS navigation signal or other spoofed navigation signal such as a spoofing of navigation signal 240) transmitted via an adversary radio; applying a linear time invariant matching filter to generate a plurality of second correlation data based on correlation of the replica cryptographic pseudorandom function ranging code with each of the accumulated plurality of spoofed cryptographic pseudorandom function ranging code samples; and/or generating a second aggregated value based on processing the plurality of second correlation data. In addition or the alternative to any of the foregoing examples (including examples of a client device or a receiver module), the spoofed navigation signal is not authenticated based on the aggregated value comparing unfavorably to the threshold value. In addition or the alternative to any of the foregoing examples (including examples of a client device or a receiver module), failed authentication of the spoofed navigation signal meets the threshold authentication security level based on the accumulated plurality of spoofed cryptographic pseudorandom function ranging code samples being accumulated in accordance with the threshold ranging code accumulation requirement.

In addition or the alternative to any of the foregoing examples (including examples of a client device or a receiver module), the at least one processor is further operable to: generate pseudorange data based on processing the accumulated plurality of cryptographic pseudorandom function ranging code samples.

In addition or the alternative to any of the foregoing examples (including examples of a client device or a receiver module), position navigation and timing data is generated based on the pseudorange data.

In addition or the alternative to any of the foregoing examples (including examples of a client device or a receiver module), the aggregated value is generated without processing the pseudorange data. In addition or the alternative to any of the foregoing examples (including examples of a client device or a receiver module), the aggregated value is not a function of the pseudorange data.

In addition or the alternative to any of the foregoing examples (including examples of a client device or a receiver module), the pseudorange data is generated after authenticating the first navigation signal, in response to authenticating the first navigation signal.

In addition or the alternative to any of the foregoing examples (including examples of a client device or a receiver module), the at least one processor is further operable to: generate a plurality of additional pseudorange data based on processing a plurality of additional cryptographic pseudorandom function ranging code samples of a plurality of other navigation signals (e.g. a plurality of other GNSS navigation signals or another plurality of other navigation signals such as a plurality of other navigation signals 240). In addition or the alternative to any of the foregoing examples (including examples of a client device or a receiver module), the aggregated value is generated without computing any pseudorange difference values between the pseudorange data with any of the plurality of additional pseudorange data. In addition or the alternative to any of the foregoing examples (including examples of a client device or a receiver module), the aggregated value is generated without performing any comparison of the pseudorange data with any of the plurality of additional pseudorange data.

In addition or the alternative to any of the foregoing examples (including examples of a client device or a receiver module), the plurality of navigation signals include a plurality of Galileo signals transmitted by a plurality of Galileo satellites of the Galileo satellite constellation. In addition or the alternative to any of the foregoing examples (including examples of a client device or a receiver module), the first navigation signal is a first Galileo signal authenticated without computing any pseudorange difference values between the pseudorange data with any of the plurality of additional pseudorange data and without performing any comparison of the pseudorange data with any of the plurality of additional pseudorange data. In addition or the alternative to any of the foregoing examples (including examples of a client device or a receiver module), the first navigation signal is a first Galileo signal authenticated without processing the pseudorange data.

In addition or the alternative to any of the foregoing examples (including examples of a client device or a receiver module), at least some of the plurality of satellites are located in LEO orbit, and/or the first satellite of the plurality of satellites transmits the first navigation signal from LEO orbit.

In addition or the alternative to any of the foregoing examples (including examples of a client device or a receiver module), the first satellite of the plurality of satellites transmits the first navigation signal from LEO orbit based on being a satellite that is associated with the Galileo GNSS service and that is operating in LEO orbit.

In addition or the alternative to any of the foregoing examples (including examples of a client device or a receiver module), the first satellite of the plurality of satellites transmits the first navigation signal from LEO orbit based on being a satellite that is associated with the Pulsar service and that is operating in LEO orbit.

In addition or the alternative to any of the foregoing examples (including examples of a client device or a receiver module), at least some of the plurality of satellites are located in MEO orbit, and/or the first satellite of the plurality of satellites transmits the first navigation signal from MEO orbit.

In addition or the alternative to any of the foregoing examples (including examples of a client device or a receiver module), the plurality of navigation signals are a plurality of navigation signals transmitted via a plurality of satellites of a satellite constellation, where the first navigation signal is a first navigation signal.

In addition or the alternative to any of the foregoing examples (including examples of a client device or a receiver module), the plurality of navigation signals are a plurality of Pulsar signals, where the first navigation signal is a first Pulsar signal.

FIG. 13B presents an example embodiment of a GNSS receiver module 2610 (e.g. of a client device 160) that receives signals 132 via an antenna 1902 and/or a corresponding receiver 1904, where the received navigation signals 132 undergo processing via processing system 1920 that implements an authentication module 1950 operable to generate authentication output 1947 (e.g. via processing authentication key data 1905, for example, implemented as and/or based on a cryptographic seed that was to generate a PRF ranging code included in the signal 132) indicating whether a corresponding received navigation signal 132 is authenticated, for example, where navigation signals 132 are only further processed to render generation of GNSS position and/or timing data 2271 when the signal is determined to be authenticated (e.g. via processing of the authentication output 1947).

For example, the generation and processing of authentication output 1947 is implemented in conjunction with applying GNSS signal authentication mechanism 2310. As a particular example, the GNSS signals 132 are Galileo signals (e.g. Galileo E6-C signals and/or Galileo E1-B signals), and/or the GNSS receiver module 2610 implements a Galileo receiver. Some or all features and/or functionality of GNSS signal receiver module 2610, processing system 1920, authentication module 1950 and/or GNSS signal authentication mechanism 2310 of FIG. 13B can implement some or all features and/or functionality of any client device, receiver module, processing system, authentication module, GNSS signal authentication mechanism, and/or signal authentication described herein. Some or all features and/or functionality of processing GNSS signals 132 of FIG. 13B can be implemented in a same or similar fashion as processing navigation signals 240 described herein, for example, as presented in conjunction with FIG. 12B.

FIG. 13C presents an example embodiment of a processing system 1920 (e.g. of a GNSS receiver module 2610 and/or of a client device 160) that implements authentication module 1950 operable to generate authentication output 1947 (e.g. via processing authentication key data 1905, for example, implemented as and/or based on a cryptographic seed that was to generate a PRF ranging code included in the signal 132) via implementing a statistical value generator module 1939, where authentication output 1947 includes a set of statistical values 1962.1-1962.V (e.g. the set of statistical values includes at least one statistical value 1962, where V is greater than or equal to one). For example, navigation signals 132 are only further processed to render generation of GNSS position and/or timing data 2271 when the signal is determined to be authenticated, based on whether some or all statistical values 1962.1-1962.V compare favorably to (e.g. fall below) corresponding threshold values 1944.1-1944.V (e.g. statistical value 1962.1 is compared to threshold value 1944.1; statistical value 1962.2 is compared to threshold value 1944.2; etc.). For example, the generation and processing of authentication output 1947 is implemented in conjunction with applying GNSS signal authentication mechanism 2310. As a particular example, the GNSS signals 132 are Galileo signals (e.g. Galileo E6-C signals and/or Galileo E1-B signals), and/or the GNSS receiver module 2610 implements a Galileo receiver. Some or all features and/or functionality of GNSS signal receiver module 2610, processing system 1920, authentication module 1950 and/or GNSS signal authentication mechanism 2310 of FIG. 13C can implement some or all features and/or functionality of any client device, receiver module, processing system, authentication module, GNSS signal authentication mechanism, and/or signal authentication described herein. Some or all features and/or functionality of processing GNSS signals 132 of FIG. 13C can be implemented in a same or similar fashion as processing navigation signals 240 described herein, for example, as presented in conjunction with FIG. 12C.

In various examples, the set of V statistical values 1962.1-1962.V can include a single value or optionally a plurality of values. Authentication of the GNSS signal 132 can be based on whether some or all of the statistical values compare favorably to threshold values 1944.1-1944.V (e.g. a statistical value 1962.i compares favorably to a corresponding threshold value 1944.i based on being greater than, greater than or equal to, less than, and/or less than or equal to the respective threshold values, for example, depending on whether the values are threshold maximums or threshold minimums). Some or all statistical values 1962 can all be compared to a same threshold value 1944 and/or different threshold values 1944 can be set for some or all different statistical values 1962.

In various examples, a first value 1962.1 of the set of statistical values 1962.1-1962.V corresponds to a probability of missed detection computed via the statistical value generator module 1939 and/or a second value 1962.2 of the set of statistical values 1962.2 corresponds to a probability of false alarm computed via the statistical value generator module 1939. In some embodiments, the set of statistical values 1962.1-1962.V optionally only includes these two values and no additional statistical values, where authentication is only based on whether or not these two values compare favorably to a same respective threshold (e.g. a threshold maximum probability value) or whether or not these to values each compare favorably to different respective thresholds (e.g. two different threshold maximum probability values).

FIGS. 13D and 13E present an example embodiment of a processing system 1920 (e.g. of a GNSS receiver module 2610 and/or of a client device 160) where authentication module 1950 implements a correlator module 1274 that generates correlator output 1955 generated from incoming signals with internal signals 1273 generated via an internal signal generator 1272. As a particular example, the internal signals 1273 are generated to include a replica PRF ranging code 2309 generated via a PRF module 2331 applied to PRF seed data 1932 (e.g. the PRF seed is fed into to a corresponding cryptographic pseudorandom function applied by PRF module 2331 to generate the replica PRF ranging code 2309 included in internal signals 1273). Ranging values 1255 included in correlator output 1255 can be processed via an output generator module 1919 to render generation of authentication output 1947. Some or all features and/or functionality of GNSS signal receiver module 2610, processing system 1920, authentication module 1950 and/or GNSS signal authentication mechanism 2310 of FIG. 13C can implement some or all features and/or functionality of any client device, receiver module, processing system, authentication module, GNSS signal authentication mechanism, and/or signal authentication described herein. Some or all features and/or functionality of processing GNSS signals 132 of FIG. 13D and/or 13E can be implemented in a same or similar fashion as processing navigation signals 240 described herein, for example, as presented in conjunction with FIG. 12H, where internal signals 1273 are instead generated to include replica PRF ranging codes 2309 instead of watermarking spreading sequences 1909 based on the respective GNSS signals 132 being implemented to employ authentication via including corresponding PRF ranging codes rather than watermarked ranging codes, for example, based on configuration of a corresponding GNSS constellation, for example, configured to perform PRF ranging (e.g. the receiver module 2610 is configured to receive, authenticate, decrypt, and/or process encrypted GNSS signals 132 such as GPS's M-Code signals and/or Galileo's Public Regulated Service (PRS) signals).

For example, as illustrated in the example of FIG. 13D, the authentication output indicates that a first incoming signal, corresponding to a true GNSS signal 132, is authenticated, for example, based on high correlation of the true GNSS signal 132 with the internal signals 1273 based on having the same PRF ranging code 2309 and/or based on the authentication module 1950 being implemented via applying the GNSS signal authentication mechanism 2310 to have low probability of false alarm. Alternatively or in addition, as another example, as illustrated in the example of FIG. 13E, the authentication output indicates that a second incoming signal, corresponding to a spoofed GNSS signal 133, is not authenticated, for example, based on lower correlation of the spoofed GNSS signal 133 with the internal signals 1273, for example, based on having the a spoofed PRF ranging code 2319 not matching replica PRF ranging code 2309, and/or based on the authentication module 1950 being implemented via applying the GNSS signal authentication mechanism 2310 to have low probability of missed detection.

In various examples, GNSS signal authentication mechanism 2310 can be implemented based on known, derived, and/or configured relationships between some or all values of the table below:

| Notation | Definition and Short Description |
|---|---|
| n | The number of chips within a single ranging code (or ranging |
| | code segment). For instance, for Galileo's E6-C, n = 5115. |
| T | The length of time covering a single ranging code. For |
| | instance, for Galileo's E6-C, T = 1 ms. |
| W | The number of ranging codes (or ranging code segments) |
| | that should be aggregated when making an authentication |
| | determination. |
| R | A replica of the ranging code with elements −1 and 1, |
| | sometimes with a superscript denoting what generated the |
| | replica and subscript denoting whether it is reversed in time |
| | for a matching convolution. |
| F | The frequency of the radio making the authentication |
| | determination. |
| S | The signal measured over T with frequency F. |
| P | The power of the ranging signal immediately preceeding |
| | correlation. |
| σ² | The noise power. |
| p | The probability of correctly estimating a chip. |

In various examples, GNSS signal authentication mechanism 2310 can be implemented based on principles of PRF ranging.

In various examples, such as examples of implementing GNSS signal authentication mechanism 2310 based on principles of PRF ranging, GNSS ranging codes of GNSS signals 132 are designed to have high autocorrelation and low cross-correlation. For example, GNSS receiver 2610 can be configured to use a replica of the ranging code (e.g. generated via PRF module 2331) to shift-correlate with its observed radio signal (e.g. via correlator module 1274). In various examples the high autocorrelation can enable the receivers to lift the signal from the noise, and/or the sharp autocorrelation peak can enable the receiver to measure a precise signal arrival time forming a pseudorange. For example at least four satellite pseudoranges enable a receiver to deduce its position and time via trilateration.

In various examples, such as examples of implementing GNSS signal authentication mechanism 2310 based on principles of PRF ranging, random code can serve as ranging codes since random sequences have high autocorrelation and low cross-correlation. For example, pseudorandom code sequences (e.g. sequences that appear random but actually derive from a deterministic process) can also suffice. In various examples, when a ranging code derives from a cryptographic PRF, the ranging code can inherit cryptographic security properties. For example, when a ranging code derives from a cryptographic PRF utilizing a secret seed (e.g. of PRF seed data 2332), then the ranging code admits no efficient algorithm that can distinguish it from a truly random sequence nor predict future chips with probability better than random guessing. In various examples, before a PRF ranging code's broadcast, their security limits adversarial attempts to forge ranging signals to that of random guesses. In various examples, PRF ranging codes can be derived multiple ways, including via encryption or cryptographic hashing. For example, such PRF ranging can be implemented in GNSS signals such as GPS's M-Code signals and/or Galileo's PRS signals.

In various examples, such as examples of implementing GNSS signal authentication mechanism 2310 based on principles of PRF ranging, a GNSS navigation service encrypts ranging codes of GNSS signal 132 and never discloses the deriving key. The GNSS navigation service can perform a second encryption on these ranging codes, for example, utilizing undisclosed authentication keys (e.g. TESLA keys). These second-encrypted ranging codes can be available for download from a server to any receiver. As the GNSS navigation service reveals TESLA keys, the receiver can be able decrypt the second-encrypted ranging codes and/or perform post processing of the GNSS signal 132 to determine authenticity. Such a receiver can be improved to determine authenticity with high confidence based on employing some or all features and/or functionality of various examples of GNSS signal authentication mechanism 2310 described herein.

As a particular example of such a GNSS navigation service can include the Galileo navigation service. In various examples, Galileo's SAS implementation of PRF ranging authentication with Galileo's encrypted E6-C signal with assistance from Galileo's OSNMA on Galileo's E1-B signals can apply such methodology. For example, the Galileo navigation system encrypts ranging codes of its E6-C signal and never discloses the deriving key. The Galileo navigation system can perform a second encryption on the E6-C ranging codes utilizing the undisclosed TESLA keys from OSNMA. These second-encrypted ranging codes can be available for download from a server to any receiver. As OSNMA reveals TESLA keys, the receiver will be able decrypt the second-encrypted E6-C ranging codes and perform post processing of the E6-C signal to determine authenticity. Such a receiver can be improved to determine authenticity of Galileo signals with high confidence based on employing some or all features and/or functionality of various examples of GNSS signal authentication mechanism 2310 described herein.

In various examples, GNSS signal authentication mechanism 2310 can be implemented based on principles of chip estimation theory.

In various examples, such as examples of implementing GNSS signal authentication mechanism 2310 based on principles of chip estimation theory, ranging signals can be modeled as binary keyed code (e.g. Binary Phase-Shift Keyed (BPSK)). For example, each broadcast bit, mapped to 1 or 1, is called a chip. In various examples, when the ranging code derives from a PRF, the adversary cannot predict the chips before their broadcast. In various examples, some adversaries can measure the chips after broadcast. In various examples, GNSS ranging signals are below the thermal noise floor, which can make measuring individual chips difficult without large directional antenna.

In various examples, such as examples of implementing GNSS signal authentication mechanism 2310 based on principles of chip estimation theory, given the noise power σ² and the signal power P, a single measurement of the BPSK baseband (i.e., after carrier removal) signal S can be expressed as, derived from, and/or based on:

N~ [symbol] (0,σ²);

S=±\sqrt{P}+N

In various examples, such as examples of implementing GNSS signal authentication mechanism 2310 based on principles of chip estimation theory, with this model, the probability of successfully measuring a chip correctly can be expressed as, derived from, and/or based on the following (e.g. referred to herein as “eq. (3)”):

$$p = {cdf}_{N} ( \sqrt{P} )$$

In various examples, such as examples of implementing GNSS signal authentication mechanism 2310 based on principles of chip estimation theory, such a chip estimation model can be effective in implementing some or all features and/or functionality of GNSS signal authentication mechanism 2310 described herein.

In various examples, GNSS signal authentication mechanism 2310 can be implemented based on modeling of GNSS signals and/or receiver processing.

In various examples, such as examples of implementing GNSS signal authentication mechanism 2310 based on modeling of GNSS signals and/or receiver processing, GNSS signals 132 are constructed based on a baseband signal modulated with a carrier wave, and/or are subdivided into a discrete ranging code units, for which we let n be the number of chips per unit and T be time length per unit. For example, Galileo E6-C utilizes n=5115 chip ranging codes that repeat every T=1 10⁻³ seconds. In various examples, each millisecond ranging code within Galileo E6-C can become a PRF ranging code at will, for example, when encryption is turned on.

In various examples, such as examples of implementing GNSS signal authentication mechanism 2310 based on modeling of GNSS signals and/or receiver processing, novel construction of receiver module 2610 is implemented, for example, after the receiver module 2610 has removed the carrier wave within a tracking loop. In various examples, tracking errors can be accounted for, as discussed in further detail herein. In various examples, the GNSS authentic baseband signal can be constructed as, expressed as, derived from, and/or based on:

S^{Auth}=\sqrt{P}R^{PRF}+N

In various examples, such as examples of implementing GNSS signal authentication mechanism 2310 based on modeling of GNSS signals and/or receiver processing, S, R, and N are each vectors that span a single ranging code. For example, when the receiver sampling frequency is F, then the length of each is FT. In various examples, the resampled replica of the PRF sequence (e.g. the replica PRF ranging code 2309) can be constructed as, expressed as, derived from, and/or based on:

R_{PRF}∈{−1,1}^{FT}

In various examples, such as examples of implementing GNSS signal authentication mechanism 2310 based on modeling of GNSS signals and/or receiver processing, P is the power per chip, which can be is constant per ranging code. In various examples, this assumption that the power per chip is constant per ranging code can be relaxed, for example, as discussed in greater detail in conjunction with subsequent examples presented herein.

FIG. 13F presents a block diagram illustrating implementing of GNSS signal authentication mechanism 2310 via receiver module 2610 (e.g. via a corresponding radio performing the authentication determination), for example, implemented in conjunction with performing PRF ranging implementing favorable levels of authentication security. Some or all features and/or functionality of the GNSS signal authentication mechanism 2310 and/or receiver module 2610 of FIG. 13F can implement some or all features and/or functionality of any client device, receiver module, processing system, authentication module, GNSS signal authentication mechanism, and/or signal authentication described herein.

In various examples, the receiver module 2610 can implement a GNSS tracking loop 2351 (e.g. implemented as a standard GNSS tracking loop), for example, as illustrated in the grey region of FIG. 13F. In various examples of implementing the GNSS tracking loop 2351, after carrier removal, multiple replica correlations aid a tracking loop. In various examples of implementing the GNSS tracking loop 2351, early, prompt, and late (EPL) correlations are used to form a tracking loop to determine the carrier phase, doppler, and/or code phase.

In various examples, initially, the receiver will not have knowledge of R^{PRF}, so it receives the authenticated tracking states from a network or by tracking another synchronized signal. For example, an unknown PRF sequence is known to be present, so the baseband samples are stored into memory awaiting the PRF replica seed. As a particular example, in cases where Galileo's SAS is applied via implementing GNSS signal authentication mechanism 2310, the Galileo's encrypted E6-B and Galileo's open E1-B signal can initially be used for tracking before observing the encrypted E6-C after the PRF secrets are revealed. For example, because Galileo's E6-B is transmitted on the same band as E6-C (as opposed to Galileo's E1-B), utilizing Galileo's E6-B tracking states will not need corrections related to the signal carrier (assuming, reasonably, Galileo can transmit E6-B and E6-C perfectly in phase). In various examples, before the receiver gets the needed secrets to derive R^{PRF} within the E6-C signal, the receiver stores the baseband samples in memory 2359.

In various examples, after receiver module 2610 derives R^{PRF}, it can process those stored baseband samples to determine authentication. For example, after distribution of the PRF seed, the receiver performs an additional correlation with the PRF replica to determine authenticity. In various examples, the samples from memory are fed into a linear time-invariant (LTI) matching filter 2360 (e.g. R^{PRF}). In various examples, gain 2361 (e.g. k^{PRF}) is then applied, for example, where gain 2361 is generated as, expressed as, derived from, and/or based on:

$${k}_{PRF} = \frac{1}{{‖ {R}^{PRF} ‖}_{1}} \frac{1}{\sqrt{P}} = \frac{1}{FT} \frac{1}{\sqrt{P}}$$

In various examples, output of gain 2361 renders generation of a value 2366 (e.g. Y_{PRF}), which can be generated for a corresponding ranging code. In various examples, an aggregating filter 2367 (e.g. E_{W}), such as an averaging filter, is then applied, for example, to aggregate (e.g. average) the result of a predetermined number (e.g. W) of ranging codes (e.g. W values Y_{PRF}), for example, generate a respective aggregated value 2368. In various examples, a threshold gate 2369 that determines authenticity is applied, for example, to determine whether the aggregated value 2368 compares favorably to a predetermined threshold value (e.g. 0.5 in this example, or another value). For example, aggregate value 2368 is implemented as statistical value 1962, for example, where the set of statistical values 1962.1-1962.V of FIG. 13C is implemented to include only one statistical value 1962 that is implemented as aggregated value 2368. Alternatively or in addition, as another example, the predetermined threshold value of threshold gate 2369 is implemented as threshold value 1944 to which statistical value 1962 is compared, for example, where the set of threshold values 1944.1-1944.V of FIG. 13C is implemented to include only one threshold value 1944 that is implemented as the predetermined threshold value of threshold gate 2369 (e.g. 0.5, or a different value, for example, between 0 and 1).

In various examples, a PRF signal is processed to authenticate another signal, for example, as illustrated in the example of FIG. 13F. As a particular example, the encrypted Galileo E6-C is processed, for example, as illustrated in FIG. 13F, to authenticate the open Galileo E1-B. As another example, a similar authentication system can use the PRF ranges directly for Position, Navigation, and Timing (PNT), for example, to generate corresponding GNSS position and/or timing data 2271.

In various examples, the filter 2360 and/or gain 2361 are constructed in a particular configuration, such as the example configurations described above, that are derived from and/or otherwise based on predetermined constraints, for example, relating to bounding the PMD and/or PFA (e.g. via enabling a concise mathematical pathway to bound the PMD and PFA).

In various examples, the receiver module 2610 (e.g. corresponding radio block diagram of FIG. 13F) has a secure way (i.e., resistant to adversarial manipulation) to determine the power of the incoming signal, for example as implicit in and/or dictated by the configuration of filter 2360 and/or gain 2361. In some embodiments, the receiver module 2610 (e.g. corresponding radio block diagram of FIG. 13F) is configured based on an assumption that a predetermined threshold value receiver will cease to function and will not attempt to authenticate when the C/N₀<predetermined threshold value (e.g. 30 dB-Hz). For example, receivers coherently integrating over T=1 ms can need much larger C/N₀, meaning that 30 dB-Hz is meant to correspond to an unreasonably low worst case. This assumption can also be applied to make some or all security derivations described herein. In some embodiments, because assuming this unfavorable noise condition makes the security results worse, the receiver should expect better security in reasonable operating conditions. In various example, by selecting this conservative value and/or a different conservative value, the uncertainty resulting from an adversary manipulating the receiver's power estimator, simultaneously jamming the receiver, and/or inducing tracking errors, can be accounted for. In various examples, other conservative assumptions can be applied in other embodiments to render corresponding derivations dictating different corresponding construction of receiver module 2610 accordingly (e.g. by maintaining some or all of the same mathematical derivations described herein when utilizing a different predetermined threshold value of dB-Hz).

In various examples, the receiver module 2610 (e.g. corresponding radio block diagram of FIG. 13F) is configured based on a conservative, worst-case receiver radio model and/or a corresponding worst-case estimate for frequency F (e.g. an assumption that the radio operates at the Nyquist Frequency, for example alternatively or in addition to the unreasonable C/N₀ described above). For example, for Galileo's E6-C, F=10.230 MHz. In various examples, one expects better-reported-security for a real receiver out in the field because they will utilize a sampling frequency greater than the required Nyquist frequency. In various examples, other worst-case assumptions for frequency F can be applied in other embodiments to render corresponding derivations dictating different corresponding construction of receiver module 2610 accordingly (e.g. by maintaining some or all of the same mathematical derivations described herein when utilizing a different predetermined value for F).

In various examples, the receiver module 2610 (e.g. corresponding radio block diagram of FIG. 13F) is configured based on at least one defined adversarial model (e.g. corresponding requirements for a spoofer).

In various examples, such examples for configuring receiver module 2610 based on at least one defined adversarial model, to define the at least one adversarial model, first consider a simple GNSS spoofer with only a transmitting antenna for an open (i.e., not encrypted) signal. For example, this adversary has access to the signal specification, and the ranging signal is simply a repeated, known ranging code. In various examples, the adversary can utilize the specification to submit forged signals to the receiver. For example, to manipulate the victim's deduced position and time, the adversary manipulates the arrival times of the forged signals. In various examples, in supposing the spoofed signal derives from a PRF derived from a secret unknown to anyone except the GNSS provider, then, without the needed cryptographic secrets, the adversary cannot predict the ranging codes before the GNSS provider broadcasts them, even with possession of the signal specification. However, in various examples, a GNSS spoofer with listening and transmitting antenna could observe and then replay the PRF sequence to the victim receiver.

In various examples, such examples for configuring receiver module 2610 based on at least one defined adversarial model, to define the at least one adversarial model, a binary classification can be employed: assuming the adversary either engages in a Security Code Estimation and Replay (SCER) or it does not. In various examples, in an SCER attack, the adversary attempts to observe the unpredictable chips before submitting a forgery to the victim receiver. In various examples, when the receiver does not engage in an SCER attack, it is called a Non-SCER adversary. In various examples, such a binary classification poses a convenience for constraining configuration of the receiver module accordingly, for example, via posing a convenience for corresponding mathematical derivations described herein.

In various examples, such examples for configuring receiver module 2610 based on at least one defined adversarial model corresponding to a Non-SCER adversary, it is assumed that the Non-SCER adversary makes no attempt to observe the cryptographic PRF ranging codes before sub-mitting a signal to the victim receiver. For example, were the Non-SCER adversary to submit a spoof of (e.g. of the form of S^{auth} described herein), it must guess its own replica, for example, constructed as, expressed as, derived from, and/or based on:

S^{¬SCER}=\sqrt{P}R^{¬SCER}+N

In various examples, such examples for configuring receiver module 2610 based on at least one defined adversarial model corresponding to a Non-SCER adversary, suppose the Non-SCER adversary elects to manipulate the authentic signal by adding another noise term of a distribution unknown to the receiver. For example, when the ranging signal is fed through the authentication filter, which is a match filter, the output enacts what amounts to an averaging filter with typically a large number of samples. As a particular example, for Galileo's E6-C, this can amount to at least FT=10230 samples. In various examples, the output of the match filter will be averaged at least W=100 more times thereafter. In various examples, when this unknown distribution is independent and identically distributed (IID) and has finite variance, then this distribution will suffer Central Limit Theorem (CLT) effects through this filter to produce something that approaches a normal distribution anyway. Similarly, in various examples, were the Non-SCER adversary to submit a spoof (e.g. in the form S^{¬SCER} as defined above), where the power is varied, this could in effect add another unknown noise distribution that approaches a normal distribution after filtering. In various examples, if such manipulation were to provide an advantage in increasing the correlation within the match filter, the adversary would have an efficient algorithm that predicts the output of the deriving PRF. In various examples, because the PRF asserts that impossible, Non-SCER power manipulation poses no advantage.

In various examples, such examples for configuring receiver module 2610 based on at least one defined adversarial model corresponding to a Non-SCER adversary, these assumptions could be questioned over authentication determinations that involve more than 1 million samples. However, in various examples, the Non-SCER adversary has no advantage with manipulating P over time nor adding another non-normal noise term. In various examples of characterizing the Non-SCER adversary, it is assumed that the Non-SCER adversary will submit a spoof (e.g. in the form S^{¬SCER} as defined above) with constant P and noise N. In various examples, without any way to predict R^{PRF}, R^{¬SCER} is assumed to be a random guess of length n resampled into FT. In various examples of characterizing the Non-SCER adversary, it is assumed that the sampling FT uniformly spans n and/or that the small sampling quantity differences among chips poses no exploitable advantage to the Non-SCER adversary. In various examples, were there an algorithm that the FT resampling posed an advantage (e.g., the adversary could predict the polarity of the chips with more-than-average-samples-per-chip), then that adversary would break the cryptographic security of the PRF, which the PRF asserts impossible. In various examples, the same argument can be applied to the effect of measurement discretization and the associated gain control before the tracking loop.

In various examples, such examples for configuring receiver module 2610 based on at least one defined adversarial model corresponding to a Non-SCER adversary, some or all of these assumptions can be utilized to bound PMD and PFAs for PRF ranging authentication schemes implemented in applying GNSS signal authentication mechanism 2310.

In various examples, such examples for configuring receiver module 2610 based on at least one defined adversarial model corresponding to a SCER adversary, it is assumed the SCER adversary uses a receiving antenna to estimate R^{PPF} before submitting to its victim receiver. In various examples, because the adversary has access to measurements of R^{PPF}, the SCER adversary should have a better-than-50% chance of guessing each chip, so cryptographic arguments are optionally not as helpful. In some embodiments, as the SCER adversary utilizes better equipment, that probability can increase until it can perfect estimate the individual chips and completely break the ranging authentication security. In various examples, cryptography is not useful for protecting against delays and delays affect the receiver's deduced PNT, and/or full cryptographic security is not obtainable for the SCER case. In some embodiments, the constraints for such an SCER receiving antenna can be defined based on some or all of the assumptions described herein, for example, where such design constraints are generated, transmitted to, displayed to, and/or otherwise communicated to a third party (e.g. via at least one computing system, for example, implemented in association with providing of a navigation service), such as authorities responsible for detecting and stopping spoofers, to aid such authorities in their search to detect such SCER receiving antennas, for example, under their jurisdiction.

In various examples, such examples for configuring receiver module 2610 based on at least one defined adversarial model corresponding to a SCER adversary, there can be two principle ways to limit the effectiveness of SCER adversaries. For example, the first principle way to limit the effectiveness of SCER adversaries exploits how an SCER adversary must submit its spoof to the victim after a delay. In various examples, it requires time for the SCER to observe the R^{PPF}, process its measurements, and transport its forgery to the victim receiver. For example, even with a no-latency SCER model, there is a fundamental limitation via speed of light. In various examples, the receiver therefore can reject SCER-spoofed signals by rejecting late signals. In various examples, the receiver does not use the timing solution provided by GNSS or any other broadcast-only signal, meaning that the receiver optionally must utilize a GNSS-Independent clock to reject late signals. In various examples, the accuracy of this GNSS-independent clock can pose a challenge: a nanosecond of uncertainty can mean about 3 meters of position uncertainty.

Alternatively or in addition, as another example, the second principle way to limit the effectiveness of SCER adversaries exploits the low-power nature of the ranging signal. For example, as the power of the signal decreases, the adversary's chip estimation process becomes more difficult, for which the adversary can compensate by increasing the effectiveness of its radio equipment. In various examples, the adversary cannot increase the effectiveness of its radio equipment indefinitely without detection. For example, as the signal's power decreases and the required SCER equipment increases, it can be easier for authorities on the ground to observe and stop SCER spoofers (e.g. optionally based on constraints for such an SCER receiving antenna being generated, transmitted to, displayed to, and/or otherwise communicated to a third party associated with such authorities as described previously).

In various examples, such examples for configuring receiver module 2610 based on at least one defined adversarial model corresponding to a SCER adversary, a limited SCER adversary, corresponding to a Hard-decision SCER adversary, is applied to configuring receiver module 2610 (e.g. where some or all mathematical derivations dictating configuration of receiver module 2610 are based on assumptions corresponding to the Hard-decision SCER adversary). In various examples, the HDSCER adversary is assumed to make hard decisions on each measured chip via some or all features and/or functionality described herein, for example, ignoring potentially useful soft information (e.g., the posterior probability of the chip measurement). In various examples, since the HDSCER's only advantage over the Non-SCER is a p-accurate hard-decision estimate of the PRF ranging code, there is no still advantage in changing the power. In various examples, limiting to the HDSCER adversary can yield useful mathematically concise predictions, for example, similar to those by the Non-SCER adversary. In various examples, this assumption can be relaxed, for example, simple soft-information-using (e.g. PSCER) can be implemented to yield a small advantage to the HDSCER that manipulates the individual chip powers. In various examples, this small advantage can be accounted for by adjusting the results of the HDSCER. In various examples, while other soft-information adversaries could do better, the universal trade between an approximate problem with an exact solution versus an exact problem with an approximate solution is approached.

In various examples, utilizing the mathematical derivations for the HDSCER case and/or results from the PSCER case adversarial radio equipment can be predicted, where corresponding design constraints can optionally be generated, transmitted to, displayed to, and/or otherwise communicated to a third party associated with authorities, for example, enabling such authorities on the ground to search for and/or stop spoofers.

In various examples, receiver module 2610 (e.g. corresponding radio block diagram of FIG. 13F) is configured based on probability of false alarm (PFA).

In various examples, such as examples where receiver module 2610 is configured based on probability of false alarm, the authentic signal 132 can be expressed as, derived from, or based on:

S^{auth}=\sqrt{P}R^{PRF}+N

In various examples, such as examples where receiver module 2610 is configured based on probability of false alarm, S^{auth} can be fed into the LTI filter R^{PRF} (e.g. filter 2630 and/or corresponding gain 2631), where receiver module 2610 is optionally configured based on derivation of and/or application of some or all of the following:

$$\begin{matrix}{Y}_{PRF} \vert auth = {k}_{PRF} \cdot {R}_{-}^{PRF} * {S}^{auth} \\ = {k}_{PRF} \cdot {R}_{-}^{PRF} * ( \sqrt{P} {R}^{PRF} + N ) \\ = {k}_{PRF} \sqrt{P} \cdot {R}_{-}^{PRF} * {R}^{PRF} + {k}_{PRF} \cdot {R}_{-}^{PRF} * N\end{matrix} ;$$

$${Y}_{PRF} \vert auth = 1 + {k}_{PRF} \cdot {R}_{-}^{PRF} * N$$

In various examples, such as examples where receiver module 2610 is configured based on probability of false alarm, specifying the distribution can be based on a noise propagation exercise, where receiver module 2610 is optionally configured based on derivation of and/or application of some or all of the following:

$${N}_{FTW} \sim 𝒩 ( 1 , \frac{1}{W} \frac{1}{FT} \frac{{σ}^{2}}{P} ) ;$$

Y_{PRF,W}|auth=1+N_{FTW}.

In various examples, such as examples where receiver module 2610 is configured based on probability of false alarm, because of the low-power nature of GNSS signals, the receiver module 2610 can be operable to aggregate many of these statistics. Since the definition of Y^{PRF}|auth above presents a normal distribution, taking the average of W can change the variance of the noise term, where receiver module 2610 is optionally configured based on derivation of and/or application of some or all of the following:

$${N}_{FTW} \sim 𝒩 ( 1 , \frac{1}{W} \frac{1}{FT} \frac{{σ}^{2}}{P} ) ;$$

$${Y}_{PRF , W} \vert auth = 1 + {N}_{FTW} .$$

In various examples, such as examples where receiver module 2610 is configured based on probability of false alarm, the expectation Y_{PRF,W}|auth is 1. In various examples, such as examples where receiver module 2610 is configured based on probability of false alarm, the expectation Y_{PRF,W}|auth in the Non-SCER spoofing case can be zero 0. A midpoint threshold of 0.5 can be selected for Y_{PRF,W}, for example, without any reason to favor the PMD or PFA. In various examples, the PFA and/or at least one statistical value 1962 can be computed as, expressed as, derived from, and/or based on:

$$\begin{matrix}PFA = Pr ( {Y}_{PRF , W} < 0.5 \vert auth ) \\ = Pr ( 1 + {N}_{FTW} < 0.5 )\end{matrix} ;$$

$$PFA = {cdf}_{{N}_{FTW}} ( - 0.5 ) .$$

In various examples, receiver module 2610 (e.g. corresponding radio block diagram of FIG. 13F) is configured based on probability of missed detection (PMD).

In various examples, such as examples where receiver module 2610 is configured based on probability of missed detection, the PMD is computed based on the 0.5 threshold. In various examples, because of the expectation symmetry of the 0.5 threshold in the authentic and non-SCER spoofing case, and/or because the variance increases in the spoofing case, the PFA will always be less than the PMD in this symmetric 0.5 threshold case. In various examples, receiver module 2610 is configured via a particular value of W, which is optionally selected to meet a specific PMD and security level as discussed in further detail herein. In various examples, given the construction of this threshold, the PFA will always be a less than the PMD of the Non-SCER case.

In various examples, such as examples where receiver module 2610 is configured based on probability of missed detection (e.g. in the Non-SCER case), the authentic signal 132 can be expressed as, derived from, or based on (e.g. as utilized to derive the PMD in the Non-SCER case):

S^{¬SCER}=\sqrt{P}R^{¬SCER}+N

In various examples, such as examples where receiver module 2610 is configured based on probability of missed detection (e.g. in the Non-SCER case), S^{¬SCER} can be passed through the LTI filter R^{PRF}. In various examples, this can be based on the result of convolving R^{PRF} and R^{¬SCER} before either is resampled. For example, in the case that the adversary guesses every single chip of R^{PRF} incorrectly, then the convolution of R^{PRF} and R^{¬SCER} can be −n. In various examples, when the adversary guesses every chip of R^{PRF}, then they are perfectly correlated. The likelihood that the adversary guesses any chips can follow a fair binomial distribution, but with each chip guessed correctly, the correlation increases by 2. In various examples, for example, based on some or all of these relationships, receiver module 2610 is optionally configured based on derivation of and/or application of some or all of the following:

B^{¬SCER}~ [symbol] (n,0.5);

$${R}_{-}^{PRF} * {R}^{¬ SCER} = ( - n + 2 \cdot {B}^{¬ SCER} ) \frac{FT}{n} .$$

In various examples, such as examples where receiver module 2610 is configured based on probability of missed detection (e.g. in the Non-SCER case), receiver module 2610 is optionally configured based on g(b), which can be expressed as, derived from, and/or based on:

$$g ( b ) = \frac{1}{n} ( - n + 2 b ) .$$

In various examples, such as examples where receiver module 2610 is configured based on probability of missed detection (e.g. in the Non-SCER case), S^{¬SCER} can be fed into the LTI filter R^{PRF} (e.g. filter 2630 and/or corresponding gain 2631), where receiver module 2610 is optionally configured based on derivation of and/or application of some or all of the following:

$${Y}_{PRF} \vert ¬ SCER = {k}_{PRF} \cdot {R}_{-}^{PRF} * {S}^{¬ SCER} = {k}_{PRF} \cdot {R}_{-}^{PRF} * ( \sqrt{P} {R}^{¬ SCER} + N ) = {k}_{PRF} \sqrt{P} \cdot {R}_{-}^{PRF} * {R}^{¬ SCER} + {k}_{PRF} \cdot {R}_{-}^{PRF} * N ;$$

$${Y}_{PRF} \vert ¬ SCER = g ( {B}^{¬ SCER} ) + {N}_{FT} .$$

In various examples, such as examples where receiver module 2610 is configured based on probability of missed detection (e.g. in the Non-SCER case), Y^{PRF}|¬SCER is the sum of a linearly transformed binomial distribution and the noise-propagated normal distribution.

In various examples, such as examples where receiver module 2610 is configured based on probability of missed detection (e.g. in the Non-SCER case), the receiver can aggregate W of these identically distributed statistics (e.g. W instances of computed values of Y^{PRF}|¬SCER) to make an authentication determination (e.g. based on computing aggregated value 2368 from these W identically distributed statistics and comparing the aggregated value to the predetermined threshold value, such as 0.5).

In various examples, the CLT can aid designing system parameters by providing closed-form expressions of the distributions. After performing a search of system parameters utilizing the CLT, one can then verify the system parameters with the actual distributions. For example, where receiver module 2610 is configured based on the distribution of Y^{PRF}|¬SCER, such as its expectation or variance, where receiver module 2610 is optionally configured based on derivation of and/or application of some or all of the following (e.g. noting that g is a linear function):

$$\begin{matrix}𝔼 [ {Y}_{PRF} \vert ¬ SCER ] = 𝔼 [ g ( {B}^{¬ SCER} ) + {N}_{FT} ] \\ = 𝔼 [ g ( {B}^{¬ SCER} ) ] \\ = g ( 𝔼 [ {B}^{¬ SCER} ] ) \\ = g ( \frac{n}{2} ) \\ 𝔼 [ {Y}_{PRF} \vert ¬ SCER ] = 0\end{matrix} .$$

$$\begin{matrix}𝕍 [ {Y}_{PRF} \vert ¬ SCER ] = 𝕍 [ g ( {B}^{¬ SCER} ) + {N}_{FT} ] \\ = 𝕍 [ g ( {B}^{¬ SCER} ) ] + 𝕍 [ {N}_{FT} ] \\ = 𝕍 [ g ( {B}^{¬ SCER} ) ] + \frac{1}{FT} \cdot \frac{{σ}^{2}}{P} \\ = \frac{4}{{n}^{2}} 𝕍 [ {B}^{¬ SCER} ] + \frac{1}{FT} \cdot \frac{{σ}^{2}}{P} \\ = \frac{4}{{n}^{2}} \frac{n}{4} + \frac{1}{FT} \cdot \frac{{σ}^{2}}{P} \\ 𝕍 [ {Y}_{PRF} \vert ¬ SCER ] = \frac{1}{n} + \frac{1}{FT} \cdot \frac{{σ}^{2}}{P}\end{matrix} .$$

As discussed previously, such as examples where receiver module 2610 is configured based on probability of missed detection (e.g. in the Non-SCER case), the authentic vs. spoof threshold (e.g. predetermined threshold of gate 2369) can be set as 0.5 (e.g. based on not favoring PFA over PMD or vice versa), for example, based on some or all of the above and/or based on the expectation of Y_{PRF}|auth being equal to zero as discussed previously. This can be utilized to enable determination of system parameters with an acceptably low PFA and PMD.

In various examples, such as examples where receiver module 2610 is configured based on probability of missed detection (e.g. in the Non-SCER case), the expectation and/or variance of Y_{PRF} can be utilized in performing an efficient search over W to find candidate with a potentially acceptable PMD, for example, by employing the CLT. In various examples, after this search, the PMD is computed directly to verify authentication security, for example, based on derivation and/or applying of:

B^{¬SCER,W}~ [symbol] (nW,0.5).

$$PMD \vert ¬ SCER = Pr ( {Y}_{PRF , W} \geq 0.5 \vert ¬ SCER ) = Pr ( \frac{1}{W} {\sum }_{W} ( g ( {B}^{¬ SCER} ) + {N}_{FT} ) \geq 0.5 ) = Pr ( \frac{1}{W} {\sum }_{W} ( g ( {B}^{¬ SCER} ) + \frac{1}{W} {\sum }_{W} {N}_{FT} \geq 0.5 ) = Pr ( g ( \frac{1}{W} {B}^{¬ SCER , W} ) + {N}_{FTW} \geq 0.5 ) = {\sum }_{b} Pr ( g ( \frac{b}{W} ) + {N}_{FTW} \geq 0.5 ) \cdot Pr ( b = {B}^{¬ SCER , W} ) = {\sum }_{b} {ccdf}_{{N}_{FTW}} ( 0.5 - g ( \frac{b}{W} ) ) \cdot Pr ( b = {B}^{¬ SCER , W} )$$

In various examples, such as examples where receiver module 2610 is configured based on probability of missed detection (e.g. in the Non-SCER case), the derivation above provides the exact PMD up to the precision of normal Cumulative Density Function (CDF) and/or the computational numerical precision (referred to as “eq. (21)” in subsequent examples described herein).

In various examples, such as examples where receiver module 2610 is configured based on probability of missed detection (e.g. in the Non-SCER case), the mathematical derivations above and/or some or all other mathematical derivations described herein can be applied to Galileo's E6-C, where receiver module 2610 (e.g. corresponding radio block diagram of FIG. 13F) is configured based on achieving an acceptable PMD in the case of authenticating Galileo signals, for example, where Galileo's E6-C signal is processed via receiver module 2610 (e.g. via the corresponding radio block diagram of FIG. 13F), for example, to authenticate the open Galileo E1-B signal, features specific to the Galileo signal can be utilized to render appropriate configuration accordingly.

FIGS. 13G-13M illustrate relationships, for example, utilized to configure receiver module 2610 (e.g. corresponding radio block diagram of FIG. 13F) and/or utilized to predict radio configuration of spoofing adversaries, for example based on values specific to implementing signal 132 as Galileo's E6-C signal. Any embodiment of receiver module 2610 described herein can be configured based on values specific to implementing signal 132 as Galileo's E6-C signal, for example, based on relationships illustrated in one or more of the FIGS. 13G-13M. Any embodiment of generating, transmitting, displaying, and/or communicating radio configuration data required to spoof a signal described herein can be configured based on values specific to implementing signal 132 as Galileo's E6-C signal, for example, based on relationships illustrated in one or more of the FIGS. 13G-13M.

In various examples, such as examples where receiver module 2610 (e.g. corresponding radio block diagram of FIG. 13F) is configured based on achieving an acceptable PMD in the case of authenticating Galileo signals, (e.g. where the Galileo E6-C signal is used within Galileo's SAS to provide ranging authentication), the E6-C signal utilizes n=5115 ranging codes, and/or the appropriate Nyquist frequency is F=10.230 MHz. In various examples, once encryption is enabled, the ranging code can become a PRF under a commitment-based authentication protocol.

FIG. 13G provides the PMD varying W integrally from 0 to 800, for example, utilizing the derivation above of eq. (21), for example, providing the exact PMD up to the precision of normal Cumulative Density Function (CDF) and/or the computational numerical precision, for example, computed with SciPy utilizing the log survival function (log complimentary CDF function), and the products within the sum of eq. (21) utilizing the log product rule. In various examples, each of these steps is applied to minimize the losses from machine precision.

In various examples, Galileo's E6-C PRF sequence can be utilized to authenticate another band (e.g., E1-B). In various examples, if the receiver does not track separately the E6-C PRF signal (e.g., via E6-B or via network), local environmental effects may require the receiver to conduct a search to find the correlation peak. For example, this search could be required on the tracking states (e.g., carrier phase, doppler frequency, ranging code phase). In various examples, that receiver might try multiple times to find the PRF correlation.

In various examples, the net effect on the security model is that the adversary would be allowed multiple attempts to submit a potential forgery over a single range authentication determination. In that case, the minimum PMD should reflect a minimum security level of 128-bits, and so the receiver should aggregate 341 ms of data when making an authentication determination, for example, as illustrated in the relationship between W and PMD illustrated in FIG. 13G.

In various examples, if the E6-C authentication determination is aided with another signal that can provide accurate tracking states, and/or if the receiver is only allowed one attempt to make the authentication determination, then the security level can decrease provided the PMD is acceptable. This would be appropriate if another signal that is perfectly in phase is used to determine the E6-C tracking states, like the E6-B signal. Then 77 ms aggregations are sufficient, for example, in other similar applications where 32-bit security is acceptable.

In various examples, receiver guidelines will not necessarily recommend the minimum prescriptive boundaries from the previous paragraphs, but will instead round up to rounder numbers (e.g. 77 ms could become 100 ms; and 341 ms could become 400 ms; etc). If that is the case, then the initial noise assumption could be lowered further. FIG. 13H demonstrates these trends utilizing the CLT approximations, illustrating Minimum Noise Assumptions over Aggregation Time with varying security requirements utilizing the CLT approximations. Again, once a suitable candidate is found, eq. (21) can be used to bound the PMD and assert authentication security.

In various examples, such as examples where receiver module 2610 is configured to implement HDSCER PRF ranging security, the Non-SCER adversary must guess the R^{PPF}, which can explains the 50% probabilities in previous equations described herein. In various examples, since the HDSCER adversary may measure R^{PPF} before submitting to the victim receiver, the SCER adversary will have a better-than-50% chance of guessing each chip. In various examples, because a better and better HDSCER receiving radio will eventually be able to estimate the PRF ranging code chips eventually, security arguments can be offloaded authorities who can detect and search for this equipment. Ideally, the needed equipment will be large enough to be easily detected and destroyed. The receiving radio equipment required to perform an HDSCER spoof can be predicted (e.g. via computing device), for example, where the respective configuration of such radio equipment required to perform an HDSCER spoof can be generated, transmitted, displayed, and/or otherwise communicated to another computing device associated with authorities responsible for locating, confiscating, and/or destroying such equipment utilized to spoof GNSS signals (e.g. Galileo's E6-C signal).

In various examples, such as examples where configuration of radio equipment required to perform an HDSCER spoof is generated and/or communicated via a computing device, with the HDSCER adversary, the adversary makes a hard decision on each individual chip. For example, corresponding math for the HDSCER can be identical to the Non-SCER, except that the binomial distribution probability p is greater than 50% (e.g. the equation below referred to herein as “eq (23)”):

B^{HDSCER,W}~ [symbol] (nW,p);

$$PMD \vert HDSCER = {\sum }_{b} {ccdf}_{{N}_{FTW}} ( 0.5 - g ( \frac{b}{W} ) ) \cdot Pr ( b = {B}^{¬ SCER , W} )$$

In various examples, the CLT approximations can again be helpful where the equations for expectation and variance can be extended, for example, via derivation of and/or applying of:

[symbol]

[Y_{PRE}|HDSCER]=g( [symbol] [B^{HDSCER}])

=g(np);

[symbol]

[Y_{PRF}|HDSCER]=2p−1;

$$𝕍 [ {Y}_{PRF} \vert HDSCER ] = \frac{4}{n} p ( 1 - p ) + \frac{1}{FT} \cdot \frac{{σ}^{2}}{P} .$$

In various examples, such as examples where configuration of radio equipment required to perform an HDSCER spoof, for example of Galileo's E6-C signal, is generated and/or communicated via a computing device, bounding the HDSCER adversary requires assumptions that can be ultimately subjective. For example, a better adversarial receiving radio can eventually break the security afforded by any ranging service. An application of Galileo's E6-C signal can be provided, for example, assuming that the HDSCER adversary is on the ground receiving the maximum specified power from the Galileo ICD and that the radio has a 1 Hz bandwidth.

In various examples, such as examples where configuration of radio equipment required to perform an HDSCER spoof, for example of Galileo's E6-C signal, is generated and/or communicated via a computing device, the total received maximum power on the ground for E6-C is 153 dBW, after accounting for the 50% power split to E6-C. Assuming a ground temperature of 300 K yields an SNR of 50 dB. A chipping rate of 5.155 MHz chipping rate yields a processing gain of 67 dB, yielding an expected maximum adversarial chip SNR of −17 dB.

FIG. 13I provides the computed PMD given an adversarial chip SNR, generated from the CLT formulations for expectation and variance above (e.g. due to the computational speed and the expected small deviation from eq. (23)), illustrating comparison of HDSCER PMD with multiple W against the adversarial individual Chip SNR. In various examples, such as examples where configuration of radio equipment required to perform an HDSCER spoof, for example of Galileo's E6-C signal, is generated and/or communicated via a computing device, an assumed adversarial chip SNR of −17 dB is already breaking 32-bit security. In various examples, given the PMD, it is very probable that the attack would be detected, and exponentially probable after multiple checks.

In various examples, such as examples where configuration of radio equipment required to perform an HDSCER spoof, for example of Galileo's E6-C signal, is generated and/or communicated via a computing device, an interesting behavior observable from FIG. 13I is that once the HDSCER adversary is more than 50% likely to submit a forgery, increasing W supports the adversary (hence the vertical order of the W curves reverse in FIG. 13K on the right side). For example, the effect of increasing W removes uncertainty from the noise. In various examples, At this inflection point, the adversary can have a chip-estimation probability of 75%, which from equations above can predict that the expectation crosses the Y_{PRF}=0.5 decision boundary. For example, therefore, at that point, the shrinking noise effect from increasing W makes the adversarial forgery probability better. This occurs when the chip SNR is −3.42 dB after solving eq. (3) with 75% (or when the adversarial gain is about 13.58 dB considering FIG. 13I).

In various examples, such as examples where configuration of radio equipment required to perform an HDSCER spoof, for example of Galileo's E6-C signal, is generated and/or communicated via a computing device, at this inflection point, the effects of increasing adversarial jamming no longer benefit the adversary. For example, this means the conservative radio model described previously is no longer conservative. In various examples, increasing either F or the assumed C/N₀ each benefit the adversary (rather than the reverse before). For example, a conservative radio model would involve a high F and receiver C/N₀. The net effect of this model's reversal past this inflection point is the adversary will be able to certainly and effectively break the security of the ranging authentication under a conservative radio model. For example, once the adversary estimates the chips with sufficient probability that its expectation of the spoofed Y_{PRF} is above the decision boundary, the HDSCER completely breaks authentication security.

In various examples, such as examples where configuration of radio equipment required to perform an HDSCER spoof, for example of Galileo's E6-C signal, is generated and/or communicated via a computing device. to counteract this, one can increase the Y_{PRF}=0.5, which can come at the expense of the PFA. FIG. 13J provides a plot of this trade off, illustrating the effect of increasing decision boundary on Y_{PRF} on the needed breaking Adversarial SNR and PFA. In various examples, after making a selection at the expense of PFA with FIG. 13J, FIG. 13I can be recalculated using the new decision boundary. For example, after computing an expected antenna gain to break the system, a description of that radio equipment of the systems can be communicated to authorities. Given the results from 13L already predict a radio of 13 dB, this will be a directional or phased array antenna that cannot be miniaturized, providing some level of assurance that such equipment could be detected and confiscated/destroyed.

In various examples, the PMDs derived herein are validated, for example, via Monte Carlo experiments. For example, some or all features and/or functionality of receiver module 2610 described herein, and/or application to Galileo's E6-C, can be constructed so that the PMD is unreasonable small to provide authentication security. In various examples, these design goals can pose the same challenge in simulation: an unreasonable number of trials is required to observe a single missed detection. In various examples, the simulated C/N₀ is decreased substantially so that the mathematical models can actually predict simulated missed detections.

FIG. 13K provides the results of a Monte Carlo experiment to verify eq. (21). In various examples, in the experiment, each trial involves a simulated baseband signal. In various examples, the authentic and Non-SCER replicas are both chosen randomly and then resampled, with a simulated Non-SCER spoof fed through the simulated receiver filter and threshold-authentication determination. In various examples, after conducting all the trials, the fraction of observed missed detections forms an estimator of the actual PMD. In various examples, FIG. 13K compares the measured PMD and CLT 99.7% confidence bounds against the predicted PMD. For example, the same function is used to generate FIGS. 13G and 13K. In various examples, based on how the experiments match the predictions, eq. (21) and FIG. 13G can be validated.

FIG. 13L provides the results of a Monte Carlo experiment to verify eq. (23). In various examples, in the experiment, each trial involves a simulated baseband signal. In various examples, the authentic replica is chosen ran-domly, and then I simulate the HDSCER's ability to estimate the authentic replica chips. In various examples, both replicas are then resampled with a simulated HDSCER spoof fed through the simulated receiver filter and threshold-authentication determination. In various examples, After conducting all the trials, the fraction of observed missed detections forms an estimator of the predicted PMD. FIG. 13L compares the measured PMD and CLT 99.7% confidence bounds against the predicted PMD. For example, the same function is used to generate FIGS. 13I and 13L. Based on how the experiments match the predictions, eq. (23) and FIG. 13I can be validated.

In various examples, while the HDSCER provides a mathematically concise pathway to predict the SCER security probabilities, simulated evidence of a slightly better SCER adversary can be generated and/or evaluated. For example, the HDSCER adversary ignores the soft information in its measurement and does not modify its power levels. In various examples, a PSCER adversary can be defined, for example, where such a PCDER adversary sets the individual chip powers proportional to the measured posterior probability of each chip. In various examples, to counteract noticeable effects on the power, the PSCER adversary normalizes its output power over a whole PRF ranging aggregation interval (hence “proportional”). In various examples, in effect, if the adversary is more certain on a estimated chip, it will provide that chip more power in its spoof. In various examples, the effects of the radio's analog-to-digital gain control can be further considered.

FIG. 13M provides a simulation showing a small advantage with the PSCER adversary over the HDSCER. For example, since the PSCER simulated PMD is above the HDSCER PMD, the PSCER has an advantage over the HDSCER. In various examples, some performance improvement can be obtained by utilizing soft information. Looking at how far left the PSCER line is to the HDSCER line predicts the soft information advantage of approximately 0.6 dB. In various examples, one could account for this result by compensating the adversarial SNR of 0.6 dB within section IV. However, this result still does not provide an upper bound on the potential SCER performance.

In various examples, derived distributions of the authentication security of PRF GNSS ranging under several adversarial models can be generated and/or utilized in configuring a receiver module 2610. In various examples, with the derivations and/or respective predictions, a GNSS designer can design a secure PRF ranging authentication service (e.g. implemented via a receiver module 2610). In various examples, under the Non-SCER model, these derivations can be utilized to specify how long a receiver must correlate PRF ranging codes to provide a specific PMD. In various examples, under the HDSCER model, the needed spoofing radio equipment needed to break authentication security can be predicted. In various examples, for Galileo's E6-C, a receiver must aggregate at most 100 or 400 ms of PRF Galileo E6-C to assert 32-bit and 128-bit security under Galileo's SAS, respectively. In various examples, an SCER antenna with a 13 dB gain antenna should be able to estimate the chips sufficiently to break authentication security of Galileo's E6-C PRF signal, for example, neglecting the difficulty in quickly processing, transporting, and transmitting without detection either by a local authority or by the receiver's onboard GNSS-independent clock.

FIG. 13N illustrates an example method for execution. Some or all steps of FIG. 13N can be executed by: a client device such as client device 160, a receiver module such as receiver module 2610, a processing system 1920, a node of a systems such as a node of satellite constellation system 100, a data frame receival and processing system such as data frame receival and processing system 1802, and/or via at least one processor, at least one memory, and/or at least one receiver (e.g. of any computing device). Some or all steps of FIG. 13N can be performed in conjunction with implementing some or all features and/or functionality presented in conjunction with one or more of the FIGS. 13A-13M, and/or in in conjunction with implementing some or all features and/or functionality presented in conjunction with one or more of the FIGS. 1-12Z.

Step 2382 includes receiving (e.g. via at least one receiver antenna) a plurality of navigation signals (e.g. a plurality of GNSS navigation signals, and/or a plurality of other navigation signals such as navigation signals 240) from a plurality of satellites of a satellite constellation (e.g. a GNSS satellite constellation such as the Galileo or GPS satellite constellation, and/or another satellite constellation such as satellite constellation system 100). Step 2384 includes authenticating ones of the plurality of navigation signals in accordance with meeting a threshold authentication security level.

In addition or the alternative to any of the foregoing examples (including examples of a method for execution), performing step 2384 can include performing step 2386, 2388, 2390, 2392, and/or 2394. Step 2386 includes storing, in memory, an accumulated plurality of cryptographic pseudorandom function ranging code samples extracted from a first navigation signal (e.g. a first GNSS navigation signal, or other navigation signal such as a first navigation signal 240) transmitted via a first satellite of the plurality of satellites. Step 2388 includes receiving cryptographic pseudorandom function seed data. Step 2390 includes generating a replica cryptographic pseudorandom function ranging code based on processing the cryptographic pseudorandom function seed data via the corresponding cryptographic pseudorandom function. Step 2392 includes applying a linear time invariant matching filter to generate a plurality of first correlation data based on correlation of the replica cryptographic pseudorandom function ranging code with each of the accumulated plurality of cryptographic pseudorandom function ranging code samples. Step 2394 includes generating an aggregated value based on processing the plurality of first correlation data. In addition or the alternative to any of the foregoing examples (including examples of a method for execution), the first navigation signal is authenticated based on the aggregated value comparing favorably to a threshold value. In addition or the alternative to any of the foregoing examples (including examples of a method for execution), authentication of the first navigation signal meets the threshold authentication security level based on the accumulated plurality of cryptographic pseudorandom function ranging code samples being accumulated in accordance with a threshold ranging code accumulation requirement.

In addition or the alternative to any of the foregoing examples (including examples of a method for execution), at least a subset of the plurality of navigation signals are generated to include a cryptographic pseudorandom function ranging code generated via applying a corresponding cryptographic pseudorandom function.

In addition or the alternative to any of the foregoing examples (including examples of a method for execution), the method further includes authenticating ones of the plurality of navigation signals in accordance with meeting a threshold authentication security level based on: storing, in memory, an accumulated plurality of cryptographic pseudorandom function ranging code samples extracted from a first navigation signal transmitted via a first satellite of the plurality of satellites; receiving cryptographic pseudorandom function seed data; generating a replica cryptographic pseudorandom function ranging code based on processing the cryptographic pseudorandom function seed data via the corresponding cryptographic pseudorandom function; applying a linear time invariant matching filter to generate a plurality of first correlation data based on correlation of the replica cryptographic pseudorandom function ranging code with each of the accumulated plurality of cryptographic pseudorandom function ranging code samples; and/or generating an aggregated value based on processing the plurality of first correlation data.

In addition or the alternative to any of the foregoing examples (including examples of a method for execution), the first navigation signal is authenticated based on the aggregated value comparing favorably to a threshold value. In addition or the alternative to any of the foregoing examples (including examples of a method for execution), authentication of the first navigation signal meets the threshold authentication security level based on the accumulated plurality of cryptographic pseudorandom function ranging code samples being accumulated in accordance with a threshold ranging code accumulation requirement.

In addition or the alternative to any of the foregoing examples (including examples of a method for execution), the plurality of navigation signals include a plurality of Galileo signals transmitted by a plurality of Galileo satellites of the Galileo satellite constellation.

In addition or the alternative to any of the foregoing examples (including examples of a method for execution), the at least one receiver antenna is configured to receive the plurality of Galileo signals.

In addition or the alternative to any of the foregoing examples (including examples of a method for execution), the accumulated plurality of cryptographic pseudorandom function ranging code samples of the first navigation signal correspond to an accumulated plurality of Galileo E6-C ranging code samples of a first Galileo E6-C signal of the plurality of Galileo signals transmitted via a first Galileo satellite of the plurality of Galileo satellites.

In addition or the alternative to any of the foregoing examples (including examples of a method for execution), the method further includes authenticating the ones of the plurality of navigation signals further based on: receiving second-encrypted ranging data in the first Galileo E6-C signal; and/or producing the accumulated plurality of Galileo E6-C ranging code samples based on decrypting the second-encrypted ranging data via a corresponding key distinct from the cryptographic pseudorandom function seed data. In addition or the alternative to any of the foregoing examples (including examples of a method for execution), the accumulated plurality of Galileo E6-C ranging code samples are still encrypted via the cryptographic pseudorandom function seed data after decryption of the second-encrypted ranging data via the corresponding key.

In addition or the alternative to any of the foregoing examples (including examples of a method for execution), the method further includes generating, in response to authenticating the first navigation signal, position navigation and timing data based on processing the accumulated plurality of cryptographic pseudorandom function ranging code samples of the first navigation signal. In addition or the alternative to any of the foregoing examples (including examples of a method for execution), a client device executing at least some steps of the method further includes at least one additional processor separate from the receiver module and operable to process position navigation and timing data generated by the receiver module in conjunction with executing corresponding functionality of the client device.

In addition or the alternative to any of the foregoing examples (including examples of a method for execution), the method further includes authenticating the ones of the plurality of navigation signals further based on: authenticating a second navigation signal (e.g. second GNSS navigation signal and/or other navigation signal such as a navigation signal 240) in response to the aggregated value, generated via processing the accumulated plurality of cryptographic pseudorandom function ranging code samples extracted from the first navigation signal, comparing favorably to the threshold value.

In addition or the alternative to any of the foregoing examples (including examples of a method for execution), the first navigation signal and the second navigation signal are both received from the first satellite.

In addition or the alternative to any of the foregoing examples (including examples of a method for execution), the plurality of navigation signals include a plurality of signal components transmitted by each of the plurality of satellites that includes: at least one data signal component; and/or at least one pilot signal component. In addition or the alternative to any of the foregoing examples (including examples of a method for execution), the first satellite of the plurality of satellites transmits a navigation signal that includes the first navigation signal as a pilot signal component and the second navigation signal as a data signal component. In addition or the alternative to any of the foregoing examples (including examples of a method for execution), the data signal component of the navigation signal transmitted by the first satellite is authenticated in response to the aggregated value, generated via processing the accumulated plurality of cryptographic pseudorandom function ranging code samples extracted from the pilot signal component, comparing favorably to the threshold value.

In addition or the alternative to any of the foregoing examples (including examples of a method for execution), the pilot signal component is an encrypted signal component. In addition or the alternative to any of the foregoing examples (including examples of a method for execution), the data signal component is an unencrypted signal component.

In addition or the alternative to any of the foregoing examples (including examples of a method for execution), the pilot signal component corresponds to a Galileo E6-C signal. In addition or the alternative to any of the foregoing examples (including examples of a method for execution), the data signal component corresponds to one of: a Galileo E6-B signal or a Galileo E1-B signal.

In addition or the alternative to any of the foregoing examples (including examples of a method for execution), the plurality of navigation signals include: a first plurality of navigation signals (e.g. first plurality of GNSS navigation signals or first plurality of other navigation signals such as navigation signals 240) at a first frequency; and/or a second plurality of navigation signals (e.g. second plurality of GNSS navigation signals or second plurality of other navigation signals such as navigation signals 240) at a second frequency different from the first frequency.

In addition or the alternative to any of the foregoing examples (including examples of a method for execution), the first satellite of the plurality of satellites transmits the first navigation signal the first frequency and further transmits the second navigation signal at the second frequency. In addition or the alternative to any of the foregoing examples (including examples of a method for execution), the second navigation signal at the second frequency is authenticated in response to the aggregated value, generated via processing the accumulated plurality of cryptographic pseudorandom function ranging code samples extracted from the first navigation signal at the first frequency, comparing favorably to the threshold value.

In addition or the alternative to any of the foregoing examples (including examples of a method for execution), the first plurality of navigation signals at the first frequency each include a first plurality of signal components that includes an encrypted signal component and at least one other signal component. In addition or the alternative to any of the foregoing examples (including examples of a method for execution), the second plurality of navigation signals at the second frequency each include a second plurality of signal components that includes an unencrypted signal component and at least one other signal component. In addition or the alternative to any of the foregoing examples (including examples of a method for execution), the accumulated plurality of cryptographic pseudorandom function ranging code samples are extracted from the encrypted signal component of the first navigation signal at the first frequency. In addition or the alternative to any of the foregoing examples (including examples of a method for execution), the unencrypted signal component of the second navigation signal at the second frequency is authenticated in response to the aggregated value, generated via processing the accumulated plurality of cryptographic pseudorandom function ranging code extracted from the encrypted signal component of the first navigation signal at the first frequency, comparing favorably to the threshold value.

In addition or the alternative to any of the foregoing examples (including examples of a method for execution), the encrypted signal component of the first navigation signal at the first frequency corresponds to a Galileo E6-C signal. In addition or the alternative to any of the foregoing examples (including examples of a method for execution), the unencrypted signal component of the second navigation signal at the second frequency corresponds to a Galileo E1-B signal.

In addition or the alternative to any of the foregoing examples (including examples of a method for execution), the cryptographic pseudorandom function ranging code is implemented as a non-watermarked ranging code based on the cryptographic pseudorandom function ranging code being generated via applying the cryptographic pseudorandom function to the cryptographic pseudorandom function seed data.

In addition or the alternative to any of the foregoing examples (including examples of a method for execution), the threshold ranging code accumulation requirement includes at least one of: a predetermined threshold number of ranging code samples; or a predetermined threshold amount of time over which cryptographic pseudorandom function ranging code samples are accumulated. In addition or the alternative to any of the foregoing examples (including examples of a method for execution), at least one processor executing at least some steps of the method is configured to meet the threshold authentication security level based on at least one of: being configured to accumulate at least the predetermined threshold number of ranging code samples in the accumulated plurality of cryptographic pseudorandom function ranging code samples, or being configured to accumulate the accumulated plurality of cryptographic pseudorandom function ranging code samples over at least the predetermined threshold amount of time.

In addition or the alternative to any of the foregoing examples (including examples of a method for execution), based on the at least one processor executing at least some steps of the method being configured to meet the threshold authentication security level based on at least one of: at least one processor is configured to meet the threshold authentication security level based on at least one of: being configured to accumulate at least the predetermined threshold number of ranging code samples in the accumulated plurality of cryptographic pseudorandom function ranging code samples, or being configured to accumulate the accumulated plurality of cryptographic pseudorandom function ranging code samples over at least the predetermined threshold amount of time: the plurality of first correlation data includes at least the predetermined threshold number of correlation data based on the linear time invariant matching filter being applied to the accumulated plurality of cryptographic pseudorandom function ranging code samples that includes the at least the predetermined threshold number of ranging code samples; the aggregated value is generated based on processing the at least the predetermined threshold number of correlation data; and/or the threshold authentication security level is met based on the aggregated value being generated based on processing the at least the predetermined threshold number of correlation data.

In addition or the alternative to any of the foregoing examples (including examples of a method for execution), the at least one processor is configured to accumulate at least the predetermined threshold number of ranging code samples in the accumulated plurality of cryptographic pseudorandom function ranging code samples based on being configured to accumulate the accumulated plurality of cryptographic pseudorandom function ranging code samples over at least the predetermined threshold amount of time based on the at least the predetermined threshold amount of time being configured to render accumulation of the at least the predetermined threshold number of ranging code samples based on the at least the predetermined threshold amount of time being configured as a function of length of time covering a single ranging code.

In addition or the alternative to any of the foregoing examples (including examples of a method for execution), the predetermined threshold number of ranging code samples is configured based on the threshold ranging code accumulation requirement being configured to meet a 128-bit authentication security level.

In addition or the alternative to any of the foregoing examples (including examples of a method for execution), the accumulated plurality of cryptographic pseudorandom function ranging code samples of the first navigation signal correspond to an accumulated plurality of Galileo E6-C ranging code samples of a first Galileo E6-C signal of the plurality of Galileo signals transmitted via a first Galileo satellite of a plurality of Galileo satellites. In addition or the alternative to any of the foregoing examples (including examples of a method for execution), the predetermined threshold number of ranging code samples is configured as a number of ranging code samples between 300 and 400 samples further based on construction of the Galileo E6-C signal.

In addition or the alternative to any of the foregoing examples (including examples of a method for execution), the predetermined threshold amount of time over which cryptographic pseudorandom function ranging code samples are accumulated is configured based on the threshold ranging code accumulation requirement being configured to meet a 128-bit authentication security level.

In addition or the alternative to any of the foregoing examples (including examples of a method for execution), the accumulated plurality of cryptographic pseudorandom function ranging code samples of the first navigation signal correspond to an accumulated plurality of Galileo E6-C ranging code samples of a first Galileo E6-C signal of the plurality of Galileo signals transmitted via a first Galileo satellite of a plurality of Galileo satellites. In addition or the alternative to any of the foregoing examples (including examples of a method for execution), the predetermined threshold amount of time over which cryptographic pseudorandom function ranging code samples are accumulated is configured as a number of milliseconds between 300 and 400 milliseconds further based on construction of the Galileo E6-C signal.

In addition or the alternative to any of the foregoing examples (including examples of a method for execution), the predetermined threshold number of ranging code samples is configured based on the threshold ranging code accumulation requirement being configured to meet a 32-bit authentication security level.

In addition or the alternative to any of the foregoing examples (including examples of a method for execution), the accumulated plurality of cryptographic pseudorandom function ranging code samples of the first navigation signal correspond to an accumulated plurality of Galileo E6-C ranging code samples of a first Galileo E6-C signal of the plurality of Galileo signals transmitted via a first Galileo satellite of a plurality of Galileo satellites. In addition or the alternative to any of the foregoing examples (including examples of a method for execution), the predetermined threshold number of ranging code samples is configured as a number of ranging code samples between 50 and 100 ranging code samples further based on construction of the Galileo E6-C signal.

In addition or the alternative to any of the foregoing examples (including examples of a method for execution), the predetermined threshold amount of time over which cryptographic pseudorandom function ranging code samples are accumulated is configured based on the threshold ranging code accumulation requirement being configured to meet a 32-bit authentication security level.

In addition or the alternative to any of the foregoing examples (including examples of a method for execution), the accumulated plurality of cryptographic pseudorandom function ranging code samples of the first navigation signal correspond to an accumulated plurality of Galileo E6-C ranging code samples of a first Galileo E6-C signal of the plurality of Galileo signals transmitted via a first Galileo satellite of a plurality of Galileo satellites. In addition or the alternative to any of the foregoing examples (including examples of a method for execution), the predetermined threshold amount of time over which cryptographic pseudorandom function ranging code samples are accumulated is configured as a number of milliseconds between 50 and 100 milliseconds further based on construction of the Galileo E6-C signal.

In addition or the alternative to any of the foregoing examples (including examples of a method for execution), the threshold ranging code accumulation requirement is configured based on a conservative maximum threshold ranging code accumulation requirement generated based on processing a plurality of parameters corresponding to construction of the plurality of navigation signals that includes at least one of: a first parameter corresponding to a number of chips within a single cryptographic pseudorandom function ranging code; a second parameter corresponding to a length of time covering the single cryptographic pseudorandom function ranging code; a third parameter corresponding to frequency of the plurality of navigation signals; and/or a fourth parameter corresponding to received maximum power for the plurality of navigation signals.

In addition or the alternative to any of the foregoing examples (including examples of a method for execution), the conservative maximum threshold ranging code accumulation requirement is generated based on computing probability of missed detection given an adversarial chip signal to noise ratio as a function of at least some of the plurality of parameters.

In addition or the alternative to any of the foregoing examples (including examples of a method for execution), the threshold ranging code accumulation requirement is configured based on a conservative maximum threshold ranging code accumulation requirement generated based on processing a plurality of parameters corresponding to construction of a receiver module implementing the at least one processor executing at least some steps of the method that includes at least one of: a first parameter corresponding to a frequency of the receiver module making the authentication determination; or a second parameter corresponding a threshold minimum signal to noise ratio.

In addition or the alternative to any of the foregoing examples (including examples of a method for execution), generating the conservative maximum threshold ranging code accumulation requirement is based on setting the first parameter as a Nyquist frequency determined based on frequency of the plurality of navigation signals.

In addition or the alternative to any of the foregoing examples (including examples of a method for execution), the threshold ranging code accumulation requirement is configured based on processing Hard-decision Security Code Estimation and Replay modelling data.

In addition or the alternative to any of the foregoing examples (including examples of a method for execution), the threshold ranging code accumulation requirement is configured based on processing at least one of: Hard-decision Security Code Estimation and Replay modeling data; or non-Security Code Estimation and Replay modeling data.

In addition or the alternative to any of the foregoing examples (including examples of a method for execution), the threshold ranging code accumulation requirement is configured based on at least one of: a probability of false alarm, or a probability of missed detection.

In addition or the alternative to any of the foregoing examples (including examples of a method for execution), the threshold value is configured based on at least one of: a configured tradeoff between probability of false alarm and probability of missed detection; a first expectation value for the aggregated value given the first navigation signal is authentic; and/or a second expectation value of the aggregated value given the first navigation signal is spoofed.

In addition or the alternative to any of the foregoing examples (including examples of a method for execution), the first expectation value and the second expectation value are computed as one and zero, respectively, based on assuming a predetermined threshold number of ranging code samples are utilized to generate the aggregated value. In addition or the alternative to any of the foregoing examples (including examples of a method for execution), the threshold ranging code accumulation requirement is configured as the predetermined threshold number of ranging code samples. In addition or the alternative to any of the foregoing examples (including examples of a method for execution), the first navigation signal is authenticated based on the aggregated value being greater than or equal to the threshold value.

In addition or the alternative to any of the foregoing examples (including examples of a method for execution), the configured tradeoff is equal to 0.5 based on the first expectation value and the second expectation value being computed as one and zero, respectively, and/or based on applying an unweighted tradeoff between probability of false alarm and probability of missed detection.

In addition or the alternative to any of the foregoing examples (including examples of a method for execution), the second expectation value of the aggregated value given the first navigation signal is spoofed is based on an assumption that the first navigation signal is spoofed by a non-Security Code Estimation and Replay adversary.

In addition or the alternative to any of the foregoing examples (including examples of a method for execution), generating the aggregated value based on processing the plurality of first correlation data includes: generating a plurality of intermediate values based on processing the plurality of first correlation data. In addition or the alternative to any of the foregoing examples (including examples of a method for execution), each of the plurality of intermediate values is generated via processing a corresponding one of the plurality of first correlation data; and/or generating the aggregated value based on processing the plurality of intermediate values.

In addition or the alternative to any of the foregoing examples (including examples of a method for execution), the method further includes authenticating the ones of the plurality of navigation signals in accordance with meeting the threshold authentication security level further based on generating a plurality of signal power measurements based on measuring signal power over each of a plurality of fixed time periods in which each corresponding one of the accumulated plurality of cryptographic pseudorandom function ranging code samples is received. In addition or the alternative to any of the foregoing examples (including examples of a method for execution), the each of the plurality of intermediate values are generated based on further processing a corresponding signal power measurement of the plurality of signal power measurements corresponding to one of the accumulated plurality of cryptographic pseudorandom function ranging code samples for which the corresponding one of the plurality of first correlation data is generated.

In addition or the alternative to any of the foregoing examples (including examples of a method for execution), the aggregated value is generated based on computing an average of the plurality of intermediate values.

In addition or the alternative to any of the foregoing examples (including examples of a method for execution), the plurality of intermediate values are generated as a plurality of identically distributed statistics.

In addition or the alternative to any of the foregoing examples (including examples of a method for execution), a first one of the accumulated plurality of cryptographic pseudorandom function ranging code samples is received and stored prior to receiving of the cryptographic pseudorandom function seed data. In addition or the alternative to any of the foregoing examples (including examples of a method for execution), the plurality of first correlation data is generated after receiving the cryptographic pseudorandom function seed data based on the cryptographic pseudorandom function seed data being required to generate the replica cryptographic pseudorandom function ranging code.

In addition or the alternative to any of the foregoing examples (including examples of a method for execution), the threshold ranging code accumulation requirement is configured based on the threshold authentication security level.

In addition or the alternative to any of the foregoing examples (including examples of a method for execution), the threshold authentication security level is one of: a 32-bit security level, a 64-bit security level, or a 128-bit security level. In addition or the alternative to any of the foregoing examples (including examples of a method for execution), the threshold authentication security level is another security level, for example, between the 32-bit security level and the 128-bit security level, or optionally greater than the 128-bit security level.

In addition or the alternative to any of the foregoing examples (including examples of a method for execution), a client device executing at least some steps of the method further includes at least one additional processor separate from the receiver module operable to process position navigation and timing data generated by the receiver module.

In addition or the alternative to any of the foregoing examples (including examples of a client device or a receiver module),

In addition or the alternative to any of the foregoing examples (including examples of a method for execution), the aggregated value compares favorably to the threshold value based on the first navigation signal being transmitted via the first satellite of the satellite constellation. In addition or the alternative to any of the foregoing examples (including examples of a method for execution), the method is executed in accordance with meeting a threshold authentication security level further based on: storing, in memory, an accumulated plurality of spoofed cryptographic pseudorandom function ranging code samples extracted from a spoofed navigation signal (e.g. a spoofed navigation signal, or other spoofed navigation signal such as a spoofing of navigation signal 240) transmitted via an adversary radio; applying a linear time invariant matching filter to generate a plurality of second correlation data based on correlation of the replica cryptographic pseudorandom function ranging code with each of the accumulated plurality of spoofed cryptographic pseudorandom function ranging code samples; and/or generating a second aggregated value based on processing the plurality of second correlation data. In addition or the alternative to any of the foregoing examples (including examples of a method for execution), the spoofed navigation signal is not authenticated based on the aggregated value comparing unfavorably to the threshold value. In addition or the alternative to any of the foregoing examples (including examples of a method for execution), failed authentication of the spoofed navigation signal meets the threshold authentication security level based on the accumulated plurality of spoofed cryptographic pseudorandom function ranging code samples being accumulated in accordance with the threshold ranging code accumulation requirement.

In addition or the alternative to any of the foregoing examples (including examples of a method for execution), the method further includes generating pseudorange data based on processing the accumulated plurality of cryptographic pseudorandom function ranging code samples.

In addition or the alternative to any of the foregoing examples (including examples of a method for execution), position navigation and timing data is generated based on the pseudorange data.

In addition or the alternative to any of the foregoing examples (including examples of a method for execution), the aggregated value is generated without processing the pseudorange data. In addition or the alternative to any of the foregoing examples (including examples of a method for execution), the aggregated value is not a function of the pseudorange data.

In addition or the alternative to any of the foregoing examples (including examples of a method for execution), the pseudorange data is generated after authenticating the first navigation signal, in response to authenticating the first navigation signal.

In addition or the alternative to any of the foregoing examples (including examples of a method for execution), the method further includes generating a plurality of additional pseudorange data based on processing a plurality of additional cryptographic pseudorandom function ranging code samples of a plurality of other navigation signals. In addition or the alternative to any of the foregoing examples (including examples of a method for execution), the aggregated value is generated without computing any pseudorange difference values between the pseudorange data with any of the plurality of additional pseudorange data. In addition or the alternative to any of the foregoing examples (including examples of a method for execution), the aggregated value is generated without performing any comparison of the pseudorange data with any of the plurality of additional pseudorange data.

In addition or the alternative to any of the foregoing examples (including examples of a method for execution), the plurality of navigation signals include a plurality of Galileo signals transmitted by a plurality of Galileo satellites of the Galileo satellite constellation. In addition or the alternative to any of the foregoing examples (including examples of a method for execution), the first navigation signal is a first Galileo signal authenticated without computing any pseudorange difference values between the pseudorange data with any of the plurality of additional pseudorange data and without performing any comparison of the pseudorange data with any of the plurality of additional pseudorange data. In addition or the alternative to any of the foregoing examples (including examples of a method for execution), the first navigation signal is a first Galileo signal authenticated without processing the pseudorange data.

In addition or the alternative to any of the foregoing examples (including examples of a method for execution), at least some of the plurality of satellites are located in LEO orbit, and/or the first satellite of the plurality of satellites transmits the first navigation signal from LEO orbit.

In addition or the alternative to any of the foregoing examples (including examples of a method for execution), the first satellite of the plurality of satellites transmits the first navigation signal from LEO orbit based on being a satellite that is associated with the Galileo GNSS service and that is operating in LEO orbit.

In addition or the alternative to any of the foregoing examples (including examples of a method for execution), the first satellite of the plurality of satellites transmits the first navigation signal from LEO orbit based on being a satellite that is associated with the Pulsar service and that is operating in LEO orbit.

In addition or the alternative to any of the foregoing examples (including examples of a method for execution), at least some of the plurality of satellites are located in MEO orbit, and/or the first satellite of the plurality of satellites transmits the first navigation signal from MEO orbit.

In addition or the alternative to any of the foregoing examples (including examples of a method for execution), the plurality of navigation signals are a plurality of GNSS navigation signals transmitted via a plurality of satellites of a GNSS satellite constellation, where the first navigation signal is a first GNSS navigation signal.

In addition or the alternative to any of the foregoing examples (including examples of a method for execution), the plurality of navigation signals are a plurality of Pulsar signals, where the first navigation signal is a first Pulsar signal.

FIG. 13O illustrates an example method for execution. Some or all steps of FIG. 13O can be executed by: a computing device, a client device such as client device 160, a processing system 1920, a node of a systems such as a node of satellite constellation system 100, a data frame receival and processing system such as data frame receival and processing system 1802, and/or via at least one processor, at least one memory, and/or at least one receiver (e.g. of any computing device). Some or all steps of FIG. 13O can be performed in conjunction with implementing some or all features and/or functionality presented in conjunction with one or more of the FIGS. 13A-13M, and/or in in conjunction with implementing some or all features and/or functionality presented in conjunction with one or more of the FIGS. 1-12Z.

Step 2381 includes generating (e.g. via at least one processor and/or memory of at least one computing device) adversary radio configuration requirement data based on computing probability of missed detection given an adversarial chip signal to noise ratio as a function of a plurality of parameters corresponding to a plurality of navigation signals (e.g. a plurality of GNSS navigation signals or a plurality of other navigation signals such as a plurality of navigation signals 240) of a satellite constellation (e.g. a GNSS satellite constellation such as the Galileo satellite constellation or GPS satellite constellation, or other satellite constellation such as satellite constellation system 100). Step 2383 includes communicating (e.g. via at least one transmitter and/or communication interface of the at least one computing device) the adversary radio configuration requirement data to another client device (and/or a plurality of other client devices).

In addition or the alternative to any of the foregoing examples (including examples of a method for execution), an adversary radio generating spoofed navigation signals (e.g. spoofed GNSS navigation signals, or other spoofed navigation signals such as spoofing of navigation signals 240) is identified, detected, and/or located based on communication of the adversary radio configuration requirement data to the another client device.

In addition or the alternative to any of the foregoing examples (including examples of a method for execution), the adversary radio configuration requirement data indicates at least one of: a minimum gain value; or an antenna type.

In addition or the alternative to any of the foregoing examples (including examples of a method for execution), the adversary radio configuration requirement data is generated based on processing Hard-decision Security Code Estimation and Replay modelling data.

In addition or the alternative to any of the foregoing examples (including examples of a method for execution), the adversary radio configuration requirement data is Galileo adversary radio configuration requirement data corresponding to the Galileo navigation service. In addition or the alternative to any of the foregoing examples (including examples of a method for execution), the adversary radio generates spoofed Galileo signals and is identified based on communication of the adversary radio configuration data to another client device.

In addition or the alternative to any of the foregoing examples (including examples of a method for execution), the minimum gain value is at least 10 dB. In addition or the alternative to any of the foregoing examples (including examples of a method for execution), the antenna type indicates at least one of: a directional antenna or a phased-array antenna.

In addition or the alternative to any of the foregoing examples (including examples of a method for execution), the minimum gain value is 13 dB. In addition or the alternative to any of the foregoing examples (including examples of a method for execution), the minimum gain value is at least 13 dB.

In addition or the alternative to any of the foregoing examples (including examples of a method for execution), the adversary radio configuration requirement data further indicates predicted equipment size data based on the minimum gain value.

In various examples, a computing device includes at least one processor and at least one memory that stores operational instructions that, when executed by the at least one processor, cause the at least one processor to: generate adversary radio configuration requirement data based on computing probability of missed detection given an adversarial chip signal to noise ratio as a function of a plurality of parameters corresponding to a plurality of navigation signals (e.g. a plurality of GNSS navigation signals or a plurality of other navigation signals such as a plurality of navigation signals 240) of a satellite constellation (e.g. a GNSS satellite constellation such as the Galileo satellite constellation or GPS satellite constellation, or other satellite constellation such as satellite constellation system 100); and/or communicate the adversary radio configuration requirement data to another client device.

In addition or the alternative to any of the foregoing examples (including examples of a computing device), an adversary radio generating spoofed navigation signals is identified based on communication of the adversary radio configuration requirement data to the another client device.

In addition or the alternative to any of the foregoing examples (including examples of a computing device), an adversary radio generating spoofed GNSS navigation signals (e.g. spoofed GNSS navigation signals, or other spoofed navigation signals such as spoofing of navigation signals 240) is identified, detected, and/or located based on communication of the adversary radio configuration requirement data to the another client device.

In addition or the alternative to any of the foregoing examples (including examples of a computing device), the adversary radio configuration requirement data indicates at least one of: a minimum gain value; or an antenna type.

In addition or the alternative to any of the foregoing examples (including examples of a computing device), the adversary radio configuration requirement data is generated based on processing Hard-decision Security Code Estimation and Replay modelling data.

In addition or the alternative to any of the foregoing examples (including examples of a computing device), the adversary radio configuration requirement data is Galileo adversary radio configuration requirement data corresponding to the Galileo navigation service. In addition or the alternative to any of the foregoing examples (including examples of a computing device), the adversary radio generates spoofed Galileo signals and is identified based on communication of the adversary radio configuration data to another client device.

In addition or the alternative to any of the foregoing examples (including examples of a computing device), the minimum gain value is at least 10 dB. In addition or the alternative to any of the foregoing examples (including examples of a computing device), the antenna type indicates at least one of: a directional antenna or a phased-array antenna.

In addition or the alternative to any of the foregoing examples (including examples of a computing device), the minimum gain value is 13 dB. In addition or the alternative to any of the foregoing examples (including examples of a computing device), the minimum gain value is at least 13 dB.

In addition or the alternative to any of the foregoing examples (including examples of a computing device), the adversary radio configuration requirement data further indicates predicted equipment size data based on the minimum gain value.

Some or all features and/or functionality of one or more systems, modules, method steps, algorithms, and/or functions described herein (e.g. some or all features and/or functionality of any embodiment of data frame generation and transmission system 1801, satellite 110, satellite processing system 300, client device 160, any receiver and/or receiver module, data frame receival and processing system 1802, and/or any node of a satellite constellation system 100) can optionally be implemented in a virtual environment (e.g. in conjunction with performing design, testing, and/or simulation of a respective system and/or corresponding receivers/receiver modules), for example, as a reference implementation and/or corresponding software-based package, library, and/or application. For example, any generation, transmission, receipt, and/or processing of data frames, data streams, and/or signals such as navigation signals 240 described herein can be performed virtually (e.g. without generation, transmission, receipt, and/or processing of data frames/data streams/signals that are actually broadcast physically), for example, to simulate how such generation, transmission, receipt, and/or processing of data frames/data streams/signals would be performed physically (e.g. in conjunction with design, testing, and/or simulation of a corresponding system).

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such a advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified operations and relationships thereof. The boundaries and sequence of these functional building blocks and method steps have been arbitrarily defined herein for convenience of description. Alternate boundaries and sequences can be defined so long as the specified operations and relationships are appropriately performed. Any such alternate boundaries or sequences are thus within the scope and spirit of the claims. Similarly, flow diagram blocks may also have been arbitrarily defined herein to illustrate certain significant functionality.

Any flowchart and/or block diagram in the drawings is intended to illustrate the architecture, functionality, and/or operation of possible implementations of systems, methods, and computer program products according to aspects of the system. In this regard, each block may represent and/or be implemented by one or more processing resources such as a module, segment, one or more executable instructions, one or more discrete components, application specific integrated circuits, processors executing appropriate software and the like or any combination thereof for implementing the specified operation(s).

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown.

Further, while a flow diagram indicates a particular ordering of steps, other orderings are likewise possible provided that the principles of causality are maintained. For example, two blocks shown in an apparent sequence can sometimes be executed in the reverse order, depending upon the functions/operations involved. In another example, two blocks shown in an apparent sequence may, in fact, be executed substantially concurrently via parallelized processing resources. Any such parallelized operations performed by such parallel processing resources can, in various examples, can involve the generation, input, analysis, output, display and/or other processing of data, including data streams and/or other information at speeds that can exceed one million operations per second and can involve megabits, gigabits, terabits or more of data. Furthermore, such parallelized operations can involve the storage and/or retrieval of data at selected storage locations within one or more storage devices, a storage network, cloud storage and/or other parallelized storage media.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

The terms “comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions steps, and/or operations associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, generative AI, generative adversarial networks, variational autoencoders, autoregressive models, large language models, and/or other AI and/or machine learning models and/or techniques. The human mind is not equipped to perform such AI techniques, not only due to the complexity of these techniques, but also due to the fact that artificial intelligence, by its very definition—requires “artificial” intelligence—i.e. machine/non-human intelligence.

One or more functions steps, and/or operations associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions steps, and/or operations associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions steps, and/or operations associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions steps, and/or operations associated with the methods and/or processes described herein can be implemented in a system that is operable to electronically store digital data in a memory device. Such storage cannot practically be performed by the human mind because the human mind is not equipped to electronically store digital data.

One or more functions, steps, and/or operations associated with the methods and/or processes described herein can be performed in parallel and/or concurrently via a plurality of parallelized processing resources. For example, multiple instances of any given step of one or more methods and/or functions described herein can be performed in parallel and/or concurrently via a plurality of parallelized processing resources, where each parallelized processing resource of the plurality of parallelized processing resources performs the given step in parallel with and/or concurrently with other ones of the plurality of parallelized processing resources also performing the given step. As another example, any given step of one or more methods and/or functions described herein can be performed based on a plurality of parallelized processing resources performing assigned portions of the given step in parallel and/or concurrently, where each parallelized processing resource of the plurality of parallelized processing resources performs their assigned portion of the step in parallel with and/or concurrently with other ones of the plurality of parallelized processing resources also performing their own assigned portions of the given step. Any parallelized and/or concurrently performed steps performed by such parallel processing resources can, in various examples, involve operations that can include the generation, input, analysis, output and/or other processing of data, including data streams and/or other information at speeds that can exceed one million operations per second and furthermore can involve megabits, gigabits, terabits or more of data. Such parallelized processing cannot practically be performed by the human mind because the human mind is not equipped to perform multiple functions, steps, and/or operations simultaneously in parallel. One or more functions, steps, and/or operations associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

One or more functions, steps, and/or operations associated with the methods and/or processes described herein may involve determining data, information, and/or instructions (e.g. regarding subsequent actions to be performed). As used herein, “determining” particular data/information/instructions, for example, by a processing module, can include and/or be based on: receiving the data/information/instructions (e.g. via a wired and/or wireless network and/or other communication resources accessible via the processing module), retrieving the data/information/instructions from storage in memory resources in memory (e.g. that is accessible via the processing module), configuration of the data/information/instructions via user input (e.g. to a corresponding user input device coupled to the process module and/or in an instruction received from another computing device based on being configured via user input to the other computing device), automatically selecting the data/information/instructions from a plurality of options and/or automatically generating the data/information (e.g. via performing a deterministic function, via performing random or pseudorandom function, via performing at least one calculation, via performing at least one optimization algorithm, via performing at least one statistical function and/or applying a statistical model, and/or via applying at least one machine learning and/or AI technique and/or applying a machine learning model), and/or otherwise obtaining the data/information/instructions. While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A client device comprising:
at least one receiver module comprising:
at least one receiver antenna configured to receive a plurality of GNSS navigation signals from a plurality of satellites of a GNSS satellite constellation, wherein at least a subset of the plurality of GNSS navigation signals are generated to include a cryptographic pseudorandom function ranging code generated via applying a corresponding cryptographic pseudorandom function;
at least one processor operable to authenticate ones of the plurality of GNSS navigation signals in accordance with meeting a threshold authentication security level based on:
storing, in memory, an accumulated plurality of cryptographic pseudorandom function ranging code samples extracted from a first GNSS navigation signal transmitted via a first satellite of the plurality of satellites;
receiving cryptographic pseudorandom function seed data;
generating a replica cryptographic pseudorandom function ranging code based on processing the cryptographic pseudorandom function seed data via the corresponding cryptographic pseudorandom function;
applying a linear time invariant matching filter to generate a plurality of first correlation data based on correlation of the replica cryptographic pseudorandom function ranging code with each of the accumulated plurality of cryptographic pseudorandom function ranging code samples; and
generating an aggregated value based on processing the plurality of first correlation data, wherein the first GNSS navigation signal is authenticated based on the aggregated value comparing favorably to a threshold value, and wherein authentication of the first GNSS navigation signal meets the threshold authentication security level based on the accumulated plurality of cryptographic pseudorandom function ranging code samples being accumulated in accordance with a threshold ranging code accumulation requirement.

2. The client device of claim 1, wherein the plurality of GNSS navigation signals include a plurality of Galileo signals transmitted by a plurality of Galileo satellites of the Galileo satellite constellation.

3. The client device of claim 2, wherein the accumulated plurality of cryptographic pseudorandom function ranging code samples of the first GNSS navigation signal correspond to an accumulated plurality of Galileo E6-C ranging code samples of a first Galileo E6-C signal of the plurality of Galileo signals transmitted via a first Galileo satellite of the plurality of Galileo satellites, and wherein the at least one processor is operable to authenticate the ones of the plurality of GNSS navigation signals further based on:
receiving second-encrypted ranging data in the first Galileo E6-C signal; and
producing the accumulated plurality of Galileo E6-C ranging code samples based on decrypting the second-encrypted ranging data via a corresponding key distinct from the cryptographic pseudorandom function seed data, wherein the accumulated plurality of Galileo E6-C ranging code samples are still encrypted via the cryptographic pseudorandom function seed data after decryption of the second-encrypted ranging data via the corresponding key.

4. The client device of claim 1, wherein the at least one processor is further operable to generate, in response to authenticating the first GNSS navigation signal, position navigation and timing data based on processing the accumulated plurality of cryptographic pseudorandom function ranging code samples of the first GNSS navigation signal, further comprising:
at least one additional processor separate from the receiver module and operable to process position navigation and timing data generated by the receiver module in conjunction with executing corresponding functionality of the client device.

5. The client device of claim 1, wherein the at least one processor is operable to authenticate the ones of the plurality of GNSS navigation signals further based on:
authenticating a second GNSS navigation signal in response to the aggregated value, generated via processing the accumulated plurality of cryptographic pseudorandom function ranging code samples extracted from the first GNSS navigation signal, comparing favorably to the threshold value.

6. The client device of claim 5, wherein the first GNSS navigation signal and the second GNSS navigation signal are both received from the first satellite, and wherein the plurality of GNSS navigation signals include:
a plurality of signal components transmitted by each of the plurality of satellites that includes:
at least one data signal component; and
at least one pilot signal component;
wherein the first satellite of the plurality of satellites transmits a GNSS navigation signal that includes the first GNSS navigation signal as a pilot signal component and the second GNSS navigation signal as a data signal component; and
wherein the data signal component of the GNSS navigation signal transmitted by the first satellite is authenticated in response to the aggregated value, generated via processing the accumulated plurality of cryptographic pseudorandom function ranging code samples extracted from the pilot signal component, comparing favorably to the threshold value.

7. The client device of claim 6, wherein the pilot signal component is an encrypted signal component and wherein the data signal component is an unencrypted signal component, wherein the pilot signal component corresponds to a Galileo E6-C signal, and wherein the data signal component corresponds to one of: a Galileo E6-B signal or a Galileo E1-B signal.

8. The client device of claim 6, wherein the plurality of GNSS navigation signals include:
a first plurality of GNSS navigation signals at a first frequency; and
a second plurality of GNSS navigation signals at a second frequency different from the first frequency;
wherein the first satellite of the plurality of satellites transmits the first GNSS navigation signal the first frequency and further transmits the second GNSS navigation signal at the second frequency; and
wherein the second GNSS navigation signal at the second frequency is authenticated in response to the aggregated value, generated via processing the accumulated plurality of cryptographic pseudorandom function ranging code samples extracted from the first GNSS navigation signal at the first frequency, comparing favorably to the threshold value.

9. The client device of claim 8,
wherein the first plurality of GNSS navigation signals at the first frequency each include a first plurality of signal components that includes an encrypted signal component and at least one other signal component;
wherein the second plurality of GNSS navigation signals at the second frequency each include a second plurality of signal components that includes an unencrypted signal component and at least one other signal component;
wherein the accumulated plurality of cryptographic pseudorandom function ranging code samples are extracted from the encrypted signal component of the first GNSS navigation signal at the first frequency, and
wherein the unencrypted signal component of the second GNSS navigation signal at the second frequency is authenticated in response to the aggregated value, generated via processing the accumulated plurality of cryptographic pseudorandom function ranging code extracted from the encrypted signal component of the first GNSS navigation signal at the first frequency, comparing favorably to the threshold value.

10. The client device of claim 1, wherein the cryptographic pseudorandom function ranging code is implemented as a non-watermarked ranging code based on the cryptographic pseudorandom function ranging code being generated via applying the corresponding cryptographic pseudorandom function to the cryptographic pseudorandom function seed data.

11. The client device of claim 1, wherein the threshold ranging code accumulation requirement includes at least one of: a predetermined threshold number of ranging code samples; or a predetermined threshold amount of time over which cryptographic pseudorandom function ranging code samples are accumulated; and
wherein the at least one processor is configured to meet the threshold authentication security level based on at least one of: being configured to accumulate at least the predetermined threshold number of ranging code samples in the accumulated plurality of cryptographic pseudorandom function ranging code samples, or being configured to accumulate the accumulated plurality of cryptographic pseudorandom function ranging code samples over at least the predetermined threshold amount of time.

12. The client device of claim 11, wherein, based on the at least one processor being configured to meet the threshold authentication security level based on the at least one of: being configured to accumulate at least the predetermined threshold number of ranging code samples in the accumulated plurality of cryptographic pseudorandom function ranging code samples, or being configured to accumulate the accumulated plurality of cryptographic pseudorandom function ranging code samples over at least the predetermined threshold amount of time:
the plurality of first correlation data includes at least the predetermined threshold number of correlation data based on the linear time invariant matching filter being applied to the accumulated plurality of cryptographic pseudorandom function ranging code samples that includes the at least the predetermined threshold number of ranging code samples;
the aggregated value is generated based on processing the at least the predetermined threshold number of correlation data; and
the threshold authentication security level is met based on the aggregated value being generated based on processing the at least the predetermined threshold number of correlation data.

13. The client device of claim 11, wherein the at least one processor is configured to accumulate at least the predetermined threshold number of ranging code samples in the accumulated plurality of cryptographic pseudorandom function ranging code samples based on being configured to accumulate the accumulated plurality of cryptographic pseudorandom function ranging code samples over at least the predetermined threshold amount of time based on the at least the predetermined threshold amount of time being configured to render accumulation of the at least the predetermined threshold number of ranging code samples based on the at least the predetermined threshold amount of time being configured as a function of length of time covering a single ranging code.

14. The client device of claim 1, wherein the threshold ranging code accumulation requirement is configured based on a conservative maximum threshold ranging code accumulation requirement generated based on processing a plurality of parameters corresponding to construction of the plurality of GNSS navigation signals that includes at least one of:
a first parameter corresponding to a number of chips within a single cryptographic pseudorandom function ranging code;
a second parameter corresponding to a length of time covering the single cryptographic pseudorandom function ranging code;
a third parameter corresponding to frequency of the plurality of GNSS navigation signals; or
a fourth parameter corresponding to received maximum power for the plurality of GNSS navigation signals.

15. The client device of claim 1, wherein the threshold ranging code accumulation requirement is configured based on a conservative maximum threshold ranging code accumulation requirement generated based on processing a plurality of parameters corresponding to construction of a receiver module implementing the at least one processor that includes at least one of:
a first parameter corresponding to a frequency of the receiver module making the authentication determination; or
a second parameter corresponding a threshold minimum signal to noise ratio.

16. The client device of claim 1, wherein generating the aggregated value based on processing the plurality of first correlation data includes:
generating a plurality of intermediate values based on processing the plurality of first correlation data, wherein each of the plurality of intermediate values is generated via processing a corresponding one of the plurality of first correlation data; and
generating the aggregated value based on processing the plurality of intermediate values.

17. The client device of claim 1, wherein a first one of the accumulated plurality of cryptographic pseudorandom function ranging code samples is received and stored prior to receiving of the cryptographic pseudorandom function seed data, and wherein the plurality of first correlation data is generated after receiving the cryptographic pseudorandom function seed data based on the cryptographic pseudorandom function seed data being required to generate the replica cryptographic pseudorandom function ranging code.

18. The client device of claim 1, wherein the aggregated value compares favorably to the threshold value based on the first GNSS navigation signal being transmitted via the first satellite of the GNSS satellite constellation, wherein the at least one processor operates in accordance with meeting a threshold authentication security level further based on:
storing, in memory, an accumulated plurality of spoofed cryptographic pseudorandom function ranging code samples extracted from a spoofed GNSS navigation signal transmitted via an adversary radio;
applying a linear time invariant matching filter to generate a plurality of second correlation data based on correlation of the replica cryptographic pseudorandom function ranging code with each of the accumulated plurality of spoofed cryptographic pseudorandom function ranging code samples; and
generating a second aggregated value based on processing the plurality of second correlation data, wherein the spoofed GNSS navigation signal is not authenticated based on the aggregated value comparing unfavorably to the threshold value, and wherein failed authentication of the spoofed GNSS navigation signal meets the threshold authentication security level based on the accumulated plurality of spoofed cryptographic pseudorandom function ranging code samples being accumulated in accordance with the threshold ranging code accumulation requirement.

19. A receiver module comprising:
at least one receiver antenna configured to receive a plurality of navigation signals from a plurality of satellites of a satellite constellation, wherein at least a subset of the plurality of navigation signals are generated to include a cryptographic pseudorandom function ranging code generated via applying a corresponding cryptographic pseudorandom function;
at least one processor operable to authenticate ones of the plurality of navigation signals in accordance with meeting a threshold authentication security level based on:
storing, in memory, an accumulated plurality of cryptographic pseudorandom function ranging code samples extracted from a first navigation signal transmitted via a first satellite of the plurality of satellites;
receiving cryptographic pseudorandom function seed data;
generating a replica cryptographic pseudorandom function ranging code based on processing the cryptographic pseudorandom function seed data via the corresponding cryptographic pseudorandom function;
applying a linear time invariant matching filter to generate a plurality of first correlation data based on correlation of the replica cryptographic pseudorandom function ranging code with each of the accumulated plurality of cryptographic pseudorandom function ranging code samples; and
generating an aggregated value based on processing the plurality of first correlation data, wherein the first navigation signal is authenticated based on the aggregated value comparing favorably to a threshold value, and wherein authentication of the first navigation signal meets the threshold authentication security level based on the accumulated plurality of cryptographic pseudorandom function ranging code samples being accumulated in accordance with a threshold ranging code accumulation requirement.

20. A method for execution by at least one processor, comprising:
storing, in memory, an accumulated plurality of cryptographic pseudorandom function ranging code samples extracted from a first navigation signal;
receiving cryptographic pseudorandom function seed data;
generating a replica cryptographic pseudorandom function ranging code based on processing the cryptographic pseudorandom function seed data via a corresponding cryptographic pseudorandom function;
applying a linear time invariant matching filter to generate a plurality of first correlation data based on correlation of the replica cryptographic pseudorandom function ranging code with each of the accumulated plurality of ranging code samples; and
generating an aggregated value based on processing the plurality of first correlation data, wherein the first navigation signal is authenticated based on the aggregated value comparing favorably to a threshold value.
